(19) United States
(12) Patent Application Publication
(10) Pub. No.: US 2025/0243053 A1
(43) Pub. Date: Jul. 31, 2025

(54) SYSTEMS AND METHODS OF PROCESSING AMMONIA

(71) Applicant: AMOGY Inc., Brooklyn, NY (US)

(72) Inventors: Gregory Robert JOHNSON, Annandale, NJ (US); Young Suk JO, Brooklyn, NY (US); Zhong HE, Bridgewater, NJ (US); Cody Michael DIAZ, Brooklyn, NY (US); Jon KURILOFF, Saint James, NY (US); Hyunho KIM, Brooklyn, NY (US); Poornima NATARAJAN, Houston, TX (US); Ananya SRIVASTAVA, Houston, TX (US)

(21) Appl. No.: 19/170,638

(22) Filed: Apr. 4, 2025

Related U.S. Application Data
(63) Continuation of application No. PCT/US2023/076144, filed on Oct. 5, 2023.
Application No. PCT/US2023/076144 is a continuation of application No. 18/454,692, filed on Aug. 23, 2023, now Pat. No. 11,975,968.
Application No. 18/454,692 is a continuation of application No. 17/975,184, filed on Oct. 27, 2022, now Pat. No. 11,840,447.
Application No. 17/975,184 is a continuation of application No. 17/974,997, filed on Oct. 27, 2022, now Pat. No. 11,834,334.
Application No. 17/974,997 is a continuation of application No. 17/974,885, filed on Oct. 27, 2022, now Pat. No. 11,912,574.
(60) Provisional application No. 63/413,717, filed on Oct. 6, 2022.
(60) Provisional application No. 63/423,717, filed on Nov. 8, 2022.
(60) Provisional application No. 63/449,655, filed on Mar. 3, 2023.
(60) Provisional application No. 63/457,740, filed on Apr. 6, 2023.
(60) Provisional application No. 63/510,342, filed on Jun. 26, 2023.
(60) Provisional application No. 63/581,916, filed on Sep. 11, 2023.

(51) Int. Cl. C01B 3/04

(52) U.S. Cl. CPC C01B 3/047; C01B 2203/0244; C01B 2203/066; C01B 2203/0811; C01B 2203/1614; C01B 2203/1638

(57) ABSTRACT

The present disclosure provides systems and methods for processing ammonia (NH₃). A heater may heat reformers and NH₃ reforming catalysts therein. NH₃ may be directed to the reformers from storage tanks, and the NH₃ may be decomposed to generate a reformate stream comprising hydrogen (H₂) and nitrogen (N₂). At least part of the reformate stream may be used to heat the reformers.

### CROSS REFERENCE

This application is a continuation of International Patent Application No. PCT/US2023/076144, filed Oct. 5, 2023, which claims the benefit of U.S. Provisional Patent Application No. 63/413,717, filed Oct. 6, 2022, U.S. Provisional Patent Application No. 63/423,717, filed Nov. 8, 2022, U.S. Provisional Patent Application No. 63/449,655, filed Mar. 3, 2023, U.S. Provisional Patent Application No. 63/457,740, filed Apr. 6, 2023, U.S. Provisional Patent Application No. 63/510,342, filed Jun. 26, 2023, and U.S. Provisional Patent Application No. 63/581,916, filed Sep. 11, 2023; and, also claims priority to U.S. patent application Ser. No. 18/454,692, filed Aug. 23, 2023, now U.S. Pat. No. 11,975,968 issued May 7, 2024, which is a continuation of U.S. patent application Ser. No. 17/975,184, filed Oct. 27, 2022, now U.S. Pat. No. 11,840,447, issued Dec. 12, 2023, which is a continuation of U.S. patent application Ser. No. 17/974,997, filed Oct. 27, 2022, now U.S. Pat. No. 11,834,334, issued Dec. 5, 2023, which is a continuation of U.S. patent application Ser. No. 17/974,885, filed Oct. 27, 2022, now U.S. Pat. No. 11,912,574, issued Feb. 27, 2024, all of which are incorporated herein by reference in their entirety for all purposes.

### TECHNICAL FIELD

Generally, this disclosure provides systems and methods for processing ammonia (NH₃). In one example, NH₃ may be contacted with a catalyst in a heated reformer to generate a reformate stream comprising hydrogen (H₂) and nitrogen (N₂). In this example, the reformate stream may be directed to heat the reformer.

### BACKGROUND

Various systems may be operated using a fuel source. The fuel source may have a specific energy corresponding to an amount of energy stored or extractable per unit mass of fuel. The fuel source may be provided to the various systems to enable such systems to generate energy and/or deliver power (e.g., for movement or transportation purposes). Fossil fuels, such as coal, oil, and natural gas, remain the most widely used fuel type to power the various systems. Generally, fossil fuels are hydrocarbon materials containing carbon and hydrogen, and need to be burned to produce energy. Burning fossil fuels releases a large amount of carbon dioxide into the atmosphere, leading to pollution and global warming. As the world economy aims to decarbonize by 2050 or sooner, interest in zero-carbon (or carbon-neutral) energy systems has grown rapidly. A scalable zero-emission fuel (“SZEF”) is a chemical fuel that is produced using renewable, zero-carbon energy. Importantly, SZEF can replace fuels used in hard-to-decarbonize sectors. To that end, ammonia is an attractive alternative energy fuel source, especially because it does not contain carbon.

### SUMMARY

Hydrogen, being a scalable zero-emission fuel (SZEF), can be leveraged as clean energy to power various systems. Hydrogen can be synthetically produced without carbon emissions, for example, by electrolyzing freshwater using wind and solar energy. Hydrogen can provide advantages over other chemical fuels, such as diesel, gasoline, or jet fuel, which have specific energies of about 45 megajoules per kilogram (heat), as well as over lithium-ion batteries, which have specific energies of about 0.95 mega Joule (MJ)/kilogram (kg) (electrical). In contrast, hydrogen has a specific energy of over 140 MJ/kg (heat), such that 1 kg of hydrogen can provide the same amount of energy as about 3 kg of gasoline or kerosene. Thus, hydrogen reduces the amount of fuel (by mass) needed to provide a comparable amount of energy. Further, systems that consume hydrogen as a fuel generally produce benign or nontoxic byproducts such as water, and minimal or near zero greenhouse gas emissions (e.g., carbon dioxide and nitrous oxide), thereby reducing the environmental impacts of various systems (e.g., modes of transportation) that use hydrogen as a fuel source. Recognized herein are various limitations with hydrogen storage and production systems currently available. Although hydrogen has a relatively high gravimetric density (measured in MJ/kg), fuel storage systems for compressed and liquefied hydrogen are often complex due to specialized storage conditions. For example, storage of hydrogen may require tanks that can withstand high pressures (e.g., about 350-700 bar or about 5,000-10,000 psi), and/or may require cryogenic temperatures (since the boiling point of hydrogen at 1 atm of pressure is about −252.8° C.). Additionally, hydrogen storage containers may be constructed using materials that are highly specialized, costly, and difficult to develop, which may limit the ability to manufacture such hydrogen storage containers at a large scale. Ammonia (NH₃) is a SZEF that can be used as a hydrogen storage vector. Since ammonia can be stored at significantly lower pressures (and/or higher temperatures) than hydrogen, ammonia overcomes some of the aforementioned shortcomings of hydrogen. Further recognized herein are various limitations of conventional ammonia processing systems, which generally have slow startup times, non-ideal thermal characteristics, suboptimal ammonia conversion efficiencies, and high weight and volume requirements.

In one general aspect, the present disclosure provides a method for reforming ammonia, the method comprising:
(a) heating a first reformer to a first target temperature range;
(b) directing ammonia to the first reformer to produce reformate comprising hydrogen and nitrogen;
(c) combusting the reformate in a combustion heater to heat a second reformer to a second target temperature range; and
(d) directing additional ammonia to the second reformer to produce additional reformate, wherein a first portion of a reformate stream is combusted to heat the second reformer while ammonia is being reformed in the second reformer, wherein the reformate stream comprises the reformate, the additional reformate, or a combination thereof.

In some embodiments, the first portion of the reformate stream is produced from the ammonia, the additional ammonia, or a combination thereof.

In some embodiments, the method further comprises processing a second portion of the reformate stream in a hydrogen processing module.

In some embodiments, the hydrogen processing module is a fuel cell.

In some embodiments, the reformate stream is directed through a hydrogen processing module prior to combusting the first portion of the reformate stream to heat the second reformer.

In some embodiments, the reformate stream from the first reformer is further reformed in the second reformer.

In some embodiments, the additional reformate from the second reformer is directed to the first reformer.

In some embodiments, the additional reformate from the second reformer is further reformed in the first reformer.

In some embodiments, the additional ammonia is directed to the first reformer before being directed to the second reformer.

In some embodiments, a pressure of the reformate stream is reduced when the reformate stream is directed through the hydrogen processing module compared to when the reformate stream is not directed through the hydrogen processing module.

In some embodiments, a threshold amount of the reformate stream being directed to the hydrogen processing module results in directing at least about 80% of the reformate stream to the hydrogen processing module.

In some embodiments, an amount of ammonia directed to the second reformer is increased over a time period, wherein the time period begins when the second reformer is heated to the second target temperature range.

In some embodiments, the amount of ammonia directed to the second reformer is increased to a first target ammonia flowrate range.

In some embodiments, the reformate stream is directed to a hydrogen processing module when the first target ammonia flowrate range is reached.

In some embodiments, the ammonia flowrate is subsequently increased to a second target ammonia flowrate when the first target ammonia flowrate range is reached.

In some embodiments, the first portion of the reformate stream is combusted with oxygen, and the oxygen is provided in a substantially constant proportion relative to the hydrogen in the first portion of the reformate stream.

In some embodiments, the method further comprises ceasing to perform (a)-(c) after the second reformer reaches the second target temperature range.

In some embodiments, the first portion of the reformate stream is controlled so that the second reformer maintains a temperature in the second target temperature range.

In some embodiments, combustion of the reformate stream maintains a temperature in the second reformer in the second target temperature range.

In some embodiments, the reformate stream is directed to the combustion heater in thermal communication with the second reformer so that the combustion heater receives at least about 90% of the reformate stream.

In some embodiments, at least a portion of the reformate stream is directed out of the combustion heater.

In some embodiments, the method further comprises increasing an amount of a second portion of the reformate stream that is processed in a hydrogen processing module.

In some embodiments, the method further comprises increasing the amount of ammonia directed to the second reformer to a first target ammonia flowrate range.

In some embodiments, the reformate stream is combusted with a stoichiometric excess of oxygen, wherein the combusting is performed at an air-to-fuel ratio of greater than about 1 and less than about 5.

In some embodiments, the reformate stream or portion thereof is provided to a heat recovery module.

In some embodiments, the heat recovery module generates at least one of electricity, mechanical power, or combinations thereof.

In some embodiments, the reformate stream or portion thereof is provided to an auxiliary combustor configured to transfer heat to the heat recovery module, wherein the auxiliary combustor is separate from the combustion heater.

In some embodiments, directing the reformate stream or portion thereof to the heat recovery module bypasses the combustion heater.

In some embodiments, the first reformer is electrically heated.

In some embodiments, the first reformer is heated using combustion of a fuel.

In some embodiments, the reformate stream is combusted with a stoichiometric excess of oxygen.

In some embodiments, combusting the reformate stream with a stoichiometric excess of oxygen is performed at an air-to-fuel ratio of greater than about 1 and less than about 5.

In some embodiments, the oxygen is sourced from air.

In some embodiments, the first reformer comprises a first ammonia reforming catalyst and the second reformer comprises a second ammonia reforming catalyst.

In some embodiments, the first and second ammonia reforming catalysts are the same catalyst.

In some embodiments, the first target temperature range and the second target temperature range at least partially overlap.

In some embodiments, the method further comprises directing a combustion exhaust from the combustion heater to a heat recovery module.

In some embodiments, the heat recovery module generates at least one of electrical power or mechanical power.

In some embodiments, the combustion exhaust comprises one or more of hydrogen, nitrogen, oxygen, or water.

In some embodiments, the heat recovery module recovers at least one of exhaust heat or hydrogen from the combustion heater.

In some embodiments, the heat recovery module comprises a hydrogen separation membrane that recovers hydrogen from the combustion exhaust.

In some embodiments, the method further comprises combusting the reformate stream in an auxiliary combustor configured to transfer heat to the heat recovery module, wherein the auxiliary combustor is separate from the combustion heater.

In some embodiments, the heat recovery module is a boiler configured to generate steam.

In some embodiments, the method further comprises directing the steam to an ammonia filter configured to remove trace or residual ammonia from the reformate stream, wherein the steam regenerates the ammonia filter by desorbing the trace or residual ammonia from the ammonia filter.

In some embodiments, the heat recovery module comprises a heat exchanger.

In some embodiments, the heat exchanger comprises a shell-and-tube heat exchanger or a plate heat exchanger.

In some embodiments, the heat recovery module comprises a turbocharger.

In some embodiments, the turbocharger is configured to provide mechanical power to a compressor, wherein the compressor is configured to compress air.

In some embodiments, the air is provided to the combustion heater for combustion of the reformate stream.

In some embodiments, the heat recovery module comprises a turbine.

In some embodiments, the turbine is configured to generate mechanical power for propulsion of a vehicle.

In some embodiments, the turbine comprises a generator configured to generate electrical power for an electrical motor, wherein mechanical power generated by the electrical motor powers propulsion of a vehicle.

In some embodiments, the turbine comprises a generator configured to generate electrical power for a battery.

In some embodiments, the hydrogen processing module is a fuel cell configured to generate electrical power for an electrical motor, wherein mechanical power generated by the electrical motor and the mechanical power generated by the turbine are combined to power propulsion of a vehicle.

In some embodiments, the hydrogen processing module is a combustion engine configured to generate mechanical power, wherein the mechanical power generated by the combustion engine and the mechanical power generated by the turbine are combined to power propulsion of a vehicle.

In some embodiments, the heat recovery module is a Rankine module comprising a boiler, a turbine, and a condenser, wherein a working fluid is configured to circulate between the boiler, the turbine, and the condenser.

In some embodiments, the turbine of the Rankine module is configured to generate electrical power or mechanical power.

In some embodiments, the working fluid comprises water.

In some embodiments, the reformate stream or portion thereof is provided to a hydrogen separation membrane.

In some embodiments, directing the reformate stream or portion thereof to the hydrogen separation membrane bypasses the combustion heater.

In some embodiments, the method further comprises reigniting combustion in the combustion heater based at least in part on a temperature of a combustion exhaust from the combustion heater being less than a threshold temperature.

In some embodiments, the method further comprises reigniting combustion in the combustion heater based at least in part on an oxygen concentration of a combustion exhaust from the combustion heater being greater than a threshold oxygen concentration.

In another general aspect, the present disclosure provides a method for reforming ammonia, the method comprising:
(a) directing ammonia to a reformer at an ammonia flow rate to produce a reformate stream comprising hydrogen and nitrogen;
(b) combusting a first portion of the reformate stream with oxygen at an oxygen flow rate in a combustion heater to heat the reformer;
(c) processing a second portion of the reformate stream in a hydrogen processing module; and
(d) based at least in part on a stimulus, performing one or more of:
   (i) changing the ammonia flow rate,
   (ii) changing a percentage of the reformate stream that is the first portion of the reformate stream,
   (iii) changing a percentage of the reformate stream that is the second portion of the reformate stream, or
   (iv) changing an oxygen flow rate.

In some embodiments, at least two of (i)-(iv) are performed.

In some embodiments, at least three of (i)-(iv) are performed.

In some embodiments, all of (i)-(iv) are performed.

In some embodiments, the stimulus comprises a change in an amount of the hydrogen used by the hydrogen processing module.

In some embodiments, the stimulus comprises a temperature of the reformer being outside of a target temperature range.

In some embodiments, the stimulus comprises a change in an amount or concentration of ammonia in the reformate stream.

In some embodiments, one or more of (i)-(iv) are performed so that:
(x) a temperature of the reformer is within a target temperature range; and
(y) at most about 10% of the reformate is vented or flared.

In some embodiments, one or more of (i)-(iv) are achieved for at least about 95% of an operational time period.

In some embodiments, the operational time period is at least about 8 consecutive hours.

In some embodiments, the stimulus is based at least in part on an increased amount of the hydrogen used by the hydrogen processing module.

In some embodiments, the increased amount of hydrogen is a projected increased amount of hydrogen.

In some embodiments, based on the stimulus, one or more of:
(q) the ammonia flow rate is increased;
(r) the percentage of the reformate stream that is the first portion of the reformate stream is decreased; or
(s) the percentage of the reformate stream that is the second portion of the reformate stream is increased.

In some embodiments, the oxygen flow rate is increased when (q) is performed.

In some embodiments, the oxygen flow rate is decreased when at least one of (r) or(s) is performed.

In some embodiments, the stimulus is based at least in part on a decreased amount of the hydrogen used by the hydrogen processing module.

In some embodiments, the decreased amount of hydrogen is a projected decreased amount of hydrogen.

In some embodiments, based on the stimulus one or more of:
(q) the ammonia flow rate is decreased;
(r) the percentage of the reformate stream that is the first portion of the reformate stream is increased; or
(s) the percentage of the reformate stream that is the second portion of the reformate stream is decreased.

In some embodiments, the oxygen flow rate is decreased when (q) is performed.

In some embodiments, the oxygen flow rate is increased when at least one of (r) or(s) is performed.

In some embodiments, the stimulus comprises (a) a discontinued processing of hydrogen using the hydrogen processing module or (b) a fault or malfunction of the hydrogen processing module.

In some embodiments, the hydrogen processing module comprises a plurality of hydrogen processing modules, and the stimulus comprises at least one of (a) a discontinued processing of the hydrogen using one of the plurality of hydrogen processing modules or (b) a fault or malfunction in one of the plurality of hydrogen processing modules.

In some embodiments, the percentage of the reformate stream that is the second portion of the reformate stream is changed to about zero percent in response to the stimulus.

In some embodiments, at most about 10% of the reformate stream is directed to the hydrogen processing module in response to the stimulus.

In some embodiments, at least about 90% of the reformate stream is directed to a combustion heater in thermal communication with the reformer in response to the stimulus.

In some embodiments, a portion of the reformate stream is directed out of the combustion heater in response to the stimulus.

In some embodiments, the stimulus is detected using a sensor.

In some embodiments, the stimulus is communicated to a controller.

In some embodiments, (d) is performed with the aid of a programmable computer or controller.

In some embodiments, (d) is performed using a flow control module.

In some embodiments, the stimulus is a pressure.

In some embodiments, the pressure is increased in response to decreasing a flowrate to the hydrogen processing module.

In some embodiments, the pressure is a pressure of the reformate stream.

In some embodiments, the reformate stream is combusted with a stoichiometric excess of oxygen.

In some embodiments, combusting the reformate stream with a stoichiometric excess of oxygen is performed at an air-to-fuel ratio of greater than about 1 and less than about 5.

In some embodiments, the hydrogen processing module is a fuel cell.

In some embodiments, the method further comprises directing a combustion exhaust from the combustion heater to a heat recovery module.

In some embodiments, the heat recovery module generates at least one of electrical power or mechanical power.

In some embodiments, the combustion exhaust comprises one or more of hydrogen, nitrogen, oxygen, or water.

In some embodiments, the heat recovery module recovers at least one of exhaust heat or hydrogen from the combustion heater.

In some embodiments, the heat recovery module comprises a hydrogen separation membrane that recovers hydrogen from the combustion exhaust.

In some embodiments, the method further comprises combusting the reformate stream in an auxiliary combustor configured to transfer heat to the heat recovery module, wherein the auxiliary combustor is separate from the combustion heater.

In some embodiments, the heat recovery module is a boiler configured to generate steam.

In some embodiments, the method comprises directing the steam to an ammonia filter configured to remove trace or residual ammonia from the reformate stream, wherein the steam regenerates the ammonia filter by desorbing the trace or residual ammonia from the ammonia filter.

In some embodiments, the heat recovery module comprises a heat exchanger.

In some embodiments, the heat exchanger comprises a shell-and-tube heat exchanger or a plate heat exchanger.

In some embodiments, the heat recovery module comprises a turbocharger.

In some embodiments, the turbocharger is configured to provide mechanical power to a compressor, wherein the compressor is configured to compress air.

In some embodiments, the air is provided to the combustion heater for combustion of the reformate stream.

In some embodiments, the heat recovery module comprises a turbine.

In some embodiments, the turbine is configured to generate mechanical power for propulsion of a vehicle.

In some embodiments, the turbine comprises a generator configured to generate electrical power for an electrical motor, wherein mechanical power generated by the electrical motor powers propulsion of a vehicle.

In some embodiments, the turbine comprises a generator configured to generate electrical power for a battery.

In some embodiments, the hydrogen processing module is a fuel cell configured to generate electrical power for an electrical motor, wherein mechanical power generated by the electrical motor and the mechanical power generated by the turbine are combined to power propulsion of a vehicle.

In some embodiments, the hydrogen processing module is a combustion engine configured to generate mechanical power, wherein the mechanical power generated by the combustion engine and the mechanical power generated by the turbine are combined to power propulsion of a vehicle.

In some embodiments, the heat recovery module is a Rankine module comprising a boiler, a turbine, and a condenser, wherein a working fluid is configured to circulate between the boiler, the turbine, and the condenser.

In some embodiments, the turbine of the Rankine module is configured to generate electrical power or mechanical power.

In some embodiments, the working fluid comprises water.

In some embodiments, the reformate stream or portion thereof is provided to a hydrogen separation membrane.

In some embodiments, directing the reformate stream or portion thereof to the hydrogen separation membrane bypasses the combustion heater.

In some embodiments, the method comprises reigniting combustion in the combustion heater based at least in part on a temperature of a combustion exhaust from the combustion heater being less than a threshold temperature.

In some embodiments, the method comprises reigniting combustion in the combustion heater based at least in part on an oxygen concentration of a combustion exhaust from the combustion heater being greater than a threshold oxygen concentration.

In yet another general aspect, the present disclosure provides a method for reforming ammonia, the method comprising:
(a) directing ammonia to a reformer at an ammonia flow rate to produce a reformate stream comprising hydrogen and nitrogen;
(b) combusting a first portion of the reformate stream with oxygen at an oxygen flow rate in a combustion heater to heat the reformer;
(c) processing a second portion of the reformate stream in a hydrogen processing module;
(d) measuring a temperature in the reformer or the combustion heater; and
(e) based at least in part on the measured temperature being outside of a target temperature range of the reformer or the combustion heater, performing one or more of:
   (i) changing the ammonia flow rate,
   (ii) changing the oxygen flow rate,
   (ii). changing a percentage of the reformate stream that is the second portion of the reformate stream,
   (iv) changing a percentage of the reformate stream that is the first portion of the reformate stream, or
   (v) changing a percentage of the reformate stream that is directed out of the combustion heater.

In some embodiments, the hydrogen processing module is a fuel cell.

In some embodiments, the reformer comprises an ammonia reforming catalyst.

In some embodiments, at least two of (i)-(v) are performed.

In some embodiments, at least three of (i)-(v) are performed.

In some embodiments, all of (i)-(v) are performed.

In some embodiments, the temperature is measured using a temperature sensor.

In some embodiments, the measured temperature is communicated to a controller.

In some embodiments, (i)-(v) are performed with the aid of a controller.

In some embodiments, at least one of (iii)-(v) are performed using a flow control module.

In some embodiments, at least one of (iii)-(v) are performed by changing the second portion of reformate processed in the hydrogen processing module.

In some embodiments, the method comprising:
based at least in part on the measured temperature being greater than the target temperature range, performing one or more of:
(q) increasing the ammonia flow rate;
(r) increasing the percentage of the reformate stream that is the second portion of the reformate stream that is processed by the hydrogen processing module;
(s) decreasing the percentage of the reformate stream that is the first portion of the reformate stream;
(t) increasing the percentage of the reformate stream that is directed out of the combustion heater; or
(u) changing the oxygen flow rate.

In some embodiments, increasing the percentage of the reformate stream that is the second portion of the reformate stream decreases the first portion of the reformate stream that is combusted.

In some embodiments, the hydrogen processing module is a fuel cell, and the first portion of the reformate stream is an anode off-gas that is directed from the fuel cell to the combustion heater.

In some embodiments, decreasing the percentage of the reformate stream that is the first portion comprises decreasing the ammonia flow rate to the reformer to produce less hydrogen in the reformate stream.

In some embodiments, the hydrogen processing module is a fuel cell, and increasing the percentage of the second portion of the reformate stream that is processed by the hydrogen processing module increases an amount of power output by the fuel cell.

In some embodiments, the reformate stream is combusted with a stoichiometric excess of oxygen and changing the oxygen flow rate increases the oxygen flow rate.

In some embodiments, the reformate stream is combusted with a stoichiometric excess of hydrogen and changing the oxygen flow rate decreases the oxygen flow rate.

In some embodiments, the method comprises adding water to the reformate stream to decrease the temperature of the reformer or the combustion heater.

In some embodiments, the hydrogen processing module is a fuel cell, wherein the water is sourced from a cathode off-gas of the fuel cell.

In some embodiments, (t) comprises venting or flaring the percentage of the reformate stream that is directed out of the combustion heater.

In some embodiments, (t) comprises directing the percentage of the reformate stream that is directed out of the combustion heater to a heat recovery module.

In some embodiments, the method comprises:
based at least in part on the measured temperature being less than the target temperature range, performing one or more of:
(q) decreasing the ammonia flow rate
(r) decreasing the percentage of the reformate stream that is the second portion of the reformate stream that is processed by the hydrogen processing module;
(s) increasing the percentage of the reformate stream that is the first portion of the reformate stream;
(t) decreasing the percentage of the reformate stream that is directed out of the combustion heater; or
(v) changing the oxygen flow rate.

In some embodiments, decreasing the percentage of the second portion of the reformate stream that is the second portion increases the first portion of the reformate stream that is combusted.

In some embodiments, the hydrogen processing module is a fuel cell, and the first portion of the reformate stream is an anode off-gas that is directed from the fuel cell to the combustion heater.

In some embodiments, increasing the percentage of the reformate stream that is the first portion comprises increasing the ammonia flow rate to the reformer to produce more hydrogen in the reformate stream.

In some embodiments, the hydrogen processing module is a fuel cell, and decreasing the percentage of the second portion of the reformate stream that is processed by the hydrogen processing module decreases an amount of power output by the fuel cell.

In some embodiments, the reformate stream is combusted with a stoichiometric excess of oxygen and changing the oxygen flow rate decreases the oxygen flow rate.

In some embodiments, the reformate stream is combusted with a stoichiometric excess of hydrogen and changing the oxygen flow rate increases the oxygen flow rate.

In some embodiments, (t) comprises venting or flaring the percentage of the reformate stream that is directed out of the combustion heater.

In some embodiments, (t) comprises directing the percentage of the reformate stream that is directed out of the combustion heater to a heat recovery module.

In some embodiments, the method further comprises:
(x) calculating a temperature difference between the temperature measured in the reformer or the combustion heater and a set-point temperature within the target temperature range; and
(y) changing one or more of (i)-(v) by an amount that is based at least in part on the temperature difference.

In some embodiments, one or more of (i)-(v) are changed by a proportional factor.

In some embodiments, the proportional factor is different for each of (i)-(v).

In some embodiments, the method further comprises repeating (x) at a subsequent time point to obtain a subsequent temperature difference and repeating (y) to further change one or more of (i)-(v) by an amount that is proportional to the subsequent temperature difference.

In some embodiments, (x) and (y) are repeated until the measured temperature is within the target temperature range.

In some embodiments, the temperature measured in the reformer or the combustion heater is a first temperature that is measured at a first time point, the method further comprising:
(q) at second time point subsequent to the first time point, measuring a second temperature of the reformer or the combustion heater;
(r) calculating a time period between the first time point and the second time point;
(s) calculating a temperature difference between the first temperature and the second temperature; and
(t) changing one or more of (i)-(v) by an amount that is based at least in part on the time period and the temperature difference.

In some embodiments, the method further comprises repeating (q)-(t) until the measured temperature is within the target temperature range.

In some embodiments, the reformate stream is combusted with a stoichiometric excess of oxygen.

In some embodiments, combusting the reformate stream with a stoichiometric excess of oxygen comprises combusting at an air-to-fuel ratio of greater than about 1 and less than about 5.

In some embodiments, the method further comprises directing a combustion exhaust from the combustion heater to a heat recovery module.

In some embodiments, the heat recovery module generates at least one of electrical power or mechanical power.

In some embodiments, the combustion exhaust comprises one or more of hydrogen, nitrogen, oxygen, or water.

In some embodiments, the heat recovery module recovers at least one of exhaust heat or hydrogen from the combustion heater.

In some embodiments, the heat recovery module comprises a hydrogen separation membrane that recovers hydrogen from the combustion exhaust.

In some embodiments, the method further comprises combusting the reformate stream in an auxiliary combustor configured to transfer heat to the heat recovery module, wherein the auxiliary combustor is separate from the combustion heater.

In some embodiments, the heat recovery module is a boiler configured to generate steam.

In some embodiments, the method further comprises directing the steam to an ammonia filter configured to remove trace or residual ammonia from the reformate stream, wherein the steam regenerates the ammonia filter by desorbing the trace or residual ammonia from the ammonia filter.

In some embodiments, the heat recovery module comprises a heat exchanger.

In some embodiments, the heat exchanger comprises a shell-and-tube heat exchanger or a plate heat exchanger.

In some embodiments, the heat recovery module comprises a turbocharger.

In some embodiments, the turbocharger is configured to provide mechanical power to a compressor, wherein the compressor is configured to compress air.

In some embodiments, the air is provided to the combustion heater for combustion of the reformate stream.

In some embodiments, the heat recovery module comprises a turbine.

In some embodiments, the turbine is configured to generate mechanical power for propulsion of a vehicle.

In some embodiments, the turbine comprises a generator configured to generate electrical power for an electrical motor, wherein mechanical power generated by the electrical motor powers propulsion of a vehicle.

In some embodiments, the turbine comprises a generator configured to generate electrical power for a battery.

In some embodiments, the hydrogen processing module is a fuel cell configured to generate electrical power for an electrical motor, wherein mechanical power generated by the electrical motor and the mechanical power generated by the turbine are combined to power propulsion of a vehicle.

In some embodiments, the hydrogen processing module is a combustion engine configured to generate mechanical power, wherein the mechanical power generated by the combustion engine and the mechanical power generated by the turbine are combined to power propulsion of a vehicle.

In some embodiments, the heat recovery module is a Rankine module comprising a boiler, a turbine, and a condenser, wherein a working fluid is configured to circulate between the boiler, the turbine, and the condenser.

In some embodiments, the turbine of the Rankine module is configured to generate electrical power or mechanical power.

In some embodiments, the working fluid comprises water.

In some embodiments, the reformate stream or portion thereof is provided to a hydrogen separation membrane.

In some embodiments, directing the reformate stream or portion thereof to the hydrogen separation membrane bypasses the combustion heater.

In some embodiments, the method further comprises reigniting combustion in the combustion heater based at least in part on a temperature of a combustion exhaust from the combustion heater being less than a threshold temperature.

In some embodiments, the method further comprises reigniting combustion in the combustion heater based at least in part on an oxygen concentration of a combustion exhaust from the combustion heater being greater than a threshold oxygen concentration.

In some embodiments, the reformer comprises a plurality of reformers, wherein at least one reformer of the plurality of reformers receives a different amount of the first portion of the reformate stream, compared to others of the reformers, based at least partially on the temperature of the at least one reformer being greater or less than the target temperature range.

In some embodiments, the temperature of the at least one reformer is greater than the target temperature range, and the method comprises decreasing the first portion of the reformate stream provided to the at least one reformer.

In some embodiments, the temperature of the at least one reformer is less than the target temperature range, and the method comprises increasing the first portion of the reformate stream provided to the at least one reformer.

In some embodiments, the first portion of the reformate stream provided to the at least one reformer of the plurality of reformers is modulated using a flow control module.

In some embodiments, the plurality of the reformers comprises at least one electrically heated reformer and at least one combustion-heated reformer.

In some embodiments, at least two reformers of the plurality of reformers fluidically communicate in series so that the reformate stream exiting one of the at least two reformers is supplied to another of the at least two reformers.

In some embodiments, at least two reformers of the plurality of reformers fluidically communicate in parallel.

In some embodiments, the oxygen is sourced from air.

In some embodiments, the oxygen is sourced from air.

In some embodiments, the oxygen is sourced from air.

In yet another general aspect, the present disclosure provides an ammonia (NH₃) reforming method, the method comprising:
(e) heating a first reformer to a first target temperature range;
(f) reforming an NH₃ stream at a first flowrate in the first reformer to generate a first reformate stream comprising hydrogen (H₂) and nitrogen (N₂);
(g) combusting the first reformate stream to heat a second reformer to a second target temperature range;
(h) reforming the NH₃ stream at a second flowrate in the second reformer to generate a second reformate stream comprising H₂ and N₂, wherein the second flowrate is greater than the first flowrate; and
(i) combusting a first portion of the second reformate stream to heat the second reformer.

In some embodiments, the method further comprises increasing the second flowrate to an operating flowrate.

In some embodiments, the first flowrate is greater than about 1% and less than about 10% of the operating flowrate.

In some embodiments, the second flowrate, prior to being increased to the operating flowrate, is greater than about 5% and less than about 50% of the operating flowrate.

In some embodiments, the operating flowrate is chosen before (a).

In some embodiments, the operating flowrate is changed after increasing the second flowrate to the operating flowrate.

In some embodiments, the operating flowrate is chosen within a range of operating flowrates.

In some embodiments, the operating flowrate is changed based on an increase in H₂ demand of an H₂ processing module configured to process H₂.

In some embodiments, the H₂ processing module comprises a fuel cell configured to generate electricity.

In some embodiments, the operating flowrate is chosen at least in part based on a H₂ processing capacity of an H₂ processing module configured to process H₂.

In some embodiments, the H₂ processing module comprises a fuel cell configured to generate electricity.

In some embodiments, the operating flowrate is chosen at least in part based on a reforming capacity of the first reformer, a reforming capacity of the second reformer, or a combination thereof.

In some embodiments, the first reformate stream and the second reformate stream are separate streams.

In some embodiments, the first reformate stream is combined with the second reformate stream.

In some embodiments, the method further comprises purging at least one of the first reformer or the second reformer before (a) or (b).

In some embodiments, the method further comprises vaporizing the NH₃ stream using an electric heater.

In some embodiments, the method further comprises vaporizing the NH₃ stream using a heat exchanger configured to exchange heat between (1) the NH₃ stream, and one or more of (2) the first reformate stream, the second reformate stream, or a hydrogen processing module configured to generate electricity.

In some embodiments, the method further comprises reducing power to an electrical heater in thermal communication with the first reformer.

In some embodiments, the method further comprises using the NH₃ stream to cool the first reformer after reducing power to the electrical heater.

In some embodiments, the method further comprises, after (c), decreasing a portion of the NH₃ stream that is reformed in the first reformer.

In some embodiments, the method further comprises, after (c), ceasing to reform the NH₃ stream in the first reformer.

In some embodiments, ceasing to reform the NH₃ stream in the first reformer is performed after a measured temperature of the first reformer is less than or equal to a threshold temperature.

In some embodiments, the threshold temperature is less than the first target temperature range.

In some embodiments, the method further comprises reforming residual NH₃ in the first reformate stream using the second reformer.

In some embodiments, the method further comprises reforming residual NH₃ in the second reformate stream using the first reformer.

In some embodiments, a heat exchanger exchanges heat between (1) the NH₃ stream and at least one of (2) the first reformate stream or the second reformate stream.

In some embodiments, the method further comprises providing the NH₃ stream to the second reformer, wherein the NH₃ stream bypasses the first reformer.

In some embodiments, the NH₃ stream bypasses the first reformer after (c) or before (d).

In some embodiments, a heat exchanger is arranged in parallel fluid communication with the first reformer.

In some embodiments, the method further comprises providing the NH₃ stream to the heat exchanger, wherein the NH₃ stream bypasses the first reformer.

In some embodiments, the NH₃ stream bypasses the first reformer after (c) or before (d).

In some embodiments, the NH₃ stream is directed to the first reformer after exiting a heat exchanger, wherein the heat exchanger is configured to exchange heat between (1) the NH₃ stream and at least one of (2) the first reformate stream or the second reformate stream.

In some embodiments, the method further comprises directing the first reformate stream to a combustion heater in thermal communication with the second reformer.

In some embodiments, the method further comprises directing the first reformate stream to the second reformer before providing the first reformate stream to the combustion heater.

In some embodiments, the method further comprises directing the first reformate stream to the combustion heater, wherein the first reformate stream bypasses the second reformer.

In some embodiments, the method further comprises directing the first reformate stream to a heat exchanger before providing the first reformate stream to the combustion heater, wherein the heat exchanger is configured to exchange heat between the first reformate stream and the NH₃ stream.

In some embodiments, the method further comprises directing the first reformate stream to an NH₃ filter configured to remove residual NH₃ before providing the first reformate stream to the combustion heater.

In some embodiments, the method further comprises filtering at least one of the first reformate stream or the second reformate stream to remove residual NH₃.

In some embodiments, the method further comprises providing at least one of the first reformate stream or the second reformate stream to a combustion heater in thermal communication with the second reformer, wherein the at least one of the first reformate stream or the second reformate stream bypasses an NH₃ filter configured to remove residual NH₃.

In some embodiments, the method further comprises providing a second portion of the second reformate stream to an H₂ processing module.

In some embodiments, the H₂ processing module comprises a fuel cell configured to generate electricity.

In some embodiments, the H₂ processing module comprises a combustion engine configured to generate mechanical work.

In some embodiments, the method further comprises providing an off-gas comprising hydrogen from the H₂ processing module to a combustion heater in thermal communication with the second reformer.

In some embodiments, the first portion of the second reformate stream is provided to the combustion heater upstream of the H₂ processing module.

In some embodiments, (1) the first portion of the second reformate stream and (2) at least part of the off-gas are provided to the combustion heater simultaneously.

In some embodiments, at least one of (1) the first portion of the second reformate stream or (2) at least part of the off-gas is not provided to the combustion heater.

In some embodiments, (1) at least part of the off-gas is not provided to the combustion heater and (2) a remaining part of the off-gas is provided to the combustion heater.

In some embodiments, an H₂ utilization rate of the H₂ processing module is greater than about 10% and less than about 90% of the H₂ in the second portion of the reformate stream.

In some embodiments, an H₂ consumption rate of the H₂ processing module is constant within a tolerance, and the first portion of the second reformate stream is modulated to control a temperature in the second reformer.

In some embodiments, an H₂ utilization rate of the H₂ processing module is constant within a tolerance, and the first portion of the second reformate stream is modulated to control a temperature in the second reformer.

In some embodiments, the method further comprises processing at least a portion of the first reformate stream in a secondary H₂ processing module.

In some embodiments, the secondary H₂ processing module comprises a fuel cell configured to generate electricity.

In some embodiments, the method further comprises providing the first reformate stream to an NH₃ filter before providing at least the portion of the first reformate stream to the secondary H₂ processing module.

In some embodiments, the method further comprises providing an off-gas comprising hydrogen from the secondary H₂ processing module to a combustion heater in thermal communication with the second reformer.

In some embodiments, the method further comprises providing the first reformate stream, the second reformate stream, or a combination thereof to an ammonia oxidation catalyst to reduce residual ammonia.

In some embodiments, the method further comprises providing the first reformate stream, the second reformate stream, or the combination thereof to an NH₃ filter after providing the first reformate stream, the second reformate stream, or the combination thereof to the ammonia oxidation catalyst.

In some embodiments, the method further comprises transferring heat from (1) at least one of the first reformate stream or the second reformate stream to (2) the NH₃ stream.

In some embodiments, the heat is transferred using a heat transfer fluid.

In some embodiments, the method further comprises transferring heat from (1) a H₂ processing module configured to process H₂ to (2) the NH₃ stream.

In some embodiments, the heat is transferred using a heat transfer fluid.

In some embodiments, the method further comprises transferring heat from (1) a water or air source to (2) the NH₃ stream.

In some embodiments, the heat is transferred using a heat transfer fluid.

In some embodiments, the water or air source comprises seawater, freshwater, or air.

In some embodiments, the method further comprises transferring heat from (1) at least one of the first reformate stream or the second reformate stream to (2) a water or air source.

In some embodiments, the heat is transferred using a heat transfer fluid.

In some embodiments, the water or air source comprises seawater, freshwater, or air.

In some embodiments, the method further comprises transferring heat from (1) a H₂ processing module configured to process H₂ to (2) a water or air source.

In some embodiments, the heat is transferred using a heat transfer fluid.

In some embodiments, the water or air source comprises seawater, freshwater, or air.

In some embodiments, the method further comprises transferring heat from (1) a H₂ processing module configured to process H₂, the first reformate stream, the second reformate stream, or a combination thereof to (2) a water or air source.

In some embodiments, the heat is transferred using a heat transfer fluid.

In some embodiments, the water or air source comprises seawater, freshwater, or air.

In some embodiments, the first reformer and the second reformer are a single reformer.

In some embodiments, the single reformer is in thermal communication with an electric heater, a combustion heater, or a combination thereof.

In yet another general aspect, the present disclosure provides an ammonia (NH₃) reforming system, the system comprising:
a first reformer configured to reform an NH₃ stream at a first flowrate and at a first target temperature range to generate a first reformate stream comprising hydrogen (H₂) and nitrogen (N₂); and
a second reformer configured to reform the NH₃ stream at a second flowrate and at a second target temperature range to generate a second reformate stream comprising H₂ and N₂,
wherein the second reformer is configured to be heated to the second target temperature range by combusting the first reformate stream,
wherein the second flowrate is greater than the first flowrate, and
wherein the second reformer is configured to be heated by combusting a first portion of the second reformate stream.

In yet another general aspect, the present disclosure provides an ammonia (NH₃) reforming method, the method comprising:
(j) reforming an NH₃ stream at a first flowrate using an NH₃ reforming catalyst to generate a first reformate stream comprising hydrogen (H₂) and nitrogen (N₂);
(k) combusting the first reformate stream to heat the NH₃ reforming catalyst;
(l) reforming the NH₃ stream at a second flowrate using the NH₃ reforming catalyst to generate a second reformate stream comprising H₂ and N₂, wherein the second flowrate is greater than the first flowrate; and
(m) combusting a first portion of the second reformate stream to heat the NH₃ reforming catalyst.

In some embodiments, the NH₃ reforming catalyst is in a reformer.

In some embodiments, a first region of the NH₃ reforming catalyst is in a first reformer, and a second region of the NH₃ reforming catalyst is in a second reformer.

In some embodiments, the NH₃ reforming catalyst is in thermal communication with an electric heater, a combustion heater, or a combination thereof.

In some embodiments, the NH₃ reforming catalyst is heated by an electrical heater before (a).

In some embodiments, a first region of the NH₃ reforming catalyst is heated by an electrical heater, and a second region of the NH₃ reforming catalyst is heated by a combustion heater.

In some embodiments, (b) and (d) are performed using the combustion heater.

In some embodiments, the NH₃ reforming catalyst is heated to a target temperature range.

In some embodiments, the NH₃ reforming catalyst is at a target temperature range.

In some embodiments, a first region of the NH₃ reforming catalyst is heated to a first target temperature range, and a second region of the NH₃ reforming catalyst is heated to a second target temperature range.

In some embodiments, the first target temperature range and the second target temperature range at least partially overlap.

In some embodiments, the first target temperature range and the second target temperature range are different.

In some embodiments, a midpoint temperature of the first target temperature range is greater than a midpoint temperature of the second target temperature range.

In yet another general aspect, the present disclosure provides an ammonia decomposition system, the system comprising:
a reformer configured to reform ammonia to generate a reformate stream comprising hydrogen, nitrogen, and residual ammonia;
a hydrogen processing module configured to utilize a portion of the hydrogen in the reformate stream, and output an exhaust comprising water;
a water extraction device configured to extract the water from the exhaust; and
an ammonia filter configured to reduce a concentration of the residual ammonia in the reformate stream using scrubbing fluid, wherein the scrubbing fluid comprises at least part of the water extracted from the exhaust.

In some embodiments, the hydrogen processing module comprises a fuel cell.

In some embodiments, a portion of the extracted water is used to humidify at least one of an anode or a cathode of the fuel cell.

In some embodiments, the exhaust comprises an anode exhaust of the fuel cell or a cathode exhaust of the fuel cell.

In some embodiments, at least about 10% of the scrubbing fluid is the extracted water.

In some embodiments, about 100% of the scrubbing fluid is the extracted water.

In some embodiments, a portion of the extracted water is provided to a combustion heater.

In some embodiments, the ammonia filter is configured to discharge the scrubbing fluid.

In some embodiments, the discharged scrubbing fluid comprises at least about 5% ammonia by weight and at most about 60% ammonia by weight.

In some embodiments, at most 10% of the water extracted from the exhaust is discharged externally.

In some embodiments, the scrubbing fluid comprises an acid.

In some embodiments, the acid comprises sulfuric acid or nitric acid.

In yet another general aspect, the present disclosure provides an ammonia decomposition system, the system comprising:
a reformer configured to reform ammonia to generate a reformate stream comprising hydrogen, nitrogen, and residual ammonia; and
a first NH₃ filter configured to reduce a concentration of the ammonia using scrubbing fluid.

In some embodiments, the ammonia is provided to the first NH₃ filter from a position between an NH₃ storage tank and the reformer.

In some embodiments, the position is at one or more fluid lines that fluidically couple at least one of:
an ammonia storage tank and the reformer;
the ammonia storage tank and a flow control module; or
the flow control module and the reformer.

3 In some embodiments, the ammonia is diluted with air before being provided to the first NH₃ filter.

In some embodiments, the method further comprises a second NH₃ filter configured to reduce a concentration of the residual ammonia in the reformate stream using a scrubbing fluid.

In some embodiments, the reformate stream is provided to the second NH₃ filter from a position between the reformer and an H₂ processing module.

In some embodiments, the position is at one or more fluid lines that fluidically couple at least one of:
the reformer and an H₂ processing module;
the reformer and an adsorbent;
the adsorbent and the H₂ processing module;
the reformer and a first flow control module;
the first flow control module and the adsorbent
the adsorbent and a second flow control module; or
the second flow control module and the H₂ processing module.

In some embodiments, the reformate stream is diluted with an inert gas before being provided to the second NH₃ filter.

In yet another general aspect, the present disclosure provides an ammonia decomposition system, the system comprising:
a reformer configured to reform ammonia to generate a reformate stream comprising hydrogen and nitrogen; and
a reactor adjacent to the reformer configured to transfer heat from an exothermic reaction to the reformer, wherein the exothermic reaction consumes at least a portion of the hydrogen.

In some embodiments, the exothermic reaction comprises oil hydrogenation.

In yet another general aspect, the present disclosure provides an ammonia decomposition system, the system comprising:
an electrical heater configured to heat a reformer to a target temperature range, wherein the reformer is configured to reform ammonia to generate a reformate stream comprising hydrogen and nitrogen; and
an H₂ processing module configured to utilize a portion of the hydrogen in the reformate stream to generate electrical power,
wherein the utilized portion comprises at least about 80% of the hydrogen in the reformate stream, and
wherein at least part of the electrical power generated by the H₂ processing module is provided to the electrical heater to heat the reformer.

In some embodiments, the hydrogen processing module comprises a fuel cell.

In some embodiments, the hydrogen processing module comprises a combustion engine.

In some embodiments, the electrical heater is configured to receive low-carbon electrical power to heat the reformer.

In some embodiments, the low-carbon electrical power is sourced from at least one of:
a photovoltaic solar generator;
a concentrated solar power (CSP) generator;
a wind turbine generator;
a hydropower generator;
a geothermal generator;
a biofuel-fired generator;
an ocean-power generator;
a nuclear generator; or
stored electrical power.

In some embodiments, a portion of the hydrogen in the reformate stream is not utilized in the H₂ processing module.

In some embodiments, the nonutilized portion of the hydrogen comprises less than about 20% of the hydrogen.

In some embodiments, the nonutilized portion of the hydrogen is provided to a filter configured to remove water, ammonia, or a combination thereof.

In some embodiments, the nonutilized portion of the hydrogen is used to purge an ammonia filter.

In some embodiments, the nonutilized portion of the hydrogen is combusted to heat at least one of:
the reformer;
an NH₃ filter to desorb ammonia from the NH₃ filter;
a water filter to desorb water from the water filter;
a water boiler; or
a heat-transfer fluid.

In some embodiments, the nonutilized portion of the hydrogen is not provided to the H₂ processing module.

In yet another general aspect, the present disclosure provides an ammonia reforming method, the method comprising:
(a) reforming ammonia (NH₃) using a reformer to generate a reformate stream comprising hydrogen (H₂), nitrogen (N₂), and residual ammonia;
(b) reducing a concentration of the residual ammonia in the reformate stream using scrubbing fluid; and
(c) further reducing the concentration of the residual ammonia in the reformate stream using an adsorbent.

In some embodiments, the method further comprises using a water extraction device to extract water from the reformate stream.

In some embodiments, the water extraction device extracts the water from the reformate stream after (b).

In some embodiments, the water extraction device comprises a chiller or condenser.

In some embodiments, the scrubbing fluid comprises a first scrubbing fluid and a second scrubbing fluid arranged in parallel fluid communication.

In some embodiments, the first scrubbing fluid stops performing (b) and the second scrubbing fluid starts performing (b).

In some embodiments, the method further comprises utilizing at least a portion of the hydrogen in the reformate stream using a fuel cell to generate electricity.

In some embodiments, the method further comprises outputting an anode off-gas and a cathode off-gas from the fuel cell.

In some embodiments, the method further comprises extracting water from at least one of (i) the anode off-gas or (ii) the cathode off-gas using one or more water extraction devices and providing the extracted water to a drain tank.

In some embodiments, the extracted water is provided to the drain tank using gravity.

In some embodiments, the method further comprises extracting water from a combustion exhaust output by a combustion heater configured to heat the reformer, and providing the water extracted from the combustion exhaust to the drain tank.

In some embodiments, the method further comprises providing the extracted water to the scrubbing fluid.

In some embodiments, the method further comprises using a perfluorinated and polyfluorinated substance (PFAS) filter to remove PFAS from the extracted water.

In some embodiments, the method further comprises discharging the extracted water after filtering to remove the PFAS.

In some embodiments, the extracted water is discharged based on a concentration of the PFAS in the extracted water being less than a threshold concentration.

In yet another general aspect, the present disclosure provides an ammonia reforming method, the method comprising:
(a) reforming ammonia (NH₃) using a reformer to generate a reformate stream comprising hydrogen (H₂) and nitrogen (N₂);
(b) utilizing at least a portion of the hydrogen in the reformate stream using a fuel cell to generate electricity;
(c) outputting an anode off-gas and a cathode off-gas from the fuel cell;
(d) extracting water from at least one of (i) the anode off-gas or (ii) the cathode off-gas using one or more water extraction devices; and
(e) using a perfluorinated and polyfluorinated substance (PFAS) filter to remove PFAS from the extracted water.

In some embodiments, the method further comprises reducing a concentration of residual ammonia in the reformate stream using scrubbing fluid.

In some embodiments, the scrubbing fluid reduces the concentration of the residual ammonia in the reformate stream after (a).

In some embodiments, the method further comprises providing the extracted water to the scrubbing fluid.

In some embodiments, the extracted water is provided to the scrubbing fluid after (d).

In some embodiments, the method further comprises discharging the extracted water after filtering to remove the PFAS.

In some embodiments, the extracted water is discharged based on a concentration of the PFAS in the extracted water being less than a threshold concentration.

In yet another general aspect, the present disclosure provides a method, comprising: reforming ammonia (NH₃) in a reformer to generate a reformate stream comprising hydrogen (H₂), nitrogen (N₂), and residual ammonia; reducing a concentration of the residual ammonia in the reformate stream by passing the reformate stream through a scrubber comprising a scrubbing fluid, thereby generating an ammonia-containing solution comprising at least part of the residual ammonia and the scrubbing fluid, and generating a purified reformate stream; reducing a concentration of the at least part of the residual ammonia in the ammonia-containing solution by passing a gas stream through a stripper comprising the ammonia-containing solution, thereby regenerating the scrubbing fluid, and generating an ammonia-containing gas stream including the at least part of the residual ammonia.

In some embodiments, the gas stream comprises at least one of air or an inert gas.

In some embodiments, the method further comprises heating the reformer using a combustion heater; and transferring heat from a combustion exhaust of the combustion heater to the gas stream before the gas stream passes through the stripper.

In some embodiments, the method further comprises transferring heat from the reformate stream to the gas stream before the gas stream passes through the stripper.

In some embodiments, the method further comprises heating the reformer using a combustion heater; and transferring heat from the combustion exhaust to the ammonia-containing solution before providing the ammonia-containing solution from the scrubber to the stripper.

In some embodiments, the method further comprises transferring heat from the reformate stream to the ammonia-containing solution stream before providing the ammonia-containing solution from the scrubber to the stripper.

In some embodiments, the method further comprises oxidizing the at least part of the residual ammonia in the ammonia-containing gas stream, thereby generating a purified gas stream.

In some embodiments, the at least part of the residual ammonia is oxidized using an ammonia oxidation catalyst.

In some embodiments, the purified gas stream is provided to a combustion heater.

In some embodiments, the combustion heater is configured to heat the reformer.

In some embodiments, the regenerated scrubbing fluid is provided from the stripper to the scrubber.

In some embodiments, the method further comprises transferring heat from the scrubbing fluid to the ammonia.

In some embodiments, the heat is transferred from the scrubbing fluid to the ammonia before at least one of: the reforming of the ammonia; or the reducing of the concentration of the residual ammonia in the reformate stream by passing the reformate stream through the scrubber.

In some embodiments, the method further comprises transferring heat from the scrubbing fluid regenerated by the stripper to the ammonia-containing solution.

In some embodiments, the method further comprises using an ammonia filter to reduce a concentration of a remaining part of the residual ammonia in the purified reformate stream.

In some embodiments, the ammonia filter comprises an adsorbent.

In some embodiments, the ammonia filter comprises an ion exchange filter.

In some embodiments, the method further comprises using a water extraction device to reduce a concentration of water in the purified reformate stream.

In some embodiments, the water extraction device comprises a silica gel.

In some embodiments, the water extraction device comprises a membrane humidifier.

In some embodiments, the membrane humidifier is configured to humidify the purified reformate stream after an adsorbent reduces the concentration of a remaining part of the residual ammonia in the purified reformate stream.

In some embodiments, the membrane humidifier is configured to humidify the purified reformate stream before an ion exchange filter reduces the concentration of a remaining part of the residual ammonia in the purified reformate stream.

In another general aspect, the present disclosure provides an ammonia reforming system, comprising: an ammonia reformer configured to reform ammonia (NH₃) to generate a reformate stream comprising hydrogen (H₂), nitrogen (N₂), and residual ammonia; a scrubber comprising a scrubbing fluid, wherein the scrubber is configured to reduce a concentration of the residual ammonia in the reformate stream by passing the reformate stream through the scrubber, thereby generating an ammonia-containing solution comprising at least part of the residual ammonia and the scrubbing fluid, and generating a purified reformate stream; a stripper configured to reduce a concentration of the at least part of the residual ammonia in the ammonia-containing solution by passing a gas stream through the stripper comprising the ammonia-containing solution, thereby regenerating the scrubbing fluid, and generating an ammonia-containing gas stream including the at least part of the residual ammonia.

In another general aspect, the present disclosure provides an ammonia reforming method, comprising reforming ammonia (NH₃) in a reformer to generate a reformate stream comprising hydrogen (H₂) and nitrogen (N₂); and using a fuel cell to process a second portion of the hydrogen in the reformate stream to generate electricity.

In some embodiments, the fuel cell comprises at least one of: a proton exchange membrane fuel cell (PEMFC), a solid oxide fuel cell (SOFC), a phosphoric acid fuel cell (PAFC), or a molten carbonate fuel cell (MCFC).

In some embodiments, the method further comprises transferring heat from the fuel cell to the ammonia before the ammonia is reformed in the reformer.

In some embodiments, the heat is transferred from the fuel cell to the ammonia by transferring heat from at least one of (i) an anode off-gas of the fuel cell, (ii) a cathode off-gas of the fuel cell, or (iii) a heat transfer fluid configured to cool the fuel cell.

In some embodiments, the method further comprises driving a turbine using the heat transfer fluid before transferring heat from the heat transfer fluid to the ammonia.

In some embodiments, the method further comprises driving a turbine using the heated ammonia before the ammonia is reformed.

In some embodiments, the method further comprises transferring heat from the fuel cell to a gas stream.

In some embodiments, the heat is transferred from the fuel cell to the gas stream by transferring heat from at least one of (i) an anode off-gas of the fuel cell, (ii) a cathode off-gas of the fuel cell, or (iii) a heat transfer fluid configured to cool the fuel cell.

In some embodiments, the method further comprises providing the heated gas stream to at least one of (i) the fuel cell, (ii) a combustion heater configured to heat the reformer, or (iii) a stripper configured to remove at least part of residual ammonia from an ammonia-containing solution.

In some embodiments, the method further comprises compressing an air stream, and providing the compressed air stream to the fuel cell and a combustion heater configured to heat the reformer.

In some embodiments, the method further comprises driving a turbine using the reformate stream.

In some embodiments, the method further comprises using the turbine to drive a compressor configured to compress an anode off-gas of the fuel cell.

In some embodiments, the method further comprises transferring heat from the fuel cell to an ammonia-containing solution.

In some embodiments, the heat is transferred to the ammonia-containing solution from at least one of (i) an anode off-gas of the fuel cell, (ii) a cathode off-gas of the fuel cell, or (iii) a heat transfer fluid configured to cool the fuel cell.

In some embodiments, the ammonia-containing solution is generated by passing the reformate stream through a scrubber to remove at least part of residual ammonia in the reformate stream.

In some embodiments, the method further comprises providing the heated ammonia-containing solution to a stripper configured to remove the at least part of the residual ammonia from the ammonia-containing solution.

In some embodiments, the method further comprises generating a mixture by mixing at least two of (i) an anode off-gas of the fuel cell, (ii) a gas stream, or (iii) a first portion of the hydrogen in the reformate stream.

In some embodiments, the method further comprises providing the mixture to a combustion heater configured to heat the reformer.

In some embodiments, the mixture is generated using a vacuum ejector.

In some embodiments, the method further comprises providing the reformate stream to a membrane configured to separate the hydrogen from the nitrogen and residual ammonia in the reformate stream. The membrane may generate a permeate stream comprising the separated hydrogen. The membrane may generate a retentate stream comprising leftover hydrogen that is not separated by the membrane, the nitrogen, and the residual ammonia.

In some embodiments, the method further comprises providing the permeate stream to the fuel cell.

In some embodiments, the method further comprises providing an anode off-gas of the fuel cell to the permeate stream.

In some embodiments, the method further comprises providing the retentate stream to a combustion heater configured to heat the reformer.

In some embodiments, the method further comprises providing the retentate stream to an ammonia oxidation catalyst before providing the retentate stream to the combustion heater.

In some embodiments, the method further comprises providing at least part of an anode off-gas of the fuel cell to an ammonia oxidation catalyst.

In some embodiments, the method further comprises providing a first part of a cathode off-gas of the fuel cell to the ammonia oxidation catalyst.

In some embodiments, the method further comprises providing a purified anode off-gas from the ammonia oxidation catalyst to a combustion heater in thermal communication with the reformer.

In some embodiments, the method further comprises providing a second part of a cathode off-gas of the fuel cell to the combustion heater.

In some embodiments, the method further comprises transferring heat from a combustion exhaust of the combustion heater to at least one of (i) an air stream provided to the fuel cell, or (ii) the ammonia provided to the reformer.

In some embodiments, the method further comprises using a combustion exhaust of the combustion heater to drive a turbine.

In some embodiments, the method further comprises using the turbine to drive a compressor configured to compress at least one of (i) an air stream provided to the fuel cell, (ii) the reformate stream generated by the reformer, or (iii) the anode off-gas of the fuel cell.

In yet another general aspect, the present disclosure provides a system, comprising: a reformer configured to reform ammonia (NH₃) to generate a reformate stream comprising hydrogen (H₂) and nitrogen (N₂); and a fuel cell configured to process a second portion of the hydrogen in the reformate stream to generate electricity.

In yet another general aspect, the present disclosure provides a method, comprising oxidizing residual ammonia in a gas stream using an ammonia oxidation catalyst.

In some embodiments, the method further comprises, before oxidizing the residual ammonia in the gas stream, desorbing the residual ammonia from an adsorbent using the gas stream.

In some embodiments, the adsorbent is configured to adsorb the residual ammonia from a reformate stream comprising hydrogen (H₂), nitrogen (N₂), and the residual ammonia.

In some embodiments, the method further comprises, before oxidizing the residual ammonia in the gas stream, removing the residual ammonia from an ammonia-contaminated scrubbing fluid using the gas stream, thereby regenerating the scrubbing fluid.

In some embodiments, the method further comprises, before oxidizing the residual ammonia in the gas stream, separating the residual ammonia from a reformate stream comprising hydrogen (H₂), nitrogen (N₂), and the residual ammonia, thereby generating the gas stream including the residual ammonia.

In some embodiments, the method further comprises absorbing heat from the oxidation by reforming leftover residual ammonia that is not oxidized using an ammonia reforming catalyst.

In some embodiments, the ammonia reforming catalyst is in thermal communication with the ammonia oxidation catalyst.

In some embodiments, the gas stream is at least one of (i) a reformate stream comprising hydrogen and nitrogen, (ii) an inert gas, or (iii) air.

In some embodiments, the method further comprises absorbing heat from the oxidation by boiling fluid in a boiler.

In some embodiments, the boiler in thermal communication with the ammonia oxidation catalyst.

In some embodiments, an ammonia oxidation catalyst is configured to oxidize residual ammonia in a gas stream.

In yet another general aspect, the present disclosure provides an ammonia reforming method, comprising:
(a) heating a first reformer to a first target temperature range;
(b) reforming an NH₃ stream at a first flowrate in the first reformer to generate a first reformate stream comprising hydrogen (H₂) and nitrogen (N₂);
(c) combusting at least part of the first reformate stream to heat a second reformer to a second target temperature range;
(d) reforming the NH₃ stream at a second flowrate in the second reformer to generate a second reformate stream comprising H₂ and N₂, wherein the second flowrate is greater than the first flowrate; and
(e) combusting a first portion of the second reformate stream to heat the second reformer.

In some embodiments, the first reformer comprises a first ammonia reforming catalyst and the second reformer comprises a second ammonia reforming catalyst.

In some embodiments, the first ammonia reforming catalyst comprises at least one of: Ru, Pt, Pd, Ni, Co, Mo, Fe, or Cu.

In some embodiments, the second ammonia reforming catalyst comprises at least one of: Ru, Pt, Pd, Ni, Co, Mo, Fe, or Cu.

In some embodiments, the first ammonia reforming catalyst and the second ammonia reforming catalyst have a same chemical composition.

In some embodiments, the first ammonia reforming catalyst and the second ammonia reforming catalyst have at least partially a same chemical composition.

In some embodiments, the first ammonia reforming catalyst and the second ammonia reforming catalyst have different chemical compositions.

In some embodiments, the first reformer and the second reformer have different housings or vessels.

In some embodiments, the first reformer and the second reformer share a housing or vessel.

In some embodiments, the first reformer is a first region of the housing or vessel, and the second reformer is a second region of the housing or vessel.

In some embodiments, the first reformer and the second reformer are at least partially in thermal communication with each other.

In some embodiments, the first reformer and the second reformer are in fluid communication.

In some embodiments, the method further comprises passing at least one of the following through the first reformer, the second reformer, or a combination thereof: (i) the NH₃ stream at the first flowrate, (ii) the NH₃ stream at the second flowrate, (iii) the first reformate stream, or (iv) the second reformate stream.

In some embodiments, the method further comprises passing at least three of (i) to (iv) through the first reformer, the second reformer, or a combination thereof.

In some embodiments, the method further comprises passing all of (i) to (iv) through the first reformer, the second reformer, or a combination thereof.

In some embodiments, the method further comprises ceasing the passing of at least one of (i) to (iv) through the first reformer, the second reformer, or a combination thereof.

In some embodiments, the method further comprises reducing the passing of at least one of (i) to (iv) through the first reformer, the second reformer, or a combination thereof.

In some embodiments, (i) or (ii) are at least partially reformed in the first reformer and subsequently reformed in the second reformer.

In some embodiments, (i) or (ii) are at least partially reformed in the second reformer and subsequently reformed in the first reformer.

In some embodiments, the method further comprises ceasing or reducing the heating of the first reformer.

In some embodiments, the method further comprises using a combustion heater to combust at least one of (1) the first reformate stream or (2) the first portion of the second reformate stream, wherein the combustion heater is in thermal communication with the second reformer.

In some embodiments, the combustion heater performs at least one of (c) or (e).

In some embodiments, the combustion that heats the second reformer is fuel-rich.

In some embodiments, the combustion that heats the second reformer is fuel-lean.

In some embodiments, the method further comprises using an electrical heater to heat the first reformer.

In some embodiments, the method further comprises using a combustion heater to combust a fuel to heat the first reformer, wherein the combustion heater is in thermal communication with the first reformer.

In some embodiments, the fuel comprises at least one of hydrogen, ammonia, a hydrocarbon, or at least part of the first reformate stream.

In some embodiments, the fuel is supplied from a fuel storage tank.

In some embodiments, the combustion that heats the first reformer is fuel-rich.

In some embodiments, the combustion that heats the first reformer is fuel-lean.

In yet another general aspect, the present disclosure provides an ammonia (NH₃) reforming system, comprising: a first reformer configured to reform an NH₃ stream at a first flowrate and at a first target temperature range to generate a first reformate stream comprising hydrogen (H₂) and nitrogen (N₂); wherein the first reformer is configured to be heated to the first target temperature range; and a second reformer configured to reform the NH₃ stream at a second flowrate and at a second target temperature range to generate a second reformate stream comprising H₂ and N₂, wherein the second reformer is configured to be heated to the second target temperature range by combusting the first reformate stream, wherein the second flowrate is greater than the first flowrate, and
wherein the second reformer is configured to be heated by combusting a first portion of the second reformate stream.

In some embodiments, the first reformer comprises a first ammonia reforming catalyst and the second reformer comprises a second ammonia reforming catalyst.

In some embodiments, the first ammonia reforming catalyst comprises at least one of: Ru, Pt, Pd, Ni, Co, Mo, Fe, or Cu.

In some embodiments, the second ammonia reforming catalyst comprises at least one of: Ru, Pt, Pd, Ni, Co, Mo, Fe, or Cu.

In some embodiments, the first ammonia reforming catalyst and the second ammonia reforming catalyst have a same chemical composition.

In some embodiments, the first ammonia reforming catalyst and the second ammonia reforming catalyst have at least partially a same chemical composition.

In some embodiments, the first ammonia reforming catalyst and the second ammonia reforming catalyst have different chemical compositions.

In some embodiments, the first reformer and the second reformer have different housings or vessels

In some embodiments, the first reformer and the second reformer share a housing or vessel.

In some embodiments, the first reformer is a first region of the housing or vessel, and the second reformer is a second region of the housing or vessel.

In some embodiments, the first reformer and the second reformer are at least partially in thermal communication with each other.

In some embodiments, the first reformer and the second reformer are in fluid communication.

In some embodiments, the first reformer, the second reformer, or a combination thereof are configured to receive at least one of the following: (i) the NH₃ stream at the first flowrate, (ii) the NH₃ stream at the second flowrate, (iii) the first reformate stream, or (iv) the second reformate stream.

In some embodiments, the first reformer, the second reformer, or a combination thereof are configured to receive at least three of (i) to (iv).

In some embodiments, the first reformer, the second reformer, or a combination thereof are configured to receive all of (i) to (iv).

In some embodiments, the first reformer, the second reformer, or a combination thereof are configured to cease receiving at least one of (i) to (iv).

In some embodiments, the first reformer, the second reformer, or a combination thereof are configured to reduce receiving at least one of (i) to (iv).

In some embodiments, the first reformer is configured to partially reform (i) or (ii), and the second reformer is configured to subsequently reform (i) or (ii).

In some embodiments, the second reformer is configured to partially reform (i) or (ii), and the first reformer is configured to subsequently reform (i) or (ii).

In some embodiments, the first reformer is configured to cease or reduce heating.

In some embodiments, the system further comprises a combustion heater configured to combust at least one of (1) the first reformate stream or (2) the first portion of the second reformate stream to heat the second reformer, wherein the combustion heater is in thermal communication with the second reformer.

In some embodiments, the combustion that heats the second reformer is fuel-rich.

In some embodiments, the combustion that heats the second reformer is fuel-lean.

In some embodiments, the system further comprises an electrical heater configured to heat the first reformer.

In some embodiments, the system further comprises a combustion heater configured to combust a fuel to heat the first reformer, wherein the combustion heater is in thermal communication with the first reformer.

In some embodiments, the fuel comprises at least one of hydrogen, ammonia, a hydrocarbon, or at least part of the first reformate stream.

In some embodiments, the fuel is supplied from a fuel storage tank.

In some embodiments, the combustion that heats the first reformer is fuel-rich.

In some embodiments, the combustion that heats the first reformer is fuel-lean.

In another general aspect, the present disclosure provides an ammonia (NH₃) reforming method, comprising: (a) reforming an NH₃ stream at a first flowrate using an NH₃ reforming catalyst to generate a first reformate stream comprising hydrogen (H₂) and nitrogen (N₂); (b)
combusting the first reformate stream to heat the NH₃ reforming catalyst; (c)
reforming the NH₃ stream at a second flowrate using the NH₃ reforming catalyst to generate a second reformate stream comprising H₂ and N₂, wherein the second flowrate is greater than the first flowrate; and (d) combusting a first portion of the second reformate stream to heat the NH₃ reforming catalyst.

In some embodiments, the NH₃ reforming catalyst is in a reformer.

In some embodiments, a first region of the NH₃ reforming catalyst is in a first reformer, and a second region of the NH₃ reforming catalyst is in a second reformer.

In some embodiments, the NH₃ reforming catalyst is in thermal communication with an electric heater, a combustion heater, or a combination thereof.

In some embodiments, the NH₃ reforming catalyst is heated by an electrical heater before (a).

In some embodiments, a first region of the NH₃ reforming catalyst is heated by an electrical heater, and a second region of the NH₃ reforming catalyst is heated by a combustion heater.

In some embodiments, (b) and (d) are performed using the combustion heater.

In some embodiments, the NH₃ reforming catalyst is heated to a target temperature range.

In some embodiments, the NH₃ reforming catalyst is at a target temperature range.

In some embodiments, a first region of the NH₃ reforming catalyst is heated to a first target temperature range, and a second region of the NH₃ reforming catalyst is heated to a second target temperature range.

In some embodiments, the first target temperature range and the second target temperature range at least partially overlap.

In some embodiments, the first target temperature range and the second target temperature range are different.

In some embodiments, a midpoint temperature of the first target temperature range is greater than a midpoint temperature of the second target temperature range.

In some embodiments, a first region of the NH₃ reforming catalyst comprises a first NH₃ reforming catalyst and a second region of the NH₃ reforming catalyst comprises a second NH₃ reforming catalyst.

In some embodiments, the first NH₃ reforming catalyst comprises at least one of: Ru, Pt, Pd, Ni, Co, Mo, Fe, or Cu.

In some embodiments, the second NH₃ reforming catalyst comprises at least one of: Ru, Pt, Pd, Ni, Co, Mo, Fe, or Cu.

In some embodiments, the first ammonia reforming catalyst and the second ammonia reforming catalyst have a same chemical composition.

In some embodiments, the first ammonia reforming catalyst and the second ammonia reforming catalyst have at least partially a same chemical composition.

In some embodiments, the first ammonia reforming catalyst and the second ammonia reforming catalyst have different chemical compositions.

In yet another general aspect, the present disclosure provides an ammonia (NH₃) reforming system, comprising: (a) reforming an NH₃ stream at a first flowrate using an NH₃ reforming catalyst to generate a first reformate stream comprising hydrogen (H₂) and nitrogen (N₂); (b) combusting the first reformate stream to heat the NH₃ reforming catalyst; (c) reforming the NH₃ stream at a second flowrate using the NH₃ reforming catalyst to generate a second reformate stream comprising H₂ and N₂, wherein the second flowrate is greater than the first flowrate; and (d) combusting a first portion of the second reformate stream to heat the NH₃ reforming catalyst.

In some embodiments, the system further comprises a reformer comprising the NH₃ reforming catalyst.

In some embodiments, the system further comprises a first reformer comprising a first region of the NH₃ reforming catalyst, and a second reformer comprising a second region of the NH₃ reforming catalyst.

In some embodiments, the NH₃ reforming catalyst is in thermal communication with an electric heater, a combustion heater, or a combination thereof.

In some embodiments, the system further comprises an electrical heater configured to heat the NH₃ reforming catalyst before (a).

In some embodiments, the system further comprises an electrical heater configured to heat a first region of the NH₃ reforming catalyst, and a combustion heater configured to heat a second region of the NH₃ reforming catalyst.

In some embodiments, the combustion heater is configured to perform (b) and (d).

In some embodiments, the NH₃ reforming catalyst is configured to be heated to a target temperature range.

In some embodiments, the NH₃ reforming catalyst is configured to be at a target temperature range.

In some embodiments, a first region of the NH₃ reforming catalyst is configured to be heated to a first target temperature range, and a second region of the NH₃ reforming catalyst is configured to be heated to a second target temperature range.

In some embodiments, the first target temperature range and the second target temperature range at least partially overlap.

In some embodiments, the first target temperature range and the second target temperature range are different.

In some embodiments, a midpoint temperature of the first target temperature range is greater than a midpoint temperature of the second target temperature range.

In some embodiments, a first region of the NH₃ reforming catalyst comprises a first NH₃ reforming catalyst, and a second region of the NH₃ reforming catalyst comprises a second NH₃ reforming catalyst.

In some embodiments, the first NH₃ reforming catalyst comprises at least one of: Ru, Pt, Pd, Ni, Co, Mo, Fe, or Cu.

In some embodiments, the second NH₃ reforming catalyst comprises at least one of: Ru, Pt, Pd, Ni, Co, Mo, Fe, or Cu.

In some embodiments, the first ammonia reforming catalyst and the second ammonia reforming catalyst have a same chemical composition.

In some embodiments, the first ammonia reforming catalyst and the second ammonia reforming catalyst have at least partially a same chemical composition.

In some embodiments, the first ammonia reforming catalyst and the second ammonia reforming catalyst have different chemical compositions.

In another general aspect, the present disclosure provides an ammonia decomposition method, comprising:
(a) providing an inert gas to a first reformer; and
(b) reforming ammonia using the first reformer to generate a first reformate stream comprising hydrogen and nitrogen.

In some embodiments, (b) is performed after stopping (a).

In some embodiments, (a) purges the first reformer thereby removing residual contaminants.

In some embodiments, the residual contaminants comprise at least one of ammonia, oxygen, water, or hydrogen.

In some embodiments, the first reformer is an electrically heated reformer, a combustion heated reformer, or a combination thereof.

In some embodiments, the method further comprises heating the first reformer during (a).

In some embodiments, the method further comprises, recirculating the inert gas to the first reformer after (a), so that the inert gas that leaves the first reformer is provided again to the first reformer.

In some embodiments, the method further comprises (c) providing the inert gas to a second reformer.

In some embodiments, the method further comprises, recirculating the inert gas to the second reformer after (c), so that the inert gas that leaves the second reformer is provided again to the second reformer.

In some embodiments, (c) is performed before (b).

In some embodiments, (c) purges the second reformer thereby removing residual contaminants.

In some embodiments, the residual contaminants comprise at least one of ammonia, oxygen, water, or hydrogen.

In some embodiments, the second reformer is an electrically heated reformer, a combustion heated reformer, or a combination thereof.

In some embodiments, the method further comprises heating the second reformer during (c).

In some embodiments, the inert gas is provided to the second reformer from the first reformer, so that the inert gas that leaves the first reformer is provided to the second reformer.

In some embodiments, the method further comprises recirculating the inert gas to the second reformer after (c), so that the inert gas that leaves the first reformer and the second reformer is provided to the second reformer.

In some embodiments, the method further comprises (d) providing the inert gas to an ammonia filter.

In some embodiments, the method further comprises recirculating the inert gas to the ammonia filter after (d), so that the inert gas that leaves the ammonia filter is provided again to the ammonia filter.

In some embodiments, (d) is performed before (b).

In some embodiments, the ammonia filter is at least one of an adsorbent, a scrubber, or an ion exchange filter.

In some embodiments, the method further comprises (e) providing the inert gas to a combustion heater in thermal communication with the second reformer.

In some embodiments, the method further comprises recirculating the inert gas to the combustion heater after (e), so that the inert gas that leaves the combustion heater is provided again to the combustion heater.

In some embodiments, the method further comprises (f) providing the first reformate stream to a second reformer.

In some embodiments, the method further comprises (g) providing the first reformate stream to an adsorbent.

In some embodiments, the method further comprises (h) combusting the first reformate stream in a combustion heater in thermal communication with a second reformer.

In some embodiments, providing the first reformate stream to the combustion heater bypasses the second reformer.

In some embodiments, providing the first reformate stream to the combustion heater bypasses an ammonia filter.

In some embodiments, the ammonia filter is at least one of an adsorbent, a scrubber, or an ion exchange filter.

In some embodiments, the method further comprises (i) providing the inert gas to the second reformer while (h) is performed.

In some embodiments, the inert gas provided to the second reformer facilitates heat transfer from the combustion heater to an NH₃ reforming catalyst in the second reformer.

In some embodiments, the method further comprises (j) reforming the ammonia using the second reformer to generate a second reformate stream comprising hydrogen and nitrogen. In some embodiments, (j) is performed after stopping (b).

In some embodiments, providing the ammonia to the second reformer bypasses the first reformer.

In some embodiments, the method further comprises providing the ammonia to a heat exchanger before providing the ammonia to the second reformer.

In some embodiments, providing the ammonia to the heat exchanger bypasses the first reformer.

In some embodiments, the method further comprises using a gas stream to regenerate an ammonia filter and generate an ammonia-containing gas stream and providing the ammonia-containing gas stream to the first reformer.

In some embodiments, the method further comprises venting or flaring at least one of the inert gas or the first reformate stream.

In yet another general aspect, the present disclosure provides an ammonia reforming system comprising: a first reformer configured to (a) receive an inert gas, and (b) reform ammonia to generate a first reformate stream comprising hydrogen and nitrogen.

In yet another general aspect, the present disclosure provides a method for reforming ammonia, comprising: (a) directing ammonia to a reformer at an ammonia flow rate to produce a reformate stream comprising hydrogen and nitrogen; (b) combusting a first portion of the reformate stream with oxygen at an oxygen flow rate in a combustion heater to heat the reformer; (c) processing a second portion of the reformate stream in a hydrogen processing module; and (d) based at least in part on a stimulus, performing one or more of: (i) changing the ammonia flow rate, (ii) changing a percentage of the reformate stream that is the first portion of the reformate stream, (iii) changing a percentage of the reformate stream that is the second portion of the reformate stream, or (iv) changing an oxygen flow rate.

In some embodiments, the stimulus is at least in part on a decreased amount of the hydrogen used by the hydrogen processing module.

In some embodiments, the decreased amount of hydrogen is a projected decreased amount of hydrogen.

In some embodiments, the ammonia flow rate is decreased in response to the stimulus.

In some embodiments, the ammonia flow rate is decreased to about zero flow rate.

In some embodiments, the method further comprises reducing or stopping at least one of (a), (b), or (c) after the ammonia flowrate is decreased in response to the stimulus.

In some embodiments, the method further comprises (e) heating the reformer after the ammonia flow rate is decreased in response to the stimulus.

In some embodiments, an electric heater is used to heat the reformer after the ammonia flow rate is decreased in response to the stimulus.

In some embodiments, an insulated enclosure comprises the reformer enclosed therein, and the electric heater heats the reformer enclosed inside the insulated enclosure.

In some embodiments, the electric heater is attached, affixed, or secured a wall of the insulated enclosure.

In some embodiments, the electric heater is attached or part of the reformer.

In some embodiments, the electric heater is attached, affixed, or secured a wall of the reformer.

In some embodiments, the method further comprises increasing the ammonia flow rate and reducing or stopping (e).

In some embodiments, the method further comprises increasing or starting at least one of (a), (b), or (c) after increasing the ammonia flow rate.

In some embodiments, the method further comprises increasing or starting all of (a), (b), or (c) after increasing the ammonia flow rate.

In some embodiments, at least about 50% of mechanical work or electricity generated by the hydrogen processing module is not used for at least one of vehicle propulsion, battery charging, or hotel load.

In some embodiments, the hotel load comprises at least one of climate control, communications, entertainment, lighting, refrigeration, or water distribution.

In some embodiments, at least about 50% of mechanical work or electricity generated by the hydrogen processing module is used to power at least one of (1) an air supply unit configured to provide the oxygen to the combustion heater or (2) an air supply unit configured to provide oxygen to the hydrogen processing module.

In some embodiments, the method further comprises increasing the ammonia flow rate, and at most about 30% of mechanical work or electricity generated by the hydrogen processing module is used to power at least one of (1) an air supply unit configured to provide the oxygen to the combustion heater or (2) an air supply unit configured to provide oxygen to the hydrogen processing module.

Unless otherwise defined, all technical and scientific terms used herein have the same meaning as commonly understood by one of ordinary skill in the art to which the present application belongs. Methods and materials are described herein for use in the present application; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control. Other features and advantages of the present application will be apparent from the following detailed description and figures, and from the claims.

### DESCRIPTION OF DRAWINGS

The novel features the methods, compositions, and systems described in this disclosure are set forth with particularity in the appended claims. A better understanding of the features and advantages may be obtained by reference to the following detailed description that sets forth illustrative embodiments, in which the principles of the methods, compositions, and systems are utilized, and the accompanying drawings, of which:

FIGS. 1A-4B are block diagrams illustrating an ammonia reforming system, in accordance with one or more embodiments of the present disclosure.

FIGS. 5A-5I are block diagrams illustrating utilization of a controller and sensors to control the ammonia reforming system shown in FIGS. 1A-4B, in accordance with one or more embodiments of the present disclosure.

FIGS. 6A-6T are block diagrams illustrating additional or alternative components and processes of the ammonia reforming system shown in FIGS. 1A-4B, in accordance with one or more embodiments of the present disclosure.

FIG. 7-11C are flow charts illustrating startup processes for an ammonia reforming method, in accordance with one or more embodiments of the present disclosure.

FIGS. 12A-12B are flow charts illustrating post-startup processes for an ammonia reforming method, in accordance with one or more embodiments of the present disclosure.

FIG. 13 is a schematic diagram illustrating utilization of an oxidation-resistant catalyst to generate reformate to purge the ammonia reforming system shown in FIGS. 1A-4B, in accordance with one or more embodiments of the present disclosure.

FIG. 14 is a schematic diagram illustrating a system combining ammonia synthesis and ammonia reforming, in accordance with one or more embodiments of the present disclosure.

FIG. 15A is a schematic diagram illustrating a multi-stage ammonia filter, in accordance with one or more embodiments of the present disclosure.

FIG. 15B is a plot illustrating performance calculation data of the multi-stage ammonia filter shown in FIG. 15A, in accordance with one or more embodiments of the present disclosure.

FIGS. 16A-16F are block diagrams illustrating various recovery modules configured to recover waste heat and separation modules configured to separate hydrogen, nitrogen, oxygen, or water, in accordance with one or more embodiments of the present disclosure.

FIGS. 17A-20B are block diagrams illustrating various configurations of an ammonia reforming system, in accordance with one or more embodiments of the present disclosure.

FIGS. 21A-21B are flow charts illustrating various ammonia reforming methods, in accordance with one or more embodiments of the present disclosure.

FIG. 22 is a block diagram illustrating an ammonia filter configured to reduce an ammonia concentration in a reformate stream using water extracted from a fuel cell exhaust, in accordance with one or more embodiments of the present disclosure.

FIG. 23 is a block diagram illustrating various ammonia filters, in accordance with one or more embodiments of the present disclosure.

FIG. 24 is a block diagram illustrating various sources of heat for an ammonia reformer, in accordance with one or more embodiments of the present disclosure.

FIG. 25 is a block diagram illustrating the heating of an ammonia reformer using an exothermic reaction, in accordance with one or more embodiments of the present disclosure.

FIG. 26 is a block diagram illustrating a fuel cell operating at a high hydrogen utilization rate, in accordance with one or more embodiments of the present disclosure.

FIGS. 27A-27D are block diagrams illustrating the usage of a scrubber to remove residual ammonia from the reformate stream and thus conserve the adsorption capacity of adsorbents, in accordance with one or more embodiments of the present disclosure.

FIGS. 28A-28B are block diagrams illustrating the usage of a perfluorinated and polyfluorinated substance (PFAS) filter to remove PFAS from water extracted from fuel cell exhaust, in accordance with one or more embodiments of the present disclosure.

FIGS. 29A-29E are block diagrams illustrating the integration of a scrubber and a stripper with an ammonia reforming system, in accordance with one or more embodiments of the present disclosure.

FIGS. 30A-30O are block diagrams illustrating the integration of a fuel cell with an ammonia reforming system, in accordance with one or more embodiments of the present disclosure.

FIGS. 31A-31C are block diagrams illustrating the integration of an ammonia oxidation catalyst with an ammonia reforming system, in accordance with one or more embodiments of the present disclosure.

FIGS. 32A-32C are various configurations of ammonia reformers, in accordance with one or more embodiments of the present disclosure.

FIGS. 33A-33D are block diagrams illustrating the startup of an ammonia reforming system using a inert gas, in accordance with one or more embodiments of the present disclosure.

FIG. 34 is a block diagram illustrating the heating of a reformer inside an insulated enclosure, in accordance with one or more embodiments of the present disclosure.

FIG. 35 is a block diagram illustrating the usage of mechanical work or electricity generated by a hydrogen processing module to power air supply units, in accordance with one or more embodiments of the present disclosure.

FIG. 36 is a block diagram illustrating a computer system that is programmed or otherwise configured to implement methods and systems provided herein.

### DETAILED DESCRIPTION

While various embodiments of the methods, compositions, and systems have been shown and described herein, it will be understood by those skilled in the art that such embodiments are provided by way of example only. Numerous variations, changes, and substitutions may occur to those skilled in the art without departing from this disclosure. It should be understood that various alternatives to the embodiments of the methods, compositions, and systems described herein may be employed. It should be understood that any of the embodiments, configurations and/or components described with respect to a particular figure may be combined with other embodiments, configurations, and/or components described with respect to other figures.

The terminology used herein is for the purpose of describing particular embodiments only and is not intended to be limiting of example embodiments. The present disclosure may be divided into sections using headings. The headings should not be construed to limit the present disclosure and are merely present for organization and clarity purposes.

As used herein, the singular forms “a,” “an” and “the” are intended to include the plural forms as well (and vice versa), unless the context clearly indicates otherwise. For example, “a,” “an,” and “the” may be construed as “one or more.”

The expressions “at least one of A and B” and “at least one of A or B” may be construed to mean at least A, at least B, or at least A and B (i.e., a set comprising A and B, which set may include one or more additional elements). The term “A and/or B” may be construed to mean only A, only B, or both A and B.

The expressions “at least about A, B, and C” and “at least about A, B, or C” may be construed to mean at least about A, at least about B, or at least about C. The expressions “at most about A, B, and C” and “at most about A, B, or C” may be construed to mean at most about A, at most about B, or at most about C. Similarly, the expression “about A, B, or C” may be construed to mean about A, about B, or about C.

The expression “between about A and B, C and D, and E and F” may be construed to mean between about A and about B, between about C and about D, and between about E and about F. The expression “between about A and B, C and D, or E and F” may be construed to mean between about A and about B, between about C and about D, or between about E and about F.

Any range described in the present disclosure may also describe subrange(s) within the range. For example, a range described as “greater than about 10% and less than about 90%” may also describe “greater than about 20% and less than about 80%,” and “greater than about 30% and less than about 70%.”

As used herein, the terms “module” and “unit” are used interchangeably and are not limited to a single component, piece, part, or individual unit.

The terms “decompose,” “dissociate,” “reform,” “crack,” and “break down,” and their grammatical variations, may be construed interchangeably. For example, the expression “decomposition of ammonia” may be interchangeable with “dissociation of ammonia,” “reforming of ammonia,” “cracking of ammonia,” etc.

The terms “ammonia conversion,” “ammonia conversion rate,” and “ammonia conversion efficiency,” and their grammatical variations, may be construed as a fraction of ammonia that is converted to hydrogen and nitrogen, and may be construed interchangeably. For example, “an ammonia conversion efficiency of 90%” may represent 90% of ammonia being converted to hydrogen and nitrogen.

The term “auto-thermal reforming” may be construed as a condition where an ammonia decomposition reaction (2NH₃→N₂+3H₂; an endothermic reaction) is heated by a hydrogen combustion reaction (2H₂+O₂→2H₂O; an exothermic reaction) using at least part of the hydrogen produced by the ammonia decomposition reaction itself.

In some cases, the term “auto-thermal reforming” may be construed as a condition where an ammonia decomposition reaction is heated by a hydrogen combustion reaction using at least part of hydrogen produced by the ammonia decomposition reaction itself, electrical heating, or a combination of both (which may result in an overall positive electrical and/or chemical energy output). For example, if “auto-thermal reforming” is performed using a hydrogen combustion reaction and/or electrical heating, the hydrogen produced from the ammonia decomposition reaction may be enough to provide the hydrogen combustion reaction with combustion fuel, and/or to provide electrical energy for the electrical heating via hydrogen-to-electricity conversion devices (e.g., fuel cell, combustion engine, etc.).

In some cases, the hydrogen provided for the hydrogen combustion reaction and/or the electrical heating may or may not use the hydrogen from the ammonia decomposition reaction (for example, the hydrogen may be provided by a separate hydrogen source, the electricity may be provided from batteries or a grid, etc.).

In some cases, “auto-thermal reforming” may be construed as a condition where an ammonia decomposition reaction is heated by a combustion reaction (e.g., ammonia combustion, hydrocarbon combustion, etc.), electrical heating, or a combination of both, which may result in an overall positive electrical and/or chemical energy output. For example, if “auto-thermal reforming” is performed using a combustion reaction and/or electrical heating, the chemical energy (e.g., lower heating value) from the hydrogen produced from the ammonia decomposition reaction may be higher than the combustion fuel chemical energy (e.g., lower heating value), and/or may be enough to provide electrical energy for the electrical heating via hydrogen-to-electricity conversion devices (e.g., fuel cell, combustion engine, etc.).

In some cases, a startup mode may be construed as a process in which an ammonia reforming system is initiating an operation (e.g., heating up one or more reformers to a target temperature range). In some cases, an operation mode may be construed as a process in which the ammonia reforming system is generating an electrical power output (using one or more fuel cells) or generating a hydrogen output (for various chemical or industrial processes) while maintaining auto-thermal reforming. In some cases, a hot standby mode may be construed as a process in which auto-thermal reforming of the ammonia reforming system is maintained while the power output (using the one or more fuel cells) and/or the hydrogen output (supplied to various chemical or industrial processes) are reduced (e.g., to zero, or to an amount that is less than the operation mode).

### Ammonia Reforming Systems

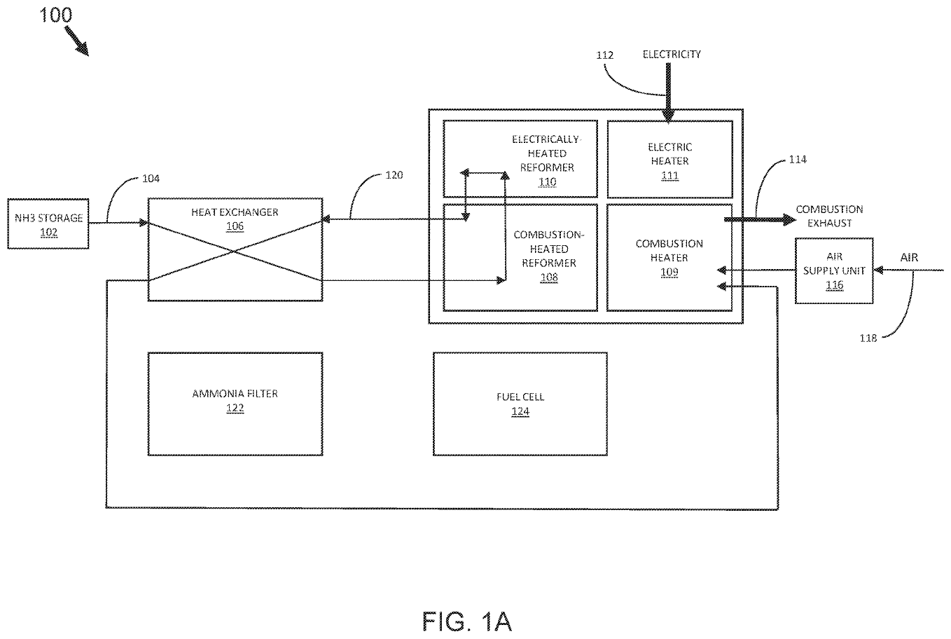

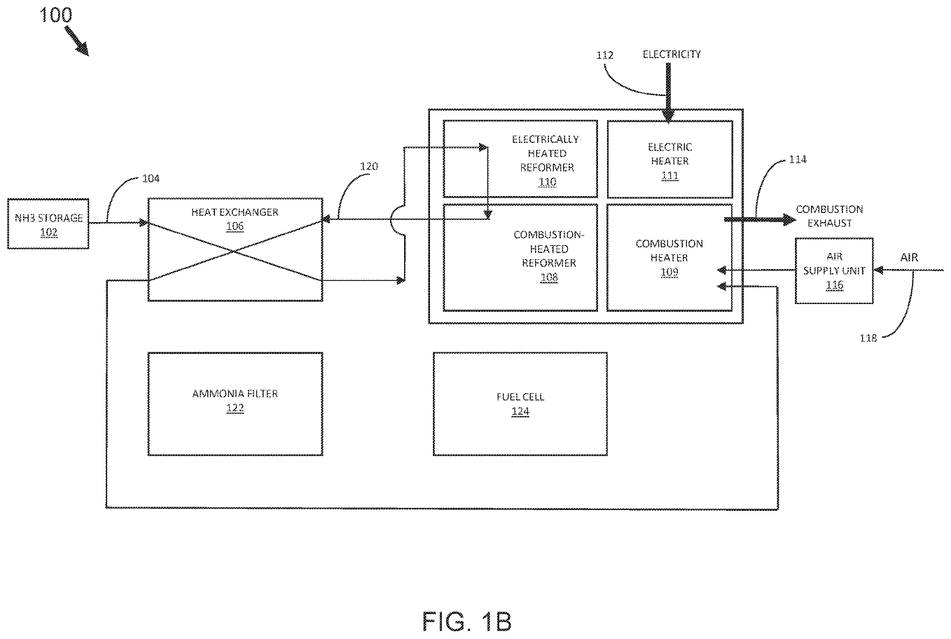

FIGS. 1A-4B are block diagrams illustrating an ammonia reforming system 100, in accordance with one or more embodiments of the present disclosure. The ammonia reforming system 100 comprises an NH₃ storage tank 102, a heat exchanger 106, one or more combustion-heated reformers 108, a combustion heater 109, one or more electrically heated reformers 110, an electric heater 111, an air supply unit 116, an ammonia filter 122, and a fuel cell 124.

The NH₃ storage tank 102 may be configured to store NH₃ under pressure (e.g., 7-9 bars absolute) and/or at a low temperature (e.g., about −30° C.). The NH₃ storage tank 102 may comprise a metallic material that is resistant to corrosion by ammonia (e.g., steel). The storage tank 102 may comprise one or more insulating layers (e.g., perlite or glass wool). In some cases, an additional heater may be positioned near, adjacent, at, or inside the NH₃ storage tank 102 to heat and/or pressurize the NH₃ stored therein.

The heat exchanger 106 may be configured to exchange heat between various input fluid streams and output fluid streams. For example, the heat exchanger 106 may be configured to exchange heat between an incoming ammonia stream 104 provided by the storage tank 102 (e.g., relatively cold liquid ammonia) and a reformate stream 120 (e.g., a relatively warm H₂/N₂ mixture) provided by the reformers 108 and 110. The heat exchanger 106 may be a plate heat exchanger, a shell-and-tube heat exchanger, or a tube-in-tube heat exchanger, although the present disclosure is not limited thereto.

The reformers 108 and 110 may be configured to generate and output the reformate stream 120 comprising at least a mixture of hydrogen (H₂) and nitrogen (N₂) (with a molar ratio of H₂ to N₂ of about 3:1 at a high ammonia conversion). The H₂/N₂ mixture may be generated by contacting the incoming ammonia stream 104 with NH₃ reforming catalyst 130 positioned inside each of the reformers 108 and 110. The reformers 108 and 110 may be heated to a sufficient temperature range to facilitate ammonia reforming (for example, of from about 400° C. to about 650° C.).

In some embodiments, the reformers 108 and 110 may comprise a plurality of reformers, which may fluidically communicate in various series and/or parallel arrangements. For example, an electrically heated reformer 110 may fluidically communicate in series or in parallel with a combustion-heated reformer 108 (or vice versa) as a pair of reformers 108-110. Such a pair of reformers 108-110 may fluidically communicate in parallel with other reformer 108-110 or pairs of reformers 108-110 (so that pairs of reformers 108-110 combine their outputs into a single reformate stream 120) or may fluidically communicate in series with other reformers 108-110 or pairs of reformers 108-110.

In some embodiments, the number of combustion-heated reformers 108 may be the same as the number of electrically heated reformers 110, and the reformers 108-110 may fluidically communicate in various series and/or parallel arrangements. For example, two electrically heated reformers 110 may fluidically communicate in series with two combustion-heated reformers 108 (or vice versa).

In some embodiments, the number of combustion-heated reformers 108 may be different from the number of electrically heated reformers 110 and the reformers 108-110 may fluidically communicate in various series and/or parallel arrangements. For example, two electrically heated reformers 110 may fluidically communicate in series with four combustion-heated reformers 108 (or vice versa).

The combustion heater 109 may be in thermal communication with the combustion-heated reformer 108 to heat the NH₃ reforming catalyst 130 in the reformer 108. The combustion heater 109 may react at least part of the reformate stream 120 (e.g., the H₂ in the H₂/N₂ mixture) with an air stream 118 (e.g., at least oxygen (O₂)). The heat from the exothermic combustion reaction in the combustion heater 109 may be transferred to the NH₃ reforming catalyst 130 in the reformer 108. For example, the hot combustion product gas 114 may contact walls of the reformer 108, and the hot combustion product gas 114 may be subsequently output from the combustion heater 109 as combustion exhaust 114. The combustion heater 109 may comprise a separate component from the reformer 108 (and may be slidably insertable or removable in the reformer 108). In some cases, the combustion heater 109 is a unitary structure with the combustion-heated reformer 108 (and both the reformer 108 and the heater 109 may be manufactured via 3D printing and/or casting).

The air supply unit 116 (e.g., one or more pumps and/or compressors) may be configured to supply the air stream 118 (which may be sourced from the atmosphere and may comprise at least about 20% oxygen by molar fraction). The air stream 118 may comprise pure oxygen by molar fraction, or substantially pure oxygen by molar fraction (e.g., at least about 99% pure oxygen).

The electric heater 111 may be in thermal communication with the electrically heated reformer 110 to heat the NH₃ reforming catalyst 130 in the reformer 110. The electric heater 111 may heat the NH₃ reforming catalyst 130 in the electrically heated reformer 110 by resistive heating or Joule heating. In some cases, the electrical heater 111 may comprise at least a heating element (e.g., nichrome or ceramic) that transfers heat to the catalyst 130 in the electrically heated reformer 110. In some cases, the electrical heater 111 may comprise metal electrodes (e.g., copper or steel electrodes) that pass a current through the catalyst 130 to heat the catalyst 130 in the reformer 110.

The ammonia filter 122 may be configured to filter or remove trace ammonia in the reformate stream 120. The ammonia filter 122 may be configured to reduce the concentration of NH₃ in the reformate stream 120, for example, from greater than about 10,000 parts per million (ppm) to less than about 100 ppm. The ammonia filter 122 may comprise a fluidized bed comprising a plurality of particles or pellets. The ammonia filter 122 may be cartridge-based (for simple replaceability, for example, after the ammonia filter 122 is saturated with ammonia).

The ammonia filter 122 may comprise an adsorbent (e.g., bentonite, zeolite, clay, biochar, activated carbon, silica gel, metal organic frameworks (MOFs), and other nanostructured materials). The adsorbent may comprise pellets and may be stored in one or more columns or towers. In some instances, the ammonia filter 122 may comprise an absorbent, a solvent-based material, and/or a chemical solvent.

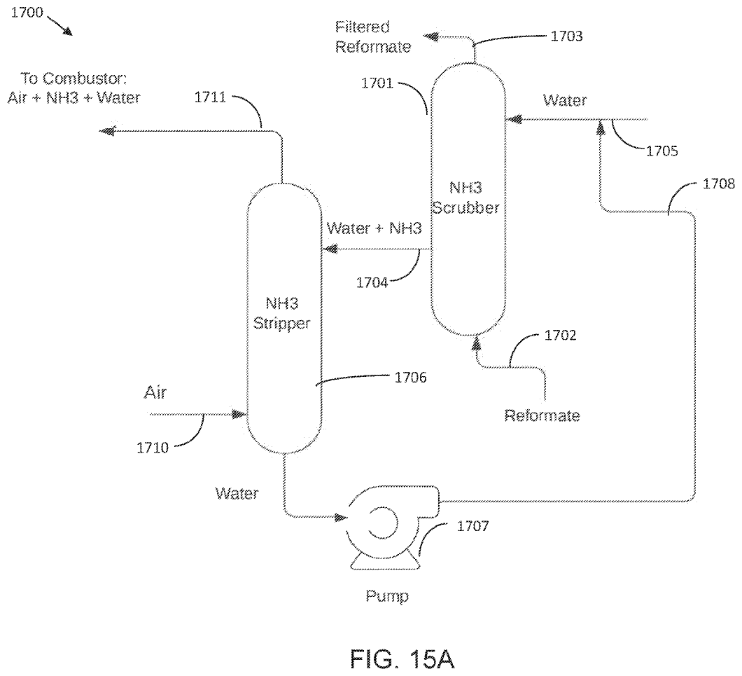

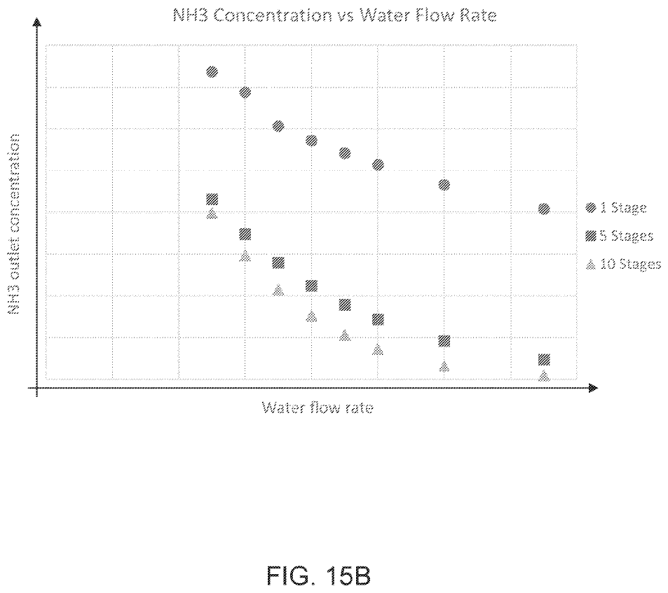

In some embodiments, the ammonia filter 122 comprises a multi-stage ammonia filtration system (e.g., water-based) comprising a plurality of filtration stages. The replacement of water-based absorbents may be performed for continuous operation. The multi-stage ammonia filter is described in detail with respect to FIGS. 15A-15B.

In some embodiments, the ammonia filter 122 comprises a selective ammonia oxidation (SAO) reactor including oxidation catalysts configured to react the trace ammonia in the reformate stream 120 with oxygen (O₂) to generate nitrogen (N₂) and water (H₂O). The air stream 118 (or a separate oxygen source) may be provided to the SAO reactor to provide the oxygen for the oxidation reaction.

In some embodiments, the ammonia filter 122 may comprise an acidic ammonia remover (for example, in addition to adsorbents), which may include an acidic solid or solution. The acidic ammonia remover may be regenerated (to desorb the ammonia captured therein) by passing an electric current through the acidic ammonia remover.

The fuel cell 124 may comprise an anode, a cathode, and an electrolyte between the anode and the cathode. The fuel cell 124 may comprise a polymer electrolyte membrane fuel cell (PEMFC), a solid oxide fuel cell (SOFC), a molten carbonate fuel cell (MCFC), a phosphoric acid fuel cell (PAFC), or an alkaline fuel cell (AFC), although the present disclosure is not limited thereto. The fuel cell 124 may process the H₂ in the reformate stream 120 at an anode and process the O₂ in the air stream at a cathode, to generate electricity (to power an external electrical load). The fuel cell 124 may be configured to receive hydrogen (e.g., at least part of the reformate stream 120) via one or more anode inlets, and oxygen (e.g., at least part of the air stream 118 or a separate air stream) via one or more cathode inlets.

In some embodiments, the fuel cell 124 may output unconsumed hydrogen (e.g., as an anode off-gas) via one or more anode outlets, and/or may output unconsumed oxygen (e.g., as a cathode off-gas) via one or more cathode outlets. The anode off-gas and/or the cathode off-gas may be provided to the combustion heater 109 as reactants for the combustion reaction performed therein.

As shown in FIGS. 1A-B, the storage tank 102 may be in fluid communication with the combustion-heated reformer 108 and/or the electrically heated reformer 110 (e.g., using one or more lines or conduits). The storage tank 102 may provide the incoming ammonia stream 104 (for example, by actuating a valve). In some instances, the heat exchanger 106 may facilitate heat transfer from the (relatively warmer) reformate stream 120 to the (relatively cooler) incoming ammonia stream 104 to preheat and/or vaporize the incoming ammonia stream 104 (changing the phase of the ammonia stream 104 from liquid to gas). The incoming ammonia stream 104 may then enter the reformers 108 and 110 to be reformed into hydrogen and nitrogen.

In some embodiments, the incoming ammonia stream 104 may first be partially reformed by the electrically heated reformer 110 into a partially cracked reformate stream 120 (e.g., comprising at least about 10% H₂/N₂ mixture by molar fraction) (for example, during a start-up or initiation process). Subsequently, the partially cracked reformate stream 120 may be further reformed in the combustion-heated reformer 108 to generate a substantially cracked reformate stream (e.g., comprising less than about 10,000 ppm of residual or trace ammonia by volume and/or greater than about 99% H₂/N₂ mixture by molar fraction). Passing the ammonia stream 104 through the electrically heated reformer 110 first, and then subsequently passing the ammonia stream 104 through the combustion-heated reformer 108, may advantageously result in more complete ammonia conversion (e.g., greater than about 99%).

In some embodiments, the incoming ammonia stream 104 may first be partially reformed by the combustion-heated reformer 108 into a partially cracked reformate stream 120 (e.g., comprising at least about 10% H₂/N₂ mixture by molar fraction). Subsequently, the partially cracked reformate stream 120 may be further reformed in the electrically heated reformer 110 to generate a substantially cracked reformate stream (e.g., comprising less than about 10,000 ppm of residual or trace ammonia by volume and/or greater than about 99% H₂/N₂ mixture by molar fraction). Passing the ammonia stream 104 through the combustion-heated reformer 108 first, and then subsequently passing the ammonia stream 104 through the electrically heated reformer 110, may advantageously result in more complete ammonia conversion (e.g., greater than about 99%).

In some cases, the incoming ammonia stream 104 may first be preheated by the combustion exhaust 114 and/or the combustion heater 109. In some cases, the preheated incoming ammonia stream 104 may then enter the reformers 108 and 110 to be reformed into hydrogen and nitrogen.

In some embodiments, the incoming ammonia stream 104 may first be reformed by the electrically heated reformer 110 to generate a partially or substantially cracked reformate stream 120 (for example, during a start-up or initiation process). Subsequently, at least part of the partially or substantially cracked reformate stream 120 generated by the electrically heated reformer 110 may be combusted as a combustion fuel to heat at least one combustion heater 109 of the one or more combustion-heated reformers 108.

In some cases, the electrically heated reformer 110 may be configured to preheat or vaporize the incoming ammonia stream 104 (to avoid reforming liquid ammonia). In some cases, the electrically heated reformer 110 may reform or crack the incoming ammonia stream 104 at an ammonia conversion efficiency of at least about 10, about 15, about 20, about 25, about 30, about 35, about 40, about 45, about 50, about 55, about 60, about 65, about 70, about 75, about 80, about 85, about 90, about 95, about 99, or about 99.5%. In some cases, the electrically heated reformer 110 may reform or crack the incoming ammonia stream 104 at an ammonia conversion efficiency of at most about 10, about 15, about 20, about 25, about 30, about 35, about 40, about 45, about 50, about 55, about 60, about 65, about 70, about 75, about 80, about 85, about 90, about 95, about 99, or 99.5%. In some cases, the electrically heated reformer 110 may reform or crack the incoming ammonia stream 104 at an ammonia conversion efficiency of about 10 to about 30, about 20 to about 40, about 30 to about 50, about 40 to about 60, about 50 to about 70, about 60 to about 80, about 70 to about 90, about 80 to about 99%, or about 90 to about 99.5%.

In some cases, power input to the electric heater 111 of the electrically heated reformer 110 may be reduced or entirely turned off based on a temperature of the combustion-heated reformer 108 and/or the combustion heater 109 being equal to or greater than a target temperature (e.g., in a target temperature range). In some cases, power input to the electric heater 111 of the electrically heated reformer 110 may be reduced or entirely turned off based on a flow rate of the incoming ammonia stream 104 being equal to or greater than a target flow rate range. In some cases, power input to the electric heater 111 of the electrically heated reformer 110 may be turned on or increased during an entire operational time period of the ammonia reforming system 100 (e.g., during the startup mode, the operation mode, and/or the hot standby mode described in the present disclosure). In some cases, power input to the electric heater 111 of the electrically heated reformer 110 may be turned on or off or increased intermittently during the operational time period of the ammonia reforming system 100 (e.g., turned on or increased during the startup mode and/or the hot standby mode, and turned off or decreased during the operation mode).

In some cases, power input to the electric heater 111 may be controlled so that the temperature of the electrically heated reformer 110 and/or the electrical heater 111 increases or decreases at a target temperature change rate (ΔTemperature/ΔTime, e.g., ° C./minute). In some cases, the target temperature change rate is at least about 5, about 10, about 20, about 25, about 30, about 35, about 40, about 45, about 50, about 60, about 65, about 70, about 75, about 80, about 85, about 90, about 95, or about 100° C./minute. In some cases, the target temperature change rate is at most about 5, about 10, about 20, about 25, about 30, about 35, about 40, about 45, about 50, about 60, about 65, about 70, about 75, about 80, about 85, about 90, about 95, or about 100° C./minute.

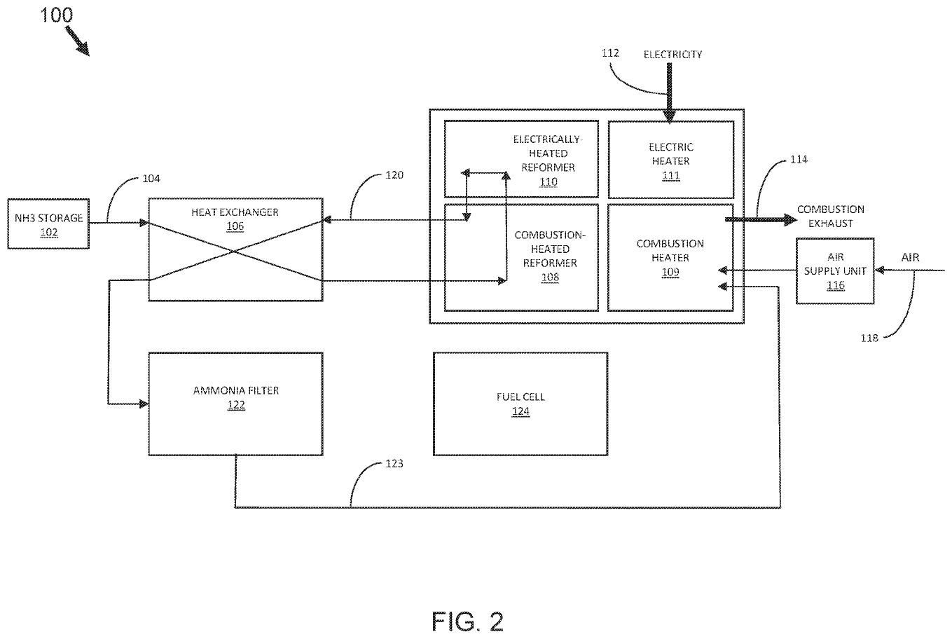

As shown in FIG. 2, the ammonia filter 122 may be configured to remove trace ammonia in the reformate stream 120 and output a filtered reformate stream 123. The filtered reformate stream 123 may then be provided to the combustion heater 109 to combust for heating the reformer 108 (i.e., by auto-thermal reforming).

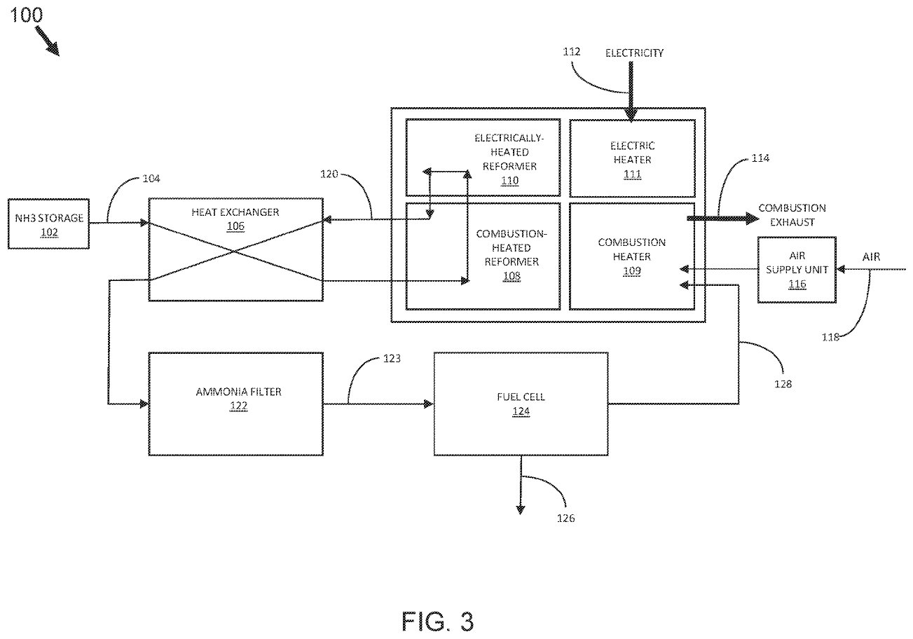

As shown in FIG. 3, the filtered reformate stream 123 may be provided to the fuel cell 124 to generate electrical power 126. An external load (e.g., an electrical motor to power a transport vehicle, or a stationary electrical grid) may utilize the electrical power 126. The fuel cell 124 may provide the anode off-gas 128 (e.g., containing unconsumed or unconverted hydrogen) to the combustion heater 109 to combust for self-heating.

In some embodiments, the ammonia reforming system 100 includes a battery (so that the system 100 is a hybrid fuel cell-battery system). The battery may be configured to power an external load in addition to the fuel cell 124. The fuel cell 124 may be configured to charge the battery (for example, based a charge of the battery being less than a threshold charge).

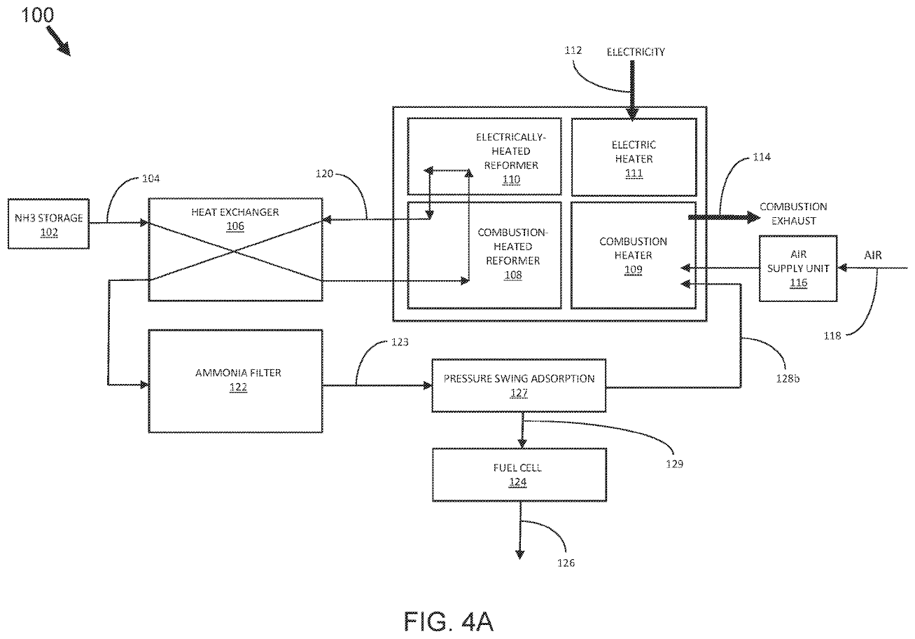

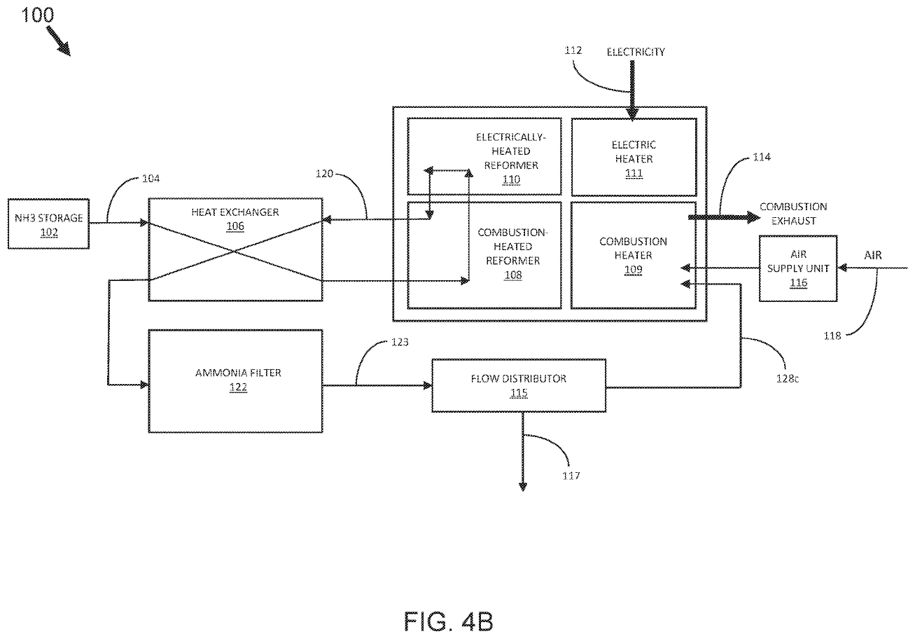

As shown in FIG. 4A, a pressure swing adsorber (PSA) 127 may be configured to adsorb NH₃ and/or N₂ in the filtered reformate stream 123 (or the reformate stream 120) to further purify the filtered reformate stream 123. The PSA may be configured to increase the molar fraction of H₂ in the filtered reformate stream 123 (or the reformate stream 120) and decrease the molar fractions of NH₃ and/or N₂ in the filtered reformate stream 123 (or the reformate stream 120). A PSA exhaust stream 128b comprising H₂ (and which may additionally comprise NH₃ and/or N₂) may then be provided to the combustion heater 109 to combust for self-heating the reformer 108 (i.e., by auto-thermal reforming). Additionally, a purified reformate stream 129 may be provided to the fuel cell 124 to generate the electrical power output 126.

As shown in FIG. 4B, a flow distributor 115 may be configured to distribute at least portion 128c of the reformate stream 120 (or the filtered reformate stream 123) to the combustion heater 109 as a combustion fuel. The flow distributor 130 may comprise, for example, one or more flow control units (e.g., one or more valves, one or more pumps, one or more flow regulators, etc.). A remaining reformate stream 117 may be provided to various chemical or industrial processes, including, but not limited to, steel or iron processing, combustion engines, combustion turbines, hydrogen storage, hydrogen for chemical processes, hydrogen fueling stations, etc. In some cases, the remaining reformate stream 117 can be supplied as a pilot, auxiliary, or main fuel to the combustion engines or combustion turbines.

In some embodiments, the reformate stream 120, the filtered reformate stream 123, the purified reformate stream 129, and/or the remaining reformate stream 117 may be provided to an internal combustion engine (ICE). Heat emitted by the ICE may be used to heat the reformer 108 and/or the reformer 110 (e.g., using a heat exchanger).

In some embodiments, the reformate stream 120, the filtered reformate stream 123, the purified reformate stream 129, and/or the remaining reformate stream 117 may be used directly for chemical or industrial processes (e.g., to reduce iron), storage (e.g., hydrogen storage), and/or hydrogen fueling stations.

In any of embodiments and/or configurations described with respect to FIGS. 1A-4B, the fuel cell 124 may be absent, and at least part of the reformate 120 may be combusted to maintain an auto-thermal reforming process. The remaining reformate 120 (that is not combusted) may be provided for chemical or industrial processes, storage (e.g., hydrogen storage), and/or hydrogen fueling stations. In some cases, the remaining reformate stream 120 is provided to an ICE. In some cases, heat emitted by the ICE may provide at least part or all of the heat required for ammonia reforming in the reformer 108 and/or the reformer 110. Any of the embodiments, configurations and/or components described with respect to FIGS. 1A-4B, may be partially or entirely powered by exhaust heat from a combustion engine.

### Controller and Sensors

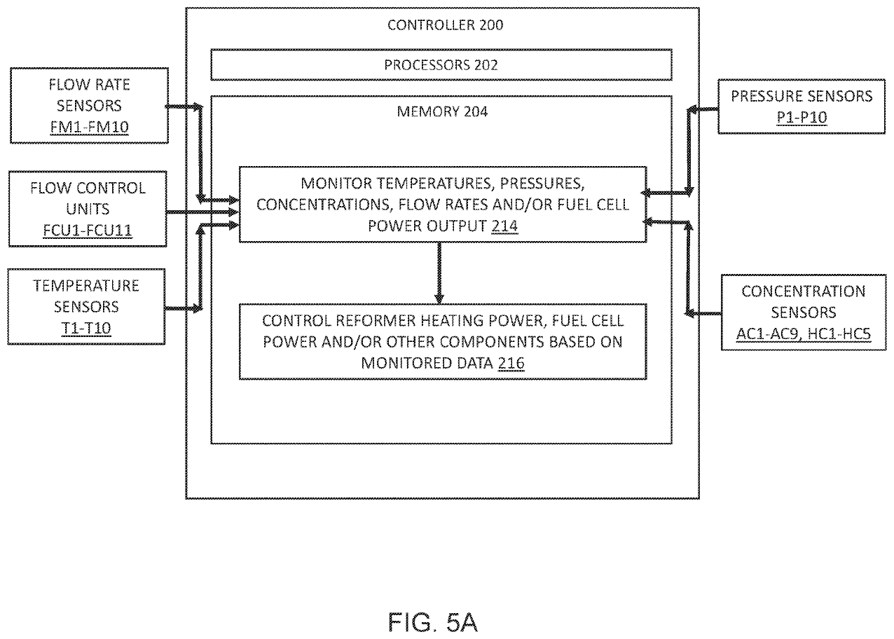

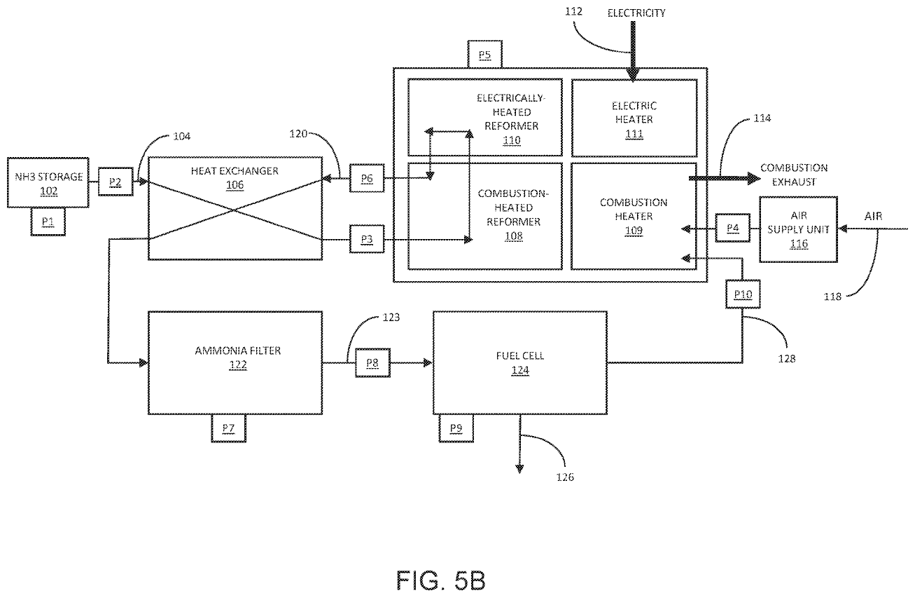

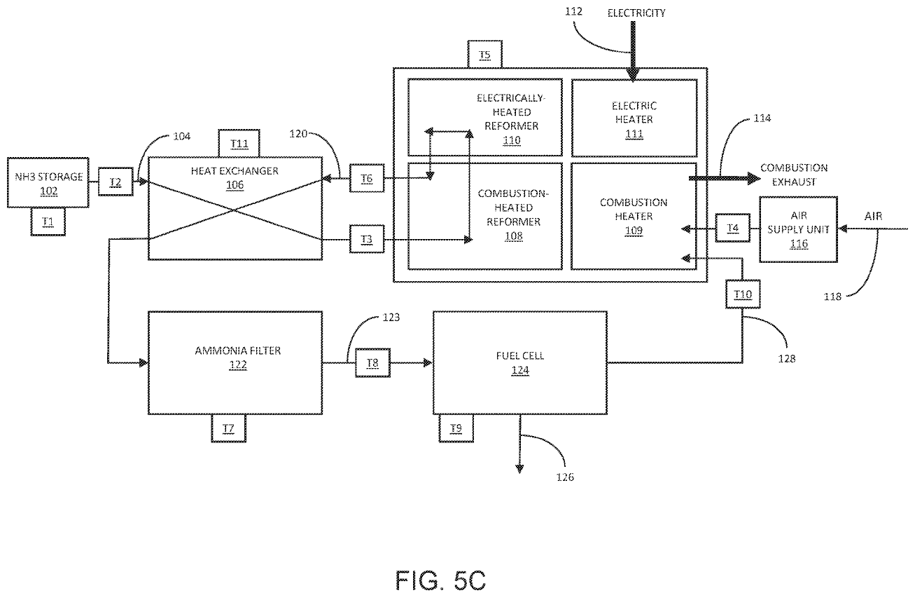

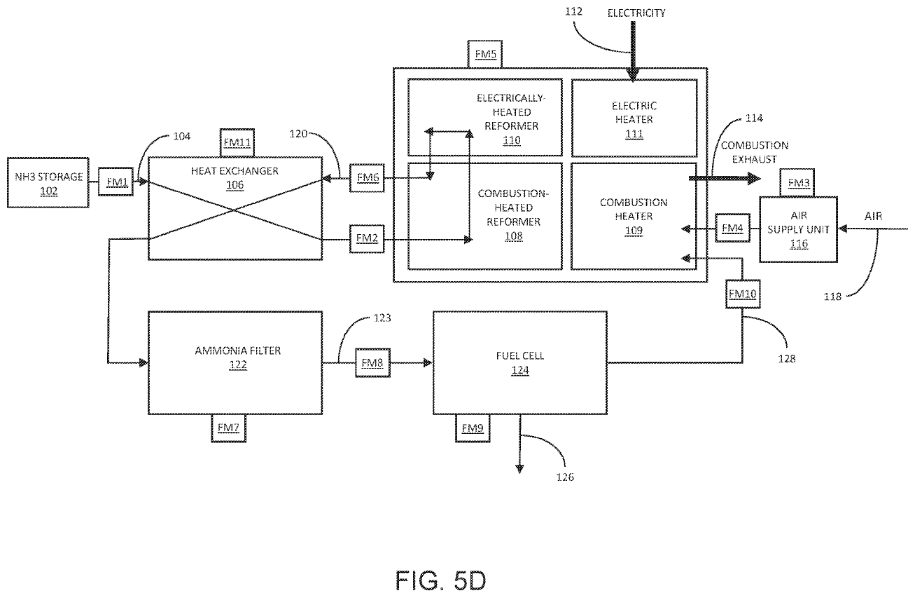

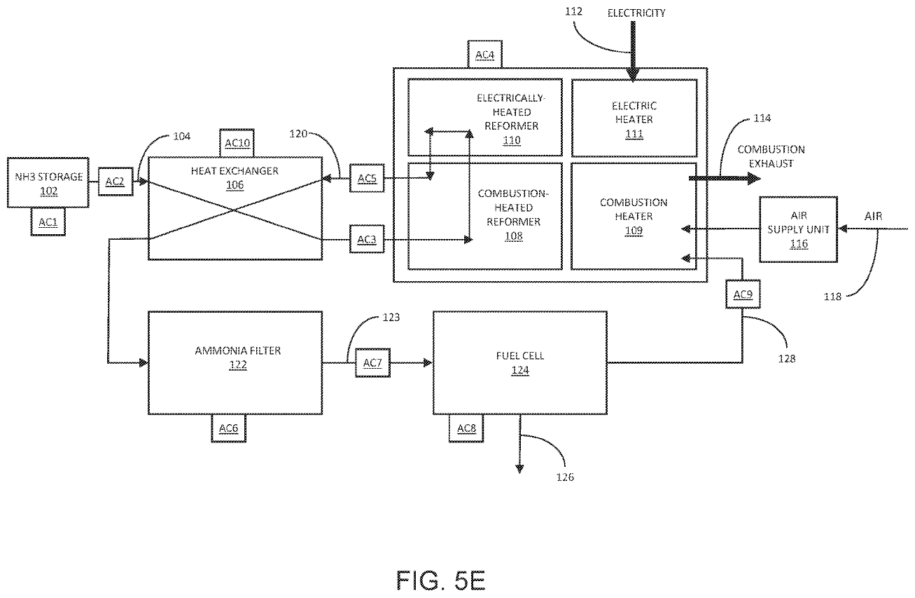

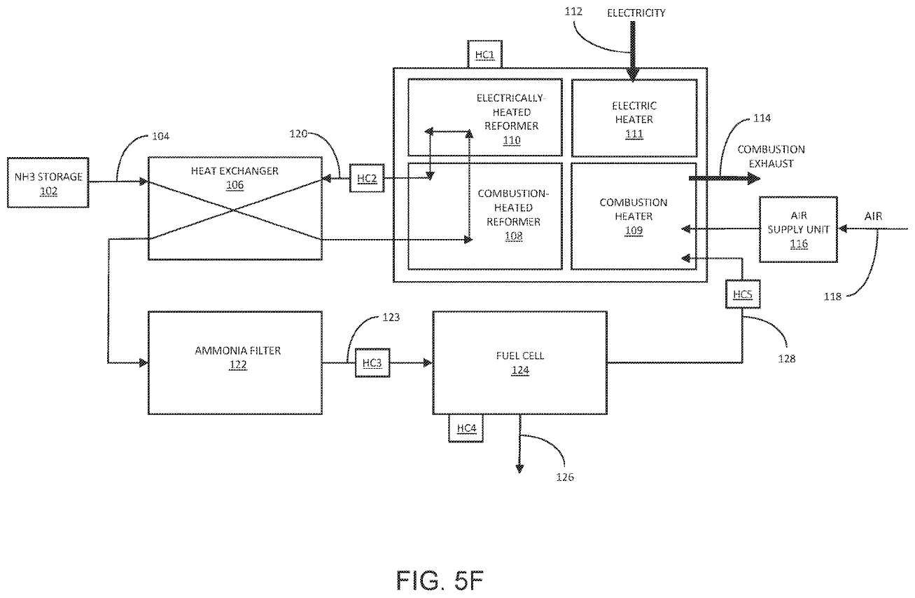

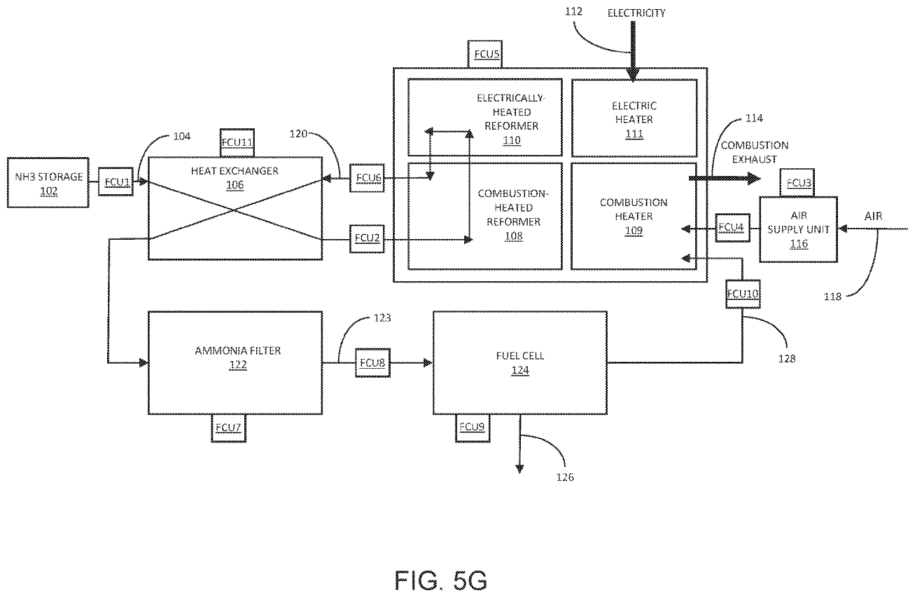

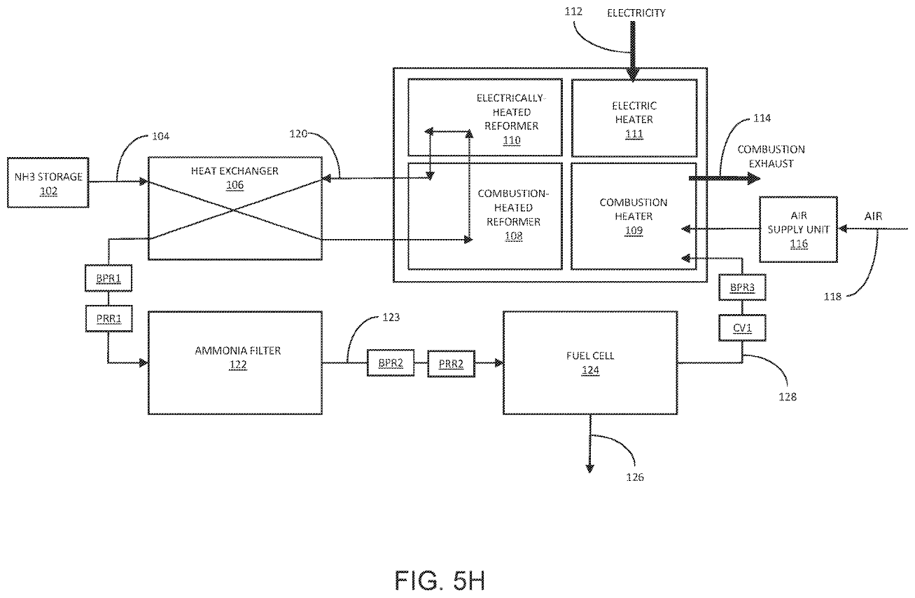

FIGS. 5A-5I are block diagrams illustrating utilization of a controller 200 (e.g., computer or computing device), sensors P1-P10, T1-T11, FM1-FM11, AC1-AC10, HC1-HC5 and flow control units FCU1-FCU11 to control the ammonia reforming system 100 shown in FIGS. 1A-4B, in accordance with one or more embodiments of the present disclosure.

As shown in FIG. 5A, the controller 200 may comprise one or more processors 202 and a memory 204. The one or more processors 202 may comprise one or more processing or logic elements (e.g., one or more micro-processor devices, one or more central processing units (CPUs), one or more graphics processing units (GPUs), one or more application specific integrated circuit (ASIC) devices, one or more field programmable gate arrays (FPGAs), or one or more digital signal processors (DSPs)), and may be configured to execute, perform or implement algorithms, modules, processes and/or instructions (e.g., program instructions stored in memory). The one or more processors 202 may be embodied in an embedded system (for example, as part of a terrestrial vehicle, an aerial vehicle, a marine vehicle, a stationary device, etc.). The memory 204 may be configured to store program instructions executable, performable or implementable by the associated one or more processors 202. For example, the memory medium 204 may comprise a non-transitory memory medium, and may comprise, but is not limited to, a read-only memory (ROM), a random-access memory (RAM), a magnetic or optical memory device (e.g., disk), a magnetic tape, a solid-state drive and the like.

The controller 200 may be in electronic communication with at least one of the sensors P1-P10, T1-T11, FM1-FM11, AC1-AC10, HC1-HC5, and flow control units FCU1-FCU11 to monitor, measure, and/or control one or more characteristics or parameters of the ammonia reforming system 100. For example, the controller 200 may be connected by wire, or wirelessly, with the sensors P1-P10, T1-T11, FM1-FM11, AC1-AC10, and HC1-HC5, and flow control units FCU1-FCU11.

A module 214 stored in the memory 204 may be configured to initiate or stop the monitoring or measurement of the ammonia reforming system 100. A module 216 may be configured to control components of the ammonia reforming system 100 based on the monitored data (for example, by modulating heating power to the heaters 109 and 111, by modulating power output of the fuel cell 124, etc.). The modules 214 and/or 216 may be implemented using a graphical user interface, such that a user of the controller 200 may view the monitored data (e.g., via one or more tables or charts) and/or manually control the ammonia reforming system 100. In some embodiments, the modules 214 and/or 216 may automatically control the ammonia reforming system 100 based on the measured on monitored data. It is noted that the modules 214 and 216 may be the same module (e.g., instead of being different modules).

The flow rate sensors FM1-FM11 may be configured to monitor or measure a flow rate (e.g., unit volume or unit mass per unit time) of a fluid (liquid or gas) in any component of the ammonia reforming system 100, and transmit data associated with the flow rate measurement to be stored in the memory 204.

The temperature sensors T1-T11 may be configured to detect a temperature (e.g., in Celsius or Kelvin) of any component of the ammonia reforming system 100 (for example, the walls of the reformers 108-110 or the walls of the heaters 109-111), or may be configured to detect the temperature of a fluid (liquid or gas) in any component of the ammonia reforming system 100, and transmit data associated with the temperature measurement to be stored in the memory 204.

The pressure sensors P1-P10 may be configured to detect a pressure (e.g., gauge pressure (barg) or absolute pressure (bara)) of a fluid stream (liquid or gas) in any component of the ammonia reforming system 100, and transmit data associated with the pressure measurement to be stored in the memory 204.

The concentration sensors AC1-AC10 and HC1-HC5 may be configured to detect a concentration (e.g., in parts per million) of a fluid (liquid or gas) in any component of the ammonia reforming system 100, and transmit data associated with the concentration measurement to be stored in the memory 204.

Referring now to FIG. 5B, the pressure sensors P1-P10 may be positioned in various components and/or fluid lines of the ammonia reforming system 100. The pressure sensor P1 may be configured to measure the pressure of ammonia stored in the tank 102. The pressure sensor P2 may be configured to measure the pressure of the incoming ammonia stream 104 before the stream 104 enters the heat exchanger 106. The pressure sensor P3 may be configured to measure the pressure of the incoming ammonia stream 104 after the stream 104 exits the heat exchanger 106. The pressure sensor P4 may be configured to measure the pressure of the air stream 118 after the stream 118 exits the air supply unit 116. The pressure sensor(s) P5 may be configured to measure the pressure of fluid at one or more inlets, one or more outlets, and/or inside of the reformers 108-110 and/or the combustion heater 109. For example, the pressure sensor(s) P5 may be configured to measure the pressure of the incoming ammonia stream 104 at the inlets of the reformers 108-110, the partially cracked reformate stream 120 inside the reformers 108-110, and/or the substantially cracked reformate stream 120 at the outlets of the reformers 108-110. In another example, the pressure sensor(s) P5 may be configured to measure the pressure of the reformate stream 120 and/or the air stream 118 at the inlets of the combustion heater 109, the combustion product gas 114 inside the combustion heater 109, and/or the combustion exhaust 114 at the outlets of the combustion heater 109. The pressure sensor P6 may be configured to measure the pressure of the reformate stream 120 after the reformate stream exits the reformer 108-110 and before the reformate stream 120 enters the heat exchanger 106. The pressure sensor(s) P7 may be configured to measure the pressure at one or more inlets, one or more outlets, and/or inside the ammonia filter 122. The pressure sensor P8 may be configured to measure the pressure of the filtered reformate stream 123 before the stream 123 enters the fuel cell 124. The pressure sensor(s) P9 may be configured to measure the pressure at one or more inlets, one or more outlets, and/or inside the fuel cell 124. The pressure sensor P10 may be configured to measure the pressure of the anode off-gas 128 after the off-gas 128 exits the fuel cell 124 and/or before the off-gas 128 enters the combustion heater 109.

Referring now to FIG. 5C, the temperature sensors T1-T11 may be positioned in various components and/or fluid lines of the ammonia reforming system 100. The temperature sensor T1 may be configured to measure the temperature of ammonia stored in the tank 102. The temperature sensor T2 may be configured to measure the temperature of the incoming ammonia stream 104 before the stream 104 enters the heat exchanger 106. The temperature sensor T3 may be configured to measure the temperature of the incoming ammonia stream 104 after the stream 104 exits the heat exchanger 106. The temperature sensor T4 may be configured to measure the temperature of the air stream 118 after the stream 118 exits the air supply unit 116. The temperature sensor T5 may be configured to measure the temperature of fluid at one or more inlets, one or more outlets, and/or inside of the reformers 108-110 and/or the combustion heater 109. For example, the temperature sensor T5 may be configured to measure the temperature of the incoming ammonia stream 104 at the inlets of the reformers 108-110, the partially cracked reformate stream 120 inside the reformers 108-110, and/or the substantially cracked reformate stream 120 at the outlets of the reformers 108-110. In another example, the temperature sensor T5 may be configured to measure the temperature of the reformate stream 120 and/or the air stream 118 at the inlets of the combustion heater 109, the combustion product gas 114 inside the combustion heater 109, and/or the combustion exhaust 114 at the outlets of the combustion heater 109. The temperature sensor T6 may be configured to measure the temperature of the reformate stream 120 after the reformate stream exits the reformer 108-110 and before the reformate stream 120 enters the heat exchanger 106. The temperature sensor T7 may be configured to measure the temperature at one or more inlets, one or more outlets, and/or inside the ammonia filter 122. The temperature sensor T8 may be configured to measure the temperature of the filtered reformate stream 123 before the stream 123 enters the fuel cell 124. The temperature sensor T9 may be configured to measure the temperature at one or more inlets, one or more outlets, and/or inside the fuel cell 124. The temperature sensor T10 may be configured to measure the temperature of the anode off-gas 128 after the off-gas 128 exits the fuel cell 124 and before the off-gas 128 enters the combustion heater 109. The temperature sensor T11 may be configured to measure the temperature at one or more inlets, one or more outlets, and/or inside the heat exchanger 106).

It is noted that the temperature sensors T1-T11 may be configured to measure temperatures of the walls of the components and/or fluid lines of the ammonia reforming system 100 (as opposed to directly measuring the temperature of the fluids passing therethrough, for example, by physically contacting the sensors with the fluid streams).

Referring now to FIG. 5D, the flow rate sensors FM1-FM11 (e.g., comprising flow meters or flow controllers) may be positioned in various components and/or fluid lines of the ammonia reforming system 100. FM1-FM11 may comprise one or more valves, one or more regulators, or one or more flow rate sensors configured to monitor and/or control the flow rates of fluid streams of the ammonia reforming system 100. The flow meter FM1 may be configured to measure the flow rate of the incoming ammonia stream 104 before the stream 104 enters the heat exchanger 106. The flow meter FM2 may be configured to measure the flow rate of the incoming ammonia stream 104 after the stream 104 exits the heat exchanger 106. The flow meter FM3 may be configured to measure the flow rate of the air stream 118 at or inside the air supply unit 116. The flow meter FM4 may be configured to measure the flow rate of the air stream 118 after the stream 118 exits the air supply unit 116. The flow meter FM5 may be configured to measure the flow rate of fluid at one or more inlets, one or more outlets, and/or inside of the reformers 108-110 and/or the combustion heater 109. For example, the flow meter FM5 may be configured to measure the flow rate of the incoming ammonia stream 104 at the inlets of the reformers 108-110, the partially cracked reformate stream 120 inside the reformers 108-110, and/or the substantially cracked reformate stream 120 at the outlets of the reformers 108-110. In another example, the flow meter FM5 may be configured to measure the flow rate of the reformate stream 120 or anode off-gas 128 and/or the air stream 118 at the inlets of the combustion heater 109, the combustion product gas 114 inside the combustion heater 109, and/or the combustion exhaust 114 at the outlets of the combustion heater 109. The flow meter FM6 may be configured to measure the flow rate of the reformate stream 120 after the reformate stream exits the reformer 108-110 and before the reformate stream 120 enters the heat exchanger 106. The flow meter FM7 may be configured to measure the flow rate at one or more inlets, one or more outlets, and/or inside the ammonia filter 122. The flow meter FM8 may be configured to measure the flow rate of the filtered reformate stream 123 before the stream 123 enters the fuel cell 124. The flow meter FM9 may be configured to measure the flow rate at one or more inlets, one or more outlets, and/or inside the fuel cell 124. The flow meter FM10 may be configured to measure the flow rate of the anode off-gas 128 after the off-gas 128 exits the fuel cell 124 and before the off-gas 128 enters the combustion heater 109. The flow meter FM11 may be configured to measure the one or more flow rates the one or more inlets, one or more outlets, or one or more locations in the heat exchanger 106.

It is noted that, in some embodiments, the flow rate meters FM1-FM11 may comprise pumps, valves, blowers, compressors, or other fluid supply device, and the respective flow rate measurements may be performed by correlating a parameter of the fluid supply device with the flow rate. For example, the flow meter FM3 may be the air supply unit 116 itself. If the air supply unit 116 comprises a valve, the flow rate may be measured by correlating a size of an opening of the valve and/or one or more pressure measurements in the air supply unit 116. If the air supply unit comprises a pump or a compressor, the flow rate may be measured by at least partly correlating a revolutions-per-minute (RPM) of the pump or the compressor.

Referring now to FIG. 5E, the ammonia sensors AC1-AC10 may be positioned in various components and/or fluid lines of the ammonia reforming system 100. The ammonia sensor AC1 may be configured to measure the concentration of ammonia in the storage tank 102. The ammonia sensor AC2 may be configured to measure the concentration of ammonia in the incoming ammonia stream 104 before the stream 104 enters the heat exchanger 106. The ammonia sensor AC3 may be configured to measure the concentration of ammonia in the incoming ammonia stream 104 after the stream 104 exits the heat exchanger 106. The ammonia sensor AC4 may be configured to measure the concentration of ammonia at one or more inlets, one or more outlets, and/or inside of the reformers 108-110 and/or the combustion heater 109. For example, the ammonia sensor AC4 may be configured to measure the concentration of ammonia in the incoming ammonia stream 104 at the inlets of the reformers 108-110, the partially cracked reformate stream 120 inside the reformers 108-110, and/or the substantially cracked reformate stream 120 at the outlets of the reformers 108-110. In another example, the ammonia sensor AC4 may be configured to measure the concentration of ammonia in the reformate stream 120 and/or the air stream 118 at the inlets of the combustion heater 109, the combustion product gas 114 inside the combustion heater 109, and/or the combustion exhaust 114 at the outlets of the combustion heater 109. The ammonia sensor AC5 may be configured to measure the concentration of ammonia in the reformate stream 120 after the reformate stream exits the reformer 108-110 and before the reformate stream 120 enters the heat exchanger 106. The ammonia sensor AC6 may be configured to measure the concentration of ammonia at one or more inlets, one or more outlets, and/or inside the ammonia filter 122. The ammonia sensor AC7 may be configured to measure the concentration of ammonia in the filtered reformate stream 123 before the stream 123 enters the fuel cell 124. The ammonia sensor AC8 may be configured to measure the concentration of ammonia at one or more inlets, one or more outlets, and/or inside the fuel cell 124. The ammonia sensor AC9 may be configured to measure the concentration of ammonia in the anode off-gas 128 after the off-gas 128 exits the fuel cell 124 and before the off-gas 128 enters the combustion heater 109. The ammonia sensor AC10 may be configured to measure the concentration of ammonia at one or more inlets, one or more outlets, and/or inside the heat exchanger 106.

Referring now to FIG. 5F, the hydrogen concentration sensors HC1-HC5 positioned in various components and/or fluid lines of the ammonia reforming system 100. The hydrogen concentration sensor HC1 may be configured to measure the concentration of hydrogen at one or more inlets, one or more outlets, and/or inside of the reformers 108-110 and/or the combustion heater 109. For example, the hydrogen concentration sensor HC1 may be configured to measure the concentration of hydrogen in the incoming ammonia stream 104 at the inlets of the reformers 108-110, the partially cracked reformate stream 120 inside the reformers 108-110, and/or the substantially cracked reformate stream 120 at the outlets of the reformers 108-110. In another example, the hydrogen concentration sensor HC1 may be configured to measure the concentration of hydrogen in the reformate stream 120, the fuel cell off-gas 128, and/or the air stream 118 at the inlets of the combustion heater 109, the combustion product gas 114 inside the combustion heater 109, and/or the combustion exhaust 114 at the outlets of the combustion heater 109. The hydrogen concentration sensor HC2 may be configured to measure the concentration of hydrogen in the reformate stream 120 after the reformate stream exits the reformer 108-110 and before the reformate stream 120 enters the heat exchanger 106. The hydrogen concentration sensor HC3 may be configured to measure the concentration of hydrogen in the filtered reformate stream 123 before the stream 123 enters the fuel cell 124. The hydrogen concentration sensor HC4 may be configured to measure the concentration of hydrogen at one or more inlets, one or more outlets, and/or inside the fuel cell 124. The hydrogen concentration sensor HC5 may be configured to measure the concentration of hydrogen in the anode off-gas 128 after the off-gas 128 exits the fuel cell 124 and before the off-gas 128 enters the combustion heater 109.

Referring now to FIG. 5G, the flow control units FCU1-FCU11 may be positioned in various components and/or fluid lines of the ammonia reforming system 100. FCU1-FCU11 may configured to monitor and/or control (i.e., increase, decrease, modulate, or maintain) one or more flow rates and/or one or more pressures of the ammonia reforming system 100. FCU1-FCU11 may comprise one or more pressure drop elements configured to reduce pressure, one or more pumps, one or more check valves, one or more one-way valves, one or more three-way valves, one or more restrictive orifices, one or more valves, one or more flow regulators, one or more pressure regulators, one or more back pressure regulators, one or more pressure reducing regulators, one or more back flow regulators, one or more flow meters, one or more flow controllers, or any combination thereof. In some cases, the flow control units FCU1-FCU11 may be controlled manually, automatically, or electronically.

The flow control unit FCU1 may be configured to measure and/or control the flow rate and/or pressure of the incoming ammonia stream 104 before the stream 104 enters the heat exchanger 106. The flow control unit FCU2 may be configured to measure and/or control the flow rate and/or pressure of the incoming ammonia stream 104 after the stream 104 exits the heat exchanger 106. The flow control unit FCU3 may be configured to measure and/or control the flow rate and/or pressure of the air stream 118 at or inside the air supply unit 116. The flow control unit FCU4 may be configured to measure and/or control the flow rate and/or pressure of the air stream 118 after the stream 118 exits the air supply unit 116. The flow control unit FCU5 may be configured to measure and/or control the flow rate and/or pressure of fluid at one or more inlets, one or more outlets, and/or inside the reformers 108-110 and/or the combustion heater 109. For example, the flow control unit FCU5 may be configured to measure and/or control the flow rate and/or pressure of the incoming ammonia stream 104 at the inlets of the reformers 108-110, the partially cracked reformate stream 120 inside the reformers 108-110, and/or the substantially cracked reformate stream 120 at the outlets of the reformers 108-110. In another example, the flow control unit FCU5 may be configured to measure and/or control the flow rate and/or pressure of the reformate stream 120 or anode off-gas 128 and/or the air stream 118 at the inlets of the combustion heater 109, the combustion product gas 114 inside the combustion heater 109, and/or the combustion exhaust 114 at the outlets of the combustion heater 109. The flow control unit FCU6 may be configured to measure and/or control the flow rate and/or pressure of the reformate stream 120 after the reformate stream exits the reformer 108-110 and before the reformate stream 120 enters the heat exchanger 106. The flow control unit FCU7 may be configured to measure and/or control the flow rate and/or pressure at one or more inlets, one or more outlets, and/or inside the ammonia filter 122. The flow control unit FCU8 may be configured to measure and/or control the flow rate and/or pressure of the filtered reformate stream 123 before the stream 123 enters the fuel cell. The flow control unit FCU9 may be configured to measure and/or control the flow rate and/or pressure at one or more inlets, one or more outlets, and/or inside the fuel cell 124. The flow control unit FCU10 may be configured to measure and/or control the flow rate and/or pressure of the anode off-gas 128 after the off-gas 128 exits the fuel cell 124 and before the off-gas 128 enters the combustion heater 109. The flow control unit FM11 may be configured to measure and/or control the flow rate and/or pressure at one or more inlets, one or more outlets, and/or inside the heat exchanger 106.

It is noted that, in some embodiments, the flow control units FCU1-FCU11 may comprise pumps, valves, blowers, compressors, or other fluid supply devices, and the respective flow rate measurements may be performed by correlating a parameter of the fluid supply device with the flow rate. For example, the flow control unit FCU3 may be the air supply unit 116 itself. If the air supply unit 116 comprises a valve, the flow rate may be measured by correlating a size of an opening of the valve and/or one or more pressure measurements in the air supply unit 116. If the air supply unit 116 comprises a pump or a compressor, the flow rate may be measured by at least partly correlating a revolutions-per-minute (RPM) of the pump or the compressor. In some cases, the flow control unit FCU1-FCU11 and the flow meter FM1-FM11 are interchangeable and/or may have one or more identical or similar functionalities.

In some instances, the flow control units FCU1-FCU11 and/or flow rate meters FM1-FM11 may maintain a flow rate to a target flow rate within a selected tolerance. In some instances, the selected tolerance may be at least about 1, about 5, about 10, about 20, about 30, about 40, about 50, about 60, about 70, about 80, or about 90%. In some instances, the selected tolerance may be at most about 1, about 5, about 10, about 20, about 30, about 40, about 50, about 60, about 70, about 80, or about 90%. In some instances, the selected tolerance may be between about 1 and 90, about 5 and about 80, about 10 and about 70, about 20 and about 60, about 30 and about 50, or about 40 and about 90%. In some instances, the selected tolerance may be less than about 20%.

In some cases, the flow control units FCU1-FCU11 and/or flow rate meters FM1-FM11 may increase a flow rate to a target flow rate at a predefined ramp-up rate (within a selected tolerance). In some cases, the selected tolerance may be at least about 1, about 5, about 10, about 20, about 30, about 40, about 50, about 60, about 70, about 80, or about 90%. In some cases, the selected tolerance may be at most about 1, about 5, about 10, about 20, about 30, about 40, about 50, about 60, about 70, about 80, or about 90%. In some cases, the selected tolerance may be between about 1 and about 90, about 5 and about 80, about 10 and about 70, about 20 and about 60, about 30 and about 50, or about 40 and about 90%. In some cases, the selected tolerance may be less than about 20%.

In some cases, the flow control units FCU1-FCU11 and/or flow rate meters FM1-FM11 may decrease a flow rate to a target flow rate at a predefined ramp-down rates (within a selected tolerance). In some cases, the selected tolerance may be at least about 1, about 5, about 10, about 20, about 30, about 40, about 50, about 60, about 70, about 80, or 90%. In some cases, the selected tolerance may be at most about 1, about 5, about 10, about 20, about 30, about 40, about 50, about 60, about 70, about 80, or 90%. In some cases, the selected tolerance may be between about 1 and about 90, about 5 and about 80, about 10 and about 70, about 20 and about 60, about 30 and about 50, or about 40 and about 90%. In some cases, the selected tolerance may be less than about 20%.

Referring now to FIG. 5H, one or more pressure regulators may be positioned in various components and/or fluid lines of the ammonia reforming system 100. For example, a back pressure regulator BPR1 (or a pressure reducing regulator PRR1) may be configured to maintain a pressure of the reformate stream 120 after the reformate stream exits the reformer 108-110, after (or before) the reformate stream 120 enters the heat exchanger 106, or before the reformate stream 120 enters the ammonia filter 122. A back pressure regulator BPR2 (or a pressure reducing regulator PRR2) may be configured to maintain a pressure of the filtered reformate stream 123 after the reformate stream 123 exits the ammonia filter 122. A back pressure regulator BPR3 (or a check valve CV1) may be configured to maintain a pressure of the anode off-gas 128.

### Fault Detection

Referring now to FIG. 5I, a fault detection module 214 may be stored in the memory 204 of the controller 200 and may be configured to detect one or more faults in the ammonia reforming system 100 (e.g., by utilizing the sensors P1-P10, T1-T11, FM1-FM11, AC1-AC10, and HC1-HC5). The faults may include major faults or minor faults.

An example of a fault may comprise a fracture of and/or leak from a reactor vessel (e.g., a fracture in the reformers 108-110 or the heater 109). The fracture and/or leak may be detected after a pressure sensor P1-P10 measures a sudden drop in pressure of the reformate stream 120 in the combustion heater 109, or a sudden drop in pressure of the incoming ammonia stream 104 (or the partially cracked reformate stream 120) in the combustion-heated reformer 108 or the electrically heated reformer 110. For example, the sudden drop in pressure may comprise a greater than 50% pressure drop (e.g., from 10 bara to less than or equal to 5 bara) within a predefined time. The predefined time may be at least about 1, about 5, about 10, about 20, about 30, about 40, about 50, about 60, about 70, about 80, or 90 minutes. In some cases, the predefined time may be at most about 1, about 5, about 10, about 20, about 30, about 40, about 50, about 60, about 70, about 80, or about 90 minutes.

Another example of a fault may comprise a leakage of ammonia above predetermined leakage levels. The leakage of ammonia may be detected after an ammonia concentration sensor AC1-AC10 detects a concentration of ammonia greater than a threshold concentration (e.g., about 25 ppm) adjacent or near any component or fluid line of the ammonia reforming system 100. In some instances, to detect the leakage, the ammonia concentration sensor AC1-AC10 may be positioned outside the wall(s) or container(s) of the component or fluid line of the ammonia reforming system 100.

An example of a fault may comprise a temperature offset (e.g., by a tolerance about 10% or more) from a target temperature range. For example, a target temperature range of the reformers 108-110 may comprise about 400 to about 600° C., and a temperature sensor T1-T11 may measure a temperature of less than about 360° C. or greater than about 660° C., indicating a temperature offset fault. In some cases, the reformers 108 and/or the reformer 110 may be maintained at a target temperature range of at least about 300, about 350, about 400, about 450, about 500, about 550, about 600, about 650, about 700, about 750, or about 800° C., and at most about 400, about 450, about 500, about 550, about 600, about 650, about 700, about 750, about 800, or about 900° C. In some cases, the target temperature ranges between about 300 and about 900, 350 and about 800, about 400 and about 750, about 450 and about 700, about 500 and about 650, or about 550 and about 600° C. In some cases, a target temperature range of the reformer 108 and a target temperature range of the reformer 110 may at least partially overlap.

In some cases, a temperature offset is defined by a selected tolerance of a target temperature (or a tolerance of a lower limit of a target temperature range, or an upper limit of a target temperature range). The selected tolerance may be at least about 1, about 5, about 10, about 20, about 30, about 40, about 50, about 60, about 70, about 80, about 90, or about 100% of the target temperature. The selected tolerance may be at most about 1, about 5, about 10, about 20, about 30, about 40, about 50, about 60, about 70, about 80, about 90, or about 100% of the target temperature. In some cases, the selected tolerance may be between about 1 and about 100, about 5 and about 90, about 10 and about 80, about 20 and about 70, about 30 and about 60, or about 40 and about 50% of the target temperature.

In another example, a fuel cell target temperature comprises about an ambient temperature to about 100° C., about 100° C. to about 150° C., or about 120° C. to about 200° C. For example, based on the target fuel cell temperature being about 120° C. to about 200° C., the temperature offset fault may be detected after a temperature sensor T1-T11 measures a fuel cell temperature of less than about 108° C. or greater than about 220° C.

An example of a fault may comprise a pressure offset (e.g., by a tolerance about 10% or more) from a target pressure range. For example, a target pressure range in the reformers 108-110 may comprise about 1 to about 5 bar-absolute (bara), about 3 to about 8 bara, about 5 to about 10 bara, or about 10 to about 20 bara. For example, if the target pressure range in the reformer is about 10 to about 20 bara a pressure sensor P1-P10 may measure a pressure of less than about 9 bara or greater than about 22 bara, indicating a pressure offset fault.

In some cases, a pressure offset is defined by a selected tolerance of a target pressure (or a tolerance of a lower limit of a target pressure range, or an upper limit of a target pressure range). The selected tolerance may be at least about 1, about 5, about 10, about 20, about 30, about 40, about 50, about 60, about 70, about 80, about 90, or about 100% of the target pressure. The selected tolerance may be at most about 1, about 5, about 10, about 20, about 30, about 40, about 50, about 60, about 70, about 80, about 90, or about 100% of the target pressure. In some cases, the selected tolerance may be between about 1 and 100, about 5 and about 90, about 10 and about 80, about 20 and about 70, about 30 and about 60, or about 40 and about 50% of the target pressure. The target pressure (or target pressure range) may be a pressure (or a pressure range) at an outlet or inside of the NH₃ storage tank 102, an inlet, an outlet, or inside of the combustion-heated reformer 108, an inlet, an outlet, or inside of the combustion heater 109, an inlet, an outlet, or inside of the electrically heated reformer 110, an inlet, an outlet, or inside of the heat exchanger 106, an inlet, an outlet, or inside of the ammonia filter 122, or an inlet, an outlet, or inside of the fuel cell 124.

An example of a fault may comprise a concentration offset (e.g., by a tolerance about 10% or more) from a target concentration range (or a tolerance of a lower limit of a target concentration range, or an upper limit of a target concentration range). A target ammonia concentration range in the filtered reformate stream 123 may comprise about 0.001 to about 0.01 ppm, about 0.01 to about 0.1 ppm, about 0.1 to about 1 ppm, about 0.1 ppm to about 100 ppm. For example, if the target ammonia concentration range is about 0.1 ppm to about 100 ppm, an ammonia concentration sensor AC1-AC10 may measure a concentration of greater than about 110 ppm, indicating a concentration offset fault.

In some cases, a concentration offset is defined by a selected tolerance of a target concentration. The selected tolerance may be at least about 1, about 5, about 10, about 20, about 30, about 40, about 50, about 60, about 70, about 80, about 90, or about 100% of the target concentration. The selected tolerance may be at most about 1, about 5, about 10, about 20, about 30, about 40, about 50, about 60, about 70, about 80, about 90, or about 100% of the target concentration. In some cases, the selected tolerance may be between about 1 and about 100, about 5 and about 90, about 10 and about 80, about 20 and about 70, about 30 and about 60, or about 40 and about 50% of the target concentration.

After a fault is detected using the fault detection module 214, in some instances, the controller 200 may execute or perform a corrective action. For example, after a fault is detected, the controller may execute or perform a complete shutdown of the ammonia reforming system 100 by stopping a flow rate of the incoming NH₃ stream 104, power provided the heaters 109-111, and/or the fuel cell 124. In another example, after a fault is detected, the controller may execute or perform a partial shutdown of the ammonia reforming system 100 by reducing power provided to the heater 109-111 and/or the fuel cell 124.

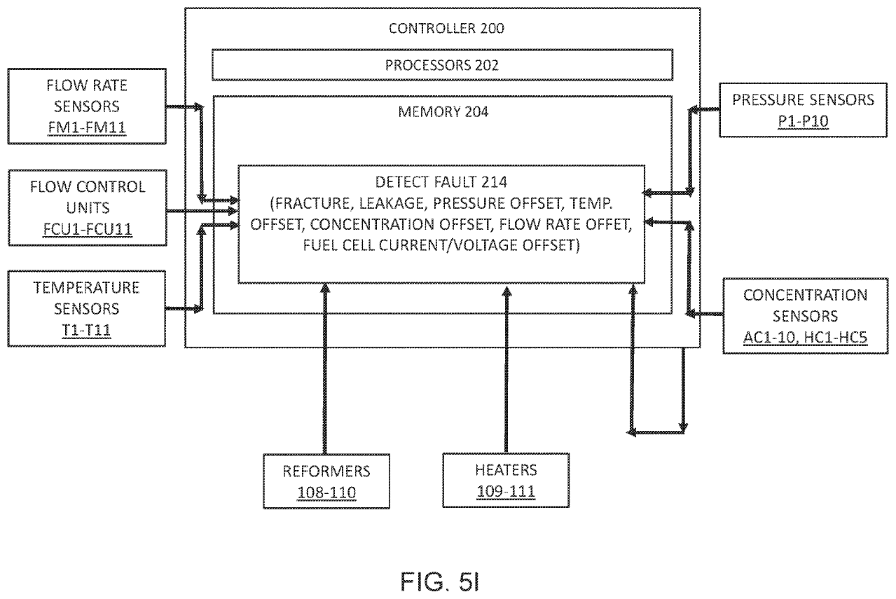

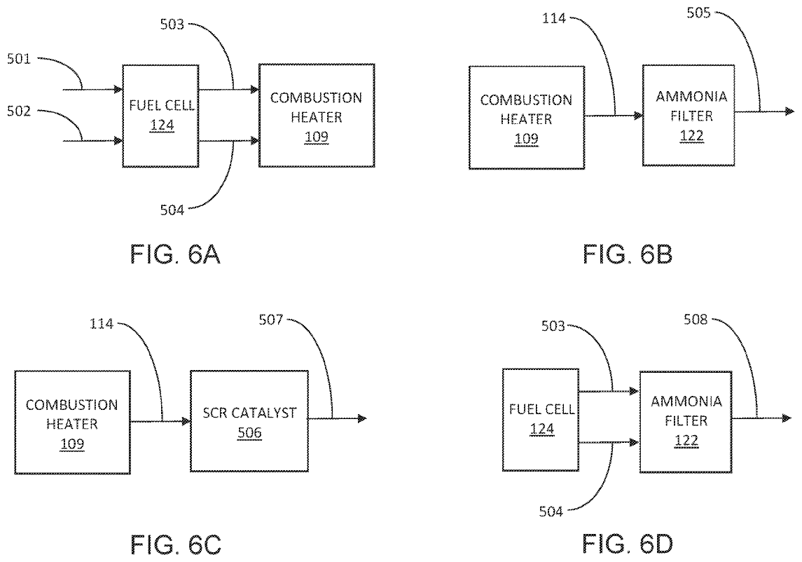

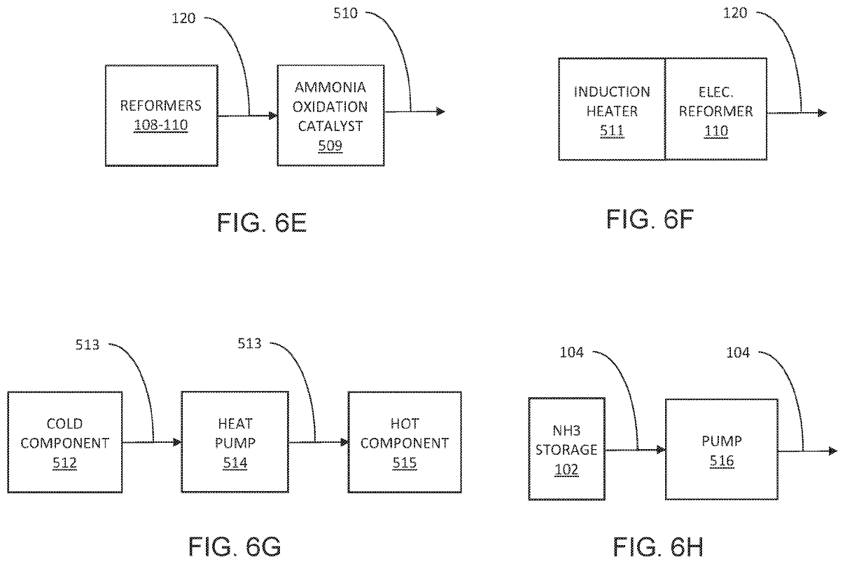

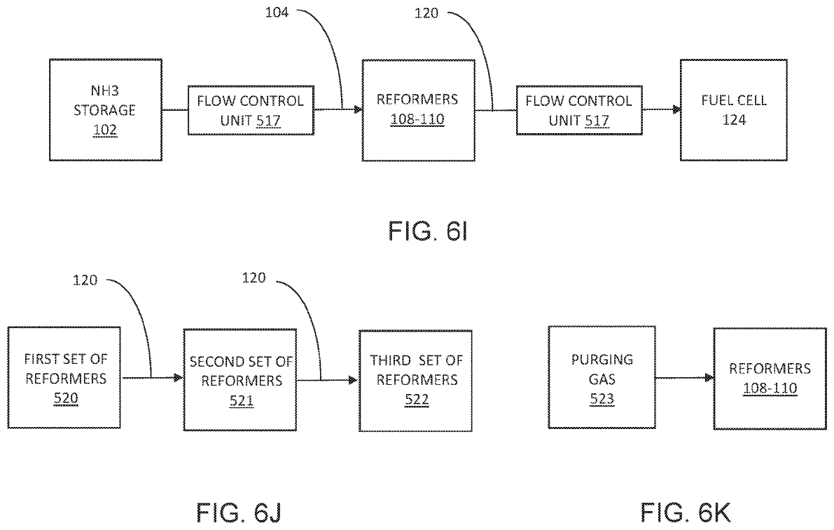

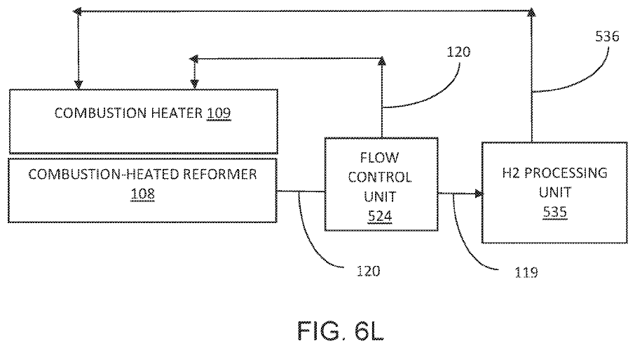

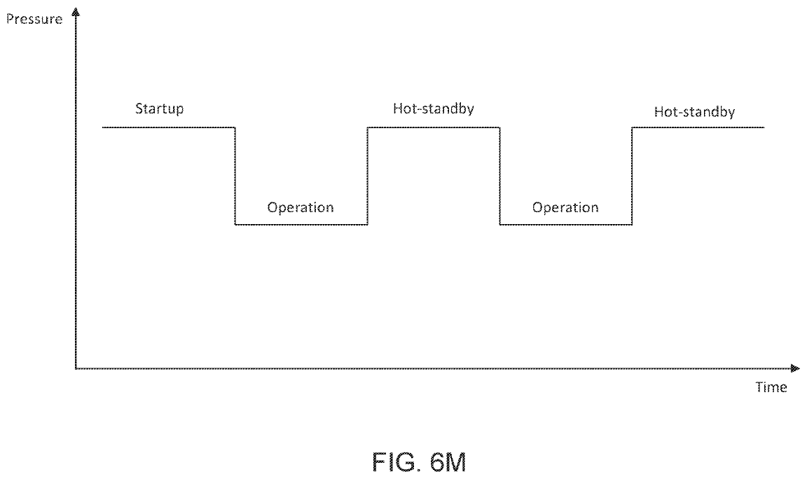

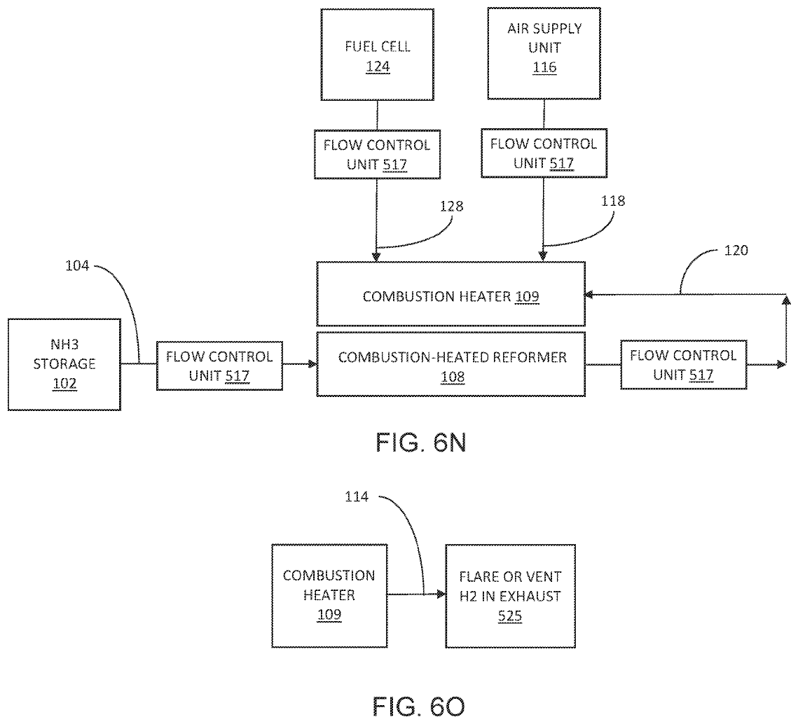

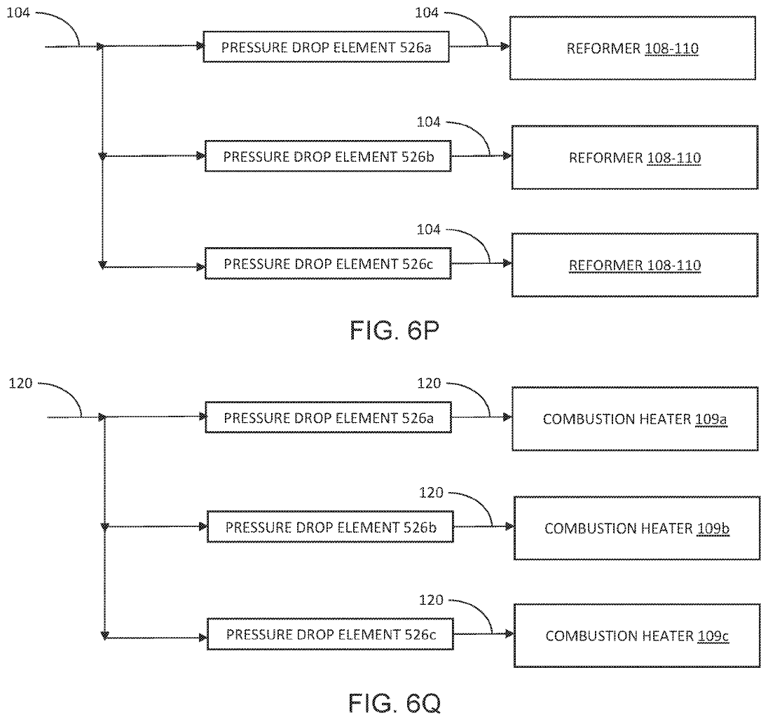

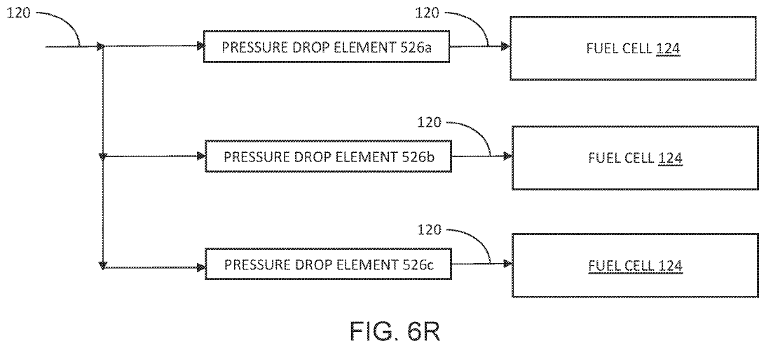

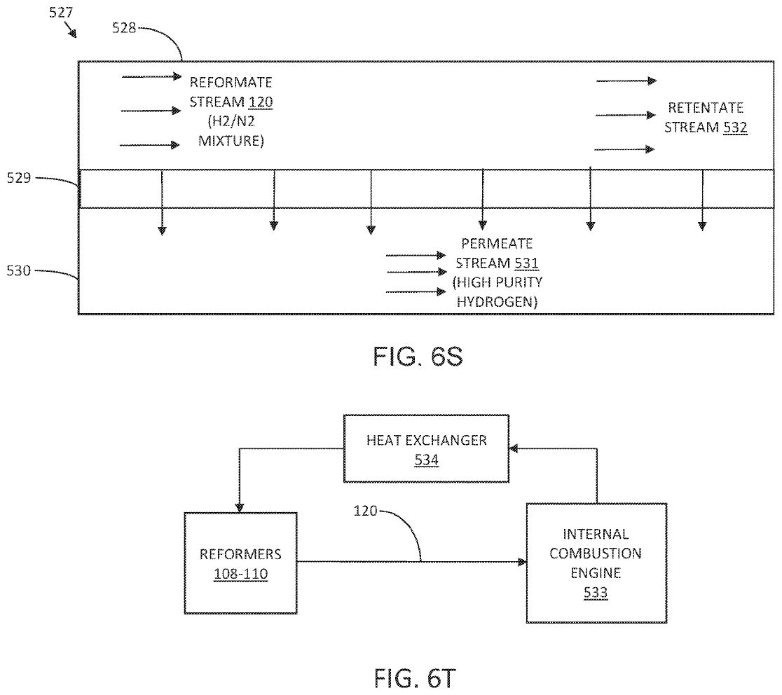

In some cases, after a fault is detected by the fault detection module 214, the combustion-heated reformer 108 may operate in a hot-standby mode to maintain the temperature in the combustion-heated reformer 108 within a target temperature range (the hot-standby mode is described in further detail with respect to FIG. 6L). In some cases, the hot standby mode (e.g., without the fuel cell outputting power) may be maintained until the shutdown process is executed. In some cases, the hot standby mode (e.g., without the fuel cell outputting power) may be maintained until fuel cell power output resumes.

### Anode Off-Gas and Cathode Off-Gas as Reactants in Combustion Heater

FIG. 6A is a block diagram illustrating the utilization of an anode off-gas 503 and a cathode off-gas 504 directed from the fuel cell 124 (for example, via one or more outlet ports in the fuel cell 124) as reactants for combustion in the combustion heater 109. The anode off-gas 503 may be substantially similar or substantially identical to the off-gas 128 described with respect to FIGS. 1A-4B.

The fuel cell may receive an anode input 501 (at least hydrogen, for example, in the reformate stream 120) and a cathode input 502 (at least oxygen, for example, in the air stream 118), for example, via one or more inlet ports in the fuel cell.

Unconsumed hydrogen (e.g., that is not consumed by the fuel cell 124) may be supplied as the anode off-gas 503, and unconsumed oxygen (e.g., that is not consumed by the fuel cell 124) may be supplied as a cathode off-gas 504 (as reactants for the combustion reaction in the combustion heater 109). In some cases, water may be removed from the anode off-gas 503 and/or the cathode off-gas 504 before the anode off-gas 503 and/or the cathode off-gas 504 are provided to the combustion heater 109 (e.g., using a condenser or a filter).

### Combustion Exhaust to Regenerate Adsorbents

FIG. 6B is a block diagram illustrating the utilization of heat from the combustion exhaust 114 (emitted by combustion heater 109) to regenerate the ammonia filter 122 (e.g., via temperature swing adsorption). The desorbed ammonia 505 may be vented to the atmosphere, combusted in the combustion heater 109, or mixed with water and discharged externally.

In some cases, the combustion exhaust stream 114 is used to regenerate the ammonia filter 122 by directly contacting the combustion exhaust stream 114 with the ammonia filter 122 (i.e., a direct purge of the filter material). In some cases, the combustion exhaust stream 114 is used to regenerate the ammonia filter 122 by transferring heat to the ammonia filter 122 via a heat exchanger (and/or an intermediate fluid, such as a glycol and/or water).

### Reduction of NOx in Combustion Exhaust

FIG. 6C is a block diagram illustrating the reduction of nitrogen oxides (NOx, e.g., NO, NO₂, N₂O, etc.) in the combustion exhaust 114 emitted by the combustion heater 109. A selective catalytic reduction (SCR) catalyst 506, such as platinum or palladium, may be used to convert NOₓ into H₂O and N₂. A reductant such as anhydrous ammonia (NH₃), aqueous ammonia (NH₄OH), or urea (CO(NH₂)₂) solution may be added to the exhaust 114 to react with NOₓ. The purified exhaust 507 may then be vented to the atmosphere. This removal of harmful NOₓ emissions advantageously reduces harm to the environment and living organisms.

### Anode Off-Gas and Cathode Off-Gas to Regenerate Adsorbents

FIG. 6D is a block diagram illustrating the utilization of the anode off-gas 503 and/or the cathode off-gas 504 to regenerate the ammonia filter 122 (e.g., via temperature swing adsorption). The desorbed ammonia 508 may be vented to the atmosphere or mixed with water and discharged externally. In some cases, combustion of the hydrogen in the anode off-gas 503 may provide heat to regenerate the ammonia filter 122. In some cases, lower temperature catalytic combustion of the hydrogen in the anode off-gas 503 may provide heat to regenerate the ammonia filter 122.

### Oxidation of NH₃ in Reformate Stream

FIG. 6E is a block diagram illustrating the oxidation of trace or residual NH₃ in the reformate stream 120 output by the combustion-heated reformer 108 and/or the electrically heated reformer 110. A selective ammonia oxidation (SAO) catalyst 509, such as tungsten, may be used to convert the trace or residual NH₃ into N₂ and H₂O. Air (including at least oxygen, e.g., the air stream 118) may be provided to the SAO catalyst 509 to react with the NH₃. The purified reformate stream 510 may be provided to the fuel cell 124 (to generate electricity) or to the combustion heater 109 (to be combusted for self-heating the reformer 108). The SAO catalyst 509, when combined with the ammonia filter 122, may advantageously reduce the size (e.g., volume and weight) of the ammonia filter 122, and may reduce the need to periodically replace cartridges in (or periodically regenerate) the ammonia filter 122. In some cases, introducing air (including at least oxygen) may combust and remove at least part of the residual NH₃ and H₂ (by converting into N₂ and H₂O) without the SAO catalyst 509.

### Induction Heater

FIG. 6F is a block diagram illustrating the heating of the electrically heated reformer 110 using an induction heater 511. The induction heater 511 may comprise a magnetically sensitive material in contact with the NH₃ reforming catalyst in the electrically heated reformer 110, in addition to a magnetic device (e.g., an electrical coil or other magnet) that generates a magnetic field to heat the magnetically sensitive material (e.g., via an electromagnetic interaction).

### Heat Pump

FIG. 6G is a block diagram illustrating the utilization of a heat pump 514 to transfer heat 513 from a relatively cold component 512 to a relatively hot component 515. The heat pump 514 may be driven by electricity (for example, vapor compression cycle), or driven by heat (for example, adsorption refrigeration), or a combination of both.

The components 512 and 514 may be any component of the ammonia reforming system 100 described in the present disclosure. For example, the heat pump 514 may transfer heat from the ammonia filter 122 to the reformate stream 120. Other examples include, but are not limited to, liquefying ammonia gas, condensing water from a cathode off-gas or combustion exhaust, removing heat from one or more heat exchangers, or removing heat from one or more fuel cells. In some cases, the refrigerants of the heat pump 514 may comprise ammonia, water, or mixture of both.

### Fluid Pump

FIG. 6H is a block diagram illustrating the utilization of a fluid pump 516 to pressurize the incoming ammonia stream 104 provided by the storage tank 102. The storage tank 102 and/or the pump 516 may use the heat provided by one or more electrical heaters, the combustion-heated reformer 108, the combustion heater 109, and/or the electrically heated reformer 110 to pressurize or vaporize the incoming ammonia stream 104. In some embodiments, the pump 516 may be electrically powered and/or controlled.

### Control of Pressure, Flow Rate, and Gas Velocity at Fuel Cell

FIG. 61 is a block diagram illustrating the utilization of flow control units 517 to control the pressure, flow rate, and/or gas velocity of fluid streams in the ammonia reforming system 100. The flow control units 517 may be substantially similar or substantially identical to the flow control units FCU1-10 described with respect to FIG. 5G. The flow control units 517 may comprise one or more pressure drop elements, one or more pumps, one or more check valves, one or more one-way valves, one or more three-way valves, one or more restrictive orifices, one or more valves, one or more flow regulators, one or more pressure regulators, one or more back pressure regulators, one or more pressure reducing regulators, one or more back flow regulators, one or more flow meters, one or more flow controllers, or any combination thereof. The flow control units 517 may be controlled manually, automatically, or electronically.

For example, the fuel cell 124 may draw the reformate stream 120 at a pressure that is maintained within a selected tolerance (e.g., a tolerance of about 1%, about 5%, or about 10%) at the inlet of the fuel cell 124. The target pressure may be at least about 1, about 2, about 3, about 4, about 5, about 6, about 7, about 8, about 9, about 10, about 15, about 20, about 25, about 30, about 35, or about 40 bar absolute (bara) at the inlet of the fuel cell 124. The target pressure may be at most about 1, about 2, about 3, about 4, about 5, about 6, about 7, about 8, about 9, about 10, about 15, about 20, about 25, about 30, about 35, or about 40 bara at the inlet of the fuel cell 124. In some cases, the target pressure may be between about 1 and 40, about 2 and about 35, about 3 and about 30, about 4 and about 25, about 5 and about 20, or about 10 and about 15 bara at the inlet of the fuel cell 124. In some cases, the target pressure range is about 2 to about 5 bara at the inlet of the fuel cell 124.

In some cases, the selected tolerance may be at least about 1, about 5, about 10, about 20, about 30, about 40, about 50, about 60, about 70, about 80, about 90, or about 100% of a target pressure at the inlet of the fuel cell 124. In some cases, the selected tolerance may be at most about 1, about 5, about 10, about 20, about 30, about 40, about 50, about 60, about 70, about 80, about 90, or about 100% of a target pressure at the inlet of the fuel cell 124. In some cases, the selected tolerance may be between about 1 and about 100, about 5 and about 90, about 10 and about 80, about 20 and about 70, about 30 and about 60, or about 40 and about 50% of the target pressure at the inlet of the fuel cell 124.

To maintain this pressure of the reformate stream 120 at the inlet of the fuel cell 124 (within the selected tolerance), the flow control units 517 may be controlled to modulate the pressure of the ammonia stream 104 (before the stream 104 enters the reformers 108-110), or the flow control units 517 may be controlled to modulate the pressure of the reformate stream 120 (before the stream 120 enters the fuel cell 124). As the fuel cell 124 consumes more of the reformate stream 120 and increases output power, the pressure of the reformate stream 120 may be measured at the fuel cell inlet (using a pressure sensor P1-P10), and the flow control units 517 may be modulated (e.g., based on the pressure measured by the pressure sensor P1-P10) to increase the flow rate of the ammonia stream 104 or the reformate stream 120 (to maintain the pressure of the reformate stream 120 at the selected tolerance at the fuel cell inlet).

In some embodiments, one or more pressure regulators (e.g., the back pressure regulators BPR1 or BPR2, or the pressure reducing regulator PRR1 or PRR2, as described with respect to FIG. 5H) may be configured to maintain the pressure of the reformate stream 120 at the inlet of the fuel cell 124 within the selected tolerance.

In some embodiments, the fuel cell 124 may draw the reformate stream 120 at a flow rate that is maintained within a selected tolerance (e.g., a tolerance of about 1%, about 5%, or about 10%) at the inlet of the fuel cell 124. In some cases, the selected tolerance may be at least about 1, about 5, about 10, about 20, about 30, about 40, about 50, about 60, about 70, about 80, about 90, or about 100% of a target flow rate at the inlet of the fuel cell 124. In some cases, the selected tolerance may be at most about 1, 5, 10, 20, 30, 40, 50, 60, 70, 80, 90, or 100% of a target flow rate at the inlet of the fuel cell 124. In some cases, the selected tolerance may be between about 1 and 100, 5 and 90, 10 and 80, 20 and 70, 30 and 60, or 40 and 50% of the target flow rate at the inlet of the fuel cell 124.

To maintain this flow rate of the reformate stream 120 at the inlet of the fuel cell 124 (within the selected tolerance), a flow rate of the reformate stream 120 may be measured at the fuel cell inlet (using a flow rate sensor FM1-FM11), and the flow control units 517 may be controlled (based on the flow rate measured by the flow rate sensor FM1-FM11) to modulate the flow rate of the ammonia stream 104 (before the stream 104 enters the reformers 108-110), or the flow control units 517 may be controlled (based on the flow rate measured by the flow rate sensor FM1-FM11) to modulate the flow rate of the reformate stream 120 (before the stream 120 enters the fuel cell 124).

In some embodiments, the flow control units 517 may be configured to modulate a gas velocity of the reformate stream 120 at the inlet of the fuel cell 124. In some cases, the hydrogen and/or nitrogen in the reformate stream 120 may purge liquid water in the fuel cell 124 by directing the liquid water out of the fuel cell 124. The gas velocity of the reformate stream 120 may be modulated based on a concentration or volume of the liquid water in the fuel cell 124 (which may be measured using, e.g., one or more humidity sensors in the fuel cell 124 in communication with the controller 200 described with respect to FIG. 5A). For example, in response to the measured concentration or volume of water in the fuel cell 124 being greater than a threshold concentration or volume, the gas velocity of the reformate stream 120 may be increased to facilitate the purging of water in the fuel cell 124 (and vice versa).

In some embodiments, at least a portion of the reformate stream 120 is recirculated in the fuel cell 124, and the recirculated portion may be adjusted based on a concentration or volume of the liquid water in the fuel cell 124, an H₂ consumption rate of the fuel cell 124, an N₂ concentration in the fuel cell 124, humidity in the fuel cell 124, the flow rate of the reformate stream 120 at the inlet of the fuel cell 124, or a power output of the fuel cell 124.

### Non-Linear Start-Up Sequence

FIG. 6J is a block diagram illustrating a non-linear start-up sequence for the ammonia reforming system 100. A first set of reformers 520 may comprise a plurality of electrically heated reformers (e.g., each one being substantially similar or substantially identical to the electrically heated reformer 110 described with respect to FIGS. 1A-4B). A second set of reformers 521 and a third set of reformers 522 may comprise a plurality of combustion-heated reformers (e.g., each one being substantially similar or substantially identical to the combustion-heated reformer 108 described with respect to FIGS. 1A-4B). It is contemplated that the number of reformers in the second set 521 may be greater than the number of reformers in the first set 520, and likewise, it is contemplated that the number of reformers in the third set 522 may be greater than the number of reformers in the second set 521. In this way, a progressively larger number of reformers may be heated at each step of the non-linear startup sequence. For example, the first set of reformers 520 may comprise two reformers, the second set of reformers 521 may comprise four reformers, the third set of reformers 522 may comprise eight reformers, and so on.

The non-linear start-up sequence may be performed by decomposing ammonia (e.g., the ammonia stream 104) using the first set of reformers 520 to generate a first reformate stream (e.g., the reformate stream 120). Subsequently, the reformate stream produced by the first set of reformers 520 may be combusted to heat the second set of reformers 521 to generate a second reformate stream. Subsequently, the second reformate stream produced by the second set of reformers 521 may be combusted to heat the third set of reformers 522 to generate a third reformate stream.

It is noted that the presently described non-linear start-up sequence may involve any number of sets of reformers (e.g., at least two sets of reformers), and each set of reformers may comprise any number of reformers (e.g., at least one reformer). It is also noted that the non-linear startup sequence may be initiated using the controller 200 (for example, by initiating the heating of the electrically heated reformers of the first set of reformers 520).

### Purging

FIG. 6K is a block diagram illustrating purging of the ammonia reforming system 100. A purging gas 523 may purge the ammonia reforming system 100 of residual gases (for example, before starting the ammonia reforming system 100 or after shutting down the ammonia reforming system 100). The purging gas 523 may direct residual ammonia in the ammonia reforming system 100 (for example, residual ammonia in the reformers 108-110) into water or a scrubber.

The purging gas 523 may comprise an inert or noble gas (for example, nitrogen or argon). In some cases, the purging gas 523 comprises hydrogen and may be flared or vented into the atmosphere. The purging gas 523 may be stored in a dedicated tank or may be generated by reforming ammonia. The purging of the ammonia reforming system may be initiated using the controller 200 (for example, by modulating a valve to direct the purging gas 523 into the reformers 108-110).

### Hot Standby Mode

FIG. 6L is a block diagram illustrating the initiation of a hot standby mode for the ammonia reforming system 100. The hot standby mode may advantageously reduce the time required to return to an operation mode, for example, by avoiding a shut-down (or reduction in temperature) of the combustion reformer 108 and/or the combustion heater 109. Additionally, the hot standby mode may advantageously enable the system 100 to adjust and respond to power demand at the fuel cell and/or hydrogen demand at a hydrogen processing module. Additionally, the hot standby mode may advantageously enable the maintenance of the fuel cell and/or the hydrogen processing module (e.g., due to a fault at the fuel cell and/or the hydrogen processing module) without shutting down (or reducing the temperature of) the combustion reformer 108 and/or the combustion heater 109. In some cases, the hot standby mode enables the system 100 to operate for stationary or mobile hydrogen and/or power generation applications.

In an operation mode of the ammonia reforming system 100, a flow control unit 524 may direct the reformate stream 120 (e.g., as an H₂ processing flow 119) to an H₂ processing module 535. The H₂ processing module 535 may be configured to generate electrical power and/or to supply H₂ to various chemical or industrial processes, including, but not limited to, steel or iron processing, combustion engines, combustion turbines, hydrogen storage, hydrogen for chemical processes, hydrogen fueling stations, and the like. The H₂ processing module 535 may comprise one or more fuel cells 124, one or more PSAs 127, one or more flow distributors 115, or one or more membrane hydrogen separation devices 527 (described with respect to FIGS. 1A-4B and FIG. 6S). A leftover reformate stream 536 (e.g., unconsumed H₂ from fuel cell 124, or H₂ that is not supplied to chemical or industrial processes) may then be supplied to the combustion heater 109 as a reactant for the combustion reaction. The leftover reformate stream 536 may comprise the filtered reformate stream 123, the anode off-gas 128, the anode off-gas 503, the PSA exhaust stream 128b, the hydrogen separation device retentate stream 532, or the portion 128c of the reformate stream 120 distributed by the flow distributor 115.

In some instances, the flow control unit 524 may configured to monitor and/or modulate one or more flow rates and/or one or more pressures. In some instances, the flow control unit 524 may comprise one or more pressure drop elements configured to reduce pressure, one or more pumps, one or more valves, one or more check valves, one or more one-way valves, one or more three-way valves, one or more restrictive orifices, one or more flow regulators, one or more pressure regulators, one or more back pressure regulators, one or more pressure reducing regulators, one or more back flow regulators, one or more flow meters, one or more flow controllers, or any combination thereof. In some instances, the flow control unit 524 may be controlled manually, automatically, or electronically.

After initiating the hot standby operation, the power output by the one or more fuel cells 124, or the supply of H₂ to the various chemical or industrial processes, may be reduced or shut off entirely (by modulating the flow control unit 524 to direct at least part of the reformate stream 120 to the combustion heater 109 for combustion in the combustion heater 109), thereby maintaining the combustion-heated reformer 108 in a target temperature range. Excess hydrogen may be vented or flared after passing the combustion heater 109 (due to fuel-rich conditions in the combustion-heater 109). In some cases, the excess hydrogen may be directed to a heat recovery module configured to recover hydrogen and/or heat from the combustion exhaust.

The hot standby mode may be terminated by modulating the flow control unit 524 to redirect the reformate stream 120 to the H₂ processing module 535 (e.g., by increasing a flow rate or pressure of the H₂ processing inlet flow 119, for example, at an inlet of the fuel cell 124), thereby starting or increasing the power output by and/or the H₂ supplied to the H₂ processing module 535.

The hot standby mode may advantageously maintain the target temperature range in the combustion-heated reformer 108 even while the H₂ processing module 535 reduces or shuts off the electrical power output or the supply of H₂ to the chemical or industrial processes (in other words, turning off the combustion-heated reformer 108 may be avoided). Therefore, during a fault situation (e.g., a fault associated with the fuel cell 124), completely shutting down the ammonia reforming system 100 may be prevented, and the time required to start-up the ammonia reforming system 100 (and increase power output by the H₂ processing module 535, and/or increase the H₂ supplied to the H₂ processing module 535) may be reduced.

In some instances, the flow rate of the incoming NH₃ stream 104 may (or may not be) configured to be the same during the operation mode and hot standby mode. In some instances, the flow rate of the incoming NH₃ stream 104 during the hot standby mode may be configured to be within a selected tolerance of the flow rate of the incoming NH₃ stream 104 during the operation mode. The selected tolerance may be at least about 1, about 5, about 10, about 20, about 30, about 40, about 50, about 60, about 70, about 80, or about 90%. The selected tolerance may be at most about 1, about 5, about 10, about 20, about 30, about 40, about 50, about 60, about 70, about 80, or about 90%. In some cases, the selected tolerance may be between about 1 and about 90, about 5 and about 80, 10 and about 70, about 20 and about 60, about 30 and about 50, or about 40 and about 90%. In some instances, the selected tolerance is about 5 to about 20%.

In some instances, the hot standby mode may be maintained without substantially reducing or increasing the flow rate of the incoming NH₃ stream 104 (or the flow rate of the reformate stream 120). In some instances, during the hot standby mode, the flow rate of the incoming NH₃ stream 104 (or the flow rate of the reformate stream 120) may be maintained within a selected tolerance of a target flow rate. The selected tolerance may be at most about 1, about 5, about 10, about 20, about 30, about 40, about 50, about 60, about 70, about 80, or about 90%. The selected tolerance may be at least about 1, about 5, about 10, about 20, about 30, about 40, about 50, about 60, about 70, about 80, or about 90%. In some cases, the selected tolerance may be between about 1 and about 90, about 5 and about 80, about 10 and about 70, about 20 and about 60, about 30 and about 50, or about 40 and 90%. In some instances, the selected tolerance may be about 5 to about 20%.

In some cases, during the hot standby mode, combustion characteristics in the combustion heater 109 may be fuel-rich, and flare may be observed in the combustion exhaust 114. In some cases, the hot standby mode is maintained by modulating a flow rate of the air stream 118 (e.g., using the air supply unit 116), so that the amount of H₂ combusted in the combustion heater 109 is modulated or controlled (which may prevent the excessive H₂ combustion and overheating of the combustion heater 109 and/or combustion-heated reformer 108).

FIG. 6M is a plot illustrating a system pressure (e.g., pressure in the incoming ammonia stream 104, reformate stream 120, reformer 108-110, heat exchanger 106, or ammonia filter 122) over time during the startup mode, during the operation mode, and during the hot-standby mode for the ammonia reforming system 100. The system pressure (e.g., pressure in the incoming ammonia stream 104, reformate stream 120, reformer 108-110, heat exchanger 106, or ammonia filter 122) during the hot standby mode may be higher than the system pressure during the operation mode. The system pressure may be measured, for example, using at least one of the pressure sensors P1-P10.

In some embodiments, the flow control unit 524 may configured to initiate the hot standby mode by increasing the system pressure. The flow control unit 524 may initiate the flow of the reformate stream 120 to the combustion heater 109 when the pressure of the reformate stream 120 (before reaching the flow control unit 524) is equal to or greater than a threshold pressure.

In one example, if the H₂ processing inlet flow 119 is at least partially blocked or closed (while maintaining the flow rate of the incoming ammonia stream 104 within a selected tolerance), the system pressure may increase. The flow rate of the incoming ammonia stream 104 may be maintained within a selected tolerance of at least about 1, 5, 10, 20, 30, 40, 50, 60, 70, 80, or 90%. The flow rate of the incoming ammonia stream 104 may be maintained within a selected tolerance of at most about 1, 5, 10, 20, 30, 40, 50, 60, 70, 80, or 90%. In some cases, the flow rate of the incoming ammonia stream 104 may be maintained within a selected tolerance between about 1 and 90, 5 and 80, 10 and 70, about 20 and about 60, about 30 and about 50, or about 40 and 90%. In some instances, the flow rate of the incoming ammonia stream 104 may be maintained within a selected tolerance of about 5 to about 20%.

If the pressure of the reformate stream 120 before the flow control unit 524 is equal to or greater than the threshold pressure (within a selected tolerance), the flow control unit 524 may direct a portion or all of the reformate stream 120 to the combustion heater 109 (thereby transitioning to the hot standby mode). The selected tolerance of the threshold pressure may be at least about 1, about 5, about 10, about 20, about 30, about 40, about 50, about 60, about 70, about 80, or about 90%. The selected tolerance of the threshold pressure may be at most about 1, about 5, about 10, about 20, about 30, about 40, about 50, about 60, about 70, about 80, or about 90%. In some cases, the selected tolerance of the threshold pressure may be between about 1 and 90, about 5 and about 80, about 10 and about 70, about 20 and about 60, about 30 and about 50, or about 40 and about 90%. In some instances, the selected tolerance is about 5 to about 20%.

In some embodiments, the hot standby mode may be terminated, and the operation mode may be initiated by reducing the system pressure (e.g., pressure in the incoming ammonia stream 104, reformate stream 120, reformer 108-110, heat exchanger 106, or ammonia filter 122).

In one example, the system pressure may be reduced by increasing or initiating the H₂ processing inlet flow 119 to the H₂ processing module 535 (while maintaining the flow rate of the incoming ammonia stream 104 within a selected tolerance). The flow rate of the incoming ammonia stream 104 may be maintained within a selected tolerance of at least about 1, about 5, about 10, about 20, about 30, about 40, about 50, about 60, about 70, about 80, or about 90%. The flow rate of the incoming ammonia stream 104 may be maintained within a selected tolerance of at most about 1, about 5, about 10, about 20, about 30, about 40, about 50, about 60, about 70, about 80, or about 90%. In some cases, the flow rate of the incoming ammonia stream 104 may be maintained within a selected tolerance of between about 1 and about 90, about 5 and about 80, about 10 and about 70, about 20 and about 60, about 30 and about 50, or about 40 and about 90%. In some instances, the flow rate of the incoming ammonia stream 104 may be maintained within a selected tolerance of about 5 to about 20%.

If the pressure of the reformate stream 120 before the flow control unit 524 is equal to or less than the threshold pressure (within a selected tolerance), the flow control unit 524 may redirect a portion or all of the reformate stream 120 supplied to the combustion heater 109 back to the H₂ processing module 535. The selected tolerance of the threshold pressure may be at least about 1, about 5, about 10, about 20, about 30, about 40, about 50, about 60, about 70, about 80, or about 90%. The selected tolerance of the threshold pressure may be at most about 1, about 5, about 10, about 20, about 30, about 40, about 50, about 60, about 70, about 80, or about 90%. In some cases, the selected tolerance of the threshold pressure may be between about 1 and about 90, about 5 and about 80, about 10 and about 70, about 20 and about 60, about 30 and about 50, or about 40 and about 90%. In some instances, the selected tolerance of the threshold pressure is about 5 to about 20%.

In some cases, the leftover reformate stream 536 may be supplied to the combustion heater 109 (to transition to the operation mode).

In some embodiments, the flow rate of the incoming NH₃ stream 104 may increase while transitioning from the hot standby mode to the operation mode. In some embodiments, the flow rate of the incoming NH₃ stream 104 may increase after transitioning from the hot standby mode to the operation mode (to increase the electrical power output by the H₂ processing module 535, and/or to supply more H₂ to the industrial or chemical processes of the H₂ processing module 535).

In some embodiments, the ammonia reforming system 100 comprises two or more ammonia reformers 108-110, and the hot standby mode may be initiated using at least one ammonia reformer 108-110, and the remaining ammonia reformers 108-110 may be maintained in the operation mode.

In some embodiments, combustion of the reformate stream 120 maintains a temperature in the combustion-heated reformer 108 within a target temperature range (for example, during the hot standby mode).

In some embodiments, the reformate stream 120 is directed to the combustion heater 109 in thermal communication with the combustion-heated reformer 108, so that the combustion heater 109 receives substantially all of the reformate stream 120 (for example, more than about 90, about 91, about 92, about 93, about 94, about 95, about 96, about 97, about 98, about 99, or about 99.5% of the reformate stream 120 and less than about 91, about 92, about 93, about 94, about 95, about 96, about 97, about 98, about 99, about 99.5% or about 100% of the reformate stream 120).

In some embodiments, an amount (e.g., flow rate) of the ammonia stream 104 directed to the combustion-heated reformer 108 is controlled so that a first portion of the reformate stream 120 (combusted in the combustion heater 109) includes substantially all of the reformate stream 120 (for example, during the hot standby mode) (for example, more than about 90, about 91, about 92, about 93, about 94, about 95, about 96, about 97, about 98, about 99, or about 99.5% of the reformate stream 120 and less than about 91, 92, about 93, about 94, about 95, about 96, about 97, about 98, about 99, about 99.5% or about 100% of the reformate stream 120).

In some embodiments, an amount (e.g., flow rate) of a second portion of the reformate stream 120 (e.g., the H₂ processing flow 119 that is processed in the hydrogen processing module 535) is increased (e.g., when transitioning from the hot standby mode to the operation mode).

In some embodiments, the amount (e.g., flow rate) of the ammonia stream 104 directed to the combustion-heated reformer 108 may be increased to a first target ammonia flow rate range (for example, during the hot standby mode).

In some embodiments, a second portion of the reformate stream 120 is directed out of the combustion heater 109 (e.g., vented or flared, or provided to a heat recovery module, for example, during the hot standby mode). In some cases, at least about 30, about 40, about 50, about 60, about 70, about 80, or about 90% of the reformate stream 120 may be directed out of the combustion heater 109 during the hot standby mode. In some cases, at most about 30, about 40, about 50, about 60, about 70, about 80, or about 90% of the reformate stream 120 may be directed out of the combustion heater 109 during the hot standby mode. In some cases, of from about 30 to about 60%, of from about 40 to about 70%, of from about 50 to about 80%, or of from about 60 to about 90% of the reformate stream 120 is directed out of the combustion heater 109 during the hot standby mode.

### Startup Mode

As shown in FIG. 6M, the system pressure (e.g., pressure in the incoming ammonia stream 104, reformate stream 120, reformer 108-110, heat exchanger 106, or ammonia filter 122) during the startup mode and hot standby mode may be higher than the system pressure during the operation mode. In some cases, the system pressure during the startup mode may be the same as (or different from) the system pressure during the hot standby mode. In some cases, the system pressure during the startup mode and hot standby mode may be higher than the system pressure during the operation mode. In some cases, the system pressure during the startup mode may be the same as the system pressure during the hot standby mode within a selected tolerance. The selected tolerance may be at least about 1, about 5, about 10, about 20, about 30, about 40, about 50, about 60, about 70, about 80, or about 90%. The selected tolerance may be at most about 1, about 5, about 10, about 20, about 30, about 40, about 50, about 60, about 70, about 80, or about 90%. In some cases, the selected tolerance may be between about 1 and about 90, about 5 and about 80, about 10 and about 70, about 20 and about 60, about 30 and about 50, or about 40 and about 90%. In some instances, the selected tolerance is about 5% to about 20%.

In some cases, the startup mode may comprise a system configuration similar or at least partially identical to the hot standby mode described with respect to FIG. 6L, for example, a portion or all of the reformate stream 120 may be supplied to the combustion heater 109 using one or more flow control units (e.g., flow control unit 524). In some cases, the startup mode may be transitioned to the operation mode by reducing the system pressure (e.g., pressure in the incoming ammonia stream 104, reformate stream 120, reformer 108-110, heat exchanger 106, or ammonia filter 122). In some cases, the system pressure may be reduced by increasing or initiating the H₂ processing inlet flow 119 to the H₂ processing module 535 using one or more flow control units (e.g., flow control unit 524). In some cases, the system pressure may be reduced by increasing or initiating the H₂ processing inlet flow 119 to the H₂ processing module 535 using one or more flow control units while maintaining the flow rate of the incoming ammonia stream 104 within a selected tolerance. In some cases, the leftover reformate stream 536 may be supplied to the combustion heater 109 to transition to the operation mode using one or more flow control units. In some cases, the flow control unit 524 may be used to transition the startup mode to the operation mode by directing the H₂ processing inlet flow 119 to the H₂ processing module 535. The selected tolerance may be at least about 1, about 5, about 10, about 20, about 30, about 40, about 50, about 60, about 70, about 80, or about 90%. The selected tolerance may be at most about 1, about 5, about 10, about 20, about 30, about 40, about 50, about 60, about 70, about 80, or about 90%. In some cases, the selected tolerance may be between about 1 and about 90, about 5 and about 80, about 10 and about 70, about 20 and about 60, about 30 and about 50, or about 40 and about 90%. In some instances, the selected tolerance is about 5% to about 20%.

In some instances, the flow rate of the incoming NH₃ stream 104 may be (or may not be) configured to be the same during the startup mode and the operation mode. In some instances, the flow rate of the incoming NH₃ stream 104 during the startup mode may be configured to be within a selected tolerance of the flow rate of the incoming NH₃ stream 104 during the operation mode. The selected tolerance may be at least about 1, about 5, about 10, about 20, about 30, about 40, about 50, about 60, about 70, about 80, or about 90%. The selected tolerance may be at most about 1, about 5, about 10, about 20, about 30, about 40, about 50, about 60, about 70, about 80, or about 90%. In some cases, the selected tolerance may be between about 1 and about 90, about 5 and 80, about 10 and 70, about 20 and 60, about 30 and 50, or about 40 and about 90%. In some instances, the selected tolerance is about 5% to about 20%.

In some embodiments, the flow rate of the incoming NH₃ stream 104 may increase while transitioning from the startup mode to the operation mode. In some embodiments, the flow rate of the incoming NH₃ stream 104 may increase after transitioning from the startup mode to the operation mode to produce higher electrical power from and/or to supply more H₂ to the industrial or chemical processes in the H₂ processing module 535.

In some embodiments, a pressure of the reformate stream 120 is reduced when the reformate stream 120 is directed through the hydrogen processing module 535 (e.g., during the operation mode) compared to when the reformate stream is not directed through the hydrogen processing module 535 (e.g., during the startup mode or the hot standby mode).

In some embodiments, when a threshold amount of the reformate stream 120 is directed to the hydrogen processing module 535, substantially all of the reformate stream 120 is directed to the hydrogen processing module 535 (e.g., during the operation mode) (for example, more than about 80, about 85, about 90, about 91, about 92, about 93, about 94, about 95, about 96, about 97, about 98, about 99, or about 99.5% of the reformate stream 120 and less than about 81, about 86, about 91, about 92, about 93, about 94, about 95, about 96, about 97, about 98, about 99, about 99.5% or about 100% of the reformate stream 120).

In some embodiments, an amount (e.g., flow rate) of the ammonia stream 104 directed to the combustion-heated reformer 108 is increased over a time period (beginning when the combustion-heated reformer 108 is heated to a target temperature range).

In some embodiments, the amount of the ammonia stream 104 directed to the combustion-heated reformer 108 is increased to a first target ammonia flow rate range. In some embodiments, the reformate stream 120 is directed to a hydrogen processing module 535 when the first target ammonia flow rate range is reached. In some embodiments, the flow rate of the ammonia stream 104 is subsequently increased to a second target ammonia flow rate.

In some embodiments, a first portion of the reformate stream 120 is combusted with oxygen, and the oxygen is provided in a substantially constant proportion relative to the hydrogen in the first portion of the reformate stream 120. In some cases, the substantially constant proportion may comprise a constant mass ratio within a selected tolerance (e.g., mass of hydrogen to mass of oxygen), a constant volume ratio within a selected tolerance (e.g., volume of hydrogen to volume of oxygen), or a constant molar ratio within a selected tolerance (e.g., moles of hydrogen to moles of oxygen). In some cases, the selected tolerance may comprise at most about 1, about 5, about 10, about 20, about 30, about 40, or about 50% of a target proportion. In some cases, the selected tolerance may comprise of from about 1 to about 10% of from about 5 to about 10%, or of from about 5 to about 15% of a target proportion.

### Control of Temperature in Combustion-Heated Reformer

FIG. 6N is a block diagram illustrating the control of temperature inside the combustion-heated reformer 108 and/or the combustion heater 109. The combustion-heated reformer 108 and/or the combustion heater 109 may be maintained at a target temperature range, for example, of from about 300° C. to about 700° C. In some instances, the combustion-heated reformer 108 and/or the combustion heater 109 may be maintained at a target temperature range of from about 400° C. to about 600° C. In some instances, the combustion-heated reformer 108 and/or the combustion heater 109 may be maintained at a target temperature range of at least about 300, about 350, about 400, about 450, about 500, about 550, about 600, about 650, about 700, about 750, or about 800° C., and at most about 400, about 450, about 500, about 550, about 600, about 650, about 700, about 750, about 800, or about 900° C. In some cases, the target temperature ranges between about 300 and about 900, about 350 and about 800, about 400 and about 750, about 450 and about 700, about 500 and about 650, or about 550 and about 600° C. It is noted that the electrically heated reformer 110 and/or the electrical heater 111 may be maintained at the same target temperature range (or a different target temperature range) as the combustion-heated reformer 108 and/or the combustion heater 109.

In response to the temperature of the combustion-heated reformer 109 being outside or deviating from the target temperature range (in other words, being less than the lower limit of the temperature range, or being greater than the upper limit of the temperature range), the flow rate and/or pressure of the ammonia stream 104, the air stream 118 (comprising oxygen), the reformate stream 120, and/or the anode off-gas 128 may be modulated (e.g., using flow control units 517 and/or the flow control units FCU1-FCU10) to maintain the temperature of the combustion-heated reformer 108 and/or the combustion heater 109 within the temperature range.

For example, to decrease the temperature of the combustion-heated reformer 108 and/or the combustion heater 109, the flow rate and/or pressure of the ammonia stream 104 may be increased (thereby providing more reactant for the endothermic ammonia reforming reaction which absorbs heat). In some cases, to decrease the temperature of the combustion-heated reformer 108 and/or the combustion heater 109, the flow rate and/or pressure of the air stream 118 may be decreased (thereby providing less oxygen for the combustion reaction). In some cases, to decrease the temperature of the combustion-heated reformer 108 and/or the combustion heater 109, the flow rate and/or pressure of the reformate stream 120 may be decreased (thereby providing less hydrogen for the combustion reaction). In some embodiments, to decrease the temperature of the combustion-heated reformer 108 and/or the combustion heater 109, the flow rate and/or pressure of the anode off-gas 128 may be decreased (thereby providing less hydrogen for the combustion reaction).

In some cases, to decrease the temperature of the combustion-heated reformer 108 and/or the combustion heater 109, water may be added to the reformate stream 120 provided to the combustion heater 109 (e.g., so that the water absorbs heat in the combustion heater 109). In some cases, the water is stored in a dedicated storage tank, and water may be provided from the storage tank when required for decreasing the temperature in the combustion heater 109. In some cases, the water is sourced from the cathode off-gas 504 emitted by the fuel cell 124 (for example, by using a condenser or a filter). In some cases, the water is sourced from the combustion exhaust 114 (for example, using a condenser or filter) and stored in the dedicated storage tank. In some cases, the water is sourced externally (e.g., fresh water, tap water, distilled water, deionized water, etc.). In some cases, the water is sourced from the anode off-gas 128.

For example, to increase the temperature of the combustion-heated reformer 108 and/or the combustion heater 109, the flow rate and/or pressure of the ammonia stream 104 may be decreased (thereby providing less reactant for the endothermic ammonia reforming reaction, which absorbs heat). In some embodiments, to increase the temperature the combustion-heated reformer 108 and/or the combustion heater 109, the flow rate and/or pressure of the air stream 118 may be increased (thereby providing more oxygen and more combustion of H₂ for the combustion reaction).

In some embodiments, to increase the temperature of the combustion-heated reformer 108 and/or the combustion heater 109, the flow rate and/or pressure of the reformate stream 120 may be increased (thereby generating more hydrogen from the ammonia reforming process and providing more hydrogen for the combustion reaction). In some embodiments, to increase the temperature of the combustion-heated reformer 108 and/or the combustion heater 109, the flow rate and/or pressure of the anode off-gas 128 may be increased (thereby providing more hydrogen for the combustion reaction).

In some cases, to increase the temperature of the combustion-heated reformer 108 and/or the combustion heater 109, the hydrogen consumption rate from the fuel cell 124 may be reduced (thereby providing more hydrogen to the anode off-gas 128 and to the combustion heater 109 for the combustion reaction). In some cases, to decrease the temperature of the combustion-heated reformer 108 and/or the combustion heater 109, the hydrogen consumption rate from the fuel cell 124 may be increased (thereby providing less hydrogen to the anode off-gas 128 and to the combustion heater 109 for the combustion reaction).

In some instances, to decrease the temperature of the combustion-heated reformer 108 and/or the combustion heater 109, the flow rate and/or pressure of the air stream 118 may be increased (thereby providing a fuel-lean or air-rich condition, where N₂ absorbs at least part of the combustion heat and lowers the flame or combustion temperature at the combustion heater 109). In some cases, the fuel-lean or air-rich condition is maintained during at least about 10, about 20, about 30, about 40, about 50, about 60, about 70, about 80, or about 90% of the operational time period of the operation mode. In some cases, the fuel-lean or air-rich condition is maintained during at most about 10, about 20, about 30, about 40, about 50, about 60, about 70, about 80, or about 90% of the operational time period of the operation mode. In some cases, the fuel-lean or air-rich condition is maintained of from about 30% to about 50% of from about 40% to about 60%, of from about 50% to about 70%, of from about 60% to about 80%, or of from about 70% to about 90% of the operational time period of the operation mode.

### Dynamic Control

The systems and methods described herein can be dynamically controlled to achieve certain objectives. For example, an amount of ammonia that is reformed can be adjusted in response to a variable need for hydrogen. In a maritime deployment, for example, at a constant speed, a ship moving into a headwind can require more hydrogen (e.g., to generate more power from fuel cell(s)) compared to when the ship moves with the wind.

In some embodiments, a dynamic control method may comprise directing the ammonia stream to a reformer at an ammonia flow rate to produce a reformate stream comprising hydrogen and nitrogen. The method can further comprise combusting a first portion of the reformate stream with oxygen to heat the reformer. A second portion of the reformate stream can be processed in a hydrogen processing module (e.g., in a fuel cell). One or more adjustments can be made based at least in part on a stimulus (e.g., the stimulus can be a user input, or an automated input based on a measurement). For example, the adjustment(s) can include changing the ammonia flow rate (i.e., increasing or decreasing an amount of ammonia reformed). The adjustment(s) can also include changing a percentage of the reformate stream that is the first portion of the reformate stream (i.e., increasing or decreasing the percentage combusted to heat the reformer). The adjustment(s) can also include changing a percentage of the reformate stream that is the second portion of the reformate stream (i.e., increasing or decreasing the percentage that is sent to the hydrogen processing module). The adjustment(s) can also include changing a percentage of the reformate stream that is directed out of a combustion heater (e.g., increasing or decreasing the percentage that is vented or flared at a combustion exhaust of the combustion heater or increasing or decreasing the percentage that is directed to a heat recovery module).

In some cases, at least two of the adjustments are performed. In some cases, at least three of the adjustments are performed. In some cases, all of the adjustments are performed. In some cases, the dynamic control method further comprises changing an oxygen flow rate (i.e., increasing or decreasing the oxygen flow rate) used for combustion to heat the reformer.

In some cases, the stimulus comprises a change in an amount of the hydrogen used by the hydrogen processing module (i.e., an increase or a decrease in an amount of hydrogen used by the hydrogen processing module). In some cases, the stimulus comprises a temperature of the reformer being outside of a target temperature range. In some cases, the stimulus comprises a change in an amount or concentration of ammonia in the reformate stream (i.e., an increase or a decrease in an amount or concentration of ammonia in the reformate stream).

In some cases, to decrease the amount or concentration of ammonia in the reformate stream 120, the temperature of the combustion heater 109 and/or the reformers 108 and/or 110 may be increased (to increase ammonia conversion efficiency). In some cases, to increase the amount or concentration of ammonia in the reformate stream 120, the temperature of the combustion heater 109 and/or the reformers 108 and/or 110 may be decreased (to lower the ammonia conversion efficiency).

In some cases, the ammonia conversion efficiency is maintained to be at least about 80, about 85, about 90, about 93, about 95, about 97, about 98, about 99, or about 99.9%. In some cases, the ammonia conversion efficiency is maintained to be at most about 80, about 85, about 90, about 93, about 95, about 97, about 98, about 99, or about 99.9%. In some cases, the ammonia conversion efficiency is maintained to be of from about 80 to about 90% of from about 97 to about 99.9%, of from about 95 to about 99%, of from about 90 to about 95%, of from about 97 to about 99%, or of from about 85 to about 90%.

In some cases, the amount or concentration of ammonia in the reformate stream 120 is maintained to be at least about 100, about 500, about 1000, about 2000, about 3000, about 4000, about 5000, about 6000, about 7000, about 8000, about 9000, about 10000, about 20000, about 30000, about 40000, or about 50000 ppm. In some cases, the amount or concentration of ammonia in the reformate stream 120 is maintained to be at most about 100, about 500, about 1000, about 2000, about 3000, about 4000, about 5000, about 6000, about 7000, about 8000, about 9000, about 10000, about 20000, about 30000, about 40000, or about 50000 ppm. In some cases, a target amount or concentration of ammonia in the reformate stream 120 is of from about 500 to about 2500 ppm, of from about 1000 to about 3000 ppm, of from about 2000 to about 4000 ppm, of from about 3000 to about 5000 ppm, of from about 4000 to about 6000 ppm, of from about 5000 to about 7000 ppm, of from about 6000 to about 8000 ppm, of from about 7000 to about 9000 ppm, of from about 8000 to about 10000 ppm, of from about 5000 to about 15000 ppm, or of from about 5000 to about 20000 ppm. In some cases, the ammonia filter 122 is used to filter residual or trace ammonia in the reformate stream 120 and produce a filtered reformate stream 123.

In some cases, the amount of ammonia reformed, the amount of reformate directed to the hydrogen processing unit, the amount of reformate directed to the combustion heater to heat the reformer, and/or the amount of reformate that is directed out of the combustion heater (e.g., vented or flared out of the combustion heater) can be changed so that: a temperature of the reformer is within a target temperature range; and/or at most about 10% of the reformate stream is directed out of the combustion heater (e.g., vented or flared out of the combustion heater).

In some cases, the adjustment(s) are performed or achieved for at least 95% of an operational time period (e.g., of the ammonia reforming system 100). An operational time period may begin when initiating the heating of a start-up reformer (such as electrically heated reformer 110), when initiating the flow of the ammonia stream 104 from the storage tank 102, or when initiating the flow of the reformate stream 120 to a hydrogen processing module, and may end after the reformer 108-110, the heaters 109-111, and/or fuel cell 124 are shut down. In some cases, the operational time period is at least about 8 consecutive hours. In some cases, the operational time period is at least about 4, about 8, about 12, about 16, about 20, about 24, about 28, or about 32 consecutive hours. In some cases, the operational time period is at most about 4, about 8, about 12, about 16, about 20, about 24, about 28, or about 32 consecutive hours.

Any suitable amount of the reformate stream can be vented or flared. In some cases, the amount of ammonia reformed to produce the reformate stream is in excess of an amount of ammonia reformed that is used by the hydrogen processing module(s) and used to heat the reformer(s). This excess amount can represent a waste of ammonia fuel when reformate is vented or flared. However, operating without excess ammonia reformation results in a lack of a buffer for the reformate required for processing in the hydrogen processing module(s) and heating the reformer(s). In some cases, about 20%, about 15%, about 10%, about 5%, about 3%, or about 1% of the reformate stream is vented or flared. In some cases, less than about 20%, about 15%, about 10%, about 5%, about 3%, or about 1% of the reformate stream is vented or flared.

In some cases, the vented reformate may be stored in a tank (e.g., to store buffer hydrogen) for later use. In some cases, the vented reformate stored in the tank may be combusted to heat one or more reformers or may be provided to a hydrogen processing module.

The systems and methods described herein can be efficiently and reliably operated. Efficient and reliable operation can include meeting an efficiency target for a suitably long period of time or suitably large fraction of a time period. For example, the adjustment(s) may be performed or achieved for at least about 5, about 10, about 15, about 20, about 25, about 30, about 35, about 40, about 45, about 50, about 55, about 60, about 65, about 70, about 75, about 80, about 85, about 90, about 95, or about 100% of an operational time period. In some cases, the adjustment(s) may be performed or achieved for at most about 5, about 10, about 15, about 20, about 25, about 30, about 35, about 40, about 45, about 50, about 55, about 60, about 65, about 70, about 75, about 80, about 85, about 90, about 95, or about 100% of an operational time period. In some cases, the operational time period is at least about 1, about 2, about 3, about 4, about 5, about 6, about 7, about 8, about 9, about 10, about 15, about 20, about 25, about 50, about 100, about 500, about 1000, or about 2000 hours. In some cases, the operational time period is at most about 1, about 2, about 3, about 4, about 5, about 6, about 7, about 8, about 9, about 10, about 15, about 20, about 25, about 50, about 100, about 500, about 1000, or about 2000 hours.

In some cases, the stimulus is based at least in part on an increase in an amount of the hydrogen used by the hydrogen processing module. In some cases, the increase in an amount of hydrogen is a projected increase in an amount of hydrogen used (in other words, a predicted increase in demand of hydrogen by the hydrogen processing module at a subsequent time) or a target increase in an amount of hydrogen. In some cases, based on the increase in an amount of hydrogen used by the hydrogen processing module, one or more of (i) the ammonia flow rate is increased, (ii) the percentage of the reformate stream that is the first portion of the reformate stream is decreased, (iii) the percentage of the reformate stream that is the second portion of the reformate stream is increased, or (iv) the percentage of the reformate stream that is directed out of the combustion heater (e.g., vented or flared) is decreased.

In some cases, the stimulus is based at least in part on a decrease in an amount of the hydrogen used by the hydrogen processing module. In some cases, the decrease in an amount of hydrogen is a projected decrease in an amount of hydrogen used (in other words, a predicted decrease in demand of hydrogen by the hydrogen processing module at a subsequent time) or a target decrease in an amount of hydrogen. In some cases, based on the decrease in an amount of hydrogen used by the hydrogen processing module, one or more of: (i) the ammonia flow rate is decreased, (ii) the percentage of the reformate stream that is the first portion of the reformate stream is increased, (iii) the percentage of the reformate stream that is the second portion of the reformate stream is decreased, or (iv) the percentage of the reformate stream that is directed out of the combustion heater (e.g., vented or flared) is increased.

In some cases, the stimulus comprises (a) a discontinued processing of hydrogen using the hydrogen processing module or (b) a fault or malfunction of the hydrogen processing module.

In some cases, a plurality of hydrogen processing modules each comprise the hydrogen processing module, and the stimulus comprises at least one of (a) a discontinued processing of the hydrogen using one of the plurality of hydrogen processing modules and/or (b) a fault or malfunction in one of the plurality of hydrogen processing modules.

In some cases, the percentage of the reformate stream that is the second portion of the reformate stream (processed by the hydrogen processing module) is changed to about zero percent in response to the stimulus.

In some cases, substantially none of the reformate stream is directed to the hydrogen processing module in response to the stimulus. In some cases, at most about 5, about 10, about 15, about 20, about 25, or about 30% of the reformate stream is directed to the hydrogen processing module in response to the stimulus.

In some cases, substantially all of the reformate stream is directed to at least one of the combustion-heated reformer and/or a combustion heater in thermal communication with the combustion-heated reformer in response to the stimulus.

In some cases, a portion of the reformate stream is directed out of the combustion heater (e.g., vented, flared, or sent to a heat recovery module) in response to the stimulus.

In some cases, the stimulus is detected using a sensor. In some cases, the stimulus is communicated to a controller. In some cases, the adjustment(s) are performed with the aid of a programmable computer or controller. In some cases, the adjustment(s) are performed using a flow control unit.

In some cases, the stimulus is a pressure. In some cases, the pressure is increased in response to decreasing a flow rate to the hydrogen processing module. In some cases, the pressure is a pressure of the reformate stream.

### Proportional Integral Derivative (PID) Control

In some embodiments, the temperature inside the combustion-heated reformer 108 and/or the combustion heater 109 may be controlled using PID control, which entails a control loop mechanism employing feedback. A PID controller may automatically apply an accurate and responsive correction to a control function. The PID controller (e.g., controller 200) in conjunction with one or more sensors (e.g., temperature sensors T1-T10) may be employed to perform the PID control.

In some embodiments, the temperature inside the combustion-heated reformer 108 and/or the combustion heater 109 may be controlled using Proportional (P), Proportional Integral (PI), or Proportional Derivative (PD) control, which entails a control loop mechanism employing feedback. A P, PI, or PD controller may automatically apply an accurate and responsive correction to a control function. The P, PI, or PD controller (e.g., controller 200) in conjunction with one or more sensors (e.g., temperature sensors T1-T10 and/or time sensors) may be employed to perform the control.

The PID controller may continuously calculate an error value (e (t)) as the difference between a desired setpoint (SP) and a measured process variable (PV), and may apply a correction based on proportional, integral, and derivative terms (denoted P, I, and D respectively). The P, PI, or PD controller may apply a correction based on one or two of proportional, integral, and derivative terms (denoted P, I, and D respectively), accordingly.

In one example, proportional control may be performed by (a) calculating a temperature difference between a temperature measured in the combustion-heated reformer 108 or the combustion heater 109 and a set-point temperature within a target temperature range, and (b) (i) changing the ammonia flow rate (e.g., the flow rate of the ammonia stream 104) by an amount that is based at least in part on the temperature difference, (ii) changing the oxygen flow rate (e.g., increasing or decreasing the flow rate of the air stream 118) by an amount that is based at least in part on the temperature difference, (iii) changing a percentage of the reformate stream 120 that is processed by the H₂ processing module 535 by an amount that is based at least in part on the temperature difference, (iv) changing a percentage of the reformate stream 120 that is combusted in the combustion heater by an amount that is based at least in part on the temperature difference, or (v) changing a percentage of the reformate stream 120 that is directed out of the combustion heater (e.g., vented, flared, or sent to a heat recovery module) by an amount that is based at least in part on the temperature difference.

For example, the ammonia flow rate, the oxygen flow rate, the percentage of the reformate stream that is processed by the H₂ processing module, the percentage of the reformate stream that is combusted in the combustion heater, and/or the percentage of the reformate stream that is directed out of the combustion heater may be changed by a proportional factor that is proportional to the temperature difference. The value of the proportional factor may be greater when the temperature difference is greater. For example, for a set point temperature of about 450° C., the proportional factor may be greater for a measured temperature of about 350° C. (a temperature difference of about 100° C.) compared to a measured temperature of about 400° C. (a temperature difference of about 50° C.).

In some embodiments, the proportional factor is different for each of changing the ammonia flow rate, the oxygen flow rate, the percentage of the reformate stream that is processed by the H₂ processing module, the percentage of the reformate stream that is combusted in the combustion heater, and/or the percentage of the reformate stream that is directed out of the combustion heater.

In some embodiments, calculating the temperature difference may be repeated at a subsequent time point to obtain a subsequent temperature difference, and changing the ammonia flow rate, the oxygen flow rate, the percentage of the reformate stream that is processed by the H₂ processing module, the percentage of the reformate stream that is combusted in the combustion heater, and/or the percentage of the reformate stream that is directed out of the combustion heater may be repeated to further change the ammonia flow rate, the oxygen flow rate, the percentage of the reformate stream that is processed by the H₂ processing module, the percentage of the reformate stream that is combusted in the combustion heater, and/or the percentage of the reformate stream that is directed out of the combustion heater (by an amount that is proportional to the subsequent temperature difference). The aforementioned steps may be repeated until the measured temperature is within the target temperature range.

In some embodiments, integral control may be performed. For example, the temperature measured in the reformer 108 or combustion heater 109 may be a first temperature that is measured at a first time point, and the integral control may be performed by (a) measuring a second temperature of the reformer 108 or the combustion heater 109 at second time point subsequent to the first time point, (b) calculating a time period between the first time point and the second time point, (c) calculating a temperature difference between first temperature and the second temperature, and (d) changing one or more of the ammonia flow rate, the oxygen flow rate, the percentage of the reformate stream that is processed by the H₂ processing module, the percentage of the reformate stream that is combusted in the combustion heater, and/or the percentage of the reformate stream that is directed out of the combustion heater (by an amount that is based at least in part on the time period and the temperature difference). In some embodiments, the aforementioned steps are repeated until the measured temperature is within the target temperature range.

### Flaring or Venting Hydrogen

FIG. 6O is a block diagram illustrating the flaring or venting 525 of hydrogen in the combustion exhaust 114 of the combustion heater 109 to depressurize the reformers 108-110.

In some embodiments, the hydrogen may be flared in the combustion exhaust 114 of the combustion heater 109 by modulating a stoichiometric ratio of (1) the hydrogen in the reformate stream 120 supplied to the combustion heater 109 to (2) the oxygen in the air stream 118 supplied to the combustion heater 109.

Modulating the stoichiometric ratio may comprise modulating the flow rate and/or pressure of the air stream 118 supplied to the combustion heater 109 to maintain a fuel rich or air lean condition of the combustion reaction (in other words, the hydrogen may be in stoichiometric excess). In some cases, modulating the stoichiometric ratio may comprise modulating the flow rate and/or pressure of the reformate stream 120 supplied to the combustion heater 109 to maintain the fuel rich condition of the combustion reaction.

In some embodiments, a temperature of the combustion heater 109 may be maintained to be less than a threshold temperature by modulating the flow rate and/or pressure of the air stream 118 supplied to the combustion heater 109 (e.g., to enable a lower temperature catalytic combustion of the hydrogen).

In some embodiments, the flow of the air stream 118 to the combustion heater 109 may be reduced or shut off completely, which may decrease the temperature of the combustion heater 109 to less than a combustion temperature, and therefore the hydrogen may be vented (instead of combusted).

### Fuel-Rich or Air-Lean Combustion

In some cases, an air-to-fuel ratio (i.e., the air to fuel ratio divided by the stoichiometric air to fuel ratio, e.g., where an air-to-fuel ratio of 1 is the stoichiometric air to fuel ratio) during the fuel-rich or air-lean combustion is about 0.2 to about 0.99. In some cases, the air-to-fuel ratio during the fuel-rich or air-lean combustion is at least about 0.2, about 0.3, about 0.4, about 0.5, about 0.6, about 0.7, about 0.8, about 0.9, or about 0.99. In some cases, the air-to-fuel ratio during the fuel-rich or air-lean combustion is at most about 0.2, about 0.3, about 0.4, about 0.5, about 0.6, about 0.7, about 0.8, about 0.9, or about 0.99. In some cases, the air-to-fuel ratio during the fuel-rich or air-lean combustion is about 0.2 to about 0.4, about 0.3 to about 0.5, about 0.4 to about 0.6, about 0.5 to about 0.7, about 0.6 to about 0.8, about 0.7 to about 0.9, or about 0.8 to about 0.99.

In some cases, the air-to-fuel ratio of the fuel-rich or air-lean combustion during the operation mode is about 0.5 to about 0.99. In some cases, an air-to-fuel ratio of the fuel-rich or air-lean combustion during the operation mode is at least about 0.5, about 0.6, about 0.7, about 0.8, about 0.9, or about 0.99. In some cases, the air-to-fuel ratio of the fuel-rich or air-lean combustion during the operation mode is at most about 0.5, about 0.6, about 0.7, about 0.8, about 0.9, or about 0.99. In some cases, the air-to-fuel ratio of the fuel-rich or air-lean combustion during the operation mode is about 0.5 to about 0.7, about 0.6 to about 0.8, about 0.7 to about 0.9, or about 0.8 to about 0.99.

In some cases, the air-to-fuel ratio of the fuel-rich or air-lean combustion during the startup mode and/or hot standby mode is about 0.2 to about 0.8. In some cases, the air-to-fuel ratio of the fuel-rich or air-lean combustion during the startup mode and/or hot standby mode is at least about 0.2, about 0.3, about 0.4, about 0.5, about 0.6, about 0.7, or about 0.8. In some cases, the air-to-fuel ratio of the fuel-rich or air-lean combustion during the startup mode and/or the hot standby mode is at most about 0.2, about 0.3, about 0.4, about 0.5, about 0.6, about 0.7, or about 0.8. In some cases, the air-to-fuel ratio of the fuel-rich or air-lean combustion during the startup mode and/or the hot standby mode is about 0.2 to about 0.4, about 0.3 to about 0.5, about 0.4 to about 0.6, about 0.5 to about 0.7, or about 0.6 to about 0.8.

### Air-Rich or Fuel-Lean Combustion

In some cases, the combustion reaction in the combustion heater 109 may comprise an air-rich or fuel-lean condition (i.e., so that oxygen is in stoichiometric excess). In some cases, the fuel-lean combustion may increase thermal or energy efficiency of the reforming system 100, since a substantial majority, or all, of the combustion fuel (e.g., the reformate stream 120) is consumed. The fuel-lean combustion may enable a small amount (or none) of the H₂ at the combustion exhaust 114 to be flared or vented, which may reduce waste H₂ since flared or vented H₂ may not be used for power generation, or for chemical or industrial processes. In some cases, the fuel-lean combustion may prevent flammability of the combustion exhaust 114, and therefore may enable a safe operation of the ammonia reforming system 100.

In some cases, the air-rich or fuel-lean combustion in the combustion heater 109 is maintained during at least about 10, about 20, about 30, about 40, about 50, about 60, about 70, about 80, or about 90% of the operational time period of the operation mode. In some cases, the air-rich or fuel-lean combustion in the combustion heater 109 is maintained during at most about 10, about 20, about 30, about 40, about 50, about 60, about 70, about 80, or about 90% of the operational time period of the operation mode. In some cases, the air-rich or fuel-lean combustion in the combustion heater 109 is maintained during substantially all of the operational time period of the operation mode. In some cases, the air-rich or fuel-lean combustion in the combustion heater 109 is maintained during of from about 10% to about 30%, of from about 20% to about 40%, of from about 30% to about 50%, of from about 40% to about 60%, of from about 50% to about 70%, of from about 60% to about 80%, or of from about 70% to about 90% of the operational time period of the operation mode.

In some cases, the air-rich or fuel-lean combustion in the combustion heater 109 is maintained during at least about 10, about 20, about 30, about 40, about 50, about 60, about 70, about 80, or about 90% of the operational time period of the startup mode and/or hot standby mode. In some cases, the air-rich or fuel-lean combustion in the combustion heater 109 is maintained during at most about 10, about 20, about 30, about 40, about 50, about 60, about 70, about 80, or about 90% of the operational time period of the startup mode and/or hot standby mode. In some cases, the air-rich or fuel-lean combustion in the combustion heater 109 is maintained during substantially all of the operational time period of the startup mode and/or hot standby mode.

In some cases, during the air-rich or fuel-lean combustion in the combustion heater 109, increasing the air flow rate provided to the combustion heater 109 may decrease the temperature of the reformer 108 and/or combustion heater 109 (e.g., by providing more air (O₂ and/or N₂) to absorb heat from the combustion reaction).

In some cases, during the air-rich or fuel-lean combustion in the combustion heater 109, decreasing the air flow rate provided to the combustion heater 109 may increase the temperature of the reformer 108 and/or combustion heater 109 (e.g., by providing less air to absorb heat from the combustion reaction). In some cases, the air flow rate provided to the combustion heater 109 is modulated to control the temperature of the reformer 108 and/or combustion heater 109.

In some cases, during the air-rich or fuel-lean combustion in the combustion heater 109, an air-to-fuel ratio (i.e., the air to fuel ratio divided by the stoichiometric air to fuel ratio, for example, where an air-to-fuel ratio of 1 is the stoichiometric air to fuel ratio) is about 1.05 to about 5. In some cases, during the air-rich or fuel-lean combustion in the combustion heater 109, the air-fuel ratio is at least about 1.05, about 1.1, about 1.2, about 1.3, about 1.4, about 1.5, about 1.6, about 1.7, about 1.8, about 1.9, about 2, about 2.5, about 3, about 3.5, about 4, about 4.5, or about 5. In some cases, during the air-rich or fuel-lean combustion in the combustion heater 109, the air-fuel ratio is at most about 1.05, about 1.1, about 1.2, about 1.3, about 1.4, about 1.5, about 1.6, about 1.7, about 1.8, about 1.9, about 2, about 2.5, about 3, about 3.5, about 4, about 4.5, or about 5. In some cases, during the air-rich or fuel-lean combustion in the combustion heater 109, the air-fuel ratio is about 1.05 to about 1.3, about 1.1 to about 1.5, about 1.2 to about 1.7, about 1.3 to about 1.9, about 1.4 to about 2, about 1.5 to about 2, about 1.6 to about 3, about 2 to about 4, or about 3 to about 5.

In some cases, the air-to-fuel ratio of an air-rich or fuel lean combustion during the operation mode is about 1.05 to about 3. In some cases, the air-to-fuel ratio of the air-rich or fuel lean combustion during the operation mode is at least about 1.05, about 1.1, about 1.2, about 1.3, about 1.4, about 1.5, about 1.6, about 1.7, about 1.8, about 1.9, about 2, about 2.5, or about 3. In some cases, the air-to-fuel ratio of the air-rich or fuel-lean combustion during the operation mode is at most about 1.05, about 1.1, about 1.2, about 1.3, about 1.4, about 1.5, about 1.6, about 1.7, about 1.8, about 1.9, about 2, about 2.5, or about 3. In some cases, the air-to-fuel ratio of the air-rich or fuel-lean combustion during the operation mode is about 1.05 to about 1.3, about 1.1 to about 1.5, about 1.2 to about 1.7, about 1.3 to about 1.9, about 1.4 to about 2, about 1.5 to about 2, about 1.6 to about 2, or about 2 to about 3.

In some cases, the air-to-fuel ratio of the air-rich or fuel-lean combustion during the startup mode and/or the hot standby mode is about 1 to about 5. In some cases, the air-to-fuel ratio of the air-rich or fuel-lean combustion during the startup mode and/or hot standby mode is at least about 1.05, about 1.1, about 1.2, about 1.3, about 1.4, about 1.5, about 1.6, about 1.7, about 1.8, about 1.9, about 2, about 2.2, about 2.4, about 2.6, about 2.8, about 3, about 3.5, about 4, about 4.5, or about 5. In some cases, the air-to-fuel ratio of the air-rich or fuel-lean combustion during the startup mode and/or hot standby mode is at most about 1.05, about 1.1, about 1.2, about 1.3, about 1.4, about 1.5, about 1.6, about 1.7, about 1.8, about 1.9, about 2, about 2.2, about 2.4, about 2.6, about 2.8, about 3, about 3.5, about 4, about 4.5, or about 5. In some cases, the air-fuel ratio of the air-rich or fuel-lean combustion during the startup mode and/or hot standby mode is about 1.05 to about 1.3, about 1.1 to about 1.5, about 1.2 to about 1.7, about 1.3 to about 1.9, about 1.4 to about 2, about 1.5 to about 2, about 1.6 to about 2, about 2 to about 2.5, about 2.2 to about 2.7, about 2.4 to about 2.9. about 2.6 to about 3.1, about 3 to about 3.5, about 3.5 to about 4, or about 4 to about 5.

### Combustion Reignition

In some cases, the combustion in the combustion heater 109 may extinguish, and therefore may require reignition. The reignition may be performed, for example, using an ignition source such as a spark plug or a heating element. In some cases, the reignition may be based at least in part on a temperature of the combustion exhaust 114 being less than a threshold combustion exhaust temperature (indicating a lack of flame in the combustion heater 109), on an oxygen concentration in the combustion exhaust 114 being greater than a threshold combustion exhaust oxygen concentration (indicating unreacted oxygen leaving the combustion heater 109), or on a hydrogen concentration in the combustion exhaust 114 being greater than a threshold hydrogen concentration (indicating unreacted hydrogen leaving the combustion heater 109). In some cases, the threshold combustion exhaust temperature is at least about 300, about 350, about 400, about 450, about 500, about 550, about 600, about 650, about 700, about 750, about 800, about 850, or about 900° C. In some cases, the threshold combustion exhaust temperature is at most about 300, about 350, about 400, about 450, about 500, about 550, about 600, about 650, about 700, about 750, about 800, about 850, or about 900° C. In some cases, the threshold combustion exhaust oxygen concentration is at least about 1, about 3, about 5, about 8, about 10, about 15, about 20, or about 25% by volume or mass. In some cases, the threshold combustion exhaust oxygen concentration is at most about 1, about 3, about 5, about 8, about 10, about 15, about 20, or about 25% by volume or mass.

### Ammonia as Combustion Fuel

In some cases, instead of combusting the reformate stream 120, the combustion heater 109 may combust ammonia to heat the combustion-heated reformer 108. In some cases, at least part of the ammonia stream 104 may be directed from the storage tank 102 to the combustion heater 109 to combust the ammonia stream 104 to heat the reformer 108. In some cases, an additional ammonia stream (separate from the ammonia stream 104) may be directed from an additional storage tank (separate from the storage tank 102) to the combustion heater 109 to combust the additional ammonia stream to heat the reformer 108.

In some cases, a pure ammonia stream (i.e., comprising only ammonia) may be directed to the combustion heater 109 for combusting. In some cases, an ammonia stream mixed with a pilot fuel (i.e., a promoter fuel to facilitate combustion) is directed to the combustion heater 109 for combusting. The pilot fuel may comprise a lower flash point compared to ammonia and may comprise a higher flame speed when combusted compared to ammonia. The pilot fuel may comprise hydrogen (for example, the hydrogen in the reformate stream 120). In some cases, the pilot fuel is a hydrocarbon (that may be, for example, generated using renewable energy).

It is contemplated that for any embodiment of the present disclosure where the reformate stream 120 is directed for combustion in the combustion heater 109, the reformate stream 120 may instead comprise ammonia for combustion in the combustion heater 109. Therefore, is also contemplated that the amount of ammonia for combustion may be controlled (e.g., the flow rate of the ammonia may be increased or decreased) based on a stimulus (for example, the temperature of the reformer 108 and/or the combustion heater 109).

### Pressure Drop Elements

FIGS. 6P-6R are block diagrams illustrating pressure drop elements 526a-c configured to maintain an even distribution of fluid pressure to a plurality of components of the ammonia reforming system 100. The pressure drop elements 526a-c may comprise, for example, restricted orifices or apertures positioned in fluid lines and/or manifolds of the ammonia reforming system 100. In some instances, the pressure drop element 526a may be smaller in size (e.g., the radius of an orifice or aperture) than the pressure drop element 526b, and in turn, the pressure drop element 526b may be smaller in size than the pressure drop element 526c. By homogenizing or equalizing the pressure of fluid provided to each of the components, the potential output of each respective component may be maximized.

In some instances, a pressure drop of the pressure drop element 526a may be different from a pressure drop of the pressure drop elements 526b and/or 526c. In some instances, a pressure drop of the pressure drop element 526a may be same as a pressure drop of the pressure drop elements 526b and/or 526c within a selected tolerance. The selected tolerance may be less than 20%.

For example, as shown in FIG. 6P, pressure drop elements 526a-c may be configured to distribute the ammonia stream 104 evenly to multiple reformers 108-110 (or sets of reformers 108-110). As shown in FIG. 6Q, pressure drop elements 526a-c may be configured to distribute the reformate stream 120 evenly to multiple combustion heaters 109. As shown in FIG. 6R, pressure drop elements 526a-c may be configured to distribute the reformate stream 120 evenly to multiple fuel cells 124.

In some cases, the one or more pressure drop elements illustrated in the FIGS. 6P-R may distribute a flow rate of fluid to each of the reformers 108-110, combustion heaters 109, or fuel cells 124 within a selected tolerance of a target flow rate. In some cases, the selected tolerance is at least about 1, about 5, about 10, about 20, about 30, about 40, about 50, about 60, about 70, about 80, about 90, or about 100%, and at most about 1, about 5, about 10, about 20, about 30, about 40, about 50, about 60, about 70, about 80, about 90, or about 100% of the target flow rate. In some cases, the selected tolerance may be between about 1 and about 100, about 5 and about 90, about 10 and about 80, about 20 and about 70, about 30 and about 60, or about 40 and about 50%. For example, if the target flow rate to a reformer of a set of three reformers is about 100 slpm (standard liters per minute) within a selected tolerance of about 10%, each of the three reformers receives flow rate of about 90 to about 110 slpm.

In some cases, pressure drops across the one or more pressure drop elements may be changed or adjusted manually or electronically (e.g., with voltage and/or current signals). In some cases, one or more pressure drop elements, one or more valves, one or more pumps, one or more regulators, or any combination of thereof, may adjust or maintain a flow rates to the one or more fuel cells 124 within a selected tolerance of a target flow rate. In some cases, the selected tolerance is at least about 1, about 5, about 10, about 20, about 30, about 40, about 50, about 60, about 70, about 80, about 90, or about 100%, and at most about 1, about 5, about 10, about 20, about 30, about 40, about 50, about 60, about 70, about 80, about 90, or about 100%. In some cases, the selected tolerance may be between about 1 and about 100, about 5 and about 90, about 10 and about 80, about 20 and about 70, about 30 and about 60, or about 40 and about 50%. In some cases, the selected tolerance is less than about 20%.

In some cases, the one or more pressure drop elements illustrated in FIGS. 6P-R may be at least partly replaced by (or may comprise additional) one or more flow control units comprising one or more pumps, one or more check valves, one or more one-way valves, one or more three-way valves, one or more restrictive orifices, one or more valves, one or more flow regulators, one or more pressure regulators, one or more back pressure regulators, one or more pressure reducing regulators, one or more back flow regulators, one or more flow meters, one or more flow controllers, or any combination thereof. In some cases, the one or more flow control units may be controlled manually, automatically, or electronically. The one or more flow control units may maintain the desired flow rate distribution to the one or more reformers, one or more combustion heaters, or one or more fuel cells. The flow rate distribution may be even (or uneven) depending on predetermined flow processing capabilities of the one or more reformers, one or more combustion heaters, or one or more fuel cells.

In some cases, the one or more flow control units may distribute the flow to the reformers 108-110, combustion heaters 109, or fuel cells 124 within a selected tolerance of a target flow rate. In some cases, the selected tolerance is at least about 1, about 5, about 10, about 20, about 30, about 40, about 50, about 60, about 70, about 80, about 90, or about 100%, and at most about 1, about 5, about 10, about 20, about 30, about 40, about 50, about 60, about 70, about 80, about 90, or about 100%. In some cases, the selected tolerance may be between about 1 and about 100, about 5 and about 90, about 10 and about 80, about 20 and about 70, about 30 and about 60, or about 40 and about 50%. For example, if the target flow rate to one reformer of a set of three reformers is about 100 slpm (standard liters per minute) with a selected tolerance of about 10%, each of the three reformers receives a flow rate of about 90 to about 110 slpm. In some cases, the selected tolerance is less than about 20%.

### Hydrogen Separation Membrane

FIG. 6S is a block diagram illustrating a hydrogen separation device 527 configured to separate hydrogen from the reformate stream 120. The hydrogen separation device 527 may comprise a retentate chamber 528, a membrane 529, and a permeate chamber 530. The hydrogen separation device 527 may increase the hydrogen purity of the reformate stream 120, which may increase the hydrogen consumption rate or output voltage of the fuel cell 124 when the high hydrogen purity reformate stream 120 is provided to the fuel cell 124.

As the reformate stream 120 passes the retentate chamber 528, hydrogen may diffuse across the membrane 529 into the permeate chamber 530. The membrane 529 may comprise platinum (Pt), palladium (Pd), vanadium (V), niobium (Nb), tantalum (Ta), an alloy thereof, or any combination thereof, although the present disclosure is not limited thereto. The permeate stream 531 (comprising the separated hydrogen, e.g., 99% or more hydrogen) may then exit the hydrogen separation device 527 (via an outlet in the permeate chamber 530) and be provided to the fuel cell 124 for electricity generation. In some cases, the retentate stream 532 comprising at least portion of the hydrogen from the reformate stream 120 may be supplied to the combustion heater 109 as a combustion fuel.

### Reforming Ammonia to Provide Hydrogen for Internal Combustion Engine

FIG. 6T is a block diagram illustrating an internal combustion engine (ICE) 533 configured to combust the reformate stream 120 (i.e., combust the hydrogen therein) to generate mechanical power (or electrical power). The ICE 533 may comprise a reciprocating piston engine or a gas turbine.

In some embodiments, the ICE 533 may be configured to combust the reformate stream 120 (e.g., such that hydrogen is the sole or primary fuel). In some cases, the reformate stream 120 may be co-combusted or co-fired with an additional fuel (e.g., auxiliary or secondary fuel), such that the hydrogen in the reformate stream 120 is advantageously provided as a pilot fuel (promoter fuel) that facilitates combustion of the additional fuel in the ICE 533.

The additional fuel may comprise ammonia (which, due to its low flame speed and high ignition chamber, is difficult to burn without a promoter fuel). The additional fuel comprising the ammonia may be provided from the storage tank 102 (described with respect to FIGS. 1A-4B) to be co-combusted with the reformate stream 120 in the ICE 533. In some instances, the additional ammonia may be provided from a dedicated secondary storage tank that is separate from the storage tank 102.

In some embodiments, the additional fuel comprises a hydrocarbon fuel, for example, gasoline, diesel, biodiesel, methane, biomethane, methanol, biomethanol, fatty-acid methyl ester (FAME), hydro-treated renewable diesel (HVO), Fischer-Tropsch (FT) diesel, marine oil, heavy fuel oil (HFO), marine diesel oil (MDO), and/or dimethyl ether (DME).

In some embodiments, the additional fuel comprises a synthetic renewable fuel (e.g., scalable zero emissions fuel (SZEF)) produced using at least one of carbon capture, renewable electricity, or renewable hydrogen.

In some embodiments, a heat exchanger 534 may be utilized to transfer heat from an exhaust of the ICE 533 to the combustion heated reformer 108 and/or the electrically heated reformer 110. This heat transfer may increase the overall energy efficiency of the ammonia reforming system 100.

### Methods of Initiating Ammonia Reforming

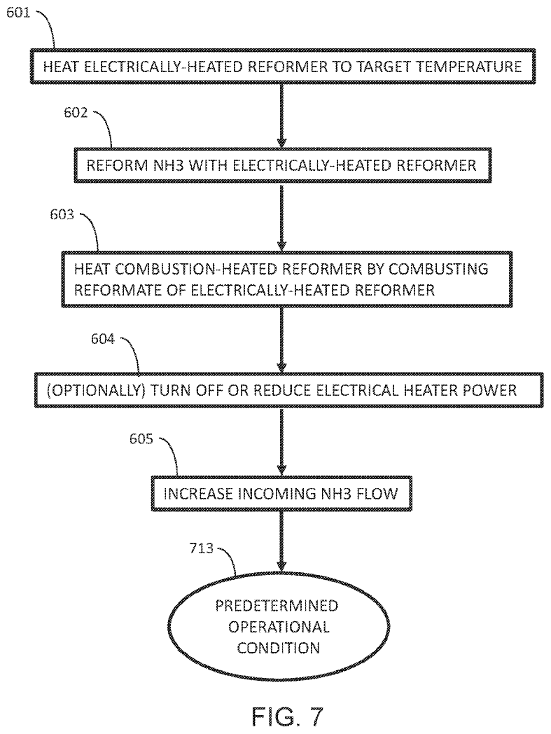

FIGS. 7-11C are a flow charts illustrating various methods of initiating ammonia reforming (e.g., startup processes for the ammonia reforming system 100). It is noted that the method steps described with respect to FIGS. 7-11C may be performed using a controller (for example, by executing program instructions using the controller 200) in response to a stimulus. The stimulus may comprise a manual input (e.g., user input), and/or an automated input. The automated input may comprise a sensor measurement (e.g., measured by sensors P1-P10, T1-T11, FM1-FM11, and AC1-AC10) being greater than or less than a threshold (e.g., threshold temperature, threshold pressure, threshold flow rate, and so on).

For example, the controller may actuate a flow control unit (e.g., open or close a valve), and direct a fluid (e.g., ammonia stream 104, reformate stream 120, air stream 118, anode off-gas 128) by increasing or decreasing a flow rate of the fluid (in response or based on the manual input or the automated input). In another example, the controller may increase or decrease heating power to the electrical heater (e.g., electrical heater 111) (in response or based on the manual input or the automated input). In another example, the controller may increase or decrease the load at the fuel cell (e.g., fuel cell 124) (in response or based on the manual input or the automated input).

### First Method of Initiating Ammonia Reforming

FIG. 7 is a flow chart illustrating a method of initiating ammonia reforming 600.

At step 601, an electrically heated reformer (e.g., electrically heated reformer 110) may be heated (e.g., using electrical heater 111) to a target temperature (within a target temperature range, for example, about 400-about 600° C.). The electrically heated reformer may be heated by initiating power supply to the electrical heater.

At step 602, ammonia (e.g., incoming ammonia stream 104) may be directed to the electrically heated reformer, and ammonia may be reformed using NH₃ reforming catalysts in the electrically heated reformer to generate hydrogen and nitrogen (e.g., an H₂/N₂ mixture, reformate stream 120).

At step 603, at least a portion of the reformate stream (generated by the electrically heated reformer) may be reacted with air (e.g., air stream 118) in a combustion reaction (e.g., in the combustion heater 109) to heat the combustion-heated reformer (e.g., combustion-heated reformer 109).

At step 604, the electrically heated reformer may be optionally turned off or reduced (e.g., after the combustion-heated reformer reaches a target temperature range). The electrically heated reformer may be turned off or reduced by reducing the power supply to the electrical heater.

At step 605, the flow rate of the incoming ammonia flow may be increased to a predefined flow rate (e.g., to generate a target flow rate of H₂/N₂ mixture in the reformate stream).

In some cases, step 601 and step 602 may be performed in sequence or in parallel. In some cases, at least two steps in steps 601-605 may be performed in sequence or in parallel. Once step 605 is performed, and self-sustained auto-thermal reforming is maintained (i.e., at a steady-state condition, or predetermined operational condition), the ammonia flow rate may be further increased above a predefined rate depending on operating requirements (e.g., fuel cell output power, electrically heated reformer temperature(s), combustion-heated reformer temperature(s), reactor pressure(s), ammonia flowrate, etc.) while maintaining auto-thermal reforming. Step 604 may be executed or unexecuted depending on combustion-heated reformer temperature and ammonia conversion efficiency.

In some embodiments, instead of the combustion-heated reformer, the electrically heated reformer may provide the majority or all of the hydrogen and nitrogen in the reformate stream (e.g., greater than about 50% of the hydrogen and nitrogen by volume).

### Second Method of Initiating Ammonia Reforming

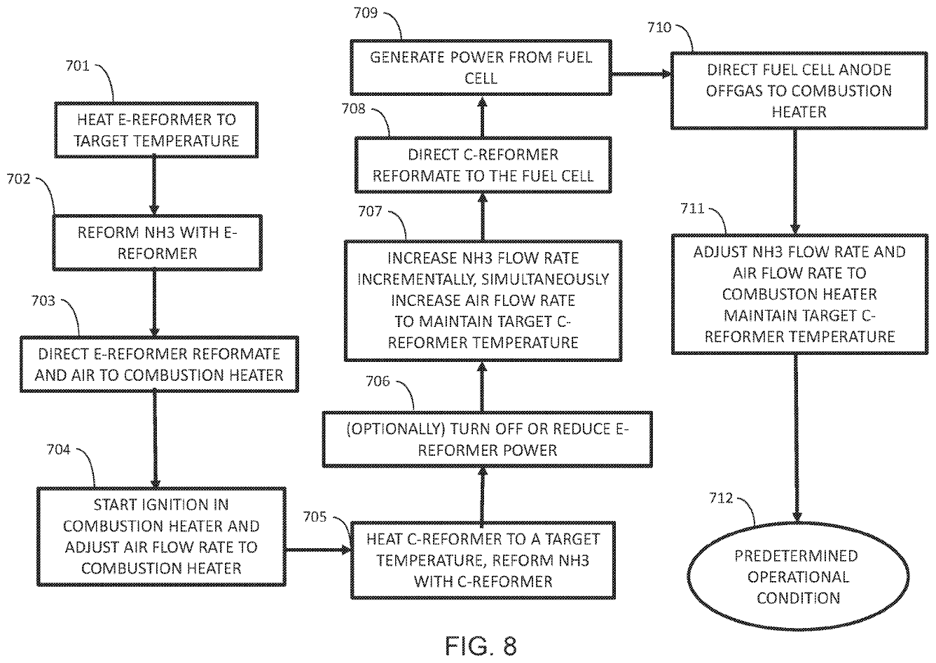

FIG. 8 is a flow chart illustrating another method of initiating ammonia reforming 700.

At step 701, an electrically heated reformer (e.g., electrically heated reformer 110) may be heated (e.g., using electrical heater 111) to a target temperature (within a target temperature range, for example, about 400-about 600° C.). The electrically heated reformer may be heated by initiating power supply to the electrical heater.

At step 702, ammonia (e.g., incoming ammonia stream 104) may be directed to the electrically heated reformer, and ammonia may be reformed using NH₃ reforming catalysts in the electrically heated reformer to generate hydrogen and nitrogen (e.g., an H₂/N₂ mixture, reformate stream 120).

At step 703, at least a portion of the reformate stream (generated by the electrically heated reformer) and air (e.g., air stream 118) may be directed to the combustion heater.

At step 704, the reformate stream may be reacted with the air in a combustion reaction (in the combustion heater 109) to heat the combustion-heated reformer (e.g., combustion-heated reformer 109). An ignition device (e.g., spark plug) may be activated to ignite the reformate and air in the combustion heater. The flow rate of the air to the combustion heater may be adjusted to increase the temperature of the combustion-heated reformer. In some instances, the flow rate of the air is modulated to maintain a target temperature ramp rate of the combustion-heated reformer.

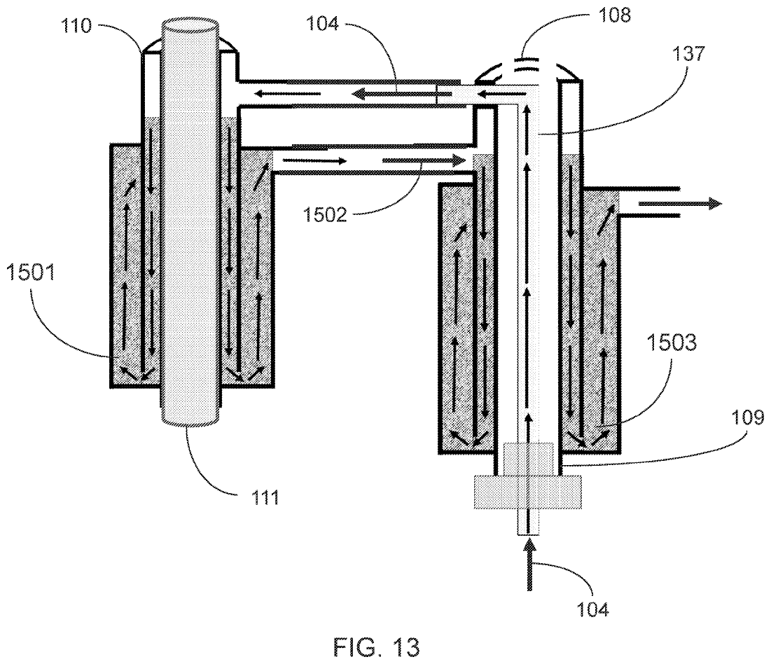

At step 705, ammonia (e.g., incoming ammonia stream 104) may be reformed (after the combustion-heated reformer reaches a target temperature range) using NH₃ reforming catalysts in the combustion-heated reformer to generate hydrogen and nitrogen (e.g., an H₂/N₂ mixture, reformate stream 120). In some instances, the combustion-heated reformer may fluidically communicate in series or in parallel with the electrically heated reformer (e.g., as shown in FIG. 13).

At step 706, heating the electrically heated reformer may be optionally turned off or reduced (e.g., after the combustion-heated reformer reaches a target temperature range). The electrically heated reformer may be turned off or reduced by reducing the power supply to the electrical heater.

At step 707, the flow rate of the incoming ammonia stream may be incrementally increased to a predefined flow rate (e.g., to generate a target flow rate of H₂/N₂ mixture in the reformate stream). Simultaneously, the flow rate of the air stream (to the combustion heater) may be increased. By simultaneously increasing both the flow rate of the incoming ammonia stream and the flow rate of the air stream, the combustion-heated reformer may be maintained in a target temperature range.

At step 708, the reformate generated by the combustion-heated reformer (and optionally the reformate generated by the electrically heated reformer) may be directed (e.g., using one or more flow control units, pumps, valves, and/or regulators) to the fuel cell (e.g., fuel cell 124).

At step 709, the fuel cell may generate an electrical power output (to supply to an electrical load, e.g., an electrical grid, an electrical battery, or a motor for a vehicle).

At step 710, the anode off-gas from the fuel cell (e.g., anode off-gas 128) may be optionally directed to the combustion heater to be combusted. For example, a three-way valve may direct the reformate from (1) being provided directly to the combustion heater to (2) being provided to the fuel cell (and, subsequently, the anode off-gas may be provided to the combustion-heater). In some instances, the step 710 is performed before the step 709, or may executed simultaneously.

At step 711, the flow rate of the incoming ammonia stream and the flow rate of the air stream may be adjusted to maintain the target temperature in the combustion-heated reformer.

At step 712, the ammonia reforming method (or system) may achieve a predetermined operational condition (steady-state condition).

It is noted that step 706 may be executed or unexecuted based on the combustion-heated reformer temperature. For example, step 706 may be unexecuted based on the combustion-heated reformer temperature being less than a predetermined threshold temperature. Step 709 may be executed any time after step 708.

### Third Method of Initiating Ammonia Reforming

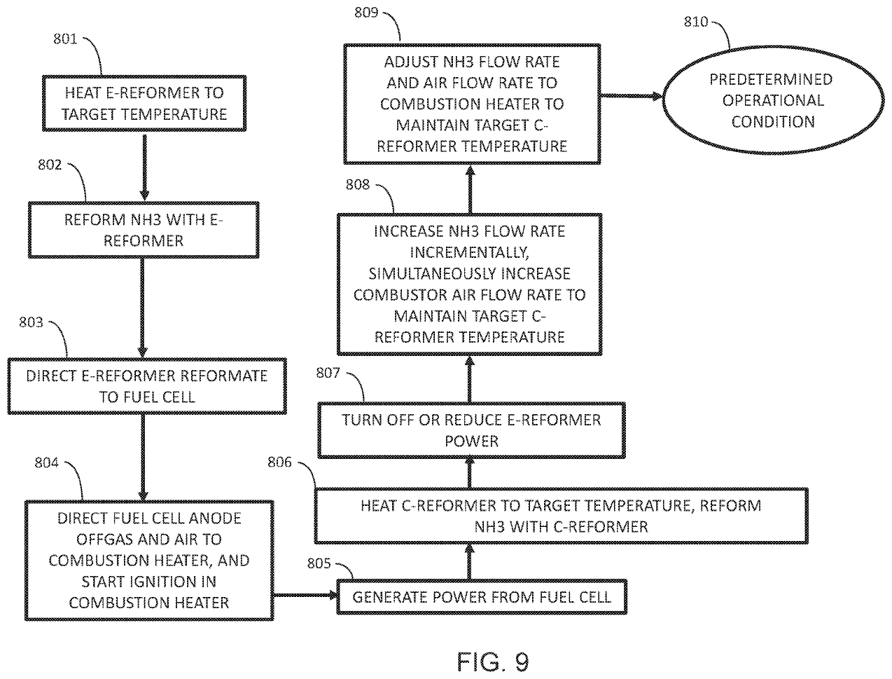

FIG. 9 is a flow chart illustrating another method of initiating ammonia reforming 800.

At step 801, an electrically heated reformer (e.g., electrically heated reformer 110) may be heated (e.g., using electrical heater 111) to a target temperature (within a target temperature range, for example, about 400—about 600° C.). The electrically heated reformer may be heated by initiating power supply to the electrical heater.

At step 802, ammonia (e.g., incoming ammonia stream 104) may be directed to the electrically heated reformer, and ammonia may be reformed using NH₃ reforming catalysts in the electrically heated reformer to generate hydrogen and nitrogen (e.g., an H₂/N₂ mixture, reformate stream 120).

At step 803, at least a portion of the reformate stream (generated by the electrically heated reformer) may be directed to a fuel cell 124.

At step 804, the anode off-gas from the fuel cell (e.g., anode off-gas 128) may be optionally directed to a combustion heater to be combusted with air (e.g., air stream 118). An ignition device (e.g., spark plug) may be activated to ignite the anode off-gas and air in the combustion heater. The flow rate of the air to the combustion heater may be adjusted to increase the temperature of the combustion-heated reformer.

At step 805, the fuel cell may generate an electrical power output (to supply to an electrical load, e.g., a motor for a vehicle). In some instances, the step 805 may be performed before the step 804 or may performed simultaneously.

At step 806, ammonia (e.g., incoming ammonia stream 104) may be reformed (after the combustion-heated reformer reaches a target temperature range) using NH₃ reforming catalysts in the combustion-heated reformer to generate hydrogen and nitrogen (e.g., an H₂/N₂ mixture, reformate stream 120). In some cases, the combustion-heated reformer may fluidically communicate in series or in parallel with the electrically heated reformer (e.g., as shown in FIG. 13).

At step 807, heating the electrically heated reformer may be optionally turned off or reduced (e.g., after the combustion-heated reformer reaches a target temperature range). The electrically heated reformer may be turned off or reduced by reducing the power supply to the electrical heater.

At step 808, the flow rate of the incoming ammonia stream may be incrementally increased to a predefined flow rate (e.g., to generate a target flow rate of H₂/N₂ mixture in the reformate stream). Simultaneously, the flow rate of the air stream (to the combustion heater) may be increased. By simultaneously increasing both the flow rate of the incoming ammonia stream and the flow rate of the air stream, the combustion-heated reformer may be maintained in a target temperature range.

At step 809, optionally, the flow rate of the incoming ammonia stream and the flow rate of the air stream may be further adjusted to maintain the target temperature in the combustion-heated reformer.

At step 810, the ammonia reforming method (or system) may achieve a predetermined operational condition (steady-state condition).

It is noted that step 807 may be executed or unexecuted based on the combustion-heated reformer temperature. For example, step 807 may be unexecuted based on the combustion-heated reformer temperature being less than a predetermined threshold temperature. Step 805 may be executed any time after step 803.

### Fourth Method of Initiating Ammonia Reforming

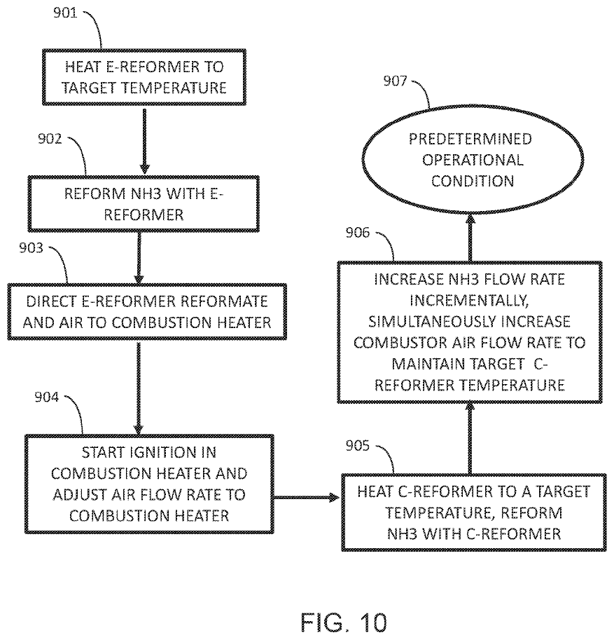

FIG. 10 is a flow chart illustrating another method of initiating ammonia reforming 900.

At step 901, an electrically heated reformer (e.g., electrically heated reformer 110) may be heated (e.g., using electrical heater 111) to a target temperature (within a target temperature range, for example, about 400 to about 600° C.). The electrically heated reformer may be heated by initiating power supply to the electrical heater.

At step 902, ammonia (e.g., incoming ammonia stream 104) may be directed to the electrically heated reformer, and ammonia may be reformed using NH₃ reforming catalysts in the electrically heated reformer to generate hydrogen and nitrogen (e.g., an H₂/N₂ mixture, reformate stream 120).

At step 903, at least a portion of the reformate stream (generated by the electrically heated reformer) and air (e.g., air stream 118) may be directed to the combustion heater.

At step 904, the reformate stream may be reacted with the air in a combustion reaction (in the combustion heater 109) to heat the combustion-heated reformer (e.g., combustion-heated reformer 109). An ignition device (e.g., spark plug) may be activated to ignite the reformate and air in the combustion heater. The flow rate of the air to the combustion heater may be adjusted to increase the temperature of the combustion-heated reformer.

At step 905, ammonia (e.g., incoming ammonia stream 104) may be reformed (after the combustion-heated reformer reaches a target temperature range) using NH₃ reforming catalysts in the combustion-heated reformer to generate hydrogen and nitrogen (e.g., an H₂/N₂ mixture, reformate stream 120). In some cases, the combustion-heated reformer may fluidically communicate in series or in parallel with the electrically heated reformer (e.g., as shown in FIG. 13).

At step 906, the flow rate of the incoming ammonia stream may be incrementally increased to a predefined flow rate (e.g., to generate a target flow rate of H₂/N₂ mixture in the reformate stream). Simultaneously, the flow rate of the air stream (to the combustion heater) may be increased. By simultaneously increasing both the flow rate of the incoming ammonia stream and the flow rate of the air stream, the combustion-heated reformer may be maintained in a target temperature range.

At step 907, the ammonia reforming method (or system) may achieve a predetermined operational condition (steady-state condition)

### Methods of Initiating Ammonia Reforming System

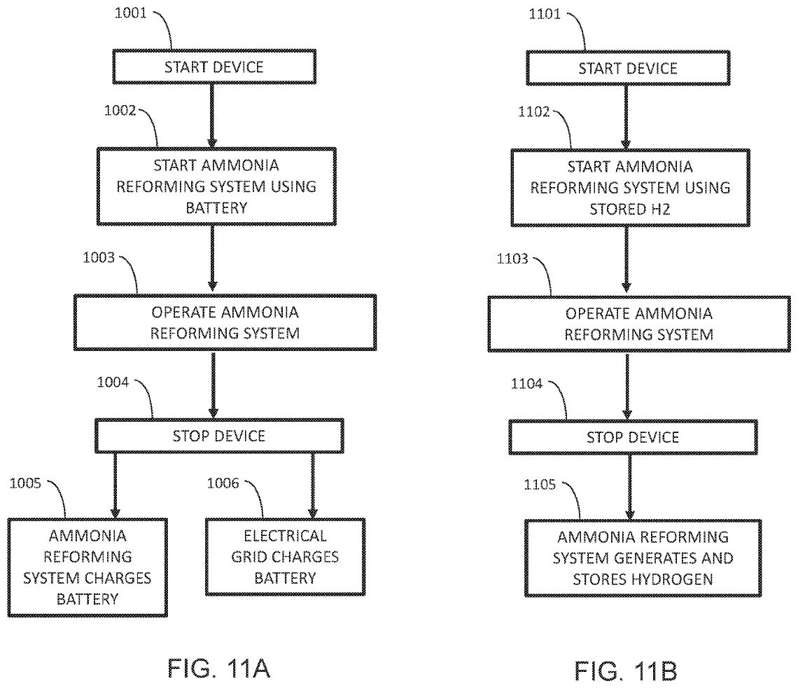

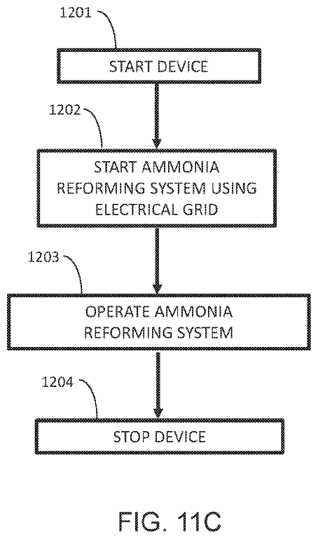

FIGS. 11A-11C are flow charts illustrating various methods of initiating an ammonia reforming system (e.g., ammonia reforming system 100) to power a device. The device may be a load powered by a fuel cell of the ammonia reforming system (for example, an electrical motor for a mobile vehicle, a stationary data center, a cell phone tower, or a charging station) or an internal combustion engine powered by reformate generated by the ammonia reforming system.

### Method of Initiating Ammonia Reforming System Using Battery

FIG. 11A is a flow chart illustrating a method of initiating an ammonia reforming system using a battery (to power a device).

At step 1001, the device may be started. For example, an electrical vehicle or device may be switched on.

At step 1002, the ammonia reforming system may be started using a battery. For example, an electrical heater may receive electrical power from the battery to heat an electrically heated reformer, and ammonia may be reformed using the NH₃ reforming catalysts in the electrically heated reformer.

At step 1003, the ammonia reforming system may be further operated. For example, any of the steps described with respect to FIGS. 7-10 may be executed or performed.

At step 1004, the device may be stopped. For example, an electrical vehicle or device may be switched off.

At step 1005, the ammonia reforming system may charge the battery (for example, by providing fuel cell power to the battery). In some embodiments, an electrical grid (e.g., external electrical grid) may charge the battery.

### Method of Initiating Ammonia Reforming System Using Stored Hydrogen

FIG. 11B is a flow chart illustrating a method of initiating an ammonia reforming system using stored hydrogen (to power a device).

At step 1101, the device may be started. For example, an electrical vehicle or device may be switched on.

At step 1102, the ammonia reforming system may be started using stored hydrogen (e.g., stored in a hydrogen storage tank). For example, a combustion heater may combust the hydrogen and air to heat a combustion-heated reformer, and ammonia may be reformed using the NH₃ reforming catalysts in the combustion-heated reformer.

At step 1103, the ammonia reforming system may be further operated. For example, any of the steps described with respect to FIGS. 7-10 may be executed or performed.

At step 1104, the device may be stopped. For example, an electrical vehicle may be switched off.

At step 1105, the ammonia reforming system may generate hydrogen, and store the hydrogen (e.g., in the hydrogen storage tank). It is noted that reformate (e.g., hydrogen/nitrogen mixture) may be stored in the hydrogen storage tank.

### Method of Initiating Ammonia Reforming System Using Electrical Grid

FIG. 11C is a flow chart illustrating a method of initiating an ammonia reforming system using an electrical grid (to power a device).

At step 1201, the device may be started. For example, a cell phone tower or charging device may be switched on.

At step 1202, the ammonia reforming system may be started using electrical power from an electrical grid. For example, an electrical heater may receive electrical power from the electrical grid to heat an electrically heated reformer, and ammonia may be reformed using the NH₃ reforming catalysts in the electrically heated reformer.

At step 1203, the ammonia reforming system may be further operated. For example, any of the steps described with respect to FIGS. 7-10 may be executed or performed.

At step 1204, the device may be stopped. For example, a cell phone tower or charging device may be switched off.

### Method of Operating Ammonia Reforming System

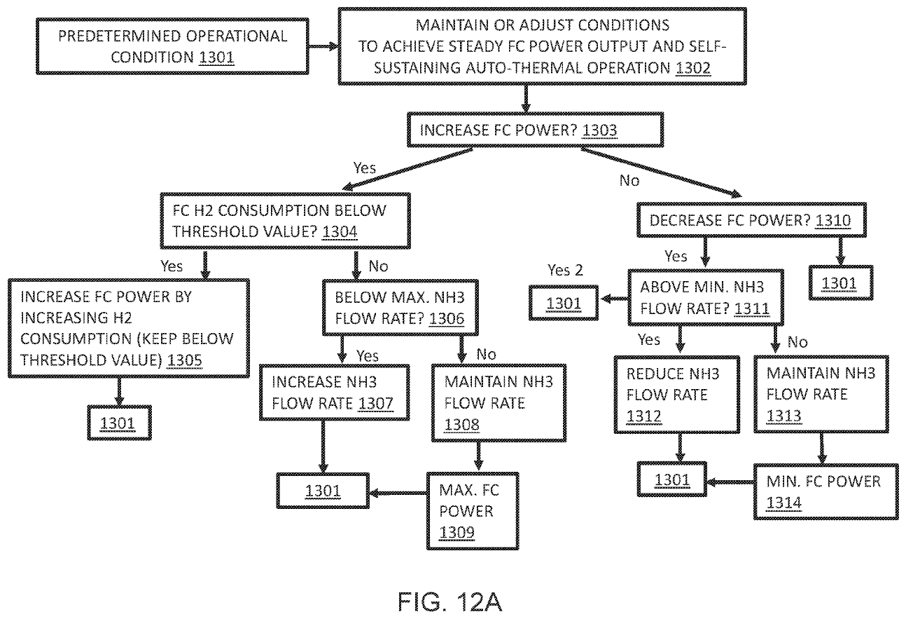

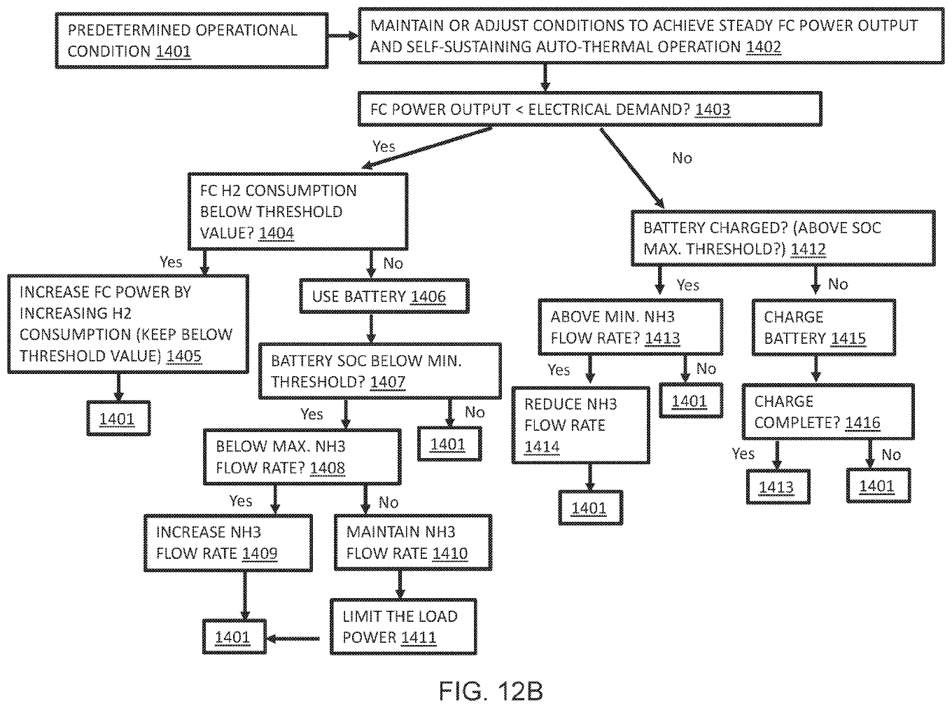

FIG. 12A is a flow chart illustrating a method of operating ammonia reforming (e.g., ammonia reforming system 100), in accordance with one or more embodiments of the present disclosure.

At step 1301, for a set of given system operational parameters, self-sustaining auto-thermal operational conditions may be predetermined (e.g., minimum and maximum NH₃ flow rates, corresponding fuel cell (FC) power and hydrogen consumption rates, minimum and maximum battery states of charge (SOC), minimum and maximum air flow rates, etc.).

At step 1302, operational parameters may be maintained and/or adjusted to maintain and/or adjust fuel cell power output (and self-sustained autothermal reforming).

At step 1303, the method may comprise monitoring the power output of the fuel cell, and automatically or manually adjusting (increasing or decreasing) the power output (based on the electrical load coupled to the fuel cell). The method may adjust various operational parameters including the flow rate of the air stream to the combustion heater, the flow rate of the incoming ammonia stream, the hydrogen consumption rate of the fuel cell, and/or the electrical power to the electrical heater. In some cases, a controller may control NH₃ flow rate, control air flow rate, control NH₃ flow pressures, control air flow pressures, control valves, control FC power output, control battery power output, control E-reformer power input, control FC hydrogen consumption rate, or any combination thereof. In some cases, one or more sensors may measure temperatures, pressures, fuel cell power output, battery power outputs, battery SOC, fuel cell hydrogen consumption rate, NH₃ conversion efficiency, or any combination thereof.

At step 1304, based on the fuel cell power being less than the electrical load power, the method may comprise increasing the power output of the fuel cell. The hydrogen consumption rate of the fuel cell may be compared to a predetermined threshold consumption rate (the threshold consumption rate may be a specific value or a range).

At step 1305, based on the hydrogen consumption rate being less than the predetermined threshold, the method may comprise increasing the power output of the fuel cell by increasing the hydrogen consumption rate (while still keeping the hydrogen consumption rate less than the predetermined threshold). The method may then proceed to step 1301.

At step 1306, based on the hydrogen consumption rate of the fuel cell being equal to or above the predetermined threshold, the method may comprise comparing the ammonia flow rate into the system to a predetermined ammonia flow rate. In some cases, the predetermined ammonia flow rate may be a maximum ammonia flow rate for the system.

At step 1307, the method may comprise increasing the ammonia flow rate (based on the flow rate of the incoming ammonia stream being less than the predetermined ammonia flow rate). The method may then proceed to step 1301.

At step 1308, the method may comprise maintaining the ammonia flow rate (based on the flow rate of the incoming ammonia stream being greater than the predetermined ammonia flow rate).

At step 1309, the method may comprise maintaining the power output of the fuel cell (based on the flow rate of the incoming ammonia stream being equal to or greater than the predetermined ammonia flow rate). In some cases, the power output of the fuel cell may be a maximum power output of the fuel cell. The method may then proceed to step 1301.

At step 1310, based on the fuel cell power being greater than the electrical load power, the method may comprise decreasing the power output of the fuel cell. Otherwise, the fuel cell power may not be decreased, and the method may proceed to step 1301.

At step 1311, the method may comprise comparing the flow rate of the incoming ammonia stream to a predetermined ammonia flow rate. In some cases, the predetermined ammonia flow rate may be a minimum ammonia flow rate. In some cases, regardless of the flow rate of the incoming ammonia stream being equal to or greater than the minimum ammonia flow rate, method may proceed to step 1301.

At step 1312, the method may comprise reducing the flow rate of the incoming ammonia stream (based on the flow rate of the incoming ammonia stream being greater than the predetermined ammonia flow rate). The method may then proceed to step 1301.

At step 1313, the method may comprise maintaining the flow rate of the incoming ammonia stream (based on the flow rate of the incoming ammonia stream being equal to or less than the predetermined ammonia flow rate).

At step 1314, the method may comprise maintaining the power output of the fuel cell (based on the flow rate of the incoming ammonia stream being equal to or less than the predetermined ammonia flow rate). The method may then proceed to step 1301.

In some cases, at step 1311, the method may or may not comprise comparing the flow rate of the incoming ammonia stream to a predetermined ammonia flow rate. Regardless of the flow rate of the incoming ammonia stream being less than, equal to, or greater than the predetermined ammonia flow rate, the method may further comprise maintaining the flow rate of the incoming ammonia stream and proceeding to step 1301. In some cases, the predetermined ammonia flow rate may be a minimum ammonia flow rate. In this way, the fuel cell power is reduced and the incoming ammonia flow rate is maintained or at least within a desired range.

In some cases, at step 1311, the method may or may not comprise comparing the flow rate of the incoming ammonia stream to a predetermined ammonia flow rate. Regardless of the flow rate of the incoming ammonia stream being less than, equal to, or greater than the predetermined ammonia flow rate, the method may further comprise maintaining the flow rate of the incoming ammonia stream and proceeding to step 1301.

In some cases, the predetermined ammonia flow rate may be a minimum ammonia flow rate. In this way, the fuel cell power is reduced, and the incoming ammonia flow rate is maintained or at least within a desired range.

In some cases, the method may comprise performing or executing a hot standby mode. In some cases, performing or executing the hot standby mode may comprise reducing the ammonia flow rate, air flow rate, and/or the fuel cell power to zero.

### Method of Operating Ammonia Reforming System Using a Battery

FIG. 12B is a flow chart illustrating a method of operating ammonia reforming (e.g., ammonia reforming system 100) using a battery, in accordance with one or more embodiments of the present disclosure.

At step 1401, for a set of given system operational parameters, self-sustaining auto-thermal operational conditions may be predetermined (e.g., minimum and maximum NH₃ flow rates, corresponding FC power and hydrogen consumption rates, minimum and maximum battery states of charge (SOC), minimum and maximum air flow rates, etc.).

At step 1402, operational parameters may be maintained and/or adjusted to maintain and/or adjust fuel cell power output (and self-sustained autothermal reforming).

At step 1403, the method may comprise monitoring the power output of the fuel cell, and automatically or manually adjusting (increasing or decreasing) the power output (based on the electrical load coupled to the fuel cell). The method may adjust various operational parameters including the flow rate of the air stream to the combustion heater, the flow rate of the incoming ammonia stream, the hydrogen consumption rate of the fuel cell, and/or the electrical power to the electrical heater. In some cases, one or more controllers may control NH₃ flow rate, control air flow rate, control NH₃ flow pressures, control air flow pressures, control valves, control FC power output, control battery power output, control E-reformer power input, control FC hydrogen consumption rate, or any combination thereof. In some cases, one or more sensors may measure temperatures, pressures, fuel cell power output, battery power outputs, battery SOC, fuel cell hydrogen consumption rate, and NH₃ conversion efficiency.

At step 1404, based on the fuel cell power being less than the electrical load power, the method may comprise comparing the FC hydrogen consumption rate to a predetermined threshold FC hydrogen consumption rate. In some cases, the predetermined threshold FC hydrogen consumption rate may be a maximum consumption rate.

At step 1405, based on the hydrogen consumption rate being less than the predetermined threshold, the method may comprise increasing the power output of the fuel cell by increasing the hydrogen consumption rate (while still keeping the hydrogen consumption rate less than the predetermined threshold). The method may then proceed to step 1401.

At step 1406, based on the hydrogen consumption rate of the fuel cell being equal to or above the predetermined threshold, the battery may be used to provide electrical power to the electrical load.

At step 1407, the battery state of charge (SOC) may be compared to a predetermined minimum threshold.

At step 1408, based on the battery SOC being less than the predetermined minimum threshold, the flow rate of the incoming ammonia stream may be compared to a predetermined ammonia flow rate. In some cases, the predetermined ammonia flow rate may be a maximum ammonia flow rate for the system.

At step 1409, the method may comprise increasing the flow rate of the incoming ammonia stream (based on the flow rate of the incoming ammonia stream being less than the predetermined ammonia flow rate). The method may then proceed to step 1401.

At step 1410, the method may comprise maintaining the flow rate of the incoming ammonia stream (based on the flow rate of the incoming ammonia stream being equal to or greater than the predetermined ammonia flow rate).

At step 1411, the method may comprise limiting an electrical load associated with the power demand. The method may then proceed to step 1401.

At step 1412, the method may comprise decreasing the power output of the fuel cell and comparing a battery SOC to a predetermined threshold.

At step 1413, based on the battery SOC being equal to or greater than the predetermined threshold, the method may comprise comparing the flow rate of the incoming ammonia stream to a predetermined ammonia flow rate. In some cases, the predetermined ammonia flow rate may be a minimum ammonia flow rate. Based on the flow rate of the incoming ammonia stream being less than the predetermined ammonia flow rate, method may then proceed to step 1401.

In some cases, at step 1413, regardless of the flow rate of the incoming ammonia stream being equal to or greater than the minimum ammonia flow rate, method may comprise reducing the fuel cell power output and proceed to step 1401. In this way, the fuel cell power is reduced, and the incoming ammonia flow rate is maintained or at least within a desired range.

At step 1414, the method may comprise reducing the flow rate of the incoming ammonia stream (based on the flow rate of the incoming ammonia stream being greater than the predetermined ammonia flow rate). The method may then proceed to step 1401.

At step 1415, based on the battery SOC being less than the predetermined threshold, the method may comprise charging the battery using electrical power generated by the fuel cell.

At step 1416, the method may comprise determining if the battery is fully charged. Based on the battery being fully charged, the method may proceed to step 1413 or step 1401. Based on the battery being less than fully charged, the method may proceed to step 1401.

In some cases, the method may comprise a shutdown process. In some cases, the shutdown process may comprise reducing any one of or a combination of ammonia flow rate, air flow rate, and fuel cell power to zero.

In some cases, the method may comprise performing or executing a hot standby mode. In some cases, performing or executing the hot standby mode may comprise reducing the ammonia flow rate, the air flow rate, and/or the fuel cell power to zero.

In some cases, by combining any of the methods illustrated in FIG. 12A-12B, the method may comprise the fuel cell providing power to the battery, and the battery may provide power for the electrical load. In some cases, the fuel cell may provide power to charge the battery, and the battery may provide power for the electrical load. In some cases, if the battery SOC is close to, equal to, or above the predetermined threshold maximum SOC, the system may execute the hot standby mode, or shut down the ammonia reforming system. In some cases, if the battery SOC falls below the threshold maximum SOC, the system may unexecute the hot standby mode and generate power from the fuel cell.

### Oxidation Resistant Catalyst for Purging

FIG. 13 is a schematic diagram illustrating utilization of an oxidation-resistant catalyst 1501 to generate reformate to purge the ammonia reforming system 100 shown in FIGS. 1A-4B, in accordance with one or more embodiments of the present disclosure.

In some cases, the electrically heated reformer 110 may comprise oxidation-resistant catalyst 1501 therein. The electrical heater 111 may heat the electrically heated reformer 110 and the catalyst 1501 to a target temperature range (e.g., about 400-about 600° C.). The oxidation-resistant catalyst 1501 may be configured to resist oxidation at the target temperature range.

Ammonia may then be reformed at the target temperature range using the oxidation-resistant catalyst 1501 to generate a reformate stream 1502 comprising hydrogen (H₂) and nitrogen (N₂).

The reformate stream 1502 may then be provided to the reformer 108 filled with oxidation-sensitive catalyst 1503. In contrast to the oxidation-resistant catalyst 1501, the oxidation-sensitive catalyst 1503 may be sensitive to oxidation at the target temperature range (e.g., about 400-about 600° C.) and/or in an environment comprising oxygen. The reformate stream 1502 (purging gas) may purge any residual gases in the reformer 108 (e.g., residual ammonia).

It is noted that, the oxidation-resistant catalyst 1501 may be configured to generate reformate to purge residual gases in any type of reactor, and that the present disclosure is not limited to purging residual gases in the reformer 108 and/or 110. For example, the oxidation resistant catalyst 1501 may be used to generate reformate to purge a steam methane reforming (SMR) reactor, a methanol reforming reactor, or any other type of reactor.

### Renewable Energy System Combining Ammonia Synthesis and Ammonia Reforming

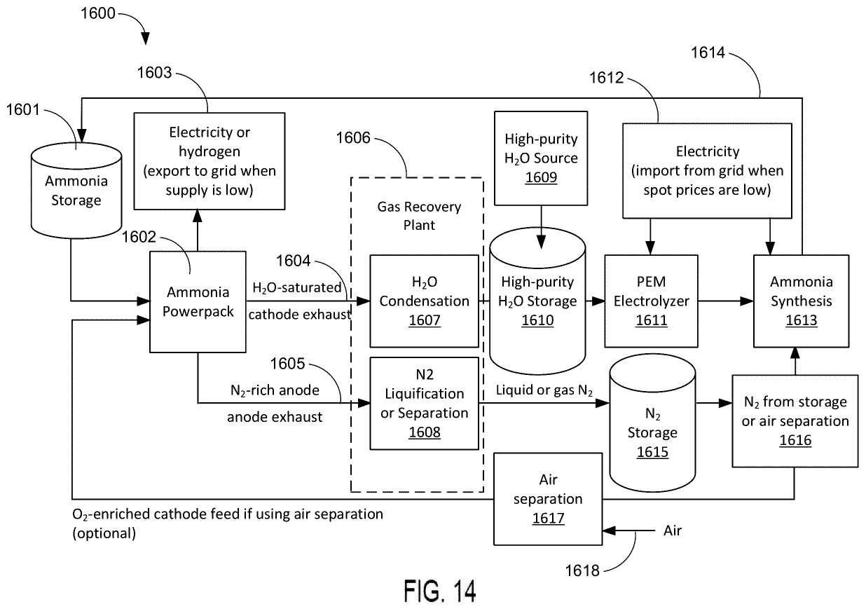

FIG. 14 is a schematic diagram illustrating a renewable energy system 1600 combining ammonia synthesis and ammonia reforming, in accordance with one or more embodiments of the present disclosure.

A storage tank 1601 (e.g., storage tank 102) may be configured to store ammonia. An ammonia powerpack 1602 (e.g., ammonia reforming system 100) may comprise a reformer (e.g., reformers 108 and 110) configured to convert the ammonia to reformate-product hydrogen (H₂) and reformate-product nitrogen (N₂). A fuel cell may be configured to react the reformate-product H₂ with oxygen (O₂) to generate water (H₂O) and an electrical power output to an electrical grid.

A gas recovery module 1606 may comprise a water condenser 1607 configured to extract the H₂O from a cathode exhaust 1604 of the fuel cell, and a nitrogen separator or liquefier 1608 configured to extract the reformate-product N₂ from an anode exhaust 1605 of the fuel cell. In some cases, the H₂O may be extracted from both the cathode exhaust 1604 and the anode exhaust 1605. In some cases, the H₂O may be extracted from the anode exhaust 1605. In some cases, the N₂ may be extracted from both the cathode exhaust 1604 and the anode exhaust 1605. In some cases, the N₂ may be extracted from the cathode exhaust 1604.

A water tank 1610 may be configured to store the extracted H₂O and/or external H₂O sourced from one or more external water sources 1609 (e.g., fresh water, distilled water, deionized water, etc.).

An electrolyzer 1611 may be configured to convert the extracted H₂O and/or the external H₂O (stored in the water tank 1610) to renewably generated H₂ (i.e., green H₂) using electrical power input from the electrical grid.

An air separator 1617 may be configured to separate air 1618 (e.g., from the atmosphere) to generate air-separated N₂. Additionally, the air separator 1617 may be configured to generate O₂ for the fuel cell.

An ammonia synthesis reactor 1613 may be configured react the renewably generated H₂ and the air-separated N₂ to generate synthesized NH₃ 1614 (for example, via the Haber-Bosch process). The synthesized NH₃ may then be stored in the ammonia storage tank 1601 (e.g., to be reformed by the ammonia powerpack 1602). The ammonia synthesis reactor 1613 may be powered (i.e., heated) using electrical power input from the electrical grid.

In some cases, a nitrogen tank 1615 is configured to receive and store the N₂ from the liquefier or separator 1608 and is configured to provide the N₂ to the ammonia synthesis reactor 1613 to react with the renewably generated H₂.

In some cases, a controller (e.g., controller 200) is operably connected to an external network (e.g., internet). The controller may be configured to determine an electricity demand of the electrical grid (e.g., using grid data received from the external network).

Based on the electricity demand being greater than a threshold electricity demand (in other words, a low supply of electricity in the electrical grid), the fuel cell of the ammonia powerpack 1602 may be directed to react the reformate-product H₂ with O₂ to generate H₂O, and output 1603 electricity to the electrical grid. In some cases, instead of outputting 1603 electricity to the electrical grid, the ammonia powerpack 1602 may export 1603 hydrogen to an external recipient.

In some cases, based on the electricity demand being less than a threshold electricity demand (in other words, a high supply of electricity in the electrical grid), the electrolyzer 1611 may be directed to convert the extracted H₂O and/or the external H₂O into the renewably-generated H₂ using the input electricity from the electrical grid, and/or the ammonia synthesis reactor 1613 may be directed to react the renewably-generated H₂ and the air-separated N₂ (and/or the reformate-product N₂) to synthesize the ammonia 1614.

In some cases, the electrical power output of the fuel cell(s) is at least about 1 kilowatt (KW) to at most about 100 megawatts (MW). In some cases, the electrical power output of the fuel cell(s) is at least about 1 kW, about 5 KW, about 10 KW, about 50 KW, about 100 KW, about 500 kW, about 1 MW, about 5 MW, about 10 MW, about 50 MW, or about 100 MW. In some cases, the electrical power output of the fuel cell(s) is at most about 1 kW, about 5 kW, about 10 kW, about 50 kW, about 100 kW, about 500 kW, about 1 MW, about 5 MW, about 10 MW, about 50 MW, or about 100 MW. In some cases, the electrical power output of the fuel cell(s) is between about 1 kW and about 100 MW, about 5 KW and about 50 MW, about 10 KW and about 10 MW, about 50 kW and about 5 MW, about 100 KW and about 1 MW, or about 500 kW and about 100 MW. The renewable energy system may comprise a start-up time of at least about 10 minutes to at most about 3 hours, a steady operation time (e.g., of the powerpack 1602, the electrolyzer 1611 and/or the ammonia synthesis reactor 1613) of at least about 10 minutes to at most about 50 hours, and a shut-down time of at least about 10 min to at most about three hours. In some cases, the start-up time is at least about 10 min, 0.5, about 1, about 1.5, about 2, about 2.5, about or about 3 hours. In some cases, the start-up time is at most about 10 min, 0.5, about 1, about 1.5, about 2, about 2.5, or about 3 hours. In some cases, the start-up time is between about 10 minutes and about 3 hours, between about 0.5 hours and about 2.5 hours, between about 1 hour and about 2 hours, or between about 1.5 hours and 3 hours. In some cases, the steady operation time is at least about 10 minutes, 0.5, about 1, about 5, about 10, about 15, about 20, about 25, about 30, about 35, about 40, about 45, or about 50 hours. In some cases, the steady operation time is at most about 10 minutes, 0.5, about 1, about 5, about 10, about 15, about 20, about 25, about 30, about 35, about 40, about 45, or about 50 hours. In some cases, the steady operation time is between about 10 minutes and 50 hours, 30 minutes and 45 hours, 1 hour and 40 hours, 5 hours and 35 hours, 10 hours and 30 hours, 15 hours and 25 hours, 20 hours and 50 hours. In some cases, the shut-down time is at least about 10 min, 0.5, about 1, about 1.5, about 2, about 2.5, or about 3 hours. In some cases, the shut-down time is at most about 10 min, 0.5, about 1, about 1.5, about 2, about 2.5, or about 3 hours. In some cases, the shut-down time is between about 10 minutes and 3 hours, 30 minutes and about 2.5 hours, 1 hour and 2 hours, or 1.5 hours, and about 3 hours. The electrical grid may preferably be provided with electricity from a zero-carbon or carbon-neutral source, for example, solar energy, wind energy, geothermal energy, hydroelectric energy, and/or nuclear energy.

### Multi-Stage Ammonia Filter

FIG. 15A is a schematic diagram illustrating a multi-stage ammonia filter 1700, in accordance with one or more embodiments of the present disclosure. FIG. 15B is a plot illustrating performance calculation data of a multi-stage ammonia filter 1700 at different stage numbers and water flow rates, in accordance with one or more embodiments of the present disclosure.

An ammonia scrubber 1701 may be configured to remove ammonia from a reformate stream 1702 (e.g., reformate stream 120) comprising at least H₂, N₂, and trace or residual NH₃ (e.g., at an ammonia concentration of about 10,000 ppm or greater). A filtered reformate stream 1703 (e.g., filtered reformate stream 123) may be output from the scrubber 1701 with the trace or residual NH₃ reduced (e.g., to an ammonia concentration less than about 500 ppm). The filtered reformate stream 1703 may be subsequently directed to a combustion heater (e.g., combustion heater 109) or to a fuel cell (e.g., fuel cell 124).

The ammonia scrubber 1701 may comprise one or more equilibrium stages. Each of the equilibrium stages may comprise water configured to absorb the trace or residual NH₃. The ammonia scrubber 1701 may be configured to receive input water (e.g., water condensate 1705 from a fuel cell) and discharge output water (e.g., a mixture 1704 of water and scrubbed NH₃). In some cases, the input water comprises fresh water, seawater, distilled water, and/or deionized water.

The discharged output water may be provided to an ammonia stripper 1706 in fluid communication with the ammonia scrubber 1701. Ammonia may be removed from the discharged output water by passing air 1710 into the discharged output water in the ammonia stripper 1706. A stripped mixture 1711 (comprising air, water, and ammonia) may then be discharged from the ammonia stripper 1706. In some cases, the stripped mixture 1711 is directed to a combustion heater (e.g., combustion heater 109).

In some instances, a pump 1707 may be configured to circulate water 1708 from the ammonia stripper 1706 to the ammonia scrubber 1701. The water 1708 may be combined with the fuel cell condensate 1705 or any other external water sources before being directed into the ammonia scrubber 1701. In this way, the multi-stage ammonia filter 1700 may be continuously regenerated (e.g., without having to replace one or more adsorbent filters), and an ammonia reforming system (e.g., ammonia reforming system 100) may be prevented from stopping (to regenerate the ammonia filter).

In some instances, increasing the number of equilibrium stages and/or the water flow rates may increase NH₃ absorption (and reduce NH₃ concentration) in the filtered reformate stream 1703 as illustrated in FIG. 15B. In some instances, the NH₃ concentration at the filtered reformate stream 1703 is below about 100, about 500, about 1000, about 2000, about 3000, about 4000, about 5000, about 6000, about 7000, about 8000, or about 9000 parts per million (ppm). In some instances, the NH₃ concentration at the filtered reformate stream 1703 is at most about 100, about 500, about 1000, about 2000, about 3000, about 4000, about 5000, about 6000, about 7000, about 8000, or about 9000 ppm. In some instances, the NH₃ concentration at the filtered reformate stream 1703 is at least about 100, about 500, about 1000, about 2000, about 3000, about 4000, about 5000, about 6000, about 7000, about 8000, or about 9000 ppm. In some instances, the NH₃ concentration at the filtered reformate stream 1703 is between about 100 and about 9000, about 500 and about 8000, about 1000 and about 7000, about 2000 and about 6000, about 3000 and about 5000, or about 4000 and about 9000 ppm. In some instances, the equilibrium stages in the ammonia scrubber may be at least 1, about 2, about 3, about 4, about 5, about 6, about 7, about 8, about 9, about 10, about 15, or about 20 stages. In some instances, the equilibrium stages in the ammonia scrubber may be at most 1, about 2, about 3, about 4, about 5, about 6, about 7, about 8, about 9, about 10, about 15, or about 20 stages. In some instances, the water flow rate may be at least about 1, about 2, about 4, about 6, about 8, about 10, about 12, about 14, about 16, about 18, about 20, about 25, or about 30 kilogram (kg)/second(s). In some instances, the water flow rate may be at most about 1, about 2, about 4, about 6, about 8, about 10, about 12, about 14, about 16, about 18, about 20, about 25, or about 30 kg/s. In some instances, the water flow rate may be between about 1 and about 30, about 2 and about 25, about 4 and about 20, about 6 and about 18, about 8 and about 16, about 10 and about 14, or about 12 and about 30 kg/s.

### Recovery Device

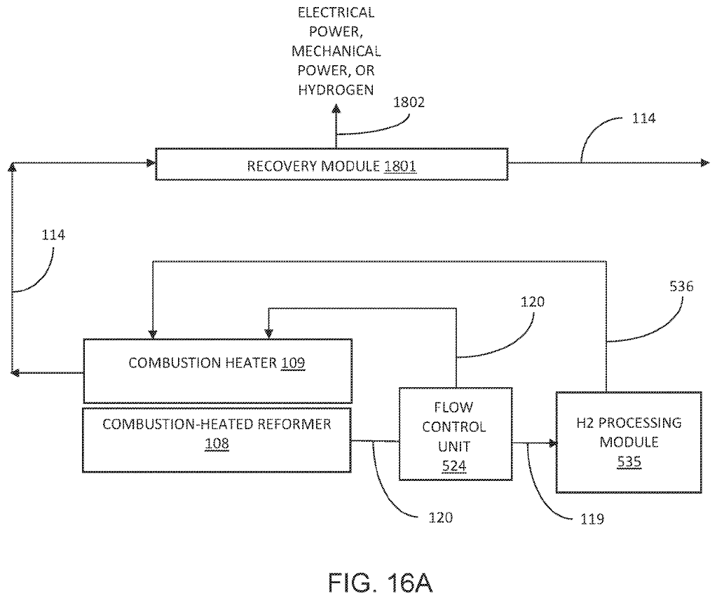

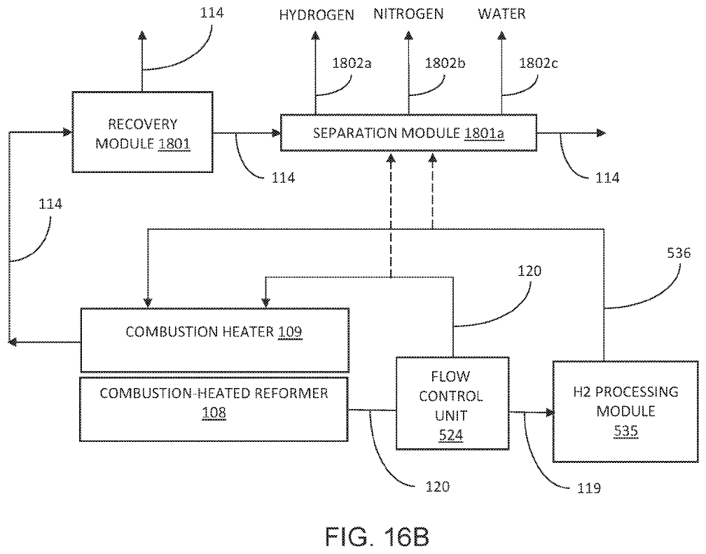

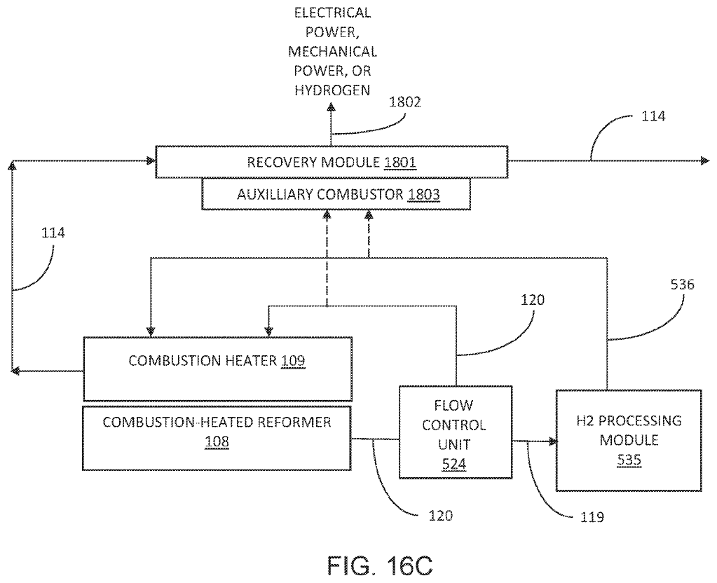

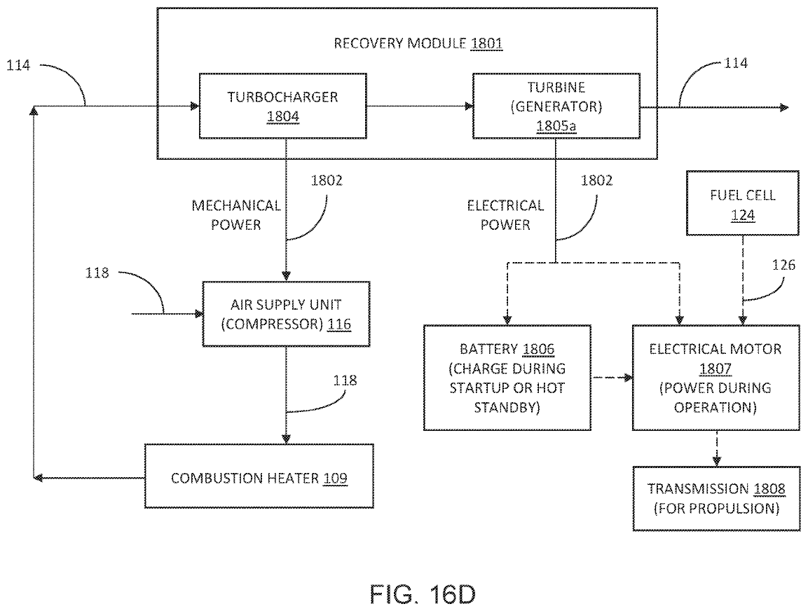

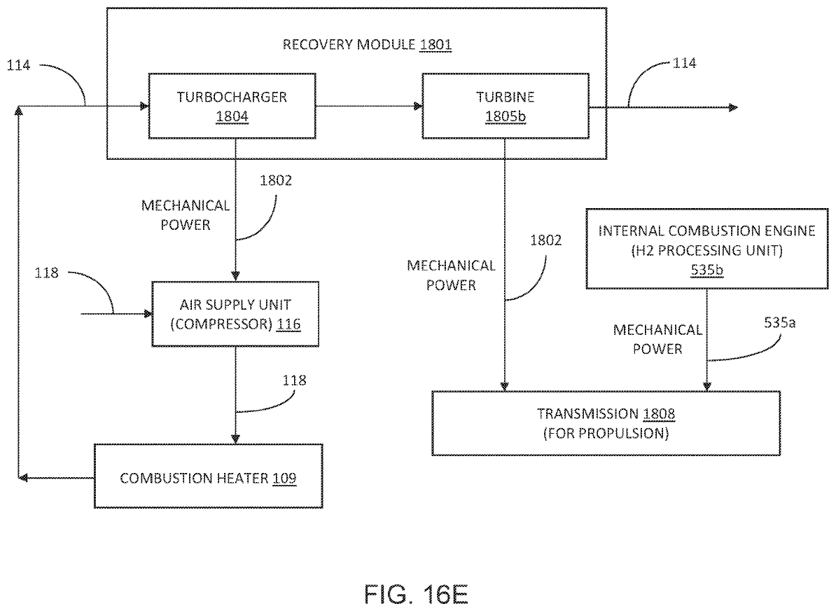

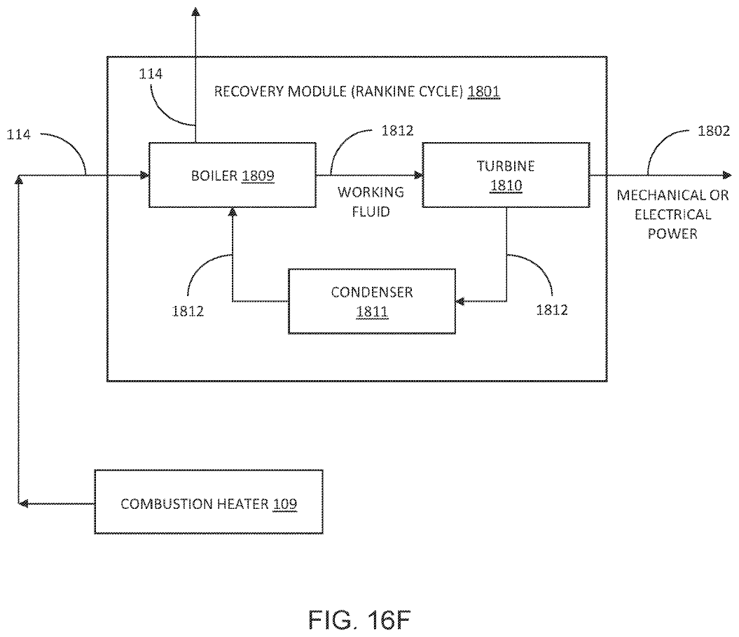

FIGS. 16A-F are block diagrams illustrating various recovery modules 1801 configured to recover waste heat and a separation module 1801a configured to separate hydrogen, nitrogen, oxygen, or water, in accordance with one or more embodiments of the present disclosure.

In some cases, the recovery module 1801 may be configured to convert the waste heat to electrical power or mechanical power 1802 (i.e., productive work). For example, the recovery module may comprise one or more turbines or turbo devices, and may utilize turbo-compounding (e.g., mechanical turbo-compounding or electrical turbo-compounding).

In some cases, the heat recovery module 1801 comprises a heat exchanger, for example, a shell-and-tube heat exchanger or a plate heat exchanger. In some cases, the recovery module 1801 may be configured to utilize the waste heat to warm a fluid stream (e.g., preheat or vaporize the incoming ammonia stream 104).

In some cases, the heat recovery module 1801 is a boiler configured to generate steam. In some cases, the steam may be directed to a turbine to generate mechanical power or electrical power. The steam may be directed to the ammonia filter 112 to regenerate the ammonia filter 112 by desorbing the trace or residual ammonia from the ammonia filter 112 (in other words, perform temperature swing adsorption (TSA) and desorption).

In some cases, the heat recovery module 1801 comprises a heat pump configured to transfer heat from the combustion exhaust 114 to a working fluid (e.g., water to generate steam). The steam may then be used to drive a turbine to generate electrical power or mechanical power, and/or may be used to regenerate the ammonia filter 112. In some cases, the heat pump may transfer heat from the reformate stream 120 (or portion thereof) or the leftover stream 536 (or portion thereof) and provide the heat to the working fluid.

The recovery module 1801 may advantageously increase an overall energy efficiency of the ammonia reforming system 100 (e.g., ammonia heating value to useful energy, such as electricity, i.e., energy conversion efficiency), for example, by at least about 2%. In some cases, the recovery module 1801 may increase the overall energy efficiency by at least about 2, about 3, about 4, about 5, about 6, about 7, about 9, or about 10%. In some cases, the recovery module 1801 may increase the overall energy efficiency by at most about 3, about 4, about 5, about 6, about 7, about 9, or about 10%.

As shown in FIG. 16A, the combustion exhaust 114 from the combustion heater 109 may be provided to the recovery module 1801. The recovery module 1801 may capture or recover heat from the combustion exhaust 114.

As shown in FIGS. 16B-C, the reformate stream 120 (or portion thereof) and/or the leftover stream 536 (or portion thereof) may be provided to the recovery module 1801a (or a separation module 1801a). In some cases, the reformate stream 120 (or portion thereof) and/or the leftover stream 536 (or portion thereof) may bypass the combustion heater 109 (for example, diverted at a location upstream from the combustion heater 109) when provided to the recovery module 1801 (or the separation module 1801a).

In some cases, the reformate stream 120 (or portion thereof) and/or the leftover stream 536 (or portion thereof) may bypass (i.e., be diverted from) the combustion heater 109 during the startup mode or the hot standby mode.

In some cases, the reformate stream 120 (or portion thereof) and/or the leftover stream 536 (or portion thereof) may not bypass the combustion heater 109 during the operation mode (for example, may be provided only to the combustion heater 109 during the operation mode).

In some cases, the reformate stream 120 (or portion thereof) and/or the leftover stream 536 (or portion thereof) may not bypass the combustion heater 109 during the startup mode, the operation mode, and/or the hot standby mode (for example, may be provided only to the combustion heater 109 during the startup mode, operation mode, or hot standby mode).

In some cases, as shown in FIG. 16B, a separation module 1801a may separate hydrogen 1802a, nitrogen 1802b, and/or water 1802c from the combustion exhaust 114, the reformate stream 120 (or portion thereof), and/or the leftover stream 536 (or portion thereof). The separation module 1801a may comprise a hydrogen separation membrane configured to separate the hydrogen 1802a from the combustion exhaust 114, the reformate stream 120 (or portion thereof), or the leftover stream 536 (or portion thereof) (which may comprise H₂, N₂, and/or H₂O). The hydrogen separation membrane may comprise platinum (Pt), palladium (Pd), vanadium (V), and/or other materials configured for hydrogen separation. In some embodiments, the separated hydrogen 1802a is stored in a storage tank. In some embodiments, the separated hydrogen 1802a is provided to a fuel cell (e.g., fuel cell 124). In some embodiments, the separated hydrogen 1802a is combusted (e.g., in the combustion heater 109 or in a boiler configured to generate steam). In some cases, the separated nitrogen 1802b may be vented to the atmosphere. In some cases, the separated nitrogen 1802b may be compressed and/or liquified. In some cases, the separation module 1801a comprises a pressure swing adsorption device (PSA) configured to separate the nitrogen 1802b. In some cases, the separation module 1801a may comprise a condenser or a filter configured to extract the water 1802c. In some cases, the separation module 1801a separates oxygen from the combustion exhaust 114.

In some cases, as shown in FIG. 16C, the recovery module 1801 may comprise an auxiliary combustor 1803. The auxiliary combustor 1803 may be configured to combust the hydrogen in the reformate stream 120 (or portion thereof) and/or the leftover stream 536 (or portion thereof). The auxiliary combustor 1803 may be in thermal communication with the recovery module 1801 (e.g., to transfer heat to the recovery module 1801).

It is noted that the auxiliary combustor 1803 may be separate from the combustion heater 109. In some cases, the auxiliary combustor 1803 combusts hydrogen in the reformate stream 120 (or portion thereof) and/or the leftover stream 536 (or portion thereof) during the hot standby mode and/or during the startup mode (e.g., to combust hydrogen in the leftover stream 536 that is not consumed by the hydrogen processing module 535). In some cases, flow control units (e.g., valves) may be configured to direct the reformate stream 120 (or portion thereof) and/or the leftover stream 536 (or portion thereof) to the auxiliary combustor 1803 during the hot standby mode or during the startup mode.

In some cases, as shown in FIG. 16D, the recovery module 1801 may include a turbocharger 1804 and/or a turbine 1805a. The turbocharger 1804 may be configured to be driven by the temperature and pressure of the combustion exhaust 114 to provide mechanical power 1802 to a compressor (e.g., air supply unit 116), which in turn compresses the air stream 118. The compressed air stream 118 may then be provided to the combustion heater 109 for combustion of the reformate stream 120 and/or the leftover stream 536. The compression of the air stream 118 may advantageously reduce the fuel requirement for combustion in the combustion heater 109.

The turbine 1805a may be configured to be driven by the temperature and pressure of the combustion exhaust 114 and may comprise a generator configured to generate electrical power 1802. The electrical power 1802 may then be provided to a battery 1806 and/or an electrical motor 1807. The electrical motor 1807 may be provided to convert the electrical power 1802 to mechanical power, and drive a transmission 1808 (e.g., which may propel a vehicle, for example, a marine vessel). The battery 1806 may provide electrical power to the electrical motor 1807 (e.g., in addition to the fuel cell 124). In some cases, the generator may provide electrical power 1802 to charge the battery 1806 during the startup mode, the operation mode, and/or the hot standby mode. In some cases, the generator may provide electrical power 1802 to actuate the electrical motor 1807 during the operation mode.

It is noted that the combustion exhaust 114 may pass in series from the turbocharger 1804 to the turbine 1805a, and the ammonia reforming system 100 may therefore utilize (electrical) turbocompounding. In some cases, the combustion exhaust 114 may pass in series from the turbine 1805a to the turbocharger 1804. In some cases, either the turbocharger 1804 or the turbine 1805a may not be present, so that the combustion exhaust 114 only passes the turbocharger 1804, or so that the combustion exhaust 114 only passes the turbine 1805a.

In some cases, as shown in FIG. 16E, the recovery module 1801 may include the turbocharger 1804 and/or a turbine 1805b. The turbine 1805b may be configured to be driven by the temperature and pressure of the combustion exhaust 114 and may be configured to generate mechanical power 1802 for the transmission 1808. In some cases, the hydrogen processing module 535 is an internal combustion engine (ICE) 535b and the turbine 1805b provides the mechanical power 1802 to the transmission 1808 (in addition to the mechanical power 535a provided by the ICE 535b).

It is noted that the combustion exhaust 114 may pass in series from the turbocharger 1804 to the turbine 1805b, and the ammonia reforming system 100 may therefore utilize (mechanical) turbocompounding. In some cases, the combustion exhaust 114 may pass in series from the turbine 1805b to the turbocharger 1804. In some cases, either the turbocharger 1804 or the turbine 1805b may not be present, so that the combustion exhaust 114 only passes the turbocharger 1804, or so that the combustion exhaust 114 only passes the turbine 1805b.

In some cases, as shown in FIG. 16F, the recovery module 1801 may be a Rankine cycle device or module comprising a boiler 1809, a turbine 1810, and a condenser 1811. A working fluid may circulate between the boiler 1809, the turbine 1810, and the condenser 1811. In some embodiments, the working fluid 1812 comprises water. The water may be sourced from the cathode off-gas 504 emitted by the fuel cell 124, sourced from the combustion exhaust 114, and/or may be sourced externally (e.g., tap water, fresh water, sea water, etc.).

The boiler 1809 may vaporize the working fluid 1812 (using the waste heat transferred from the combustion exhaust 114) to generate steam 1812. The steam 1812 may then drive the turbine 1810 to generate electrical or mechanical power 1802 (e.g., to charge a battery, actuate an electrical motor, or drive a transmission). The condenser 1811 may then condense the steam 1812, and the working fluid 1812 may be provided to the boiler 1809 to perform the Rankine cycle again.

### Alternative Hydrogen Carriers

It is contemplated that a hydrogen carrier (HC) may be reformed in the reformers 108 and 110 instead of ammonia, and that the HC may replace ammonia for any embodiment described herein. In some embodiments, the HC comprises an alkane, and the reforming reaction performed in the reformers 108-110 comprises:

CₙH₍₂₊₂ₙ₎+nH₂O→nCO+(1+2n)H₂

where n is an integer of at least one. For example, the HC may comprise methane (CH₄), and the reforming reaction and a water gas-shift (WGS) reaction performed in the reformers 108-110 comprises:

CH₄+H₂O→CO+3H₂

CO+H₂O→CO₂+H₂

The HC may comprise ethane, methane, propane, butane, pentane, hexane, heptane, octane, nonane, decane, a higher alkane, an isomer thereof, or any combination thereof.

In some embodiments, the HC comprises an alcohol. For example, the HC may comprise methanol, and the reforming reaction performed in the reformers 108-110 comprises:

CH₃OH+H₂O→3H₂+CO₂

CH₃OH→2H₂+CO

CO+H₂O→H₂+CO₂

The HC may comprise ethanol, methanol, propanol, butanol, pentanol, hexanol, heptanol, octanol, nonanol, decanol, a higher alcohol, an isomer thereof, or any combination thereof.

In some embodiments, the HC comprises a liquid organic hydrogen carrier (LOHC). For example, the LOHC may comprise methylcyclohexane, and the reforming reaction performed in the reformers 108-110 comprises:

CH₃C₆H₁₁→CH₃C₆H₅+3H₂

The HC may comprise cyclohexane (e.g., which may be reformed to benzene), methylcyclohexane (e.g., which may be reformed to toluene), decalin (e.g., which may be reformed to naphthalene), perhydro-N-ethylcarbazole (e.g., which may be reformed to N-ethylcarbazole), perhydrodibenzyltoluene (e.g., which may be reformed to dibenzyltoluene).

### Ammonia Reforming System

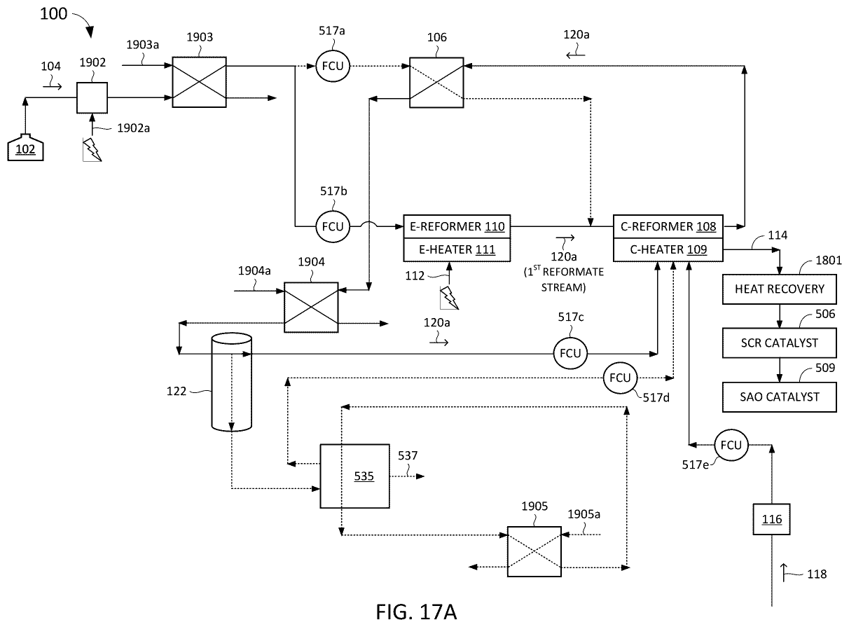

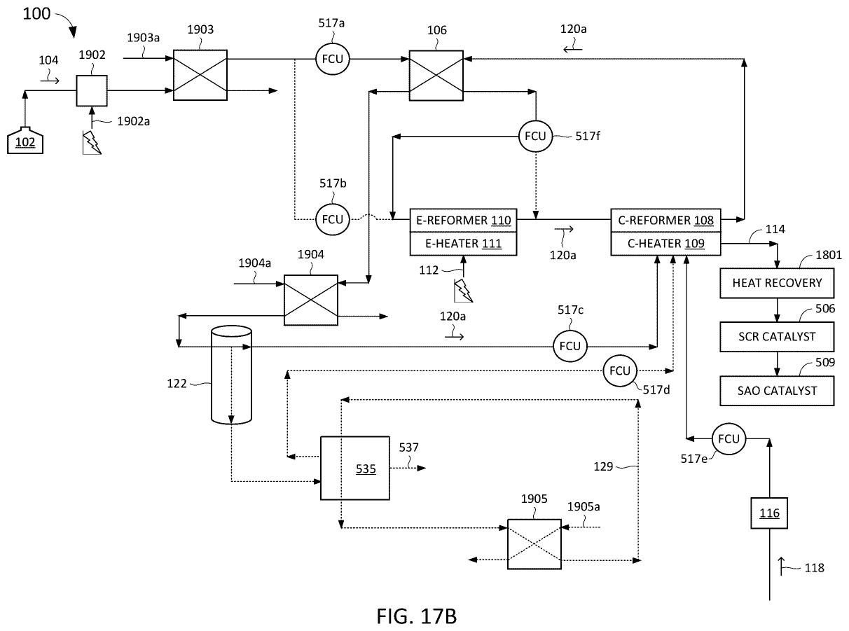

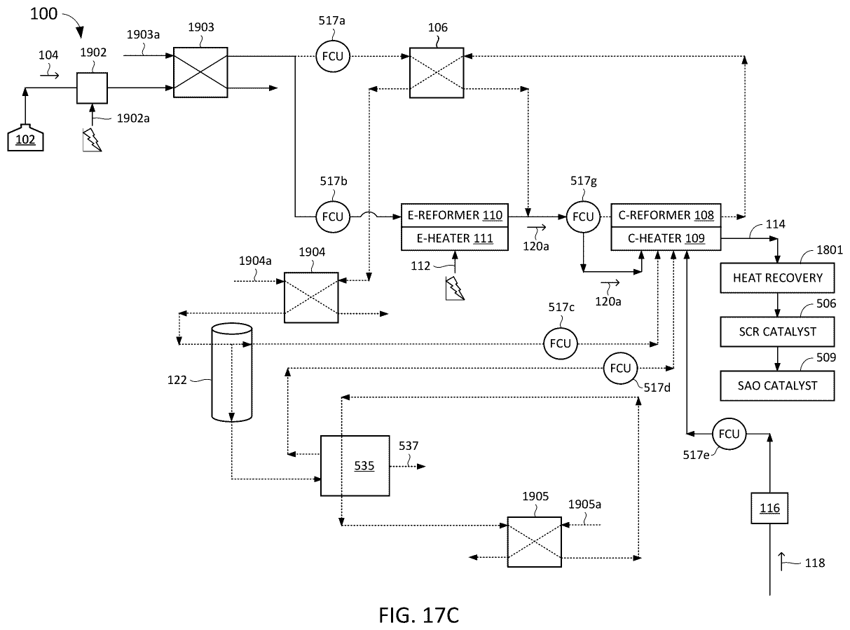

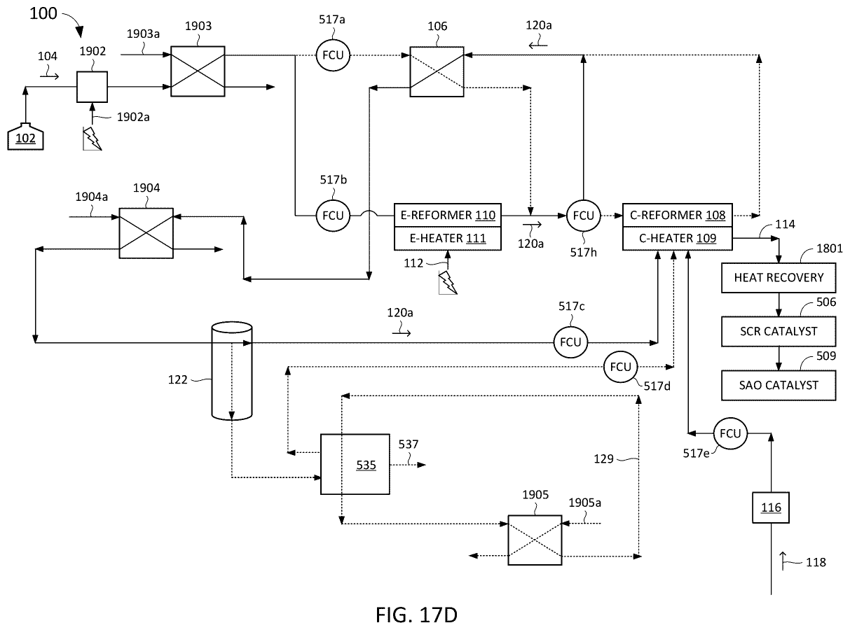

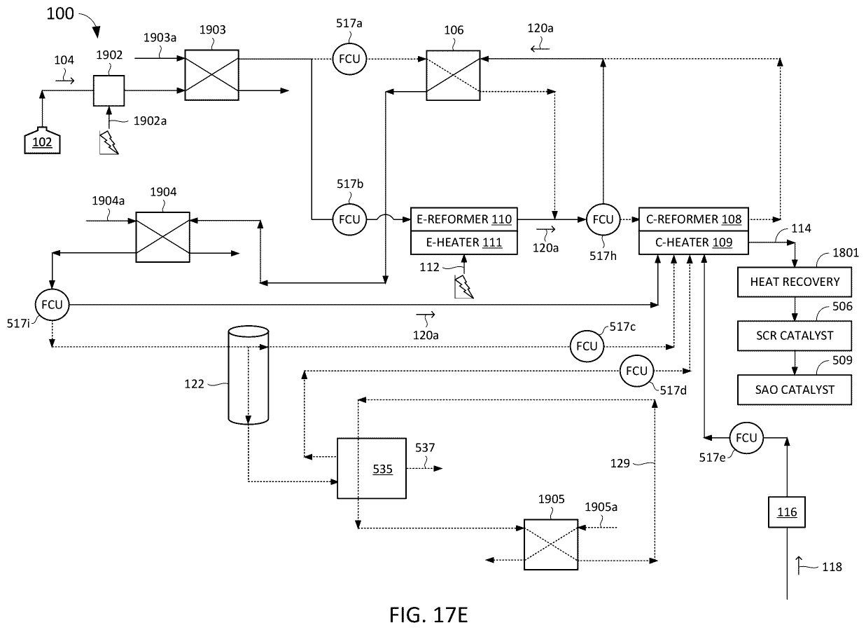

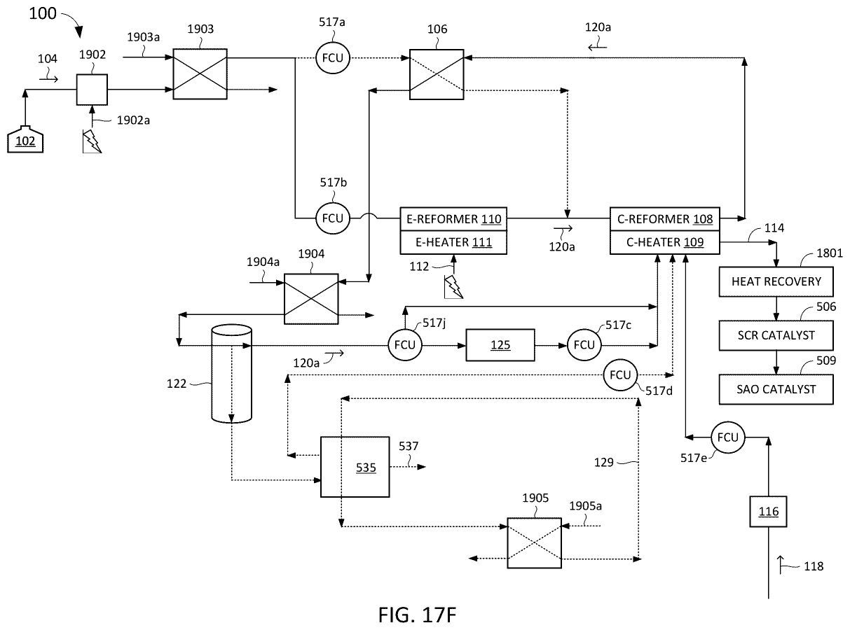

FIGS. 17A-20B are block diagrams illustrating various configurations of the NH₃ reforming system 100, in accordance with one or more embodiments of the present disclosure. The components of the system 100 described with respect to FIGS. 17A-20B may be substantially similar or substantially identical in form and function to the similarly named (or similarly numbered) components described elsewhere herein.

As shown in FIGS. 17A-20B, the system 100 may comprise an NH₃ storage tank 102, an electric heater 1902, a heat exchanger 1903, a heat exchanger 1904, a heat exchanger 106, a combustion-heated reformer 108 (hereinafter “C-reformer 108”), a combustion heater 109 (hereinafter “C-heater 109”), an electrically heated reformer 110 (hereinafter “E-reformer 110”), an electric heater 111 (hereinafter “E-heater 111”), an air supply unit 116, flow control units 517a-i, an ammonia filter 122, an H₂ processing module 535, a secondary H₂ processing module 125, a heat exchanger 1905, a heat recovery module 1801, an SCR catalyst 506, and an SAO catalyst 509.

The fluid lines (e.g., conduits that fluidically couple the components to each other) illustrated in FIGS. 17A-20B are depicted as solid lines or dashed lines for explanatory purposes. A solid line may indicate that the fluid line is in use (i.e., has fluid flowing therein) for the embodiment described with respect to the associated figure, and a dashed line may indicate that the fluid line is not in use (i.e., does not have fluid flowing therein) for the embodiment described with respect to the associated figure. However, the present disclosure is not limited thereto, and the embodiments described herein may be combined in various ways.

It is contemplated that the system 100 may generate reformate in a sequence of stages (e.g., modes). The flowrate of the NH₃ stream directed to the reformer(s) may be increased in several stages based on an operating flowrate (e.g., a steady-state flowrate which may be predefined, or changed in real-time). This sequence may initiate and maintain NH₃ reforming (e.g., from a cold-start situation) while avoiding undesirable outcomes (such as a drop in pressure of the reformate stream, and/or thermal or mechanical stress to the reformer(s), fluid lines, etc.).

For example, the system 100 may implement a start-up mode, where a first reformer (and the NH₃ reforming catalyst therein) is heated to a first target temperature range. The first reformer then reforms an NH₃ stream at a first flowrate (e.g., about 5% of an operating flowrate) to generate a first reformate stream. The first reformate stream is then combusted to heat a second reformer (and the NH₃ reforming catalyst therein) to a second target temperature range.

The system 100 may then implement a pre-operation mode, where the second reformer reforms the NH₃ stream at a second flowrate (e.g., about 10% of the operating flowrate) to generate a second reformate stream. A first portion of the second reformate stream is then combusted to heat the second reformer to control (i.e., maintain or change) the temperature of the second reformer (and the NH₃ reforming catalyst therein) within the second target temperature range. In some cases, the second flowrate of the NH₃ stream is increased (e.g., from about 10% of the operating flowrate to about 25% of the operating flowrate). In some cases, the second flowrate is increased to a threshold flowrate (e.g., about 25% of the operating flowrate).

The system 100 may then implement an operation mode (e.g., steady-state mode), where the second flowrate of the NH₃ stream is increased to the operating flowrate (e.g., about 100% of the operating flowrate). In some cases, the system 100 implements the operation mode based on the second flowrate reaching the threshold flowrate. In some cases, the system 100 implements the operation mode based on an increased demand (e.g., electrical demand, mechanical demand, hydrogen demand, etc.) of the H₂ processing module.

In some cases, the operating flowrate of the NH₃ stream is chosen before heating the first reformer (and the NH₃ reforming catalyst therein) to the first target temperature range, or before heating the second reformer (and the NH₃ reforming catalyst therein) to the second target temperature range (in other words, before implementation of the operation mode). In some cases, the operating flowrate is changed after increasing the second flowrate to the operating flowrate (in other words, the operating flowrate may be chosen after or during implementation of the operation mode).

### Startup Mode

FIGS. 17A-17F illustrate various example configurations of the system 100 implementing the start-up mode.

As shown in FIG. 17A, the E-reformer 110 (e.g., first reformer) may be heated to a temperature within a first target temperature range using the E-heater 111 (thereby heating the NH₃ reforming catalyst in the E-reformer 110). The E-heater 111 may be powered using electricity 112 supplied by a battery, fuel cell, electrical grid, or combination thereof. The power supplied to the E-heater 111 may be controlled, for example, using a controller (e.g., computing device) in electrical communication with the E-heater 111. The power supplied to the E-heater 111 may be controlled manually (e.g., by a user) or automatically to control (i.e., maintain or change) the temperature of the E-reformer 110 within the first target temperature range.

The NH₃ stream 104 may be provided from the storage tank 102 to the electric heater 1902 (e.g., preheater). The electric heater 1902 may heat (e.g., preheat) the NH₃ stream 104 to vaporize the NH₃ stream 104 (thereby converting the NH₃ stream 104 from liquid to gas). The electric heater 1902 may be powered using electricity 1902a supplied by a battery, fuel cell, electrical grid, or a combination thereof. The power supplied to the electric-heater 1902 may be controlled manually (e.g., by a user) or automatically to control (i.e., maintain or change) a temperature capable of vaporizing the NH₃ stream 104.

In some cases, the electrical heater 1902 and/or the electrical heater 111comprises an indirect resistance heater configured to generate heat using a heating element (e.g., nichrome material). In some cases, the electrical-heater 111 comprises a direct resistance heater configured to generate heat by passing a current through electrodes in contact with the catalyst in the E-reformer 110. In some cases, the electrical heater 1902 and/or the electrical-heater 111 comprises a microwave heater configured to generate heat by exciting polar molecules (e.g., water and/or ammonia). In some cases, the electrical heater 1902 and/or the electrical-heater 111 comprises an induction heater configured to generate heat using a magnetic field that interacts with a magnetically sensitive material.

The NH₃ stream 104 may then be directed to the E-reformer 110. In some cases, the FCUs 517a-b are controlled (e.g., using a controller) manually (e.g., by a user) or automatically to direct the NH₃ stream 104 to the E-reformer 110. Although two FCUs 517a-b are shown, the present disclosure is not limited thereto, and the FCUs 517a-b may comprise any number of flow control units. For example, a single FCU (e.g., a three-way valve) may be configured to direct the NH₃ stream 104 to the E-reformer 110.

The NH₃ stream 104 may be reformed in the E-reformer 110 at a first flowrate to generate a first reformate stream 120a comprising H₂ and N₂. In some cases, the first flowrate is greater than about 1% and less than about 10% of the operating flowrate. In some cases, the first flowrate is at least about 1, about 3, about 5, about 10, about 15, about 20, or about 25% of the operating flowrate. In some cases, the first flowrate is at most about 3, about 5, about 10, about 15, about 20, about 25, or about 30% of the operating flowrate. However, the present disclosure is not limited thereto, and the first flowrate may comprise any percentage of the operating flowrate. In some cases, the first reformate stream 120a is directed to the C-reformer 108 to reform residual NH₃ in the first reformate stream 120a.

In some cases, the first reformate stream 120a is directed to the heat exchanger 106. The heat exchanger 106 may transfer heat from the first reformate stream 120a to the NH₃ stream 104 (for example, to vaporize and/or preheat the NH₃ stream 104). In some cases, the electric heater 1902 and the heat exchanger 106 are both configured to heat (vaporize) the NH₃ stream 104. In some cases, the heat exchanger 106 heats the NH₃ stream 104, and the electricity 1902a supplied to the electric heater 1902 is reduced or turned off. In some cases, the first reformate stream 120a is directed to an NH₃ filter 122 to reduce (or remove) residual NH₃ in the first reformate stream 120a.

The first reformate stream 120a may then be directed to the combustion heater 109 in thermal communication with the combustion-heated reformer 108 (e.g., second reformer). The first reformate stream 120a may be combusted in the combustion heater 109 (by reacting with the oxygen (O₂) in the air stream 118) to heat the combustion-heated reformer 108 (and the NH₃ reforming catalyst therein) to a temperature within the second target temperature range. In some cases, the combustion in the combustion heater 109 is fuel-lean (i.e., air-rich with a stoichiometric excess of O₂). In some cases, the combustion in the combustion heater 109 is fuel-rich (i.e., air-lean with a stoichiometric excess of H₂). In some cases, FCUs 517c and 517e are controlled (e.g., using a controller) manually or automatically to control (i.e., maintain or change) the temperature of the combustion-heated reformer 108 within the second target temperature range. For example, the FCUs 517c and 517e may control quantities (e.g., flow rate in terms of volume per unit time, or moles per unit time) of the reformate stream 120a and the air stream 118 provided to the combustion heater 109. The quantities may be controlled to achieve stoichiometric, fuel-rich, and/or fuel-lean combustion in the combustion heater 109 (e.g., by modulating the ratio of H₂ to O₂ supplied for the combustion reaction) and control (i.e., maintain or change) the temperature of the combustion-heated reformer 108 within the second target temperature range.

As shown in FIG. 17B, in some cases, the NH₃ stream 104 is directed to the heat exchanger 106 before being directed to the E-reformer 110 (which may advantageously further heat and/or vaporize the NH₃ stream 104 and therefore reduce the required power supplied to the electrical heater 111). In some cases, an FCU 517f is controlled (e.g., using a controller) manually or automatically to direct the NH₃ stream 104 to the E-reformer 110 (after the NH₃ stream 104 exits the heat exchanger 106).

As shown in FIG. 17C, in some cases, the first reformate stream 120a is directed to the combustion heater 109 directly (so that the first reformate stream 120a bypasses the combustion-heated reformer 108 before being directed to the combustion heater 109, which may advantageously prevent a pressure drop of the first reformate stream 120a). In some cases, an FCU 517g is controlled (e.g., using a controller) manually or automatically to direct the first reformate stream 120a to the C-heater 109 (thereby bypassing the C-reformer 108). In some cases, the FCU 517g is controlled to direct the first reformate stream 120a to the C-reformer 108.

As shown in FIG. 17D, in some cases, the first reformate stream 120a is directed to the heat exchanger 106 and then to the combustion heater 109 (so that the first reformate stream 120a bypasses the combustion-heated reformer 108 before being directed to the combustion heater 109, which may advantageously prevent a pressure drop of the first reformate stream 120a). In some cases, the first reformate stream 120a is directed to the ammonia filter 122 before being directed to the combustion heater 109. In some cases, an FCU 517h is controlled (e.g., using a controller) manually or automatically to direct the first reformate stream 120a to the heat exchanger 106 and then to combustion heater 109 (thereby bypassing the combustion reformer 108). In some cases, the FCU 517h is controlled to direct the first reformate stream 120a to the combustion reformer 108.

As shown in FIG. 17E, in some cases, the first reformate stream 120a bypasses the NH₃ filter 122 before being directed to the combustion heater 109 (which may advantageously avoid oversaturating the NH₃ filter 122, for example, when the NH₃ filter 122 reaches or exceeds a maximum NH₃ adsorbing capacity). In some cases, an FCU 517i is controlled (e.g., using a controller) manually or automatically to direct the first reformate stream 120a to the combustion heater 109 (thereby bypassing the ammonia filter 122). In some cases, the FCU 517i controlled to direct the first reformate stream 120a to the ammonia filter 122. In some cases, the FCU 517i and 517e are controlled to control (i.e., maintain or change) the temperature of the combustion reformer 108 within the second target temperature range.

As shown in FIG. 17F, in some cases, the first reformate stream 120a is directed to a secondary H₂ processing module 125 (which may be, for example, a fuel cell, a combustion engine, a combustion heater, a storage tank, a fueling station, a metal ore reducer, etc.). The secondary H₂ processing module 125 may increase the overall energy efficiency of the system 100 by fully utilizing the reformate stream 120a (since, in some cases, more of the reformate stream 120a may be generated than is required to heat the combustion heater 109). In some cases, an off-gas comprising hydrogen is provided from the secondary H₂ processing module 125 to be combusted in the combustion heater 109. In some cases, an FCU 517j is configured to direct the first reformate stream 120a directly to the combustion heater 109 (thereby bypassing the secondary H₂ processing module 125). In some cases, the FCU 517j may be configured to direct some of the first reformate stream 120a to the secondary H₂ processing module 125, and to provide a remaining (i.e., leftover) part of the reformate stream 120a to the combustion heater 109. In some cases, the FCUs 517j, 517c, and/or 517e may be controlled (manually or automatically) to control (i.e., maintain or change) the temperature of the combustion reformer 108 within the second target temperature range.

In some cases, the reformer(s) 108-110 are purged using a purging gas (for example, before the start-up mode, or for maintenance purposes). In some cases, the reformer(s) 108-110 are purged to remove oxygen thereby preventing oxidation damage to the reformer(s) 108-110 (and/or to the NH₃ reforming catalyst therein). In some cases, the reformer(s) 108-110 are purged to remove hydrogen and/or ammonia thereby reducing safety risk during maintenance or other operations (since ammonia is toxic, and hydrogen is easily ignitable and asphyxiating). In some cases, the purging gas is an inert gas (e.g., N₂, CO₂, etc.). In some cases, the purging gas is reformate (e.g., a mixture of H₂/N₂). In some cases, the purging gas (including the leftover oxygen, hydrogen, and/or ammonia) is vented to the atmosphere. In some cases, the purging gas (including the leftover oxygen, hydrogen, and/or ammonia) is directed to a storage tank. In some cases, the purging gas (including the leftover oxygen, hydrogen, and/or ammonia) is directed to a combustion heater (and/or an oxidation catalyst) to combust the leftover oxygen, hydrogen, and/or ammonia.

In some cases, the first flowrate of the NH₃ stream is greater than about 1, about 2, about 3, about 4, about 5, about 6, about 7, about 8, or about 9% of the operating flowrate and less than about 2, about 3, about 4, about 5, about 6, about 7, about 8, about 9, or about 10% of the operating flowrate. However, the present disclosure is not limited thereto, and the first flowrate may be any percentage of the operating flowrate.

In some cases, the first flowrate of the NH₃ stream is increased (e.g., from about 1% of the operating flowrate to about 10% of the operating flowrate) or decreased. In some cases, the first flowrate of the NH₃ stream is increased or decreased at a constant rate (e.g., about 0.1% of the operating flowrate per second). In some cases, the first flowrate of the NH₃ stream is increased or decreased at a variable rate (e.g., about 0.5% of the operating flowrate per second, then subsequently about 0.3% of the operating flowrate per second, then subsequently about 0.1% of the operating flowrate per second, etc.).

### Pre-Operation Mode

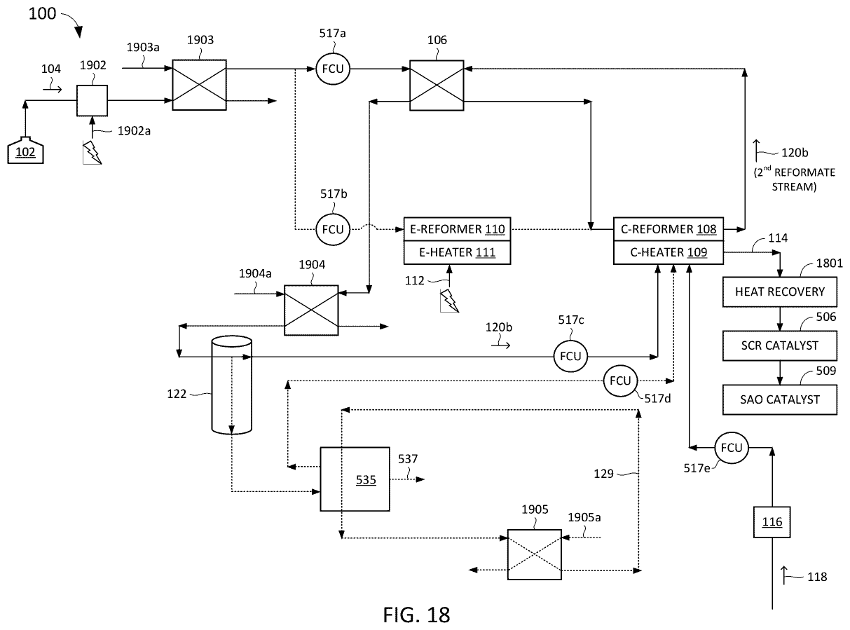

FIG. 18 illustrates an example configuration of the system 100 implementing the pre-operation mode.

After the combustion-heated reformer 108 (and the catalyst therein) is heated to the temperature within the second target temperature range (by combusting the first reformate stream 120a using the combustion heater 109), the NH₃ stream 104 may be directed to the combustion-heated reformer 108 and reformed at a second flowrate to generate a second reformate stream 120b. The second flowrate of the NH₃ stream 104 may be greater than the first flowrate of the NH₃ stream 104 (in other words, the flowrate of the NH₃ stream 104 may be increased).

The second reformate stream 120b may then be directed to the combustion heater 109 and combusted to heat the combustion-heated reformer 108 (and the NH₃ reforming catalyst therein) to control (i.e., maintain or change) the temperature of the combustion-heated reformer 108 within the second target temperature range. The second reformate stream 120b may be combusted in the combustion heater 109 by reacting with the oxygen (O₂) in the air stream 118. In some cases, a first portion of the reformate stream 120b is directed to the combustion heater 109 (and a second portion of the reformate stream 120b may be directed elsewhere, for example, to an H₂ processing module, or vented to the atmosphere).

In some cases, FCUs 517c and 517e are controlled (e.g., using a controller) manually or automatically to control (i.e., maintain or change) the temperature of the combustion-heated reformer 108 within the second target temperature range. For example, the FCUs 517c and 517e may control quantities (e.g., flow rate in terms of volume per unit time, or moles per unit time) of the reformate stream 120b and the air stream 118 provided to the combustion heater 109. The quantities may be controlled to achieve stoichiometric, fuel-rich, and/or fuel-lean combustion in the combustion heater 109 (e.g., by modulating the ratio of H₂ to O₂ supplied for the combustion reaction) and control (i.e., maintain or change) the temperature of the combustion reformer 108 within the second target temperature range.

In some cases, the second reformate stream 120b is directed to the NH₃ filter 122 to remove or reduce the residual ammonia in the second reformate stream 120b before being combusted in the combustion heater 109. In some cases, the second reformate stream 120b bypasses the NH₃ filter 122 before being combusted in the combustion heater 109.

In some cases, the second reformate stream 120b is directed to the E-reformer 110 to reform residual NH₃ in the second reformate stream 120b. In some cases, the first reformate stream 120a and the second reformate stream 120b are separate streams. In some cases, the first reformate stream 120a is combined with the second reformate stream 120b into a single reformate stream.

In some cases (e.g., during the start-up mode, the pre-operation mode, or the operation mode), the heat exchanger 106 transfers heat from the first reformate stream 120a and/or the second reformate stream 120b to the NH₃ stream 104.

As shown in FIG. 18, in some cases, the NH₃ stream 104 is directed to the combustion-heated reformer 108 through the heat exchanger 106 (e.g., which may be arranged in parallel fluid communication with the electrically heated reformer 110). As such, the NH₃ stream 104 may bypass (i.e., not pass through) the electrically heated reformer 110.

In some cases, the bypassing of the E-reformer 110 is initiated after or during implementation of the pre-operation mode or the operation mode. Bypassing the electrically heated reformer 110 may advantageously avoid a pressure drop of the NH₃ stream 104 (since the electrically heated reformer 110 may be relatively small and therefore not appropriately sized for the increased second flowrate of the NH₃ stream 104). In some cases, the FCUs 517a and/or 517b is controlled so that the NH₃ stream 104 is directed to the heat exchanger 106 and then to the combustion-heated reformer 108. In some cases, the FCUs 517a and/or 517b may be controlled so that all of the NH₃ stream 104 is directed to the heat exchanger 106 (through the FCU 517a) and then to the combustion-heated reformer 108, and none of the NH₃ stream 104 is directed to the electrically heated reformer 110 (through the FCU 517b). In some cases, the FCUs 517a and/or 517b are controlled so that a first part of the NH₃ stream 104 is directed to the heat exchanger 106 (through the FCU 517a) and then to the combustion-heated reformer 108, and a second part of the NH₃ stream 104 is directed to the electrically heated reformer 110 (through the FCU 517b). In some cases, the FCUs 517a-b comprise a single FCU (for example, a three-way valve). In some cases, the FCUs 517a-b comprise more than two FCUs.

In some cases, the power supplied to the electrical heater 111 may be reduced (for example, after or during the heating of the combustion-heated reformer 108 to the second target temperature range). The NH₃ stream 104 may be utilized to cool the electrically heated reformer 110 after reducing the power supplied to the electrical heater 111 (since the NH₃ stream 104 is relatively cold compared to the heated E-reformer 110, and the NH₃ reforming reaction in the E-reformer 110 is endothermic, i.e., energy absorbing). In some cases, a first part of the NH₃ stream 104 (e.g., about 4% of the operating flowrate) is directed to the electrically heated reformer 110 (to cool down the E-reformer 110) and a second part of the NH₃ stream 104 (e.g., about 6% of the operating flowrate) is directed to the C-reformer 108. In some cases, the reformate generated by reforming the first part of the NH₃ stream 104 and the second part of the NH₃ stream 104 may be combined into the second reformate stream 120b.

In some cases, reforming at least part (or all) of the NH₃ stream 104 in the electrically heated reformer 110 is ceased (for example, after or during the heating of the combustion-heated reformer 108 to the second target temperature range). In some cases, the FCUs 517a-b are controlled to direct none (or a negligible amount) of the NH₃ stream 104 to the electrically heated reformer 110 (thereby ceasing the reforming of the NH₃ stream 104 in the E-reformer 110). In some cases, the reforming of the NH₃ stream 104 in the electrically heated reformer 110 is ceased after a measured temperature of the electrically heated reformer 110 is less than or equal to a threshold temperature (e.g., about 300° C.). The threshold temperature may be less than the first target temperature range (for example, less than the lower limit of the first target temperature range).

In some cases, the first reformate stream 120a and/or the second reformate stream 120b are provided to an ammonia oxidation catalyst (e.g., the SAO catalyst 506 described elsewhere) to reduce residual ammonia in the first reformate stream 120a and/or the second reformate stream 120b. The ammonia oxidation catalyst may fluidically communicate with the reformer(s) 108-110 and the combustion heater 109 (and therefore may be positioned, e.g., at a point along the fluid line between the reformer(s) 108-110 and the combustion heater 109). In some cases, the ammonia oxidation catalyst is positioned in or at the heat exchanger 106, and the heat of the oxidation reaction may be provided to the NH₃ stream 104 to further heat (vaporize) the NH₃ stream 104. In some cases, the first reformate stream 120a and/or the second reformate stream 120b are directed to the NH₃ filter 122 after passing the ammonia oxidation catalyst. In some cases, the first reformate stream 120a and/or the second reformate stream 120b bypass the NH₃ filter 122 after passing the ammonia oxidation catalyst.

In some cases, the second flowrate of the NH₃ stream 104 is greater than about 5, 10, about 15, about 20, about 25, about 30, about 35, about 40, or about 45% of the operating flowrate and less than about 10, about 15, about 20, about 25, about 30, about 35, about 40, about 45, or about 50% of the operating flowrate. However, the present disclosure is not limited thereto, and the second flowrate may be any percentage of the operating flowrate.

In some cases, the second flowrate of the NH₃ stream 104 is increased (e.g., from about 10% of the operating flowrate to about 25% of the operating flowrate) or decreased. In some cases, the second flowrate of the NH₃ stream 104 is increased or decreased at a constant rate (e.g., about 0.1% of the operating flowrate per second). In some cases, the second flowrate of the NH₃ stream 104 is increased or decreased at a variable rate (e.g., about 0.5% of the operating flowrate per second, then about 0.3% of the operating flowrate per second, then about 0.1% of the operating flowrate per second, etc.).

In some cases, the second flowrate of the NH₃ stream 104 is increased to a threshold flowrate (e.g., about 25% of the operating flowrate). In some cases, based on the second flowrate reaching the threshold flowrate, the second flowrate is increased to the operating flowrate (e.g., about 100% of the operating flowrate, thus transitioning from the pre-operation mode to the operation mode). In some cases, the second flowrate is increased to the operating flowrate based on an increased demand (e.g., electrical demand, mechanical demand, hydrogen demand, etc.) of the H₂ processing module (for example, in response to starting the H₂ processing module).

### Operation Mode

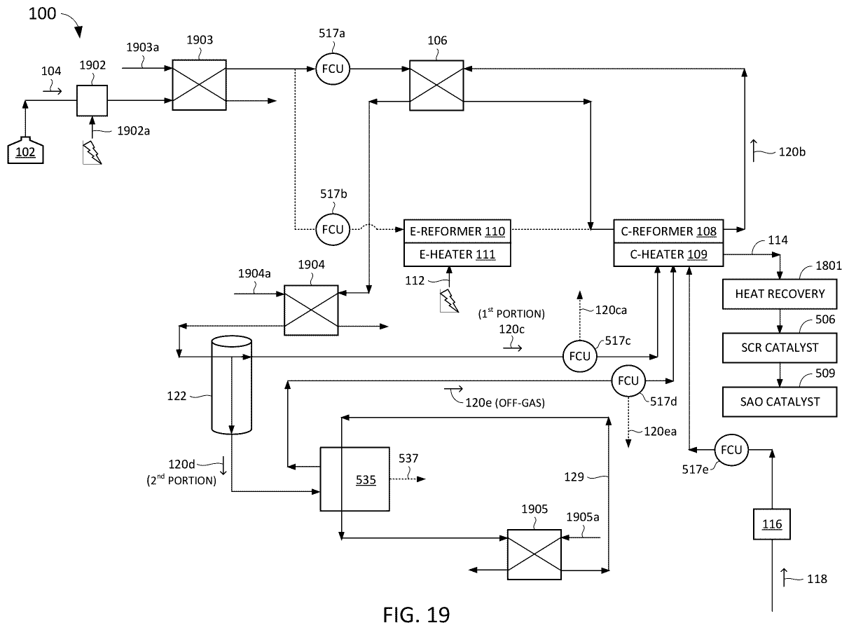

FIG. 19 illustrates an example configuration of the system 100 implementing the operation mode.

In some cases, transitioning the pre-operation mode to the operation mode, at least part of the second reformate stream 120b (e.g., at the second flow rate of about 25% of the operating flow rate) may be directed to the hydrogen processing module 535. The second flowrate may be increased to the operating flowrate (e.g., about 25% to about 100% of the operating flowrate) after or during the implementation of the operation mode. In some cases, a first portion 120c of the second reformate stream 120b is directed to the combustion heater 109 to control (i.e., maintain or change) the temperature of the C-reformer 108 (and the catalyst therein) within the second target temperature range.

A second portion 120d of the second reformate stream 120d may be directed to the H₂ processing module 535 to generate an output 537. In some cases, the H₂ processing module 535 comprises a fuel cell configured to generate electricity 537. In some cases, the H₂ processing module 535 comprises a combustion engine (e.g., a reciprocating piston engine or a gas turbine) configured to generate mechanical work 537 (or electricity 537). In some cases, the H₂ processing module 535 comprises a metal ore reducer configured to process a metal ore (e.g., iron ore or aluminum ore) and output a reduced metal 537 (e.g., iron or aluminum). In some cases, the H₂ processing module 535 comprises a hydrogen storage tank configured to store and output hydrogen 537. In some cases, the H₂ processing module 535 comprises a hydrogen pipeline configured to transport hydrogen 537. In some cases, an N₂ separation module (e.g., a membrane device, a pressure swing adsorption (PSA) device, etc.) is configured to remove N₂ from the second portion 120d before the second portion 120d is directed to the H₂ processing module 535.

At least part of the second portion 120d may be processed by the H₂ processing module 535 to generate the output 537. In some cases, an off-gas 120e (i.e., the remaining or leftover part of the second portion 120d directed to the H₂ processing module 535) comprising at least hydrogen is directed from the H₂ processing module 535 to the combustion heater 109 and combusted to control (i.e., maintain or change) the temperature of the combustion-heated reformer 108 (and the catalyst therein) within the second target temperature range. In this way, both the first portion 120c and the off-gas 120e may be combusted in the combustion heater 109 to control the temperature of the combustion-heated reformer 108 within the second target temperature range. The first portion 120c of the second reformate stream 120b may be directed to the combustion heater 109 upstream of the H₂ processing module 535 (for example, after the second reformate stream 120b is directed through the NH₃ filter 122).

In some cases, at least part of the first portion 120c and at least part of the off-gas 120e are provided to the C-heater 109 simultaneously. In some cases, at least part of the first portion 120c (for example, the part 120ca) and/or at least part of the off-gas 120e (for example, the part 120ea) is not provided to the combustion heater 109 (and may instead be vented, flared, stored in a tank, or directed to a separate H₂ processing module), and the remaining part of the first portion 120c and/or the remaining part of the off-gas 120e is provided to the combustion heater 109. In some cases, the FCUs 517c and/or 517d are controlled to direct the first portion 120c, the part 120ca, the off-gas 120e, and/or the part 120ea to the C-heater 109 (or elsewhere). In some cases, the FCUs 517c-d comprise a single FCU (e.g., three-way valve). In some cases, the FCUs 517c-d comprise more than two FCUs.

In some cases, FCUs 517c-e are controlled (e.g., using a controller) manually or automatically to control (i.e., maintain or change) the temperature of the combustion-heated reformer 108 within the second target temperature range. For example, the FCUs 517c-e may control quantities (e.g., flow rate in terms of volume per unit time, or moles per unit time) of the first portion 120c, the off-gas 120e and/or the air stream 118 provided to the combustion heater 109. The quantities may be controlled to achieve stoichiometric, fuel-rich, and/or fuel-lean combustion in the combustion heater 109 (e.g., by modulating the ratio of H₂ to O₂ supplied for the combustion reaction) and control (i.e., maintain or change) the temperature of the combustion-heated reformer 108 within the second target temperature range.

An H₂ utilization rate of the H₂ processing module 535 may be construed as a percentage of the hydrogen in the second portion 120d provided to the H₂ processing module 535 that is processed by the H₂ processing module 535 to generate the output 537. For example, if the H₂ utilization rate is about 75%, then about 75% of the hydrogen in the second portion 120d is processed by the H₂ processing module 535, and the remaining 25% of the hydrogen in the second portion 120d is directed as the off-gas 120e.

The H₂ utilization rate of the H₂ processing module may be greater than about 1, about 5, about 10, about 15, about 20, about 25, about 30, about 35, about 40, about 45, about 50, about 55, about 60, about 65, about 70, about 75, about 80, about 85, about 90, about 95% of the H₂ in the second portion 120d, and may be less than about 5, about 10, about 15, about 20, about 25, about 30, about 35, about 40, about 45, about 50, about 55, about 60, about 65, about 70, about 75, about 80, about 85, about 90, about 95, or about 100% of the H₂ in the second portion 120d. In some cases, the H₂ utilization rate of the H₂ processing module 535 is constant within a tolerance (i.e., within a variation that produces an equivalent result), and the first portion 120c is modulated to control a temperature in the combustion-heated reformer 108. The tolerance may comprise about 1, about 2, about 3, about 4, about 5, about 6, about 7, about 9, or about 10% of the H₂ utilization rate.

An H₂ consumption rate of the H₂ processing module 535 may be construed as the quantity of H₂ in the second portion 120d consumed or processed by the H₂ processing module 535 per unit time (for example, volume of H₂ per unit time or moles of H₂ per unit time). The H₂ consumption rate may be greater than about 1, about 5, about 10, about 20, about 30, about 40, about 50, about 60, about 70, about 80, about 90, about 100, about 200, about 300, about 400, about 500, about 600, about 700, about 800, about 900, about 1000, about 2000, about 3000, about 4000, about 5000, about 6000, about 7000, about 8000, or about 9000 standard liters of H₂ per minute, and less than about 5, about 10, about 20, about 30, about 40, about 50, about 60, about 70, about 80, about 90, about 100, about 200, about 300, about 400, about 500, about 600, about 700, about 800, about 900, about 1000, about 2000, about 3000, about 4000, about 5000, about 6000, about 7000, about 8000, about 9000, or about 10000 standard liters of H₂ per minute. However, the present disclosure is not limited thereto, and the H₂ consumption rate may be any quantity of H₂ per unit time. In some cases, the H₂ consumption rate is constant within a tolerance (i.e., within a variation that produces an equivalent result), and the first portion 120c is modulated to control a temperature of the combustion-heated reformer 108. The tolerance may comprise about 1, about 2, about 3, about 4, about 5, about 6, about 7, about 9 or about 10% of the H₂ consumption rate.

The operating flowrate of the NH₃ stream 104 may be chosen (e.g., selected, defined, and/or predefined) within a range of operating flowrates. In some cases, the operating flowrate is chosen manually (for example, by a user using a controller with an input device, such as a keyboard, mouse, touchpad and/or monitor). In some cases, the operating flowrate is chosen automatically (for example, based on a change in a temperature or pressure in the reformer(s) 108-100, or based on a H₂ demand of the H₂ processing module 535).

In some cases, the operating flowrate of the NH₃ stream 104 may be greater than about 1, about 2, about 3, about 4, about 5, about 6, 7, about 8, about 9, about 10, about 15, about 20, about 25, about 30, about 35, about 40, about 45, about 50, about 55, about 60, about 65, about 70, about 75, about 80, about 85, about 90, about 95, about 100, about 125, about 150, about 175, about 200, about 225, about 250, about 275, about 300, about 325, about 350, about 375, about 400, about 425, about 450, about 475, about 500, about 550, about 600, about 650, about 700, about 750, about 800, about 850, about 900, about 1000, about 2000, about 3000, about 4000, about 5000, about 6000, about 7000, about 8000, or about 9000 standard liters of NH₃ per min, and less than about 2, about 3, about 4, about 5, about 6,7, about 8, about 9, about 10, about 15, about 20, about 25, about 30, about 35, about 40, about 45, about 50, about 55, about 60, about 65, about 70, about 75, about 80, about 85, about 90, about 95, about 100, about 125, about 150, about 175, about 200, about 225, about 250, about 275, about 300, about 325, about 350, about 375, about 400, about 425, about 450, about 475, about 500, about 550, about 600, about 650, about 700, about 750, about 800, about 850, about 900, about 950, about 1000, about 2000, about 3000, about 4000, about 5000, about 6000, about 7000, about 8000, about 9000, or 10000 standard liters NH₃ per min. However, the present disclosure is not limited thereto, and the operating flowrate of the NH₃ stream 104 may be chosen to be any flowrate of NH₃ per unit of time.

In some cases, the operating flowrate of the NH₃ stream 104 is chosen (i.e., changed) based on an increase in H₂ demand of the H₂ processing module 525 configured to process H₂. For example, if the H₂ processing module 525 is configured to generate electricity 537, the operating flowrate may be changed based on an increase (or projected increase) in electrical load connected to the H₂ processing module 535. If the H₂ processing module 525 is configured to generate mechanical work 537, the operating flowrate may be changed based on an increase (or projected increase) in mechanical load connected to the H₂ processing module 535.

In some cases, the operating flowrate of the NH₃ stream 104 is chosen at least in part based on a H₂ processing capacity of the H₂ processing module 535. For example, the H₂ processing module 535 may be capable of processing a maximum amount of H₂ in the second portion 120d (such that exceeding the H₂ processing capacity may damage the H₂ processing module 535 due to overvoltage, thermal stress, mechanical stress, etc.), and thus the output 537 may be limited to a maximum output (e.g., maximum electricity output, maximum mechanical work output, etc.). As such, the operating flowrate of the NH₃ stream 104 may be chosen so that the generated hydrogen in the second portion 120d does not exceed the H₂ processing capacity of the H₂ processing module 535. In some cases, the operating flowrate of the NH₃ stream 104 is chosen so that the hydrogen generated by the reformer(s) 108-110 comprises greater than about 1, about 5, about 10, about 15, about 20, about 25, about 30, about 35, about 40, about 45, about 50, about 55, about 60, about 65, about 70, about 75, about 80, about 85, about 90, about 95, about 100, about 110, about 120, about 130, or about 140% of the H₂ processing capacity of the H₂ processing module 535, and less than about 5, about 10, about 15, about 20, about 25, about 30, about 35, about 40, about 45, about 50, about 55, about 60, about 65, about 70, about 75, about 80, about 85, about 90, about 95, about 100, about 110, about 120, about 130, about 140, or about 150% of the H₂ processing capacity of the H₂ processing module 535.

In some cases, the operating flowrate of the NH₃ stream 104 is chosen at least in part based on a NH₃ reforming capacity of the combustion-heated reformer 108 and/or the electrically heated reformer 110. For example, the combustion-heated reformer 108 and/or the electrically heated reformer 110 may be capable of reforming a maximum amount of NH₃ (such that exceeding the NH₃ reforming processing capacity damages the combustion-heated reformer 108 and/or the electrically heated reformer 110 due to thermal stress, mechanical stress, etc., and/or reduces the ammonia conversion efficiency below a target conversion efficiency, e.g., 99% conversion efficiency), and thus the generated H₂ may be limited to a maximum amount of generated H₂. As such, the operating flowrate of the NH₃ stream 104 may be chosen to not exceed the NH₃ reforming capacity of the combustion-heated reformer 108 and/or the electrically heated reformer 110. In some cases, the operating flowrate of the NH₃ stream 104 is chosen to be greater than about 1, about 5, about 10, about 15, about 20, about 25, about 30, about 35, about 40, about 45, about 50, about 55, about 60, about 65, about 70, about 75, about 80, about 85, about 90, or about 95% of the NH₃ reforming capacity of the combustion-heated reformer 108 and/or the electrically heated reformer 110, and less than about 5, about 10, about 15, about 20, about 25, about 30, about 35, about 40, about 45, about 50, about 55, about 60, about 65, about 70, about 75, about 80, about 85, about 90, about 95, or about 100% of the NH₃ reforming capacity of the combustion-heated reformer 108 and/or the electrically heated reformer 110.

For any of the embodiments described herein (for example, during the startup mode, pre-operation mode, or operation mode), the combustion in the combustion heater 109 may be fuel-rich (i.e., air-lean with a stoichiometric excess of hydrogen), or fuel-lean (i.e., air-rich with a stoichiometric excess of air).

In some cases, the NH₃ filter 122 is regenerated during the startup mode, pre-operation mode, or operation mode. The regeneration of the NH₃ filter 122 may release the NH₃ filtered by the NH₃ filter 122. In some cases, the released NH₃ is directed to the combustion heater 109, a selective ammonia oxidation catalyst, or an NH₃ scrubber.

### Single Reformer

The electrically heated reformer 110 (e.g., first reformer) and the combustion-heated reformer 108 (e.g., second reformer) may be a single reformer 108-110 (e.g., hybrid reformer). For example, the single reformer 108-110 may comprise a single housing (vessel) with NH₃ reforming catalyst positioned therein. The single reformer (and the NH₃ reforming catalyst therein) may be in thermal communication with the electrical heater 111 and/or the combustion heater 109.

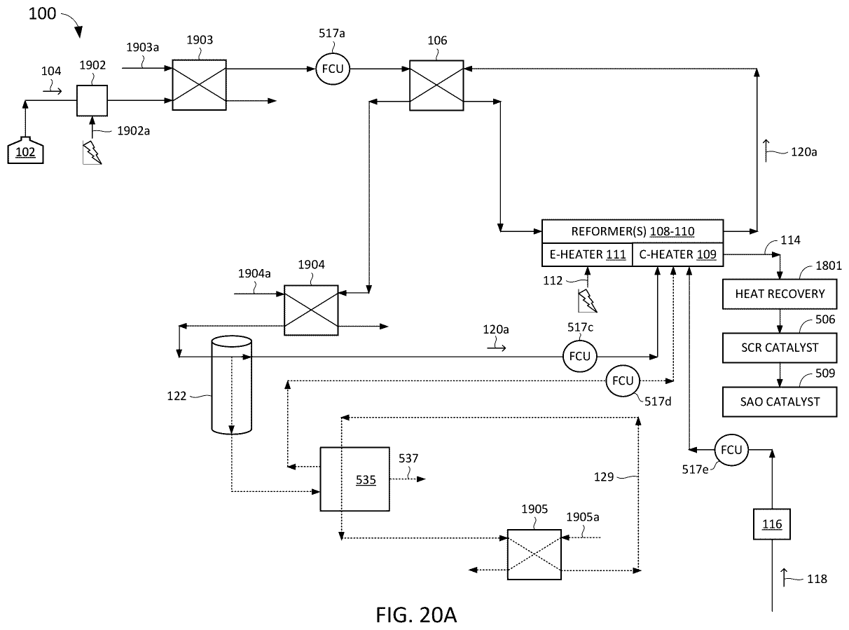

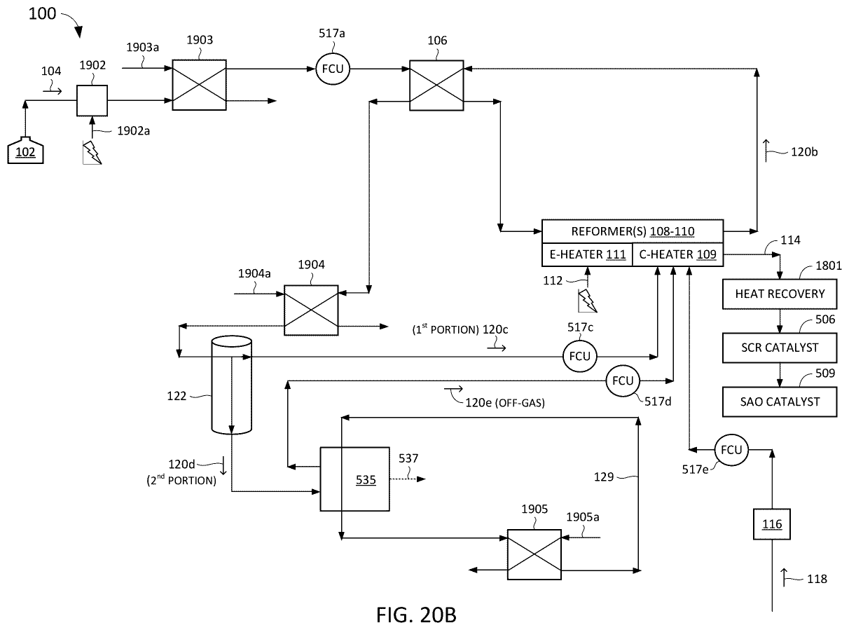

FIG. 20A illustrates an example configuration of the system 100 implementing the startup mode using a single reformer 108-110 (e.g., a hybrid reformer that is heated by both electrical heating and combustion heating) such that the NH₃ stream 104 is reformed in the single reformer 108-110 at the first flowrate (e.g., about 4% of the operating flowrate). FIG. 20B illustrates an example configuration of the system 100 implementing the operation mode using the single reformer 108-110 such that the NH₃ stream 104 is reformed in the single reformer 108-110 at the operating flowrate (e.g., about 100% of the operating flowrate). Regarding the pre-operation mode using the single reformer 108-110, it is contemplated the first flowrate of the NH₃ stream 104 may be increased to the second flowrate (as described with respect to FIG. 18) such that the NH₃ stream 104 is reformed in the single reformer 108-110 at the second flowrate.

In some cases, the NH₃ reforming catalyst is heated to a target temperature range (e.g., the first target temperature range and/or the second target temperature range). In some cases, the NH₃ reforming catalyst is at the target temperature range (without being heated, e.g., by trapping heat generated at an earlier time using insulation).

In some cases, a first region of the NH₃ reforming catalyst is heated by the electrical heater 111, and a second region of the NH₃ reforming catalyst is heated by the combustion heater 109 (or vice versa). In some cases, a first region of the NH₃ reforming catalyst is heated to a first target temperature range, and a second region of the NH₃ reforming catalyst is heated to a second target temperature range. In some cases, the first target temperature range and the second target temperature range at least partially overlap. In some cases, the first target temperature range and the second target temperature range are different. In some cases, a midpoint temperature of the first target temperature range is greater than a midpoint temperature of the second target temperature range. In some cases, a midpoint temperature of the first target temperature range is lower than a midpoint temperature of the second target temperature range. In some cases, a lower limit of the first target temperature range is greater than a lower limit of the second target temperature range. In some cases, an upper limit of the first target temperature range is greater than an upper limit of the second target temperature range. In some cases, a lower limit of the first target temperature range is lower than a lower limit of the second target temperature range. In some cases, an upper limit of the first target temperature range is lower than an upper limit of the second target temperature range.

In some cases, a first region of the NH₃ reforming catalyst is in the electrically heated reformer 110, and a second region of the NH₃ reforming catalyst is in the combustion reformer 108 (where the E-reformer 110 and C-reformer 108 are separate reformers).

### Heat Transfer

As shown in FIGS. 17A-20B, heat exchangers 1903, 1904, and 1905 may be configured to transfer heat from relatively hot components to relatively cold components. In some cases, a heat transfer fluid (i.e., intermediate fluid) is used to transfer the heat. The heat transfer fluid may comprise water, propylene glycol (PG), ethylene glycol (EG), other heat transfer fluid(s), and/or mixtures thereof.

In some cases, the heat exchanger 1903 is used to transfer heat from (1) a fluid 1903a to (2) the NH₃ stream 104 (for example, to further vaporize and/or preheat the NH₃ stream 104 in addition to the electric heater 1902 and/or the heat exchanger 106). The fluid 1903a may comprise the first reformate stream 120a and/or the second reformate stream 120b. In some cases, the fluid 1903a is a heat transfer fluid that transfers heat from (1) the first reformate stream 120a, the second reformate stream 120b, the H₂ processing module 535, and/or an environment source (e.g., air, freshwater, and/or seawater) to (2) the NH₃ stream 104.

In some cases, the heat exchanger 1904 may be used to transfer heat from (1) a fluid 1904a to (2) to the first reformate stream 120a and/or the second reformate stream 120b (for example, to cool the first reformate stream 120a and/or the second reformate stream 120b in addition to the heat exchanger 106). The fluid 1904a may comprise the NH₃ stream 104 and/or the environment source. In some cases, the fluid 1904a is a heat transfer fluid that transfers heat from (1) the NH₃ stream 104 and/or the environment source (e.g., air, freshwater, and/or seawater) to (2) to the first reformate stream 120a and/or the second reformate stream 120b.

In some cases, the heat exchanger 1905 may be used to transfer heat from (1) the H₂ processing module 535 to (2) a fluid 1905a (for example, to cool the H₂ processing module 535). In some cases, an intermediate fluid 129 (that passes by or through the H₂ processing module 535 to absorb heat from the H₂ processing module 535) is used to transfer heat to the fluid 1905a. In some cases, the fluid 1905a is a heat transfer fluid that transfers heat from (1) the H₂ processing module 535 to (2) the NH₃ stream 104 and/or the environment source.

It is contemplated that a single heat transfer fluid may be used to heat and cool several components. For example, the fluid 1903a, the fluid 1904a, and/or the fluid 1905a may comprise a single heat transfer fluid (such that the single heat transfer fluid circulates between the heat exchanger 1903, the heat exchanger 1904, and/or the heat exchanger 1905). In some cases, the single heat exchanger fluid is used to transfer heat from (1) the H₂ processing module 535, the first reformate stream 120a, and/or the second reformate stream 120b to (2) the environment source and/or the NH₃ stream 104.

### Ammonia Reforming Methods

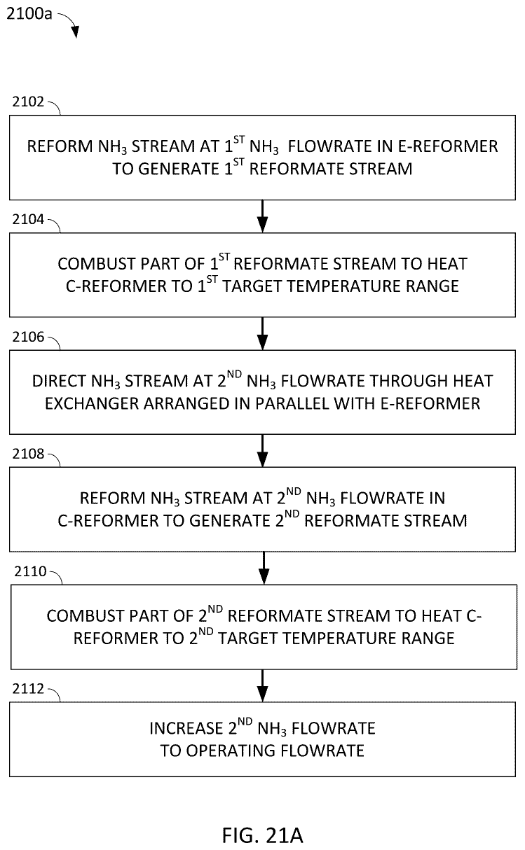

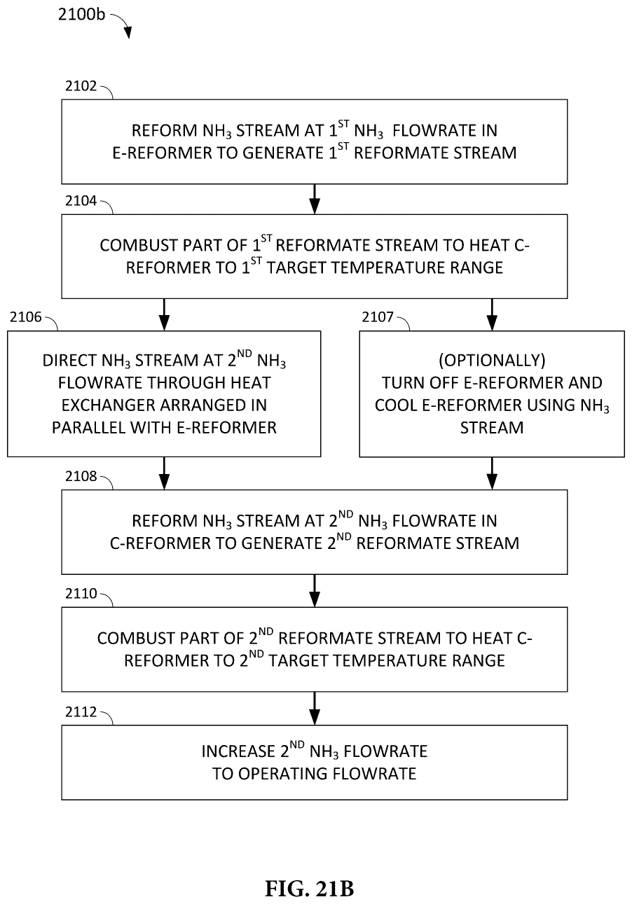

FIG. 21A is an example flow chart illustrating an ammonia reforming method 2100a implementing the startup mode, the pre-operation mode, and the operation mode.

At step 2102, an NH₃ stream may be reformed at a first flowrate (e.g., about 4% of an operating flowrate) in a first reformer (e.g., electrically heated reformer) to generate a first reformate stream. The first reformer may be at a first target temperature range (e.g., after the first reformer and the NH₃ reforming catalyst therein is heated using an electrical heater).

At step 2104, at least part of the first reformate stream (e.g., a portion or all of the first reformate stream) may be combusted to heat a second reformer (e.g., combustion-heated reformer) and the NH₃ reforming catalyst therein to a second target temperature range.

At step 2106, optionally, the NH₃ stream may be directed at a second flowrate through a heat exchanger arranged in parallel fluid communication with the first reformer.

At step 2108, the NH₃ stream may be reformed at the second flowrate (e.g., about 10% of the operating flowrate) in the second reformer to generate a second reformate stream.

At step 2110, at least part of the second reformate stream (e.g., a portion or all of the second reformate stream) may be combusted to heat the second reformer (e.g., to control a temperature of the second reformer within the second target temperature range).

At step 2112, the second flowrate may be increased to the operating flowrate (e.g., about 100% of the operating flowrate).

After step 2108, 2110, or 2112, at least part of the second reformate stream may be directed to an H₂ processing module. At least part of an off-gas from the H₂ processing module may then be directed to the combustion heater 109.

FIG. 21B is an example flow chart illustrating an ammonia reforming method 2100b which may be substantially similar to the method 2100a. However, optionally, at step 2107 (which may occur after or simultaneously with step 2104 or step 2106), the heating of the first reformer may be reduced or turned off (for example, by reducing the power supplied to an electrical heater). The NH₃ stream may then be utilized to cool the first reformer. In some cases, a first part of the NH₃ stream (e.g., about 4% of the operating flowrate) is directed to the first reformer (to cool down the first reformer) and a second part of the NH₃ stream (e.g., about 6% of the operating flowrate) is directed to the second reformer. In some cases, the reformate generated by reforming the first part of the NH₃ stream and the second part of the NH₃ stream may be combined into the second reformate stream.

Extracting Water from Fuel Cell Exhaust

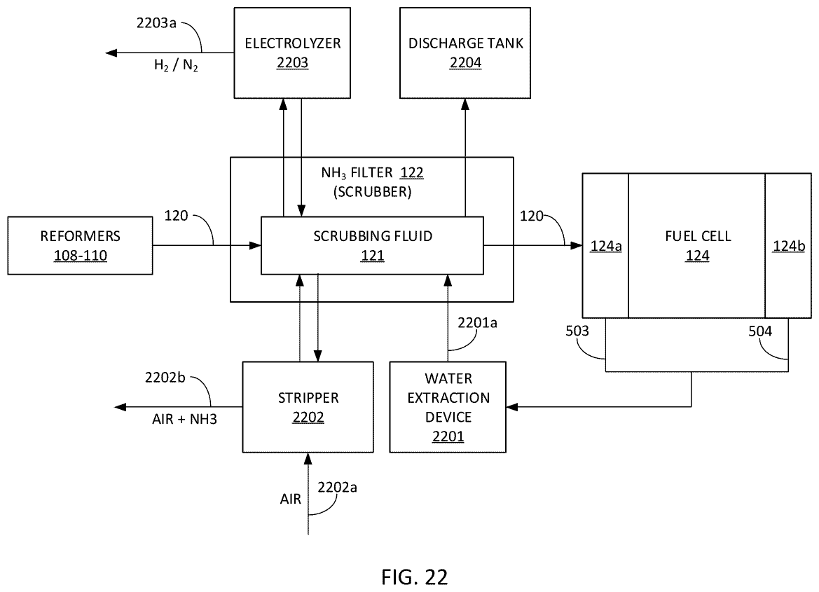

FIG. 22 is a block diagram illustrating an ammonia filter 122 configured to filter the reformate stream 120 using water 2201a extracted from the exhaust of the fuel cell 124, in accordance with one or more embodiments of the present disclosure.

A water extraction device 2201 may be configured to extract the water 2201a from the anode exhaust 503 (e.g., output from an anode 124a of the fuel cell 124) and/or the cathode exhaust 504 (e.g., output from a cathode 124b of the fuel cell 124). The water extraction device 2201 may comprise a water knockout vessel, a condenser, an adsorbent, and/or a separation membrane. In some cases, the water extraction device 2201 may be configured to extract the water 2201a from an exhaust of the H₂ processing module 535 (as described with respect to FIG. 6L). In some cases, the water extraction device 2201 may be configured to extract the water 2201a from an exhaust of a combustion engine. In some cases, a portion of the extracted water 2201a is used to humidify the anode 124a or the cathode 124b of the fuel cell 124. In some cases, a portion of the extracted water 2201a is provided to a combustion heater (e.g., the combustion heater 109), which may advantageously reduce a temperature of combustion therein.

The ammonia filter 122 (e.g., scrubber) may be configured to reduce a concentration of residual ammonia in the reformate stream 120 using a scrubbing fluid 121. The scrubbing fluid 121 may comprise at least some of the water 2201a extracted from the exhaust of the fuel cell 124. In some cases, the scrubbing fluid 121 comprises seawater or freshwater. In some cases, the scrubbing fluid 121 comprises an acid (for example, sulfuric acid or nitric acid). In some cases, the scrubbing fluid 121 comprises an organic acid. In some cases, at least about 1, about 5, about 10, about 15, about 20, about 25, about 30, about 35, about 40, about 45, about 50, about 55, about 60, about 65, about 70, about 75, about 80, about 85, about 90, or about 95% of the scrubbing fluid 121 is the extracted water 2201a, and at most about 5, about 10, about 15, about 20, about 25, about 30, about 35, about 40, about 45, about 50, about 55, about 60, about 65, about 70, about 75, about 80, about 85, about 90, about 95 or about 100% of the scrubbing fluid 121 is the extracted water 2201a.

The ammonia filter 122 may be configured to discharge the scrubbing fluid 121 (e.g., via an outlet port). In some cases, the ammonia filter 122 discharges the scrubbing fluid 121 to a discharge tank 2204. In some cases, the discharged scrubbing fluid 121 comprises at least about 1, about 5, about 10, about 15, about 20, about 25, about 30, about 35, about 40, about 45, about 50, or about 55% ammonia by weight, and at most about 5, about 10, about 15, about 20, about 25, about 30, about 35, about 40, about 45, about 50, about 55, or about 60% ammonia by weight. In some cases, at most about 1, about 2, about 3, about 4, about 5, about 6, about 7, about 8, about 9, or about 10% of the water 2201a extracted from the exhaust 503-504 is discharged externally.

In some cases, a stripper 2202 is used to regenerate the scrubbing fluid 121. The stripper 2202 may be configured to pass air 2202a through the scrubbing fluid 121, and a stream 2202b output from the stripper 2202 may comprise air, ammonia, and water. In some cases, the stream 2202b is provided to the combustion heater 109. In some cases, the stream 2202b is provided to an SAO catalyst. After the scrubbing fluid 121 is regenerated in the stripper 2202, the scrubbing fluid 121 may be provided (e.g., returned) to the NH₃ filter 122 (e.g., using a pump).

In some cases, an electrolyzer 2203 is used to regenerate the scrubbing fluid 121. The electrolyzer 2203 may be configured to pass an electric current through the scrubbing fluid 121, which decomposes ammonia in the scrubbing fluid and generates a stream 2203a comprising hydrogen and nitrogen. In some cases, the stream 2203a is provided to the combustion heater 109. In some cases, the stream 2203a is provided to the fuel cell 124. In some cases, the stream 2203a is combusted to heat a boiler or a heat transfer fluid. In some cases, the hydrogen is separated from the stream 2203a and stored in a hydrogen storage tank. After the scrubbing fluid 121 is regenerated using the electrolyzer 2203, the scrubbing fluid 121 may be provided (e.g., returned) to the NH₃ filter 122 (e.g., using a pump).

Using the extracted water 2201a as part of the scrubbing fluid 121 may advantageously reduce the burden of sourcing external water (e.g., freshwater or seawater) for the scrubbing fluid 121. Additionally, since the water in the exhaust of the fuel cell 124 may be contaminated with residual compounds (e.g., per- and polyfluoroalkyl substances (PFASs) which may be found in the polymer electrolyte membrane (PEM) of a fuel cell), using the extracted water 2201a as part of the scrubbing fluid 121 may advantageously avoid the discharge of contaminated water from the fuel cell 124 to the environment (which may harm living organisms and violate regulations).

### Multiple NH₃ Scrubbers

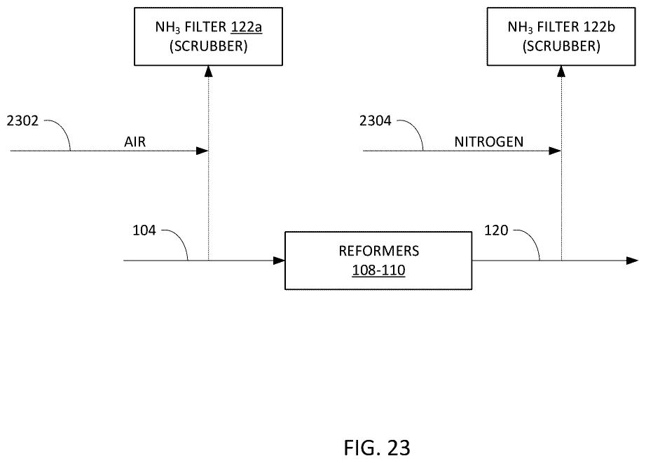

FIG. 23 is a block diagram illustrating various ammonia filters 122a-122b, in accordance with one or more embodiments of the present disclosure.

A first NH₃ filter 122a (e.g., scrubber) may be configured to reduce a concentration of ammonia in the ammonia stream 104 using a scrubbing fluid. The ammonia stream 104 may be provided to the first NH₃ filter 122a from a position between the storage tank 102 and the reformer(s) 108-110 (for maintenance, to relieve a pressure release valve, etc.). The position may be at one or more fluid lines that fluidically couple at least one of: (1) the ammonia storage tank 102 and the reformer(s) 108-110; (2) the ammonia storage tank 102 and a flow control unit 524; or (3) a flow control unit 524 and the reformer(s) 108-110.

In some cases, the ammonia stream 104 is diluted with air 2302 before being provided to the first NH₃ filter 122 (which may advantageously reduce ammonia emissions to the environment, for example, by diluting the ammonia to a concentration that is less than about 30 ppm at the point of release).

A second NH₃ filter 122b (e.g., scrubber) may be configured to reduce a concentration of residual ammonia in the reformate stream 120 using a scrubbing fluid. The reformate stream 120 may be provided to the second NH₃ filter 122b from a position between the reformer(s) 108-110 and the fuel cell 124. The position may be at one or more fluid lines that fluidically couple at least one of: (1) the reformer(s) 108-110 and the fuel cell 124; (2) the reformer(s) 108-110 and an adsorbent 122; (3) the adsorbent 122 and the fuel cell 124; (4) the reformer(s) 108-110 and a first flow control unit 524; (5) the first flow control unit 524 and the adsorbent 122; (6) the adsorbent 122 and a second flow control unit 524; or (7) the second flow control unit 524 and the fuel cell 124.

In some cases, the reformate stream 120 is diluted with nitrogen 2304 (or other inert gas) before being provided to the second NH₃ filter 122b (which may advantageously reduce the probability of hydrogen combustion in the reformate stream 120).

### Low-Carbon Sources of Heat

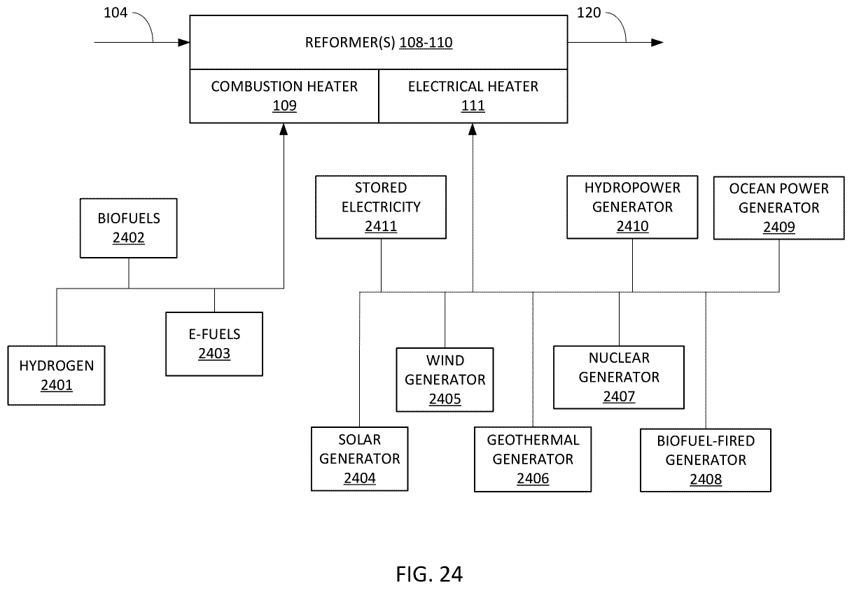

FIG. 24 is a block diagram illustrating various low-carbon (i.e., non-fossil) sources of heat 2401-2411 for the reformer(s) 108-110, in accordance with one or more embodiments of the present disclosure.

In some cases, a low-carbon chemical fuel may be combusted in the combustion heater 109 to heat the reformer(s) 108-110. For example, the low-carbon chemical fuel may comprise hydrogen 2401, biofuels 2402, and/or e-fuels 2403. The hydrogen 2401 may comprise green hydrogen (produced by electrolyzing water using renewable electricity), blue hydrogen (produced by capturing and storing CO₂ emissions from a methane reformer), turquoise hydrogen (produced by decomposing methane in a hot, inert atmosphere using renewable energy), white/gold hydrogen (produced by extracting hydrogen from a natural, sub-surface well), or pink hydrogen (produced by electrolyzing water using nuclear electricity). The biofuels 2402 may comprise biogas (e.g., biomethane, biopropane, biohydrogen, landfill gas, sewage gas, and/or digester gas), biosolids (e.g., wood chips), biomethanol, bioethanol and/or cellulose-derived biofuels. The e-fuels 2403 may comprise e-ammonia (e.g., produced using green hydrogen and a Haber-Bosch process powered by renewable electricity), e-methanol (e.g., produced using green hydrogen and carbon sourced from the atmosphere or a biological source), and other synthetic fuels.

In some cases, low-carbon electricity may be provided to the electric heater 111 to heat the reformer(s) 108-110 (for example, via a grid connection). The low carbon electricity may be provided from a solar generator 2404 (e.g., photovoltaic panels, or concentrated solar power), a wind generator 2405, a geothermal generator 2406, a nuclear generator 2407, a biofuel-fired generator 2408, an ocean/river power generator 2409 (e.g., wave power, tide power, or current power), a hydropower generator 2410 (e.g., hydroelectric dam), or stored electricity 2411 (e.g., batteries, capacitors, flywheels, pumped hydroelectric storage, compressed air storage, or thermal-electric storage). In some cases, process heat from a geothermal source or a nuclear source may be provided to the reformer(s) 108-110.

### Exothermic Reactions

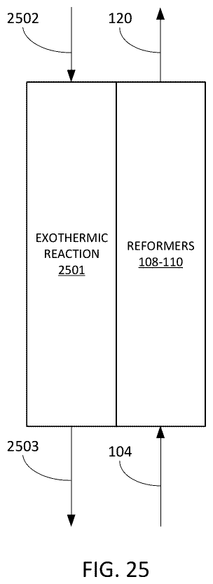

FIG. 25 is a block diagram illustrating the heating of ammonia reformer(s) 108-110 using an exothermic reaction 2501, in accordance with one or more embodiments of the present disclosure. In some cases, the exothermic reaction 2501 is not a combustion reaction. For example, the exothermic reaction 2501 may comprise a metal ore reduction process (iron ore reduction, aluminum ore reduction, etc.) which converts a metal ore 2502 into a reduced metal 2503 (e.g., sponge metal), or an oil hydrogenation process (e.g., cooking oil hydrogenation, hydrocracking, hydrotreating, desulfurization, oil upgrading, etc.) which converts an unhydrogenated oil 2502 into a hydrogenated oil 2503.

### High Hydrogen Utilization

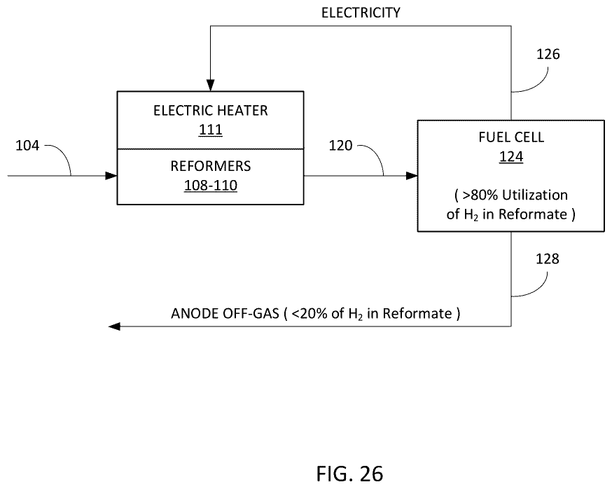

FIG. 26 is a block diagram illustrating the fuel cell 124 operating at a high hydrogen utilization rate, in accordance with one or more embodiments of the present disclosure. In some cases, the reformer(s) 108-110 may be heated without combustion (e.g., using only electricity provided by the fuel cell 126, a battery, and/or a grid connection). The fuel cell 124 may process at least about 80, about 85, about 90, or about 95% of the hydrogen in the reformate stream 120, and at most about 85, about 90, about 95, about 99, or about 100% of the hydrogen in the reformate stream 120.

A portion 128 of the hydrogen in the reformate stream 120 may not be utilized in the fuel cell 124 (for example, the anode off-gas). The nonutilized portion 128 may comprise less than about 20% of the hydrogen in the reformate stream 120. In some cases, the nonutilized portion 128 may comprise less than about 5, about 10, about 15, or about 20% of the hydrogen in the reformate stream 120. In some cases, the nonutilized portion 128 may comprise more than about 5, about 10, about 15, or about 20% of the hydrogen in the reformate stream 120. The nonutilized portion 128 of the hydrogen may be provided to a filter configured to remove water, ammonia, or a combination thereof. In some cases, the nonutilized portion 128 of the hydrogen is used to purge an ammonia filter (e.g., regenerate or desorb an adsorbent). In some cases, the non-utilized portion 128 of the hydrogen is combusted to heat the reformer(s) 108-110, an NH₃ filter (to desorb ammonia from the NH₃ filter, a water filter (to desorb water from the water filter), a water boiler, or a heat-transfer fluid. In some cases, the nonutilized portion 128 of the hydrogen is not provided to the fuel cell 124 (for example, the portion 128 may instead be diverted from the reformate stream 120 at a point upstream of the fuel cell 124).

### Scrubber to Preserve Adsorbent Capacity

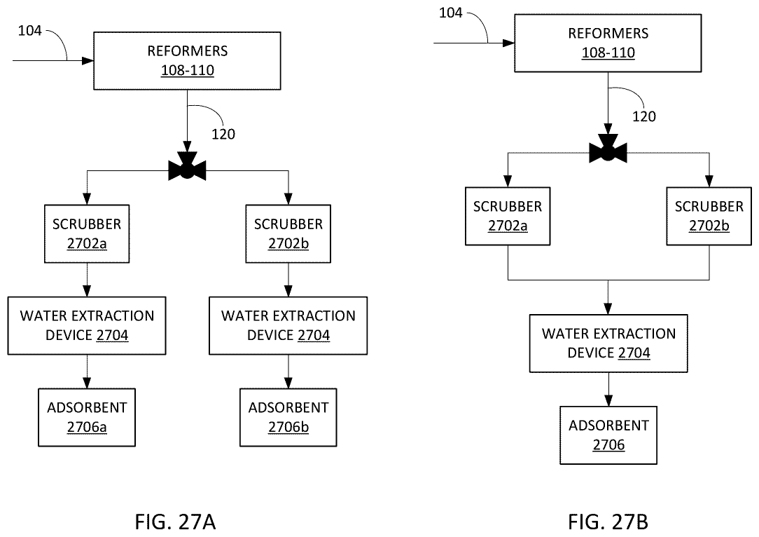

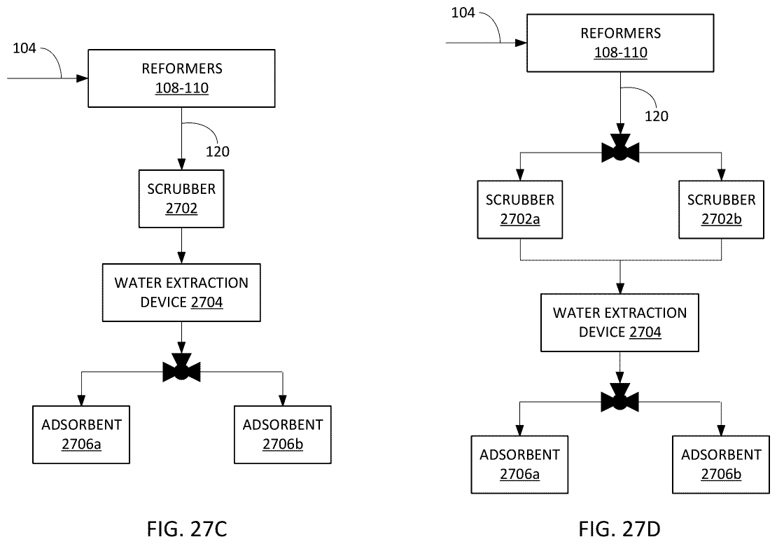

FIGS. 27A-27D are block diagrams illustrating the usage of scrubber(s) 2702 to remove residual ammonia from the reformate stream 120 and thus conserve the ammonia adsorption capacity of adsorbent(s) 2706, in accordance with one or more embodiments of the present disclosure. The scrubber(s) 2702 may be substantially similar or substantially identical to similarly named components described elsewhere in the present disclosure, and may include a scrubbing fluid therein. The adsorbent(s) 2706 may be substantially similar or substantially identical to similarly named components described elsewhere in the present disclosure, and may include an adsorbent material therein.

The reformate stream 120 output by the scrubber(s) 2702 may be humidified (e.g., greater than 50% relative humidity). This humidity may decrease the adsorption capacity of the adsorbent(s) 2706. For this or other reasons, water extraction device(s) 2704 may be used to remove water from the reformate stream 120. The water extraction device(s) 2704 may comprise a chiller (e.g., condenser), a membrane, or a combination thereof.

As shown in FIG. 27A, a first scrubber 2702a and a second scrubber 2702b may be arranged in parallel fluidic communication. After passing the respective scrubber 2702a-b, the reformate stream 120 may be provided to a respective adsorbent 2706a-b. The first scrubber 2702a may be configured to operate while the second scrubber 2702b is not operating (and vice versa). After the first scrubber 2702a reaches or exceeds a threshold ammonia absorption capacity, the first scrubber 2702a may stop removing the residual ammonia from the reformate stream 120, and the second scrubber 2702b may start removing the residual ammonia from the reformate stream 120 (for example, by modulating a valve to direct the reformate stream to the second scrubber 2702b). In this way, at least one of the scrubbers 2702a-b may be operating at all times (without waiting to regenerate the scrubbing fluid).

As shown in FIG. 27B, in some cases, after the residual ammonia is removed from the reformate stream 120 using the first scrubber 2702a or the second scrubber 2702b (arranged in parallel fluidic communication), the reformate stream 120 may be provided to a water extraction device 2704 and an adsorbent 2706.

As shown in FIG. 27C, in some cases, a single scrubber 2702 may be used to remove the residual ammonia from the reformate stream 120, and a single water extraction device 2704 may be used to remove water from the reformate stream 120 after the reformate stream 120 exits the scrubber 2702. The first adsorbent 2706a and the second adsorbent 2706b may be arranged in parallel fluidic communication. The first adsorbent 2706a may be configured to operate while the second adsorbent 2706b is not operating (and vice versa). After the first adsorbent 2706a reaches or exceeds a threshold ammonia adsorption capacity, the first adsorbent 2706a may stop removing the residual ammonia from the reformate stream 120, and the second adsorbent 2706b may start removing the residual ammonia from the reformate stream 120 (for example, by modulating a valve to direct the reformate stream to the second adsorbent 2706b). In this way, at least one of the adsorbents 2706a-b may be operating at all times (without waiting to regenerate the adsorbent material).

As shown in FIG. 27D, in some cases, the scrubbers 2702a-b may be arranged in parallel fluid communication. The reformate stream 120 output by the scrubbers 2702a-b may be provided to one or more water extraction devices 2704. After water is removed from the reformate stream 120, the reformate stream 120 may be provided to the adsorbents 2706a-b arranged in parallel fluid communication.

In some cases, the adsorbents 2706a-b may selectively or preferably adsorb ammonia over water. In such cases, the water extraction device 2704 may not be required. In some cases, the adsorbents 2706a-b are temperature swing adsorption (TSA) module(s) that cycle between adsorption and desorption (e.g., regeneration by increasing the temperature of the adsorbent material). In some cases, ammonia that is desorbed from the TSA module(s) may be provided to the scrubber 2702 to dispose the ammonia that is desorbed from the TSA module(s).

### PFAS Filter

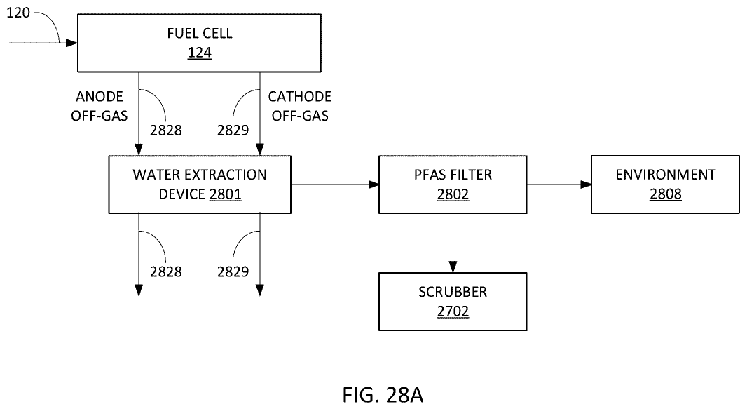

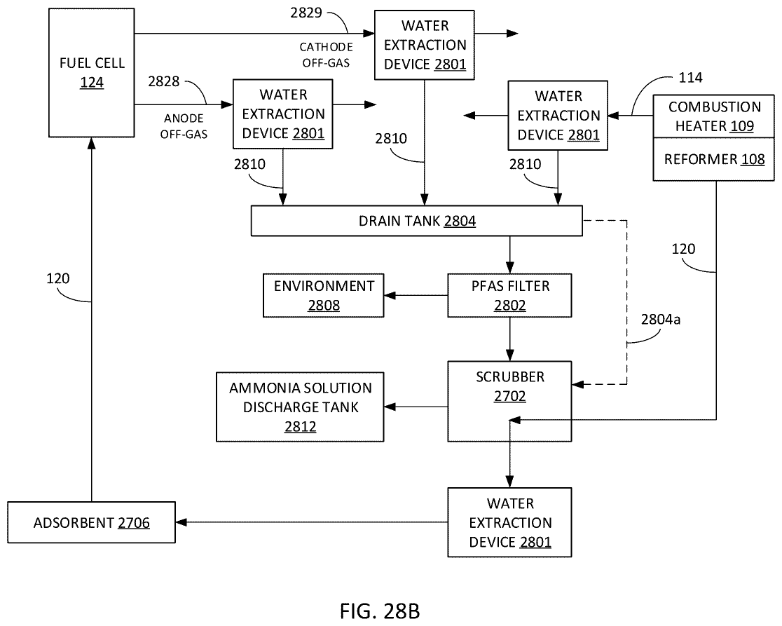

FIGS. 28A-28B are block diagrams illustrating the usage of a perfluorinated and polyfluorinated substance (PFAS) filter to remove PFAS from water extracted from fuel cell exhaust, in accordance with one or more embodiments of the present disclosure. Due to the nature of PFAS chemical bonding, PFAS substances are difficult to decompose. Because some PFAS chemicals pose health risks to living organisms, it may be desirable to remove PFAS from contaminated water.

As shown in FIG. 28A, the fuel cell 124 may output an anode off-gas 2828 and a cathode off-gas 2829, both of which may include a substantial amount of water (e.g., vapor) that is contaminated by PFAS (which may originate from the polymer electrolyte membrane of the fuel cell 124). For example, the PFAS may comprise perfluorosulfonic acid-based materials (e.g., NAFION), sulfonated perfluoropolyether-based materials, perfluoroionomer acid-based materials, etc.

A water extraction device 2801 (which may be a chiller/condenser, a membrane, or a combination thereof) may be used to extract water from the anode off-gas 2828 and/or the cathode off-gas 2829. The extracted water may then be provided to a PFAS filter 2802 to remove PFAS from the extracted water. In some cases, if the concentration of PFAS is below a threshold (for example, <100 ppt), the filtered water may be discharged into the environment 2808 (or another location that is external to the ammonia reforming system 100). In some cases, the filtered water is provided to one or more scrubber(s) 2702.

The PFAS filter 2802 may comprise an activated carbon (AC) filter (which may use activated carbon to adsorb PFAS), a granular activated carbon (GAC) filter (which may include carbon particles with a high surface area that can adsorb PFAS), a reverse osmosis (RO) filter (which may be configured to force water through a semipermeable membrane to remove contaminants), an ion exchange resin filter (which may be configured to exchange ions in water with ions on the resin surface), nanofiltration filters (which may include a membrane with nanosized pores), or an adsorbent filter (which may include activated alumina, modified clay, specialty resins, etc., that have a high affinity for PFAS).

As shown in FIG. 28B, water 2810 may be extracted from the anode off-gas 2828 and the cathode off-gas 2829 (using one or more water extraction devices 2801) and provided to a drain tank 2804. In some cases, water 2810 may be extracted from the combustion exhaust 114 of the combustion heater 109 (using the one or more water extraction devices 2801) and provided to the drain tank 2804. In some cases, the water 2810 may be provided to the drain tank 2804 using gravity.

When the water level in the drain tank 2804 is equal to or greater than a threshold (for example, by weight or volume), the water 2810 in the drain tank 2804 may be discharged. In some cases, the PFAS filter 2802 may remove PFAS in the water 2810, and then the water 2810 may be discharged to the environment 2808 (e.g., if the PFAS concentration in the filtered water is less than a threshold PFAS concentration). In some cases, the water 2810 is provided directly to the PFAS filter 2802 after being extracted by the one or more water extraction devices 2801 (without first being provided to the drain tank 2804). In some cases, after being filtered by the PFAS filter 2802, the water 2810 may be used as non-potable water.

The water 2810 in the drain tank 2804 may be provided to a scrubber 2702. In some cases, the water 2810 may be provided directly to the scrubber 2702 via the conduit 2804a without being filtered by the PFAS filter 2802 (to conserve the filtering capacity of the PFAS filter 2802). In some cases, ammonia-contaminated solution may be provided from the scrubber 2702 to a discharge tank 2812 (and the scrubber 2702 may be replenished using the extracted water 2810 and/or another water source).

### Scrubber and Stripper Integration

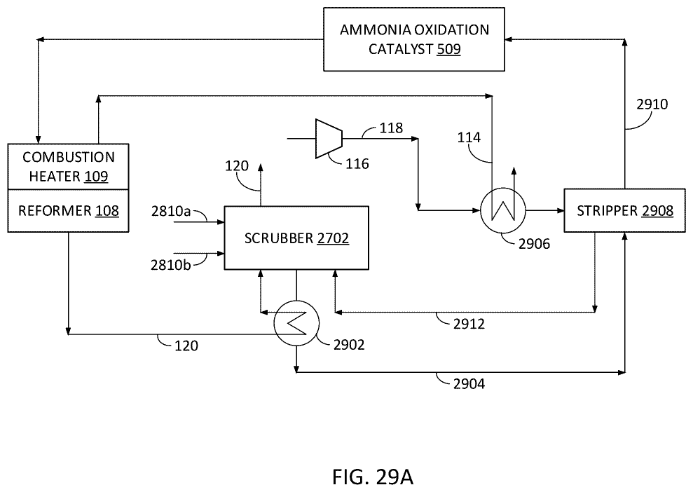

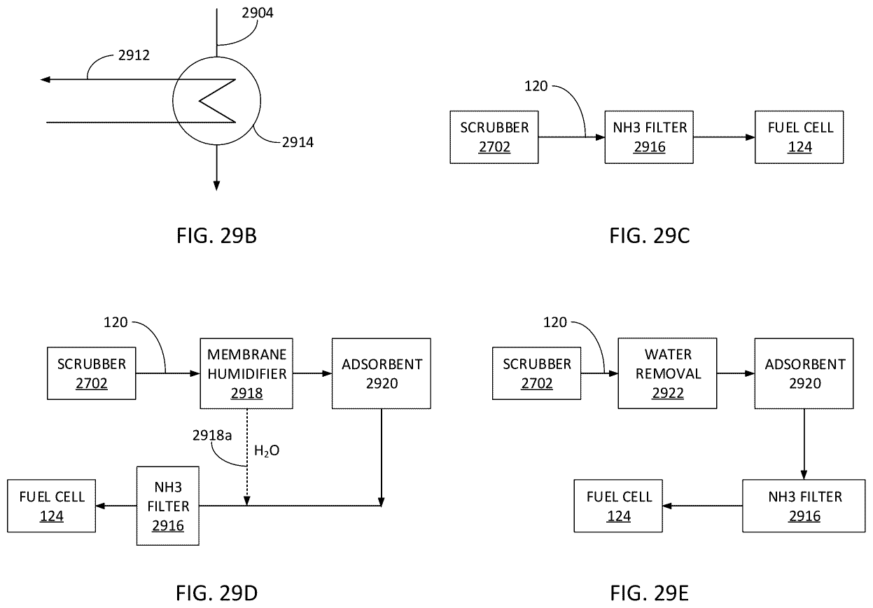

FIGS. 29A-29E are block diagrams illustrating the integration of a scrubber 2702 and a stripper 2908 with an ammonia reforming system, in accordance with one or more embodiments of the present disclosure.

The scrubber 2702 may be configured to reduce a concentration of residual ammonia in the reformate stream 120 by passing the reformate stream 120 through a scrubbing fluid, thereby generating a purified reformate stream 120, and generating an ammonia-containing solution 2904 comprising the scrubbing fluid (with the residual ammonia dissolved therein). The scrubbing fluid may comprise water or an acidic solution (for example) nitric acid or phosphoric acid.

In some cases, the scrubbing fluid may include water 2810a extracted from the anode off-gas 503 of the fuel cell 124, and/or water 2810b extracted from the cathode off-gas 504 of the fuel cell 124. In some cases, a level sensor may measure the quantity of scrubbing fluid in the scrubber 2702, and the quantity of extracted water 2810a-b provided to the scrubber 2702 may be controlled based on the measurement.

The stripper 2908 may be configured to reduce a concentration of the residual ammonia in the ammonia-containing solution 2904 by passing a gas stream 118 through the ammonia-containing solution 2904, thereby regenerating the scrubbing fluid, and generating an ammonia-containing gas stream 2910 including the residual ammonia. In some cases, the gas stream 118 comprises at least one of air, enriched oxygen, or an inert gas (e.g., N₂ or CO₂). In some cases, the gas stream 118 (e.g., air stream) is compressed using a compressor 116 (e.g., air supply unit).

In some cases, a heat exchanger 2906 is configured to transfer heat from the combustion exhaust 114 of the combustion heater 109 to the gas stream 118 before the gas stream 188 passes through the stripper. In some cases, the heat exchanger 2906 is configured to transfer heat from the reformate stream 120 to the gas stream 118 before the gas stream 118 passes through the stripper 2908.

In some cases, a heat exchanger 2902 is configured to transfer heat from the reformate stream 120 to the ammonia-containing solution 2904 before providing the ammonia-containing solution 2904 from the scrubber to the stripper. In some cases, the heat exchanger 2902 is configured to transfer heat from the combustion exhaust 114 of the combustion heater 109 to the ammonia-containing solution 2904 before providing the ammonia-containing solution 2904 from the scrubber 2702 to the stripper.

The usage of the heat exchangers 2902 and 2906 may advantageously increase the overall energy efficiency of the ammonia reforming systems and methods disclosed herein (by reducing the need for an external source of heat, such as electric heaters).

In some cases, the ammonia-containing gas stream 2910 exiting the stripper 2908 may be provided to the combustion heater 109 (e.g., to consume the oxygen in the ammonia-containing gas stream 2910 in the combustion reaction, and the dispose the residual ammonia to reduce emissions). The concentration of residual ammonia in the ammonia-containing gas stream 2910 may be at least about 0.1, 0.5, 1, 2, 3, 4, 5, 6, 7, 8, 9, 10, 11, 12, 13, 14, 15, 16, 17, 18, or 19% by volume. The concentration of residual ammonia in the ammonia-containing gas stream 2910 may be at most about 0.5, 1, 2, 3, 4, 5, 6, 7, 8, 9, 10, 11, 12, 13, 14, 15, 16, 17, 18, 19, or 20% by volume.

In some cases, the residual ammonia in the ammonia-containing gas stream 2910 may be oxidized, thereby generating a purified gas stream 2910, and advantageously reducing ammonia emissions. In some cases, an ammonia oxidation catalyst 509 may be used to oxidize the residual ammonia in the gas stream 2910. In some cases, the ammonia oxidation catalyst comprises Ru, Pt, Pd, Ag, Mv, V, Cu, Co, Fe, Ni, W, Eu, Sn, Mg, Nb, Zn, Ce, or Zr, oxides thereof, and/or alloys thereof.

In some cases, the ammonia oxidation catalyst 509 is a selective ammonia oxidation catalyst, which may preferentially combust ammonia over other gases. In some cases, other gases (e.g., hydrogen) in the ammonia-containing gas stream 2910 may be combusted with the residual ammonia.

In some cases, after the residual ammonia is oxidized, the purified gas stream 2910 may be provided to the combustion heater 109. In some cases, the ammonia-containing gas stream 2910 may be provided directly to the combustion heater 109 (e.g., without being provided to the ammonia oxidation catalyst 509).

In some cases, the scrubbing fluid 2912 regenerated in the stripper 2908 is provided from the stripper 2908 to the scrubber 2702 (which may advantageously recycle the scrubbing fluid, thereby reducing the sourcing of water from other sources, such as the water 2810a-b extracted from the fuel cell 124).

In some cases, a heat exchanger may be configured to transfer heat from the regenerated scrubbing fluid 2912 to the ammonia stream 104. For example, the heat may be transferred from the scrubbing fluid to the ammonia stream 104 before at least one of: the reforming of the ammonia stream 104 in the reformer(s) 108-110; or the reducing of the concentration of the residual ammonia in the reformate stream 120 by passing the reformate stream 120 through the scrubber 2702.

In some cases, the combustion exhaust 114 may be provided (e.g., directly without using a heat exchanger) to the stripper 2908, such that the combustion exhaust 114 passes through the stripper 2908. The combustion exhaust 114 may physically contact the ammonia-containing solution 2904, thereby regenerating the scrubbing fluid 2912. In some cases, a first portion of the combustion exhaust 114 is provided directly to the stripper 2908, while a second portion of the combustion exhaust 114 is vented (or provided to a heat recovery module).

As shown in FIG. 29B, in some cases, a heat exchanger 2914 may transfer heat from the scrubbing fluid 2912 regenerated by the stripper 2908 to the ammonia-containing solution 2904 exiting the scrubber 2702.

As shown in FIG. 29C, in some cases, an ammonia filter 2916 may be configured to reduce a concentration of a remaining part of the residual ammonia in the purified reformate stream 120 exiting the scrubber 2802. In some cases, the ammonia filter 2916 may comprises granules, beads, sheets, membranes, columns, or monoliths.

In some cases, the ammonia filter 2916 comprises an adsorbent, for example, comprising zeolite, activated carbon, alumina, polymer resins, metal organic frameworks (MOFs), or combinations thereof. In some cases, the adsorbent is configured to adsorb residual ammonia onto a surface of the adsorbent.

In some cases, the ammonia filter 2916 comprises an ion-exchange filter, for example, comprising crosslinked polystyrene-based polymer matrices (e.g., polystyrene sulfonate or polyacrylate). The ion-exchange filter may comprise a strongly acidic cation (SAC) ion-exchange resin, and/or a weakly acidic cation (WAC) ion-exchange resin. For example, the ion exchange filter may include various acidic functional groups, such as carboxylic acid or sulfonic acid. In some cases, the ion exchange filter is configured to exchange ammonium ions (NH₄) with other cations such as protons (H′), or chemically react uncharged ammonia gas (NH₃).

As shown in FIGS. 29D-29E, in some cases, a water extraction device may be configured to reduce a concentration of water in the purified reformate stream 120 exiting the scrubber 2702. In some cases, the water extraction device is a chiller or condenser.

In some cases, as shown in FIG. 29D, the water extraction device is a membrane humidifier 2918 (for example, a polymeric or ceramic membrane). In some cases, the membrane humidifier 2819 is configured to humidify 2918a the purified reformate stream 120 after an adsorbent 2920 reduces the concentration of a remaining part of the residual ammonia in the purified reformate stream 120. In some cases, the membrane humidifier 2918 is configured to humidify the purified reformate stream 120 before an ion exchange filter 2916 reduces the concentration of a remaining part of the residual ammonia in the purified reformate stream 120.

As shown in FIG. 29E, in some cases, the water extraction device comprises a desiccant 2922 such as silica gel, calcium chloride, magnesium sulfate, clay, alumina, molecular sieves, or combinations thereof. After the desiccant 2922 removes water from the purified reformate stream 120, the reformate stream 120 may be provided to an adsorbent 2920 and/or an ion exchange filter 2916.

### Fuel Cell Integration

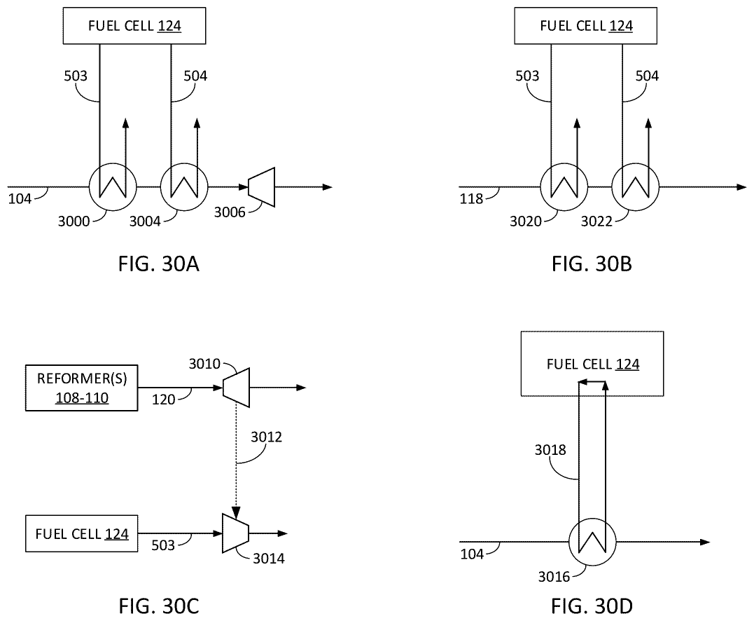

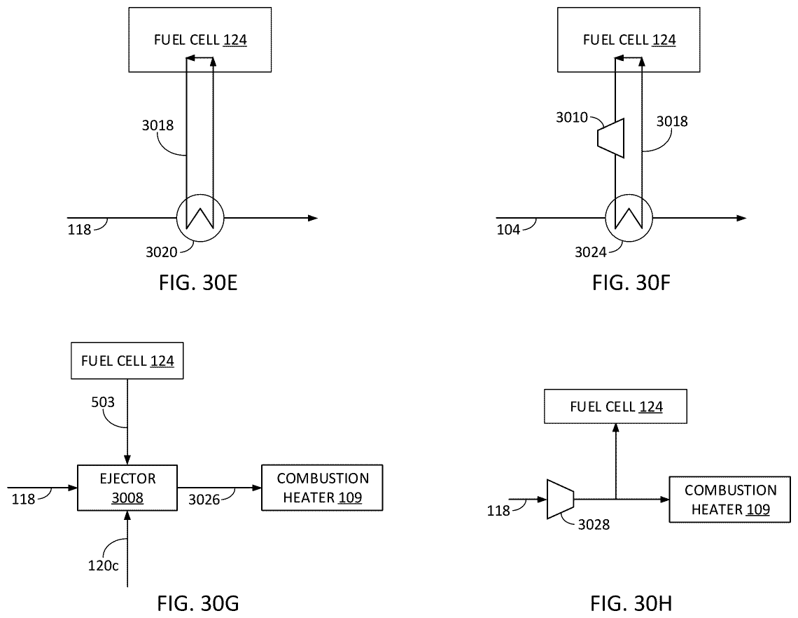

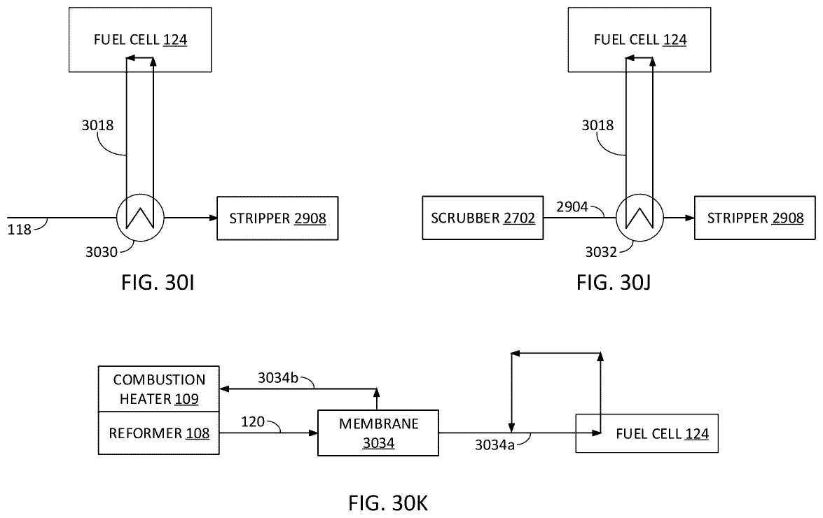

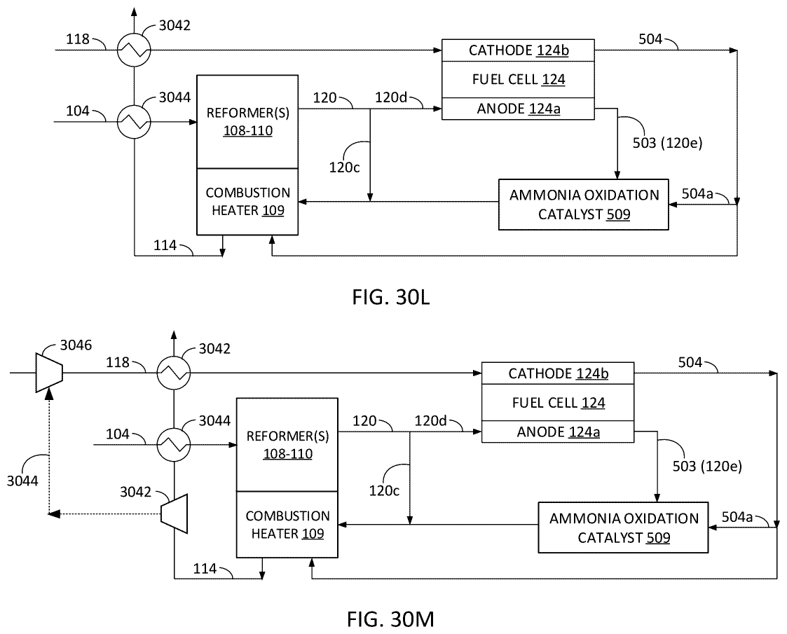

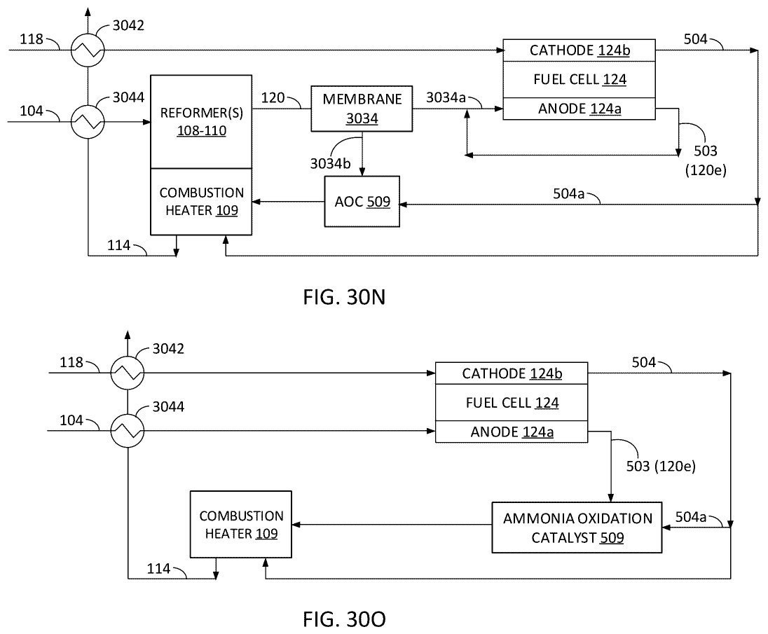

FIGS. 30A-300 are block diagrams illustrating the integration of a fuel cell 124 with an ammonia reforming system, in accordance with one or more embodiments of the present disclosure. In some cases, the fuel cell 124 is a phosphoric acid fuel cell (PAFC), a solid oxide fuel cell (SOFC), a molten carbonate fuel cell (MCFC), or alkaline fuel cell (AFC). In some cases, the operating temperature of the fuel cell 124 is at least about 100, 150, 200, 250, 300, 350, 400, 450, 500, 550, 600, 650, 700, 750, 800, 850, 900, 950, 1000, 1100, 1200, 1300, or 1400° C. In some cases, the operating temperature of the fuel cell 124 is at most about 150, 200, 250, 300, 350, 400, 450, 500, 550, 600, 650, 700, 750, 800, 850, 900, 950, 1000, 1100, 1200, 1300, or 1500° C.

In some cases, heat may be transferred from the fuel cell 124 to the ammonia stream 104 before the ammonia stream 104 is reformed in the reformer(s) 108-110. The heat may be transferred from the fuel cell 124 to the ammonia stream 104 by transferring heat from at least one of (i) an anode off-gas 503 of the fuel cell 124, (ii) a cathode off-gas 504 of the fuel cell 124, or (iii) a heat transfer fluid 3018 configured to cool the fuel cell 124.

As shown in FIG. 30A, a heat exchanger 3000 may be configured to transfer heat from the anode off-gas 503 to the ammonia stream 104, and/or a heat exchanger 3004 may be configured to transfer heat from the cathode off-gas 504 to the ammonia stream 104. In some cases, the heated ammonia stream 1004 may drive a turbine 3006 to generate mechanical or electrical power (for example, before the heated ammonia stream 1004 is reformed in the reformer(s) 108-110). The turbine 3006 may be used to compress the air stream 118, the reformate stream 120 and/or the anode off-gas 503.

As shown in FIG. 30D, a heat exchanger 3016 may be configured to transfer heat from a heat transfer fluid 3018 configured to cool the fuel cell 124 to the ammonia stream 104. In some cases, the heat transfer fluid 3018 may comprise water, ammonia, and/or a glycol.

As shown in FIG. 30F, the heat transfer fluid 3018 may drive a turbine 3010 before being provided to a heat exchanger 3024 configured to heat the ammonia stream 104. The turbine 3010 may be used to compress the air stream 118, the reformate stream 120 and/or the anode off-gas 503.

In some cases, heat may be transferred from the fuel cell 124 to a gas stream (e.g., air stream 118, an inert gas, and/or the reformate stream 120). The heat may be transferred from the fuel cell 124 to the gas stream by transferring heat from at least one of (i) an anode off-gas 503 of the fuel cell 124, (ii) a cathode off-gas 504 of the fuel cell 124, or (iii) a heat transfer fluid 3018 configured to cool the fuel cell 124. In some cases, the heated gas stream is provided to at least one of (i) the fuel cell 124, (ii) the combustion heater 109, or (iii) the stripper 2908.

As shown in FIG. 30B, a heat exchanger 3020 may be configured to transfer heat from the anode off-gas 503 to the air stream 118, and/or a heat exchanger 3022 may be configured to transfer heat from the cathode off-gas 504 to the air stream 118. In some cases, the heated air steam 118 may drive a turbine to generate mechanical or electrical power. The turbine may be used to compress the reformate stream 120 and/or the anode off-gas 503.

As shown in FIG. 30C, a turbine 3010 may be configured to be driven by the reformate stream 120 to generate mechanical or electrical power 3012. In some cases, the mechanical or electrical power 3012 may be used to drive a compressor 3014 configured to compress the anode off-gas 503. The anode off-gas 503 may then be provided to the combustion heater 109.

As shown in FIG. 30E, a heat exchanger 3020 may be configured to transfer heat from the heat transfer fluid 3018 configured to cool the fuel cell 124 to the air stream 118.

As shown in FIG. 30G, a mixture 3026 may be generated by mixing at least two of (i) the anode off-gas 503 of the fuel cell 124, (ii) a gas stream (e.g., the air stream 118), or (iii) the first portion 120c of the hydrogen in the reformate stream 120. The mixture 3026 may then be provided to the combustion heater 109 configured to heat the reformer(s) 108-110. In some cases, the mixture 3026 is generated using a vacuum ejector 3008 (which produces vacuum by means of the Venturi effect).

As shown in FIG. 30H, a compressor 3028 may be configured to compress the air stream 118. The compressed air stream 118 may then be provided to the fuel cell 124 and/or the combustion heater 109. Using a single compressor 3028 to provide oxygen to both the fuel cell 124 and the combustion heater 109 may advantageously reduce overall volume requirements.

As shown in FIG. 301, a heat exchanger 3030 may be configured to transfer heat from the heat transfer fluid 3018 configured to cool the fuel cell 124 to the air stream 118 before providing the air stream 118 to the stripper 2908.

As shown in FIG. 30J, a heat exchanger 3032 may be configured to transfer heat from the heat transfer fluid 3018 configured to cool the fuel cell 124 to the ammonia-containing solution 2904 before providing the ammonia-containing solution 2904 to the stripper 2908.

As shown in FIG. 30K, a membrane 3034 may be configured to separate the hydrogen from the nitrogen and residual ammonia in the reformate stream 120. The membrane 3034 may generate a permeate stream 3034a comprising the separated hydrogen, and a retentate stream 3034b comprising leftover hydrogen that is not separated by the membrane 3034, the nitrogen, and the residual ammonia. In some cases, the permeate stream 3034a is provided to the fuel cell 124 and may be recirculated at the fuel cell 124 (e.g., the anode off-gas 503 may be provided to the permeate stream 3034a). In some cases, the retentate stream 3034b may be provided to the combustion heater 109 (e.g., as a trim fuel). In some cases, the retentate stream 3034b is provided to an ammonia oxidation catalyst or an adsorbent before being provided to the combustion heater 109. In some cases, the membrane 3034 is heated to a temperature of at least about 50, 75, 100, 125, 150, 175, 200, 225, 250, 275, 300, 325, 350, 375, 400, 425, 450, 475, 500, 525, 550, 575, 600, 625, 650, 675, 700, 725, 750, or 775° C. In some cases, the membrane 3034 is heated to a temperature of at most about 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, or 800° C. In some cases, the membrane 3034 comprises a metallic or ceramic material.

As shown in FIG. 30L, the anode off-gas 503 (i.e., anode off-gas 120e) may be provided an ammonia oxidation catalyst 509. In some cases, the anode off-gas 503 may be mixed with the first portion 120c of the reformate stream 120 and provided to the combustion heater 109, while the second portion 120d may be provided to the anode 124a of the fuel cell 124.

In some cases, the air stream 118 may be provided to the cathode 124b. The cathode off-gas 504 (which may contain oxygen) may then be provided to the combustion heater 109. In some cases, a portion 504a (e.g., slip stream) of the cathode off-gas 504 may be provided to the ammonia oxidation catalyst 509 to react with the residual ammonia in the anode off-gas 503.

In some cases, a heat exchanger 3044 may be configured to transfer heat from the combustion exhaust 114 to the ammonia stream 104. In some cases, a heat exchanger 3042 may be configured to transfer heat from the combustion exhaust 114 to the air stream 118.

As shown in FIG. 30M, in some cases, the combustion exhaust 114 may drive a turbine 3042 to generate mechanical or electrical power 3044. The mechanical or electrical power 3044 may then be used to drive a compressor 3046 configured to compress the air stream 118.

As shown in FIG. 30N, in some cases, the reformate stream 120 may be provided to the membrane 3034. The permeate stream 3034a may be provided to the anode 124a of the fuel cell 124, and the anode off-gas 503 may be recirculated to the permeate stream 3034a. The retentate stream 3034b may be provided to the ammonia oxidation catalyst 509, and may then be provided to the combustion heater 109.

As shown in FIG. 30O, in some cases, the fuel cell 124 is a direct ammonia fuel cell (DAFC) (e.g., an SOFC), which may consume ammonia as a fuel directly without being reformed or pre-reformed. In some cases, ammonia reforming may occur at the anode 124a of the DAFC. In some cases, the reformer(s) 108-110 may be positioned adjacent or embedded in the fuel cell 124. In some cases, heat conducting elements may be used to transfer heat from the fuel cell 124 to the reformer(s) 108-110. In some cases, the combustion exhaust from the combustion heater may be used to preheat the ammonia stream 104 (using heat exchanger 3044) and/or to preheat the air stream 118 (using the heat exchanger 3042).

In some cases, the reformer(s) 108-110 (e.g., the combustion-heated reformer 108 and/or the electrically heated reformer 110) may be positioned adjacent to the fuel cell 124. In some cases, the reformer(s) 108-110 may be in physical communication with the fuel cell 124 (e.g., physical contact). In some cases, the reformer(s) 108-110 may be attached, affixed, or secured to the fuel cell 124. In some cases, the reformer(s) and the fuel cell 124 may comprise a single structure. In some cases, the reformer(s) and the fuel cell 124 may comprise different structures.

In some cases, the fuel cell 124 and the reformer(s) 108-110 may be in a single housing (e.g., an insulated enclosure). In some cases, the single housing may be a furnace (e.g., electrical or combustion-heated furnace). In some cases, the fuel cell 124 and the reformer(s) 108-110 may be in different housings.

In some cases, the reformer(s) 108-110 may be in thermal communication with the fuel cell 124. In some cases, heat may be transferred from the exothermic reaction at the fuel cell 124 to the endothermic reaction at the reformer(s) 108-110.

In some cases, the fuel cell 124 and the reformer(s) 108-110 may be thermally integrated using heat transfer elements (for example, conductive fins, plates, beads or other material configured to transfer heat from the fuel cell 124 to the reformer(s) 108-110). In some cases, a heat transfer fluid (for example, ammonia, water, air, or a glycol) may be used to transfer heat from the fuel cell 124 to the reformer(s) 108-110. In some cases, an air blower may be used to transfer heat from the fuel cell 124 to the reformer(s) 108-110.

In some cases, the reformer(s) 108-110 may be positioned at least partially in a single cell (e.g., where the cell comprises an anode layer, electrolyte layer, and cathode layer) of the fuel cell 124. In some cases, the reformer(s) 108-110 may be positioned at least partially between two or more different cells (for example, a first cell and a second cell) of the fuel cell 124. In some cases, the reformer(s) 108-110 may be positioned at least partially in two or more different cells (for example, a first cell and a second cell) of the fuel cell 124.

In some cases, the reformer(s) 108-110 may be positioned at least partially in a single layer of a cell of the fuel cell 124 (for example, at least partially in the anode layer, the electrolyte layer, or the cathode layer). In some cases, the reformer(s) 108-110 may be positioned at least partially between two or more layers of a cell of the fuel cell 124 (for example, at least partially between the anode layer and the electrolyte layer). In some cases, the reformer(s) 108-110 may be positioned at least partially in two or more layers of a cell of the fuel cell 124 (for example, at least partially in the anode layer and the electrolyte layer).

In some cases, the heater(s) 109-111 (e.g., the combustion heater reformer 109 and/or the electrical heater 111) may be positioned adjacent to the fuel cell 124. In some cases, the heater(s) 109-111 may be in physical communication with the fuel cell 124 (e.g., physical contact). In some cases, the heater(s) 109-111 may be attached, affixed, or secured to the fuel cell 124. In some cases, heater(s) 109-111 and the fuel cell 124 may comprise a single structure. In some cases, the heater(s) 109-111 and the fuel cell 124 may comprise different structures.

In some cases, the fuel cell 124 and the heater(s) 109-111 may be in a single housing (e.g., an insulated enclosure). In some cases, the single housing may be a furnace (e.g., electrical or combustion-heated furnace). In some cases, the fuel cell 124 and the heater(s) 109-111 may be in different housings.

In some cases, the heater(s) 109-111 may be in thermal communication with the fuel cell 124. In some cases, heat may be transferred from the fuel cell 124 to the heater(s) 109-111.

In some cases, the fuel cell 124 and the heater(s) 109-111 may be thermally integrated using heat transfer elements (for example, conductive fins, plates, beads or other material configured to transfer heat from the fuel cell 124 to the heater(s) 109-111). In some cases, a heat transfer fluid (for example, ammonia, water, air, or a glycol) may be used to transfer heat from the fuel cell 124 to the heater(s) 109-111. In some cases, an air blower may be used to transfer heat from the fuel cell 124 to the heater(s) 109-111.

In some cases, the heater(s) 109-111 may be positioned at least partially in a single cell (e.g., where the cell comprises an anode layer, electrolyte layer, and cathode layer) of the fuel cell 124. In some cases, the heater(s) 109-111 may be positioned at least partially between two or more different cells (for example, a first cell and a second cell) of the fuel cell 124. In some cases, the heater(s) 109-111 may be positioned at least partially in two or more different cells (for example, a first cell and a second cell) of the fuel cell 124.

In some cases, the heater(s) 109-111 may be positioned at least partially in a single layer of a cell of the fuel cell 124 (for example, at least partially in the anode layer, the electrolyte layer, or the cathode layer). In some cases, the heater(s) 109-111 may be positioned at least partially between two or more layers of a cell of the fuel cell 124 (for example, at least partially between the anode layer and the electrolyte layer). In some cases, the heater(s) 109-111 may be positioned at least partially in two or more layers of a cell of the fuel cell 124 (for example, at least partially in the anode layer and the electrolyte layer).

In some cases, the anode off-gas 503 may be provided to the reformer(s) 108-110 (e.g., such that unconverted ammonia is recirculated for further reforming in the reformer(s) 108-110) and/or the combustion heater 109. In some cases, the cathode off-gas 504 may be provided to the reformer(s) 108-110 and/or the combustion heater 109.

### Ammonia Oxidation Catalyst

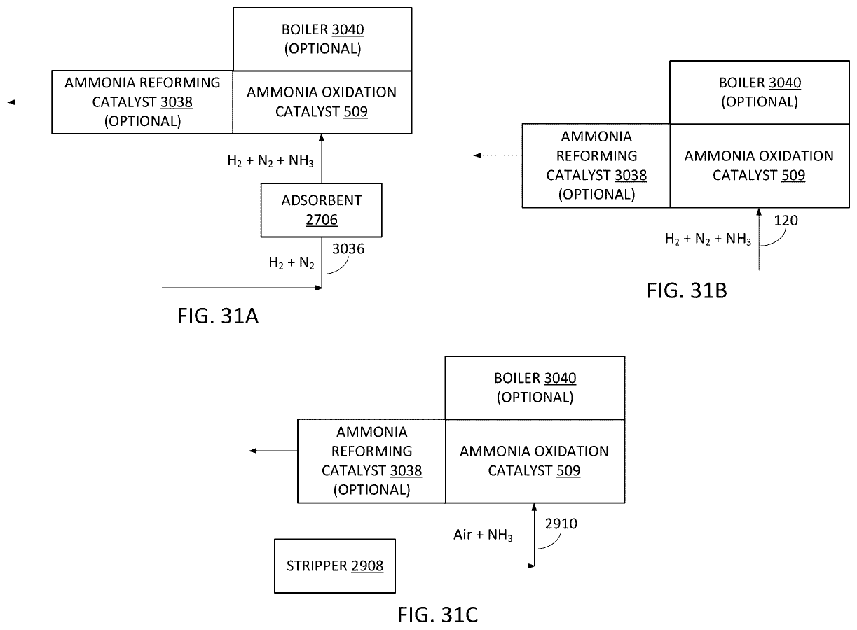

FIGS. 31A-31C are block diagrams illustrating the integration of an ammonia oxidation catalyst with an ammonia reforming system, in accordance with one or more embodiments of the present disclosure. In some cases, residual ammonia in a gas stream may be oxidized using an ammonia oxidation catalyst 509.

In some cases, an ammonia reforming catalyst 3038 may be configured to absorb heat from the ammonia oxidation catalyst 509. The ammonia reforming catalyst 3038 may be in thermal communication with the ammonia oxidation catalyst 509. In some cases, the ammonia reforming catalyst comprises ruthenium or nickel.

In some cases, a boiler 3040 may be configured to absorb heat from the ammonia oxidation catalyst 509. The boiler 3040 may be in thermal communication with the ammonia oxidation catalyst 509. The boiler 3040 may generate steam, which may be used to heat the ammonia 104 or the air stream 118.

As shown in FIG. 31A, in some cases, a purge stream 3036 (e.g., purging gas) may be used to desorb residual ammonia from the surface of an adsorbent 2706. The exit stream may then be provided to the ammonia oxidation catalyst 509 to oxidize the residual ammonia.

As shown in FIG. 31B, in some cases, the residual ammonia in the reformate stream 120 may be oxidized by the ammonia oxidation catalyst 509. The purified reformate stream 120 may then be provided to the fuel cell 124 or a hydrogen processing module.

As shown in FIG. 31C, in some cases, the ammonia-containing gas stream 2910 exiting the stripper 2908 may be provided to the ammonia oxidation catalyst 509. The purified ammonia-containing gas stream 2910 may then be provided to the fuel cell 124 or a hydrogen processing module.

### Ammonia Reformers and Catalysts

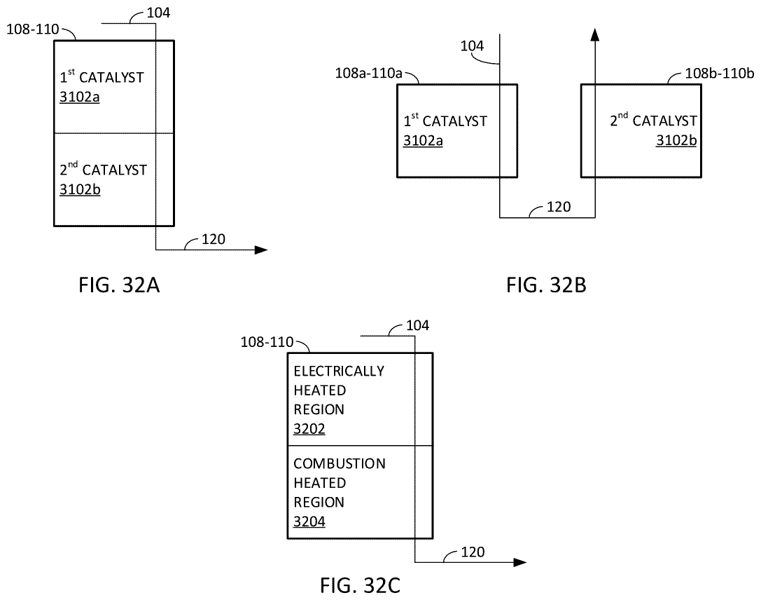

FIGS. 32A-32C are block diagrams illustrating various configurations of ammonia reformers and catalysts, in accordance with one or more embodiments of the present disclosure.

As shown in FIG. 32A, in some cases, the reformer(s) 108-110 may comprise a first ammonia reforming catalyst 3102a and a second ammonia reforming catalyst 3102b. In some cases, the first ammonia reforming catalyst 3102a may be in a first region of the reformer(s) 108-110, and the second ammonia reforming catalyst 3102b may be in a second region of the reformer(s) 108-110. In some cases, the first reforming catalyst 3102a may be mixed with the second ammonia reforming catalyst 3102b.

In some cases, the first ammonia reforming catalyst 3102a comprises at least one of: Ru, Pt, Pd, Ni, Co, Mo, Fe, or Cu. In some cases, the second ammonia reforming catalyst 3102b comprises at least one of: Ru, Pt, Pd, Ni, Co, Mo, Fe, or Cu.

In some cases, the first ammonia reforming catalyst 3102a and the second ammonia reforming catalyst 3102b have a same chemical composition. In some cases, the first ammonia reforming catalyst 3102a and the second ammonia reforming catalyst 3102b have at least partially a same chemical composition. In some cases, the first ammonia reforming catalyst 3102a and the second ammonia reforming catalyst have different chemical compositions 3102b.

In some cases, an NH₃ reforming catalyst is in a reformer 108-110. In some cases, a first region of the NH₃ reforming catalyst is in a first reformer, and a second region of the NH₃ reforming catalyst is in a second reformer. In some cases, the NH₃ reforming catalyst is in thermal communication with an electric heater, a combustion heater, or a combination thereof.

In some cases, a first region of the NH₃ reforming catalyst is heated by an electrical heater (e.g., heater 111), and a second region of the NH₃ reforming catalyst is heated by a combustion heater (e.g., heater 109).

In some cases, the NH₃ reforming catalyst is heated to a target temperature range (e.g., using the heater 109 or the heater 111). In some cases, the NH₃ reforming catalyst is at a target temperature range (for example, maintained at the target temperature range using insulation, the heater 109 and/or the heater 111).

In some cases, a first region of the NH₃ reforming catalyst is heated to a first target temperature range and a second region of the NH₃ reforming catalyst is heated to a second target temperature range. In some cases, the first target temperature range and the second target temperature range at least partially overlap. In some cases, the first target temperature range and the second target temperature range are different. In some cases, a midpoint temperature of the first target temperature range is greater than a midpoint temperature of the second target temperature range. In some cases, a first region of the NH₃ reforming catalyst comprises the first NH₃ reforming catalyst 3102a and a second region of the NH₃ reforming catalyst comprises the second NH₃ reforming catalyst 3102b.

As shown in FIG. 32B, in some cases, a first reformer 108a-110a comprises the first ammonia reforming catalyst 3102a and a second reformer 108b-110b comprises the second ammonia reforming catalyst 3102b.

In some cases, the first reformer 108a-110a and the second reformer 108b-110b have different housings or vessels. In some cases, the first reformer 108a-110a and the second reformer 108b-110b share a housing or vessel. In some cases, the first reformer 108a-110a is a first region of the housing or vessel, and the second reformer 108b-110b is a second region of the housing or vessel. In some cases, the first reformer 108a-110a and the second reformer 108b-110b are at least partially in thermal communication with each other. In some cases, the first reformer 108a-110a and the second reformer 108b-110b are in fluid communication.

As shown in FIG. 32C, in some cases, the reformer(s) 108-110 may include an electrically heated region 3202 and a combustion-heated region 3204 (e.g., a hybrid heated reformer). In some cases, the electrically heated region 3202 may heated using an electrical heater (e.g., electrical heater 111, a resistance or induction heater) and the combustion heated region 3204 may be heated using a combustion heater (e.g., combustion heater 109). In some cases, the combustion heated region 3204 may surround the electrically heated region 3202. In some cases, the electrically heated region 3202 may surround the combustion heated region 3204. In some cases, the electrically heated region 3202 may be in series fluid communication with the combustion-heated region 3204. In some cases, the electrically heated region 3202 may include the first ammonia reforming catalyst 3102a and the combustion-heated region 3204 may include the second ammonia reforming catalyst 3102b.

Heating and/or Purging Using Inert Gas

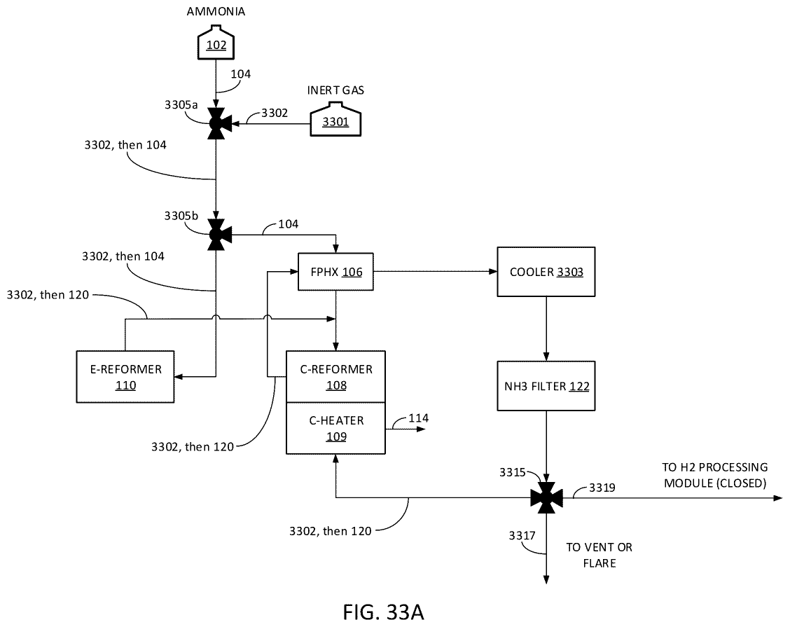

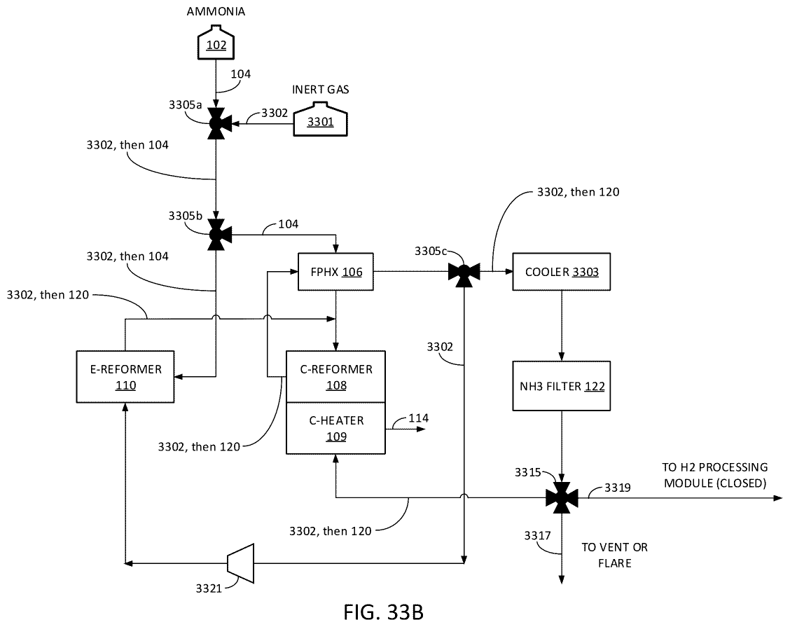

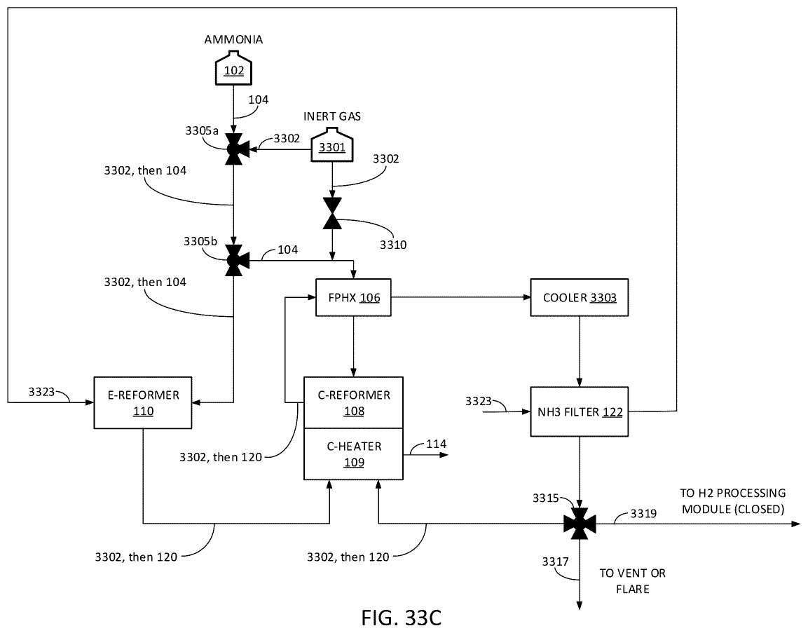

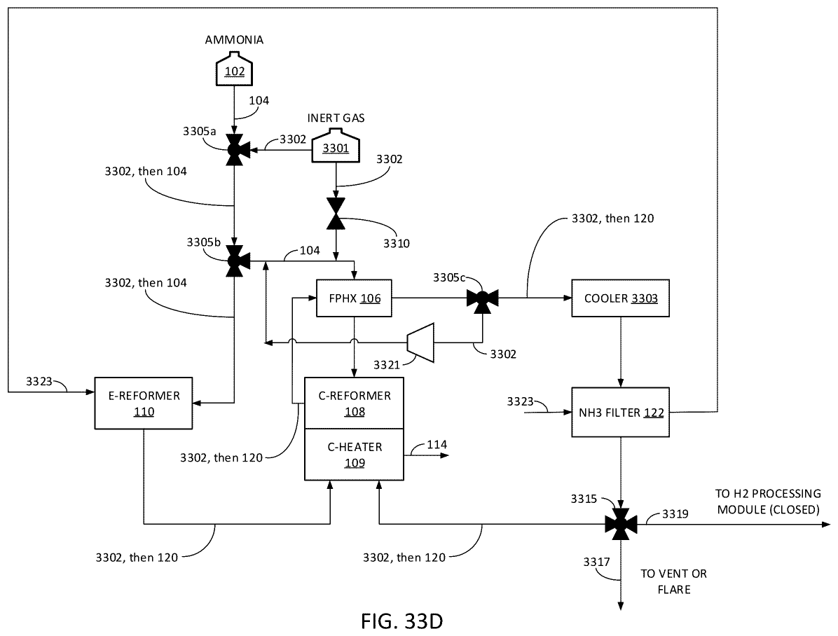

FIGS. 33A-33D are block diagrams illustrating the startup of an ammonia reforming system using an inert gas, in accordance with one or more embodiments of the present disclosure.

As shown in FIG. 33A, in some cases, the inert gas 3302 may be stored in a storage tank 3301. The inert gas 3302 may comprise nitrogen, helium, argon, or carbon dioxide. The inert gas 3302 may be in gaseous or liquid form.

In some cases, the inert gas 3302 may be provided to a first reformer 110 (e.g., the electrically heated reformer 110), a second reformer 108 (e.g., the combustion-heated reformer 108), an NH₃ filter 122 (e.g., an adsorbent, a scrubber, or an ion exchange filter), and/or a combustion heater 109. The inert gas 3302 may be provided to the first reformer 110, the second reformer 108, the NH₃ filter 122, and/or the combustion heater 109, thereby removing (e.g., purging) residual contaminants therefrom.

The residual contaminants may comprise at least one of ammonia, oxygen, or hydrogen. The purging may advantageously reduce damage to the reformer 108 and/or the reformer 110 (for example, oxygen may oxidize the catalyst in the reformer 108 and/or the reformer 110, or the structural material of the reformer 108 and/or the reformer 110), and increase the performance of the reformer 108 and/or the reformer 110 (for example, water and/or hydrogen may reduce the conversion of ammonia to hydrogen and nitrogen).

In some cases, the first reformer 110 may be heated using a heater (for example, using an electrical heater). The inert gas 3302 provided to the first reformer 110 may advantageously facilitate heat transfer from the heater (e.g., electrical heater 111) to an NH₃ reforming catalyst in the first reformer 110 (for example, by drawing heat deeper into the catalyst bed from the wall separating the reformer 110 from the combustion electrical heater 111).

In some cases, the first reformer 110 is an electrically heated reformer, a combustion heated reformer, or a combination thereof. In some cases, the second reformer 108 is an electrically heated reformer, a combustion heated reformer, or a combination thereof.

As shown in FIG. 33B, in some cases, the inert gas 3302 that leaves the first reformer 110 is provided again to the first reformer 110 (i.e., recirculated to the first reformer 110). This recirculation of the inert gas 3302 may advantageously reduce the consumption of the inert gas 3302.

In some cases, the inert gas 3302 may be recirculated to the first reformer 110, the second reformer 108, the NH₃ filter 122, and/or the combustion heater 109, so that the inert gas 3302 that leaves the first reformer 110, the second reformer 108, the NH₃ filter 122, and/or the combustion heater 109 is provided again to the first reformer 110, the second reformer 108, the NH₃ filter 122, and/or the combustion heater 109. This recirculation of the inert gas 3302 may advantageously reduce the consumption of the inert gas 3302.

In some cases, a flow control unit 3305c (e.g., valve) may be controlled to recirculate the inert gas 3302 to the first reformer 110, the second reformer 108, the NH₃ filter 122, and/or the combustion heater 109. The flow control unit 3305c may be similar or identical to the flow control unit 517 described elsewhere in this disclosure. In some cases, a flow control unit 3321 (e.g., a pump or compressor) may control a flow rate and/or pressure of the inert gas 3302 (for example, increase the flow rate and/or pressure) that is recirculated.

In some cases, the first reformer 110 may reform the ammonia stream 104 and generate a reformate stream 120 (e.g., the first reformate stream 120a as described with respect to FIGS. 17A-17F). The first reformer 110 may start reforming the ammonia stream 104, after the flow of the inert gas 3302 to the reformer 110 is stopped. For example, the flow control units 3305a and 3305b (e.g., valves) may be controlled to stop flowing the inert gas 3302 and start flowing the ammonia 104 to the reformer 110. The flow control units 3305a and 3305b may be similar or identical to the flow control unit 517 described elsewhere in this disclosure.

In some cases, the first reformate stream 120a generated by the first reformer 110 may be provided to the second reformer 108 (which may reform residual or unconverted ammonia in the reformate stream 120a).

In some cases, the first reformate stream 120a generated by the first reformer 110 may be cooled down using a cooler 3303 (e.g., a condenser or chiller, or a heat exchanger that transfers heat from the reformate stream 120 to a glycol, water, ammonia, or air). In some cases, the cooler 3303 may instead comprise (or may additionally comprise) a water extraction device such as a silica gel, a membrane humidifier, or a water adsorbent.

In some cases, the first reformate stream 120a generated by the first reformer 110 may be provided to the NH₃ filter 122 (for example, after being provided to the cooler 3303 and/or the water extraction device). In some cases, the first reformate stream 120a generated by the first reformer 110 may be provided to a cooler 3303 (or water extraction device) after exiting the ammonia filter 122.

In some cases, the first reformate stream 120a may be combusted in a combustion heater 109 in thermal communication with the second reformer 108, which may generate the combustion exhaust 114 and heat the second reformer 108 (for example, the startup mode as described with respect to FIGS. 17A-17F).

In some cases, a flow control unit 3315 (e.g., valve) may control the pressure and/or flowrate of the reformate stream 120a (or the inert gas 3302). In some cases, the flow control unit 3315 may be similar or identical to the flow control unit 517 described elsewhere in this disclosure. The flow control unit 3315 may be configured to provide part of the reformate stream 120 (or the inert gas 3302) to the combustion heater 109 and part of the reformate stream 120 (or the inert gas 3302) to the H₂ processing module 535 and/or the fuel cell 124 via fluid line 3319. In some cases, part of the reformate stream 120 (or part of the inert gas 3302) may be vented or flared via fluid line 3317.

In some cases, the fluid line 3319 may be closed during the startup mode (as described with respect to FIGS. 17A-17F) or the pre-operation mode (as described with respect to FIG. 18), such that the hydrogen processing module 535 and/or the fuel cell 124 do not receive the reformate stream 120 (e.g., the first reformate stream 120a and/or the second reformate stream 120b).

In some cases, as shown in FIGS. 33C-33D, providing the first reformate stream 120a to the combustion heater 109 may bypass the second reformer 108. For example, the first reformate stream 120a may be provided directly to the combustion heater 109 from the first reformer 110. In this way, thermal shock to the heat exchanger 106 (e.g., the feed-product heat exchanger) may be reduced.

In some cases, providing the first reformate stream 120a to the combustion heater 109 bypasses the ammonia filter 122 (which may advantageously conserve the filtering capacity of the ammonia filter 122).

In some cases, the inert gas 3302 may be provided to the second reformer 108, while (simultaneously) the combustion heater 109 may combust the reformate stream 120a generated by the first reformer 110.

For example, the flow control unit 3310 may be controlled to flow the inert gas 3302 to the second reformer 108 (e.g., combustion-heated reformer 108), while the flow control units 3305a and 3305b may be controlled to flow the ammonia 104 to the first reformer 110 (e.g., electrically heated reformer 110).

The inert gas 3302 provided to the second reformer 108 may facilitate heat transfer from the combustion heater 109 to an NH₃ reforming catalyst in the second reformer 108 (for example, by drawing heat deeper into the catalyst bed from the wall separating the combustion-heated reformer 108 from the combustion heater 109).

In some cases, the ammonia stream 104 may be reformed using the second reformer 109 to generate a second reformate stream 120b comprising hydrogen and nitrogen (for example, the pre-operation mode as described with respect to FIG. 18). In some cases, the second reformer 108 may start reforming the ammonia 104 after stopping the reforming of the ammonia in the first reformer 110. For example, the flow control unit 3305b may be controlled to stop providing the ammonia 104 to the first reformer 110, and start providing the ammonia 104 to the second reformer 108, and the flow control unit 3310 may be controlled to stop providing the inert gas 3302 to the second reformer 108.

In some cases, providing the ammonia 104 to the second reformer 108 bypasses the first reformer 110, so that the ammonia 104 is not provided to the first reformer 110. In some cases, the ammonia 104 is provided to the heat exchanger 106 (e.g., the feed-product heat exchanger) before providing the ammonia 104 to the second reformer 108. In some cases, providing the ammonia 104 to the heat exchanger 106 bypasses the first reformer 110, so that the ammonia 104 is not provided to the first reformer 110.

As shown in FIGS. 33C-33D, in some cases, a gas stream 3323 may regenerate the ammonia filter 122, and an ammonia-containing gas stream 3323 may exit the ammonia filter 122. In some cases, the gas stream 3323 may be heated (for example, using the combustion exhaust 114 via a heat exchanger, or using an electrical heater) before being provided to the ammonia filter 122 to regenerate the ammonia filter 122.

The ammonia-containing gas stream 3323 may then be provided to the first reformer 110 and/or the second reformer 108 to reform (i.e., dispose of) the residual ammonia in the gas stream 3323. In some cases, the ammonia-containing gas stream 3323 may be provided to the combustion heater 109. In some cases, the ammonia-containing gas stream 3323 may be provided to the ammonia oxidation catalyst 509.

In some cases, the gas stream 3323 comprises an inert gas (e.g., at least part of the inert gas 3302, or other source of inert gas). In some cases, the gas stream 3323 comprises the reformate stream 120 (e.g., at least part of: the reformate stream 120a, the reformate stream 120b, the reformate stream 120c, and/or the reformate stream 120e). In some cases, the gas stream 3323 comprises air (e.g., at least part of the air stream 118).

As shown in FIG. 33D, in some cases, providing the first reformate stream 120a to the combustion heater 109 may bypass the second reformer 108, and additionally the flow control unit 3305 may recirculate the inert gas 3305c to at least one of the first reformer 110, the second reformer 108, the NH₃ filter 122, and/or the combustion heater 109, so that the inert gas 3302 that leaves the first reformer 110, the second reformer 108, the NH₃ filter 122, and/or the combustion heater 109 is provided again to the first reformer 110, the second reformer 108, the NH₃ filter 122, and/or the combustion heater 109.

This combination may advantageously reduce thermal shock to the heat exchanger 106 and reduce the consumption of the inert gas 3302.

### Insulated Enclosure

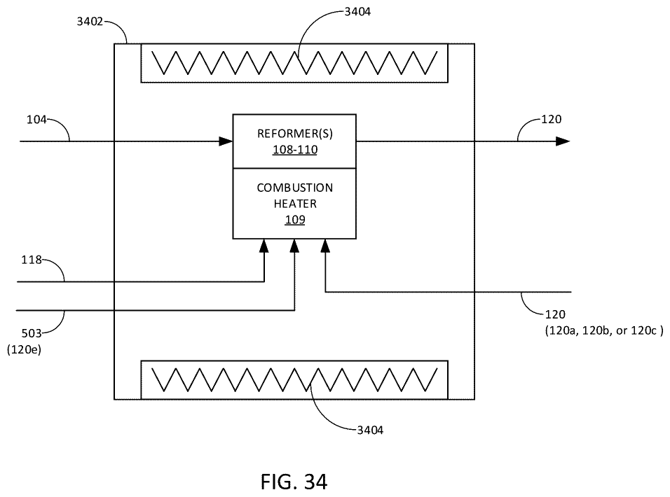

FIG. 34 is a block diagram illustrating the heating of the reformer(s) 108-110 inside an insulated enclosure 3402, in accordance with one or more embodiments of the present disclosure.

The reformer(s) 108-110 heated inside the insulated enclosure 3402 may include the electrically heated reformer 110 and/or the combustion-heated reformer 108. In some cases, the combustion heater 109 and/or the electrical heater 111 may be heated inside the insulated enclosure 3402.

In some cases, only the combustion-heated reformer 108 and the combustion heater 109 (and not the electrically heated reformer 110 and the electrical heater 111) may be heated inside the insulated enclosure 3402.

In some cases, only the electrically heated reformer 110 and the electrical heater 111 (and not the combustion-heated reformer 108 and the combustion heater 109) may be heated inside the insulated enclosure 3502.

In some cases, an electric heater 3404 may be used to heat the reformer(s) 108-110 (for example, instead of the electric heater 111). In some cases, the electric heater 3404 heats the volume or space inside the enclosure. The electric heater 3404 may comprise a resistance, induction, microwave, or plasma heater. In some cases, the electric heater is attached, affixed, or secured to a wall of the insulated enclosure.

In some cases, the ammonia stream 104 may be directed to the reformer(s) 108-110 at an ammonia flow rate to produce the reformate stream 120 comprising hydrogen and nitrogen. A first portion 120c of the reformate stream 120 may be combusted with oxygen (e.g., from the air stream 118) at an oxygen flow rate in the combustion heater 109 to heat the reformer(s) 108-110, and a second portion 120d of the reformate stream 120 may be processed in the hydrogen processing module 535 (e.g., fuel cell 124).

In some cases, the flow rate of the ammonia stream 104 may be decreased (e.g., stopped) in response to a stimulus (e.g., the stimulus can be a user input, or an automated input based on a measurement) and the reformer(s) 108-110 may subsequently be heated using the electric heater 3404 (e.g., inside the enclosure 3402). In this way, the temperature of the reformer(s) 108-110 may be maintained without consuming ammonia as a fuel to heat the reformer(s) 108-110.

In some cases, the electric heater 3404 may supply a minimum amount of heat to the insulated enclosure 3402 to replace heat lost (e.g., <5 KW) and maintain the reformer(s) 108-110 within a temperature range. For example, the insulated enclosure 3402 may be maintained at a temperature range of at least about 400, 425, 450, 475, 500, 525, 550, 575, 600, 625, 650, 675, 700, 725, 750, 775, 800, 825, 850, or 875° C. and not more than about 425, 450, 475, 500, 525, 550, 575, 600, 625, 650, 675, 700, 725, 750, 775, 800, 825, 850, 875, or 900° C.

In some cases, the flow rate of the ammonia stream 104 may be increased, and the electric heater 3404 may be reduced or stopped. The reforming of the ammonia stream 104 may start or increase, and the first portion 120c of the reformate stream 120 may be combusted to heat the reformer(s) 108-110.

Powering Air Supply Units with Hydrogen Processing Module

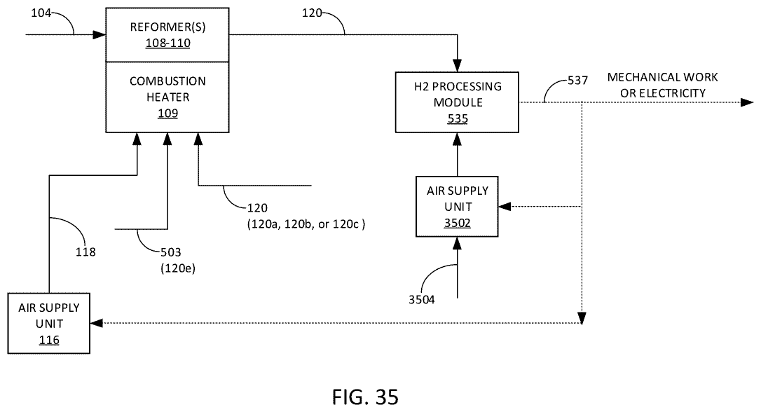

FIG. 35 is a block diagram illustrating the usage of the mechanical work or electricity 537 generated by a hydrogen processing module 535 to power auxiliary components, in accordance with one or more embodiments of the present disclosure.

In some cases, all of (or almost all of) the mechanical work or electricity 535 generated by the hydrogen processing module 535 may be used to power auxiliary components. The auxiliary components may include balance of plant (BOP) components of the ammonia reforming system 100 such as compressors and pumps. The auxiliary components may include the air supply unit 116 configured to provide oxygen (e.g., the air stream 118) to the combustion heater 109, and/or an air supply unit 3502 configured to provide oxygen (e.g., an air stream 3504) to the hydrogen processing module 535 (e.g., the fuel cell 124).

For example, in some cases, at least about 50, 55, 60, 65, 70, 75, 80, 85, 90, or 95% of the mechanical work or electricity 537 generated by the hydrogen processing module 535 is not used for at least one of vehicle propulsion (e.g., driving wheels, propellers, rotors, etc.), battery charging, or hotel load (e.g., at least one of climate control, communications, entertainment, lighting, refrigeration, or water distribution).

In some cases, at least about 50, 55, 60, 65, 70, 75, 80, 85, 90, or 95% of the mechanical work or electricity 537 generated by the hydrogen processing module 535 is used to power at least one of (1) the air supply unit 116 configured to provide oxygen to the combustion heater or (2) the air supply unit 3502 configured to provide oxygen to the hydrogen processing module 535.

### Computer Systems

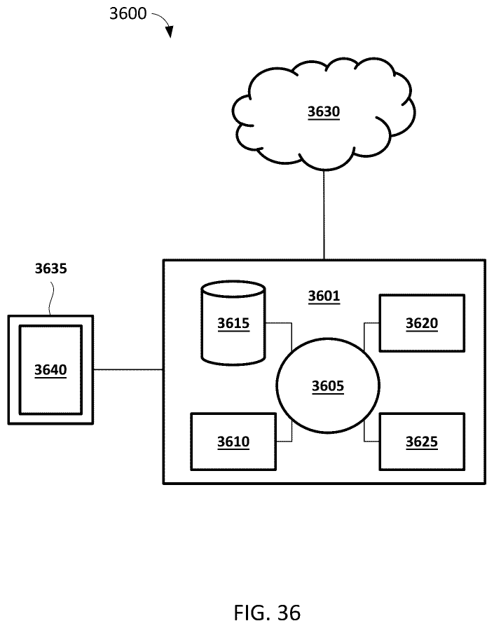

The present disclosure provides computer systems (e.g., controllers, computing devices and/or computers) that are programmed to implement methods of the disclosure. FIG. 36 shows a computer system 3601 that is programmed or otherwise configured to control the systems disclosed herein. The computer system 3601 can regulate various aspects of the systems disclosed in the present disclosure. The computer system 3601 can be an electronic device of a user or a computer system that is remotely located with respect to the electronic device. The electronic device can be a mobile electronic device.

The computer system 3601 includes a central processing unit (CPU, also “processor” and “computer processor” herein) 3605, which can be a single core or multi core processor, or a plurality of processors for parallel processing. The computer system 3601 also includes memory or memory location 3610 (e.g., random-access memory, read-only memory, flash memory), electronic storage unit 3615 (e.g., hard disk), communication interface 3620 (e.g., network adapter) for communicating with one or more other systems, and peripheral devices 3625, such as cache, other memory, data storage and/or electronic display adapters. The memory 3610, storage unit 3615, interface 3620 and peripheral devices 3625 are in communication with the CPU 3605 through a communication bus (solid lines), such as a motherboard. The storage unit 3615 can be a data storage unit (or data repository) for storing data. The computer system 3601 can be operatively coupled to a computer network (“network”) 3630 with the aid of the communication interface 3620. The network 3630 can be the Internet, an internet and/or extranet, or an intranet and/or extranet that is in communication with the Internet. The network 3630 in some cases is a telecommunication and/or data network. The network 3630 can include one or more computer servers, which can enable distributed computing, such as cloud computing. The network 3630, in some cases with the aid of the computer system 3601, can implement a peer-to-peer network, which may enable devices coupled to the computer system 3601 to behave as a client or a server.

The CPU 3605 can execute a sequence of machine-readable instructions, which can be embodied in a program or software. The instructions may be stored in a memory location, such as the memory 3610. The instructions can be directed to the CPU 3605, which can subsequently program or otherwise configure the CPU 3605 to implement methods of the present disclosure. Examples of operations performed by the CPU 3605 can include fetch, decode, execute, and writeback.

The CPU 3605 can be part of a circuit, such as an integrated circuit. One or more other components of the system 3601 can be included in the circuit. In some cases, the circuit is an application specific integrated circuit (ASIC).

The storage unit 3615 can store files, such as drivers, libraries and saved programs. The storage unit 3615 can store user data, e.g., user preferences and user programs. The computer system 3601 in some cases can include one or more additional data storage units that are external to the computer system 3601, such as located on a remote server that is in communication with the computer system 3601 through an intranet or the Internet.

The computer system 3601 can communicate with one or more remote computer systems through the network 3630. For instance, the computer system 3601 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 3601 via the network 3630.

Methods as described herein can be implemented by way of machine (e.g., computer processor) executable code stored on an electronic storage location of the computer system 3601, such as, for example, on the memory 3610 or electronic storage unit 3615. The machine executable or machine-readable code can be provided in the form of software. During use, the code can be executed by the processor 3605. In some cases, the code can be retrieved from the storage unit 3615 and stored on the memory 3610 for ready access by the processor 3605. In some situations, the electronic storage unit 3615 can be precluded, and machine-executable instructions are stored on memory 3610.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 3601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 3601 can include or be in communication with an electronic display 3635 that comprises a user interface (UI) 3640 for providing. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 3605.

It is noted that the computer system 3601 may be substantially similar or substantially identical to the controller 200 described with respect to FIGS. 5A and 5I. For example, the processor(s) 202 may be substantially similar or substantially identical to the central processing unit 3605, and the memory 204 may be substantially similar or substantially identical to the memory 3610.

### OTHER EMBODIMENTS

Embodiment 1. A method for reforming ammonia, the method comprising:
(a) heating a first reformer to a first target temperature range;
(b) directing ammonia to the first reformer to produce reformate comprising hydrogen and nitrogen;
(c) combusting the reformate in a combustion heater to heat a second reformer to a second target temperature range; and
(d) directing additional ammonia to the second reformer to produce additional reformate, wherein a first portion of a reformate stream is combusted to heat the second reformer while ammonia is being reformed in the second reformer, wherein the reformate stream comprises the reformate, the additional reformate, or a combination thereof.

Embodiment 2. The method of Embodiment 1, wherein the first portion of the reformate stream is produced from the ammonia, the additional ammonia, or a combination thereof.

Embodiment 3. The method of Embodiment 1, further comprising processing a second portion of the reformate stream in a hydrogen processing module.

Embodiment 4. The method of Embodiment 3, wherein the hydrogen processing module is a fuel cell.

Embodiment 5. The method of Embodiment 1, wherein the reformate stream is directed through a hydrogen processing module prior to combusting the first portion of the reformate stream to heat the second reformer.

Embodiment 6. The method of Embodiment 1, wherein the reformate stream from the first reformer is further reformed in the second reformer.

Embodiment 7. The method of Embodiment 1, wherein the additional reformate from the second reformer is directed to the first reformer.

Embodiment 8. The method of Embodiment 7, wherein the additional reformate from the second reformer is further reformed in the first reformer.

Embodiment 9. The method of Embodiment 1, wherein the additional ammonia is directed to the first reformer before being directed to the second reformer.

Embodiment 10. The method of Embodiment 1, wherein a pressure of the reformate stream is reduced when the reformate stream is directed through the hydrogen processing module compared to when the reformate stream is not directed through the hydrogen processing module.

Embodiment 11. The method of Embodiment 10, wherein a threshold amount of the reformate stream being directed to the hydrogen processing module results in directing at least about 80% of the reformate stream to the hydrogen processing module.

Embodiment 12. The method of Embodiment 1, wherein an amount of ammonia directed to the second reformer is increased over a time period, wherein the time period begins when the second reformer is heated to the second target temperature range.

Embodiment 13. The method of Embodiment 1, wherein the amount of ammonia directed to the second reformer is increased to a first target ammonia flowrate range.

Embodiment 14. The method of Embodiment 13, wherein the reformate stream is directed to a hydrogen processing module when the first target ammonia flowrate range is reached.

Embodiment 15. The method of Embodiment 14, wherein the ammonia flowrate is subsequently increased to a second target ammonia flowrate when the first target ammonia flowrate range is reached.

Embodiment 16. The method of Embodiment 1, wherein the first portion of the reformate stream is combusted with oxygen, and the oxygen is provided in a substantially constant proportion relative to the hydrogen in the first portion of the reformate stream.

Embodiment 17. The method of Embodiment 1, further comprising ceasing to perform (a)-(c) after the second reformer reaches the second target temperature range.

Embodiment 18. The method of Embodiment 1, wherein the first portion of the reformate stream is controlled so that the second reformer maintains a temperature in the second target temperature range.

Embodiment 19. The method of Embodiment 1, wherein combustion of the reformate stream maintains a temperature in the second reformer in the second target temperature range.

Embodiment 20. The method of Embodiment 1, wherein the reformate stream is directed to the combustion heater in thermal communication with the second reformer so that the combustion heater receives at least about 90% of the reformate stream.

Embodiment 21. The method of Embodiment 20, wherein at least a portion of the reformate stream is directed out of the combustion heater.

Embodiment 22. The method of Embodiment 20, further comprising increasing an amount of a second portion of the reformate stream that is processed in a hydrogen processing module.

Embodiment 23. The method of Embodiment 20, further comprising increasing the amount of ammonia directed to the second reformer to a first target ammonia flowrate range.

Embodiment 24. The method of Embodiment 20, wherein the reformate stream is combusted with a stoichiometric excess of oxygen, wherein the combusting is performed at an air-to-fuel ratio of greater than about 1 and less than about 5.

Embodiment 25. The method of Embodiment 1, wherein the reformate stream or portion thereof is provided to a heat recovery module.

Embodiment 26. The method of Embodiment 25, wherein the heat recovery module generates at least one of electricity, mechanical power, or combinations thereof.

Embodiment 27. The method of Embodiment 25, wherein the reformate stream or portion thereof is provided to an auxiliary combustor configured to transfer heat to the heat recovery module, wherein the auxiliary combustor is separate from the combustion heater.

Embodiment 28. The method of Embodiment 27, wherein directing the reformate stream or portion thereof to the heat recovery module bypasses the combustion heater.

Embodiment 29. The method of Embodiment 1, wherein the first reformer is electrically heated.

Embodiment 30. The method of Embodiment 1, wherein the first reformer is heated using combustion of a fuel.

Embodiment 31. The method of Embodiment 1, wherein the reformate stream is combusted with a stoichiometric excess of oxygen.

Embodiment 32. The method of Embodiment 31, wherein combusting the reformate stream with a stoichiometric excess of oxygen is performed at an air-to-fuel ratio of greater than about 1 and less than about 5.

Embodiment 33. The method of Embodiment 31, wherein the oxygen is sourced from air.

Embodiment 34. The method of Embodiment 1, wherein the first reformer comprises a first ammonia reforming catalyst and the second reformer comprises a second ammonia reforming catalyst.

Embodiment 35. The method of Embodiment 34, wherein the first and second ammonia reforming catalysts are the same catalyst.

Embodiment 36. The method of Embodiment 1, wherein the first target temperature range and the second target temperature range at least partially overlap.

Embodiment 37. The method of Embodiment 1, further comprising directing a combustion exhaust from the combustion heater to a heat recovery module.

Embodiment 38. The method of Embodiment 37, wherein the heat recovery module generates at least one of electrical power or mechanical power.

Embodiment 39. The method of Embodiment 37, wherein the combustion exhaust comprises one or more of hydrogen, nitrogen, oxygen, or water.

Embodiment 40. The method of Embodiment 37, wherein the heat recovery module recovers at least one of exhaust heat or hydrogen from the combustion heater.

Embodiment 41. The method of Embodiment 37, wherein the heat recovery module comprises a hydrogen separation membrane that recovers hydrogen from the combustion exhaust.

Embodiment 42. The method of Embodiment 37, further comprising combusting the reformate stream in an auxiliary combustor configured to transfer heat to the heat recovery module, wherein the auxiliary combustor is separate from the combustion heater.

Embodiment 43. The method of Embodiment 37, wherein the heat recovery module is a boiler configured to generate steam.

Embodiment 44. The method of Embodiment 43, further comprising directing the steam to an ammonia filter configured to remove trace or residual ammonia from the reformate stream, wherein the steam regenerates the ammonia filter by desorbing the trace or residual ammonia from the ammonia filter.

Embodiment 45. The method of Embodiment 37, wherein the heat recovery module comprises a heat exchanger.

Embodiment 46. The method of Embodiment 45, wherein the heat exchanger comprises a shell-and-tube heat exchanger or a plate heat exchanger.

Embodiment 47. The method of Embodiment 37, wherein the heat recovery module comprises a turbocharger.

Embodiment 48. The method of Embodiment 47, wherein the turbocharger is configured to provide mechanical power to a compressor, wherein the compressor is configured to compress air.

Embodiment 49. The method of Embodiment 48, wherein the air is provided to the combustion heater for combustion of the reformate stream.

Embodiment 50. The method of Embodiment 37, wherein the heat recovery module comprises a turbine.

Embodiment 51. The method of Embodiment 50, wherein the turbine is configured to generate mechanical power for propulsion of a vehicle.

Embodiment 52. The method of Embodiment 50, wherein the turbine comprises a generator configured to generate electrical power for an electrical motor, wherein mechanical power generated by the electrical motor powers propulsion of a vehicle.

Embodiment 53. The method of Embodiment 50, wherein the turbine comprises a generator configured to generate electrical power for a battery.

Embodiment 54. The method of Embodiment 50, wherein the hydrogen processing module is a fuel cell configured to generate electrical power for an electrical motor, wherein mechanical power generated by the electrical motor and the mechanical power generated by the turbine are combined to power propulsion of a vehicle.

Embodiment 55. The method of Embodiment 50, wherein the hydrogen processing module is a combustion engine configured to generate mechanical power, wherein the mechanical power generated by the combustion engine and the mechanical power generated by the turbine are combined to power propulsion of a vehicle.

Embodiment 56. The method of Embodiment 37, wherein the heat recovery module is a Rankine module comprising a boiler, a turbine, and a condenser, wherein a working fluid is configured to circulate between the boiler, the turbine, and the condenser.

Embodiment 57. The method of Embodiment 56, wherein the turbine of the Rankine module is configured to generate electrical power or mechanical power.

Embodiment 58. The method of Embodiment 56, wherein the working fluid comprises water.

Embodiment 59. The method of Embodiment 1, wherein the reformate stream or portion thereof is provided to a hydrogen separation membrane.

Embodiment 60. The method of Embodiment 59, wherein directing the reformate stream or portion thereof to the hydrogen separation membrane bypasses the combustion heater.

Embodiment 61. The method of Embodiment 1, further comprising reigniting combustion in the combustion heater based at least in part on a temperature of a combustion exhaust from the combustion heater being less than a threshold temperature.

Embodiment 62. The method of Embodiment 1, further comprising reigniting combustion in the combustion heater based at least in part on an oxygen concentration of a combustion exhaust from the combustion heater being greater than a threshold oxygen concentration.

Embodiment 63. A method for reforming ammonia, the method comprising:
(a) directing ammonia to a reformer at an ammonia flow rate to produce a reformate stream comprising hydrogen and nitrogen;
(b) combusting a first portion of the reformate stream with oxygen at an oxygen flow rate in a combustion heater to heat the reformer;
(c) processing a second portion of the reformate stream in a hydrogen processing module; and
(d) based at least in part on a stimulus, performing one or more of:
   (i) changing the ammonia flow rate,
   (ii) changing a percentage of the reformate stream that is the first portion of the reformate stream,
(iii) changing a percentage of the reformate stream that is the second portion of the reformate stream, or
(iv) changing an oxygen flow rate.

Embodiment 64. The method of Embodiment 63, wherein at least two of (i)-(iv) are performed.

Embodiment 65. The method of Embodiment 63, wherein at least three of (i)-(iv) are performed.

Embodiment 66. The method of Embodiment 63, wherein all of (i)-(iv) are performed.

Embodiment 67. The method of Embodiment 63, wherein the stimulus comprises a change in an amount of the hydrogen used by the hydrogen processing module.

Embodiment 68. The method of Embodiment 63, wherein the stimulus comprises a temperature of the reformer being outside of a target temperature range.

Embodiment 69. The method of Embodiment 63, wherein the stimulus comprises a change in an amount or concentration of ammonia in the reformate stream.

Embodiment 70. The method of Embodiment 63, wherein one or more of (i)-(iv) are performed so that:
(a) a temperature of the reformer is within a target temperature range; and
(b) at most about 10% of the reformate is vented or flared.

Embodiment 71. The method of Embodiment 70, wherein one or more of (i)-(iv) are achieved for at least about 95% of an operational time period.

Embodiment 72. The method of Embodiment 71, wherein the operational time period is at least about 8 consecutive hours.

Embodiment 73. The method of Embodiment 63, wherein the stimulus is based at least in part on an increased amount of the hydrogen used by the hydrogen processing module.

Embodiment 74. The method of Embodiment 73, wherein the increased amount of hydrogen is a projected increased amount of hydrogen.

Embodiment 75. The method of Embodiment 73, wherein, based on the stimulus, one or more of:
(a) the ammonia flow rate is increased;
(b) the percentage of the reformate stream that is the first portion of the reformate stream is decreased; or
(c) the percentage of the reformate stream that is the second portion of the reformate stream is increased.

Embodiment 76. The method of Embodiment 75, wherein the oxygen flow rate is increased when (a) is performed.

Embodiment 77. The method of Embodiment 75, wherein the oxygen flow rate is decreased when at least one of (b) or (c) is performed.

Embodiment 78. The method of Embodiment 63, wherein the stimulus is based at least in part on a decreased amount of the hydrogen used by the hydrogen processing module.

Embodiment 79. The method of Embodiment 78, wherein the decreased amount of hydrogen is a projected decreased amount of hydrogen.

Embodiment 80. The method of Embodiment 78, based on the stimulus one or more of:
(a) the ammonia flow rate is decreased;
(b) the percentage of the reformate stream that is the first portion of the reformate stream is increased; or
(c) the percentage of the reformate stream that is the second portion of the reformate stream is decreased.

Embodiment 81. The method of Embodiment 80, wherein the oxygen flow rate is decreased when (a) is performed.

Embodiment 82. The method of Embodiment 80, wherein the oxygen flow rate is increased when at least one of (b) or (c) is performed.

Embodiment 83. The method of Embodiment 63, wherein the stimulus comprises (a) a discontinued processing of hydrogen using the hydrogen processing module or (b) a fault or malfunction of the hydrogen processing module.

Embodiment 84. The method of Embodiment 63, wherein the hydrogen processing module comprises a plurality of hydrogen processing modules, and the stimulus comprises at least one of (a) a discontinued processing of the hydrogen using one of the plurality of hydrogen processing modules or (b) a fault or malfunction in one of the plurality of hydrogen processing modules.

Embodiment 85. The method of Embodiment 63, wherein the percentage of the reformate stream that is the second portion of the reformate stream is changed to about zero percent in response to the stimulus.

Embodiment 86. The method of Embodiment 63, wherein at most about 10% of the reformate stream is directed to the hydrogen processing module in response to the stimulus.

Embodiment 87. The method of Embodiment 63, wherein at least about 90% of the reformate stream is directed to a combustion heater in thermal communication with the reformer in response to the stimulus.

Embodiment 88. The method of Embodiment 63, wherein a portion of the reformate stream is directed out of the combustion heater in response to the stimulus.

Embodiment 89. The method of Embodiment 63, wherein the stimulus is detected using a sensor.

Embodiment 90. The method of Embodiment 63, wherein the stimulus is communicated to a controller.

Embodiment 91. The method of Embodiment 63, wherein (d) is performed with the aid of a programmable computer or controller.

Embodiment 92. The method of Embodiment 63, wherein (d) is performed using a flow control module.

Embodiment 93. The method of Embodiment 63, wherein the stimulus is a pressure.

Embodiment 94. The method of Embodiment 93, wherein the pressure is increased in response to decreasing a flowrate to the hydrogen processing module.

Embodiment 95. The method of Embodiment 93, wherein the pressure is a pressure of the reformate stream.

Embodiment 96. The method of Embodiment 63, wherein the reformate stream is combusted with a stoichiometric excess of oxygen.

Embodiment 97. The method of Embodiment 63, wherein combusting the reformate stream with a stoichiometric excess of oxygen is performed at an air-to-fuel ratio of greater than about 1 and less than about 5.

Embodiment 98. The method of Embodiment 63, wherein the hydrogen processing module is a fuel cell.

Embodiment 99. The method of Embodiment 63, further comprising directing a combustion exhaust from the combustion heater to a heat recovery module.

Embodiment 100. The method of Embodiment 99, wherein the heat recovery module generates at least one of electrical power or mechanical power.

Embodiment 101. The method of Embodiment 99, wherein the combustion exhaust comprises one or more of hydrogen, nitrogen, oxygen, or water.

Embodiment 102. The method of Embodiment 99, wherein the heat recovery module recovers at least one of exhaust heat or hydrogen from the combustion heater.

Embodiment 103. The method of Embodiment 99, wherein the heat recovery module comprises a hydrogen separation membrane that recovers hydrogen from the combustion exhaust.

Embodiment 104. The method of Embodiment 99, further comprising combusting the reformate stream in an auxiliary combustor configured to transfer heat to the heat recovery module, wherein the auxiliary combustor is separate from the combustion heater.

Embodiment 105. The method of Embodiment 99, wherein the heat recovery module is a boiler configured to generate steam.

Embodiment 106. The method of Embodiment 105, further comprising directing the steam to an ammonia filter configured to remove trace or residual ammonia from the reformate stream, wherein the steam regenerates the ammonia filter by desorbing the trace or residual ammonia from the ammonia filter.

Embodiment 107. The method of Embodiment 99, wherein the heat recovery module comprises a heat exchanger.

Embodiment 108. The method of Embodiment 107, wherein the heat exchanger comprises a shell-and-tube heat exchanger or a plate heat exchanger.

Embodiment 109. The method of Embodiment 99, wherein the heat recovery module comprises a turbocharger.

Embodiment 110. The method of Embodiment 109, wherein the turbocharger is configured to provide mechanical power to a compressor, wherein the compressor is configured to compress air.

Embodiment 111. The method of Embodiment 110, wherein the air is provided to the combustion heater for combustion of the reformate stream.

Embodiment 112. The method of Embodiment 99, wherein the heat recovery module comprises a turbine.

Embodiment 113. The method of Embodiment 112, wherein the turbine is configured to generate mechanical power for propulsion of a vehicle.

Embodiment 114. The method of Embodiment 112, wherein the turbine comprises a generator configured to generate electrical power for an electrical motor, wherein mechanical power generated by the electrical motor powers propulsion of a vehicle.

Embodiment 115. The method of Embodiment 112, wherein the turbine comprises a generator configured to generate electrical power for a battery.

Embodiment 116. The method of Embodiment 112, wherein the hydrogen processing module is a fuel cell configured to generate electrical power for an electrical motor, wherein mechanical power generated by the electrical motor and the mechanical power generated by the turbine are combined to power propulsion of a vehicle.

Embodiment 117. The method of Embodiment 112, wherein the hydrogen processing module is a combustion engine configured to generate mechanical power, wherein the mechanical power generated by the combustion engine and the mechanical power generated by the turbine are combined to power propulsion of a vehicle.

Embodiment 118. The method of Embodiment 99, wherein the heat recovery module is a Rankine module comprising a boiler, a turbine, and a condenser, wherein a working fluid is configured to circulate between the boiler, the turbine, and the condenser.

Embodiment 119. The method of Embodiment 118, wherein the turbine of the Rankine module is configured to generate electrical power or mechanical power.

Embodiment 120. The method of Embodiment 118, wherein the working fluid comprises water.

Embodiment 121. The method of Embodiment 63, wherein the reformate stream or portion thereof is provided to a hydrogen separation membrane.

Embodiment 122. The method of Embodiment 121, wherein directing the reformate stream or portion thereof to the hydrogen separation membrane bypasses the combustion heater.

Embodiment 123. The method of Embodiment 63, comprising reigniting combustion in the combustion heater based at least in part on a temperature of a combustion exhaust from the combustion heater being less than a threshold temperature.

Embodiment 124. The method of Embodiment 63, comprising reigniting combustion in the combustion heater based at least in part on an oxygen concentration of a combustion exhaust from the combustion heater being greater than a threshold oxygen concentration.

Embodiment 125. A method for reforming ammonia, the method comprising:
(a) directing ammonia to a reformer at an ammonia flow rate to produce a reformate stream comprising hydrogen and nitrogen;
(b) combusting a first portion of the reformate stream with oxygen at an oxygen flow rate in a combustion heater to heat the reformer;
(c) processing a second portion of the reformate stream in a hydrogen processing module;
(d) measuring a temperature in the reformer or the combustion heater; and
(e) based at least in part on the measured temperature being outside of a target temperature range of the reformer or the combustion heater, performing one or more of:
(i) changing the ammonia flow rate,
(ii) changing the oxygen flow rate,
(iii) changing a percentage of the reformate stream that is the second portion of the reformate stream
(iv) changing a percentage of the reformate stream that is the first portion of the reformate stream, or
(v) changing a percentage of the reformate stream that is directed out of the combustion heater.

Embodiment 126. The method of Embodiment 125, wherein the hydrogen processing module is a fuel cell.

Embodiment 127. The method of Embodiment 125, wherein the reformer comprises an ammonia reforming catalyst.

Embodiment 128. The method of Embodiment 125, wherein at least two of (i)-(v) are performed.

Embodiment 129. The method of Embodiment 125, wherein at least three of (i)-(v) are performed.

Embodiment 130. The method of Embodiment 125, wherein all of (i)-(v) are performed.

Embodiment 131. The method of Embodiment 125, wherein the temperature is measured using a temperature sensor.

Embodiment 132. The method of Embodiment 125, wherein the measured temperature is communicated to a controller.

Embodiment 133. The method of Embodiment 125, wherein (i)-(v) are performed with the aid of a controller.

Embodiment 134. The method of Embodiment 125, wherein at least one of (iii)-(v) are performed using a flow control module.

Embodiment 135. The method of Embodiment 125, wherein at least one of (iii)-(v) are performed by changing the second portion of reformate processed in the hydrogen processing module.

Embodiment 136. The method of Embodiment 125, the method comprising:
based at least in part on the measured temperature being greater than the target temperature range, performing one or more of:
(q) increasing the ammonia flow rate;
(r) increasing the percentage of the reformate stream that is the second portion of the reformate stream that is processed by the hydrogen processing module;
(s) decreasing the percentage of the reformate stream that is the first portion of the reformate stream;
(t) increasing the percentage of the reformate stream that is directed out of the combustion heater; or
(u) changing the oxygen flow rate.

Embodiment 137. The method of Embodiment 136, wherein increasing the percentage of the reformate stream that is the second portion of the reformate stream decreases the first portion of the reformate stream that is combusted.

Embodiment 138. The method of Embodiment 137, wherein the hydrogen processing module is a fuel cell, and the first portion of the reformate stream is an anode off-gas that is directed from the fuel cell to the combustion heater.

Embodiment 139. The method of Embodiment 136, wherein decreasing the percentage of the reformate stream that is the first portion comprises decreasing the ammonia flow rate to the reformer to produce less hydrogen in the reformate stream.

Embodiment 140. The method of Embodiment 136, wherein the hydrogen processing module is a fuel cell, and increasing the percentage of the second portion of the reformate stream that is processed by the hydrogen processing module increases an amount of power output by the fuel cell.

Embodiment 141. The method of Embodiment 136, wherein the reformate stream is combusted with a stoichiometric excess of oxygen and changing the oxygen flow rate increases the oxygen flow rate.

Embodiment 142. The method of Embodiment 136, wherein the reformate stream is combusted with a stoichiometric excess of hydrogen and changing the oxygen flow rate decreases the oxygen flow rate.

Embodiment 143. The method of Embodiment 136, further comprising adding water to the reformate stream to decrease the temperature of the reformer or the combustion heater.

Embodiment 144. The method of Embodiment 143, wherein the hydrogen processing module is a fuel cell, wherein the water is sourced from a cathode off-gas of the fuel cell.

Embodiment 145. The method of Embodiment 136, wherein (t) comprises venting or flaring the percentage of the reformate stream that is directed out of the combustion heater.

Embodiment 146. The method of Embodiment 136, wherein (t) comprises directing the percentage of the reformate stream that is directed out of the combustion heater to a heat recovery module.

Embodiment 147. The method of Embodiment 125, the method comprising:
based at least in part on the measured temperature being less than the target temperature range, performing one or more of:
(q) decreasing the ammonia flow rate
(r) decreasing the percentage of the reformate stream that is the second portion of the reformate stream that is processed by the hydrogen processing module;
(s) increasing the percentage of the reformate stream that is the first portion of the reformate stream;
(t) decreasing the percentage of the reformate stream that is directed out of the combustion heater; or
(v) changing the oxygen flow rate.

Embodiment 148. The method of Embodiment 147, wherein decreasing the percentage of the second portion of the reformate stream that is the second portion increases the first portion of the reformate stream that is combusted.

Embodiment 149. The method of Embodiment 148, wherein the hydrogen processing module is a fuel cell, and the first portion of the reformate stream is an anode off-gas that is directed from the fuel cell to the combustion heater.

Embodiment 150. The method of Embodiment 147, wherein increasing the percentage of the reformate stream that is the first portion comprises increasing the ammonia flow rate to the reformer to produce more hydrogen in the reformate stream.

Embodiment 151. The method of Embodiment 147, wherein the hydrogen processing module is a fuel cell, and decreasing the percentage of the second portion of the reformate stream that is processed by the hydrogen processing module decreases an amount of power output by the fuel cell.

Embodiment 152. The method of Embodiment 147, wherein the reformate stream is combusted with a stoichiometric excess of oxygen and changing the oxygen flow rate decreases the oxygen flow rate.

Embodiment 153. The method of Embodiment 147, wherein the reformate stream is combusted with a stoichiometric excess of hydrogen and changing the oxygen flow rate increases the oxygen flow rate.

Embodiment 154. The method of Embodiment 147, wherein (t) comprises venting or flaring the percentage of the reformate stream that is directed out of the combustion heater.

Embodiment 155. The method of Embodiment 147, wherein (t) comprises directing the percentage of the reformate stream that is directed out of the combustion heater to a heat recovery module.

Embodiment 156. The method of Embodiment 125, further comprising:
(x) calculating a temperature difference between the temperature measured in the reformer or the combustion heater and a set-point temperature within the target temperature range; and
(y) changing one or more of (i)-(v) by an amount that is based at least in part on the temperature difference.

Embodiment 157. The method of Embodiment 156, wherein one or more of (i)-(v) are changed by a proportional factor.

Embodiment 158. The method of Embodiment 157, wherein the proportional factor is different for each of (i)-(v).

Embodiment 159. The method of Embodiment 156, further comprising repeating (x) at a subsequent time point to obtain a subsequent temperature difference and repeating (y) to further change one or more of (i)-(v) by an amount that is proportional to the subsequent temperature difference.

Embodiment 160. The method of Embodiment 125, wherein (x) and (y) are repeated until the measured temperature is within the target temperature range.

Embodiment 161. The method of Embodiment 160, wherein the temperature measured in the reformer or the combustion heater is a first temperature that is measured at a first time point, the method further comprising:
(q) at second time point subsequent to the first time point, measuring a second temperature of the reformer or the combustion heater;
(r) calculating a time period between the first time point and the second time point;
(s) calculating a temperature difference between the first temperature and the second temperature; and
(t) changing one or more of (i)-(v) by an amount that is based at least in part on the time period and the temperature difference.

Embodiment 162. The method of Embodiment 161, further comprising repeating (q)-(t) until the measured temperature is within the target temperature range.

Embodiment 163. The method of Embodiment 125, wherein the reformate stream is combusted with a stoichiometric excess of oxygen.

Embodiment 164. The method of Embodiment 125, wherein combusting the reformate stream with a stoichiometric excess of oxygen comprises combusting at an air-to-fuel ratio of greater than about 1 and less than about 5.

Embodiment 165. The method of Embodiment 125, further comprising directing a combustion exhaust from the combustion heater to a heat recovery module.

Embodiment 166. The method of Embodiment 165, wherein the heat recovery module generates at least one of electrical power or mechanical power.

Embodiment 167. The method of Embodiment 165, wherein the combustion exhaust comprises one or more of hydrogen, nitrogen, oxygen, or water.

Embodiment 168. The method of Embodiment 165, wherein the heat recovery module recovers at least one of exhaust heat or hydrogen from the combustion heater.

Embodiment 169. The method of Embodiment 165, wherein the heat recovery module comprises a hydrogen separation membrane that recovers hydrogen from the combustion exhaust.

Embodiment 170. The method of Embodiment 165, further comprising combusting the reformate stream in an auxiliary combustor configured to transfer heat to the heat recovery module, wherein the auxiliary combustor is separate from the combustion heater.

Embodiment 171. The method of Embodiment 165, wherein the heat recovery module is a boiler configured to generate steam.

Embodiment 172. The method of Embodiment 171, further comprising directing the steam to an ammonia filter configured to remove trace or residual ammonia from the reformate stream, wherein the steam regenerates the ammonia filter by desorbing the trace or residual ammonia from the ammonia filter.

Embodiment 173. The method of Embodiment 165, wherein the heat recovery module comprises a heat exchanger.

Embodiment 174. The method of Embodiment 173, wherein the heat exchanger comprises a shell-and-tube heat exchanger or a plate heat exchanger.

Embodiment 175. The method of Embodiment 165, wherein the heat recovery module comprises a turbocharger.

Embodiment 176. The method of Embodiment 175, wherein the turbocharger is configured to provide mechanical power to a compressor, wherein the compressor is configured to compress air.

Embodiment 177. The method of Embodiment 176, wherein the air is provided to the combustion heater for combustion of the reformate stream.

Embodiment 178. The method of Embodiment 165, wherein the heat recovery module comprises a turbine.

Embodiment 179. The method of Embodiment 178, wherein the turbine is configured to generate mechanical power for propulsion of a vehicle.

Embodiment 180. The method of Embodiment 178, wherein the turbine comprises a generator configured to generate electrical power for an electrical motor, wherein mechanical power generated by the electrical motor powers propulsion of a vehicle.

Embodiment 181. The method of Embodiment 178, wherein the turbine comprises a generator configured to generate electrical power for a battery.

Embodiment 182. The method of Embodiment 178, wherein the hydrogen processing module is a fuel cell configured to generate electrical power for an electrical motor, wherein mechanical power generated by the electrical motor and the mechanical power generated by the turbine are combined to power propulsion of a vehicle.

Embodiment 183. The method of Embodiment 178, wherein the hydrogen processing module is a combustion engine configured to generate mechanical power, wherein the mechanical power generated by the combustion engine and the mechanical power generated by the turbine are combined to power propulsion of a vehicle.

Embodiment 184. The method of Embodiment 165, wherein the heat recovery module is a Rankine module comprising a boiler, a turbine, and a condenser, wherein a working fluid is configured to circulate between the boiler, the turbine, and the condenser.

Embodiment 185. The method of Embodiment 184, wherein the turbine of the Rankine module is configured to generate electrical power or mechanical power.

Embodiment 186. The method of Embodiment 184, wherein the working fluid comprises water.

Embodiment 187. The method of Embodiment 125, wherein the reformate stream or portion thereof is provided to a hydrogen separation membrane.

Embodiment 188. The method of Embodiment 187, wherein directing the reformate stream or portion thereof to the hydrogen separation membrane bypasses the combustion heater.

Embodiment 189. The method of Embodiment 125, further comprising reigniting combustion in the combustion heater based at least in part on a temperature of a combustion exhaust from the combustion heater being less than a threshold temperature.

Embodiment 190. The method of Embodiment 125, further comprising reigniting combustion in the combustion heater based at least in part on an oxygen concentration of a combustion exhaust from the combustion heater being greater than a threshold oxygen concentration.

Embodiment 191. The method of Embodiment 125, wherein the reformer comprises a plurality of reformers, wherein at least one reformer of the plurality of reformers receives a different amount of the first portion of the reformate stream, compared to others of the reformers, based at least partially on the temperature of the at least one reformer being greater or less than the target temperature range.

Embodiment 192. The method of Embodiment 191, wherein the temperature of the at least one reformer is greater than the target temperature range, and the method comprises decreasing the first portion of the reformate stream provided to the at least one reformer.

Embodiment 193. The method of Embodiment 191, wherein the temperature of the at least one reformer is less than the target temperature range, and the method comprises increasing the first portion of the reformate stream provided to the at least one reformer.

Embodiment 194. The method of Embodiment 191, wherein the first portion of the reformate stream provided to the at least one reformer of the plurality of reformers is modulated using a flow control module.

Embodiment 195. The method of Embodiment 191, wherein the plurality of the reformers comprises at least one electrically heated reformer and at least one combustion-heated reformer.

Embodiment 196. The method of Embodiment 191, wherein at least two reformers of the plurality of reformers fluidically communicate in series so that the reformate stream exiting one of the at least two reformers is supplied to another of the at least two reformers.

Embodiment 197. The method of Embodiment 191, wherein at least two reformers of the plurality of reformers fluidically communicate in parallel.

Embodiment 198. The method of Embodiment 1, wherein the oxygen is sourced from air.

Embodiment 199. The method of Embodiment 63, wherein the oxygen is sourced from air.

Embodiment 200. The method of Embodiment 125, wherein the oxygen is sourced from air.

Embodiment 201. An ammonia (NH₃) reforming method, the method comprising:
(e) heating a first reformer to a first target temperature range;
(f) reforming an NH₃ stream at a first flowrate in the first reformer to generate a first reformate stream comprising hydrogen (H₂) and nitrogen (N₂);
(g) combusting the first reformate stream to heat a second reformer to a second target temperature range;
(h) reforming the NH₃ stream at a second flowrate in the second reformer to generate a second reformate stream comprising H₂ and N₂, wherein the second flowrate is greater than the first flowrate; and
(i) combusting a first portion of the second reformate stream to heat the second reformer.

Embodiment 202. The method of Embodiment 201, further comprising increasing the second flowrate to an operating flowrate.

Embodiment 203. The method of Embodiment 202, wherein the first flowrate is greater than about 1% and less than about 10% of the operating flowrate.

Embodiment 204. The method of Embodiment 202, wherein the second flowrate, prior to being increased to the operating flowrate, is greater than about 5% and less than about 50% of the operating flowrate.

Embodiment 205. The method of Embodiment 202, wherein the operating flowrate is chosen before (a).

Embodiment 206. The method of Embodiment 202, wherein the operating flowrate is changed after increasing the second flowrate to the operating flowrate.

Embodiment 207. The method of Embodiment 202, wherein the operating flowrate is chosen within a range of operating flowrates.

Embodiment 208. The method of Embodiment 202, wherein the operating flowrate is changed based on an increase in H₂ demand of an H₂ processing module configured to process H₂.

Embodiment 209. The method of Embodiment 208, wherein the H₂ processing module comprises a fuel cell configured to generate electricity.

Embodiment 210. The method of Embodiment 202, wherein the operating flowrate is chosen at least in part based on a H₂ processing capacity of an H₂ processing module configured to process H₂.

Embodiment 211. The method of Embodiment 210, wherein the H₂ processing module comprises a fuel cell configured to generate electricity.

Embodiment 212. The method of Embodiment 202, wherein the operating flowrate is chosen at least in part based on a reforming capacity of the first reformer, a reforming capacity of the second reformer, or a combination thereof.

Embodiment 213. The method of Embodiment 201, wherein the first reformate stream and the second reformate stream are separate streams.

Embodiment 214. The method of Embodiment 201, wherein the first reformate stream is combined with the second reformate stream.

Embodiment 215. The method of Embodiment 201, further comprising purging at least one of the first reformer or the second reformer before (a) or (b).

Embodiment 216. The method of Embodiment 201, further comprising vaporizing the NH₃ stream using an electric heater.

Embodiment 217. The method of Embodiment 201, further comprising vaporizing the NH₃ stream using a heat exchanger configured to exchange heat between (1) the NH₃ stream, and one or more of (2) the first reformate stream, the second reformate stream, or a hydrogen processing module configured to generate electricity.

Embodiment 218. The method of Embodiment 201, further comprising reducing power to an electrical heater in thermal communication with the first reformer.

Embodiment 219. The method of Embodiment 218, further comprising using the NH₃ stream to cool the first reformer after reducing power to the electrical heater.

Embodiment 220. The method of Embodiment 201, further comprising, after (c), decreasing a portion of the NH₃ stream that is reformed in the first reformer.

Embodiment 221. The method of Embodiment 201, further comprising, after (c), ceasing to reform the NH₃ stream in the first reformer.

Embodiment 222. The method of Embodiment 221, wherein ceasing to reform the NH₃ stream in the first reformer is performed after a measured temperature of the first reformer is less than or equal to a threshold temperature.

Embodiment 223. The method of Embodiment 222, wherein the threshold temperature is less than the first target temperature range.

Embodiment 224. The method of Embodiment 201, further comprising reforming residual NH₃ in the first reformate stream using the second reformer.

Embodiment 225. The method of Embodiment 201, further comprising reforming residual NH₃ in the second reformate stream using the first reformer.

Embodiment 226. The method of Embodiment 201, wherein a heat exchanger exchanges heat between (1) the NH₃ stream and at least one of (2) the first reformate stream or the second reformate stream.

Embodiment 227. The method of Embodiment 201, further comprising providing the NH₃ stream to the second reformer, wherein the NH₃ stream bypasses the first reformer.

Embodiment 228. The method of Embodiment 227, wherein the NH₃ stream bypasses the first reformer after (c) or before (d).

Embodiment 229. The method of Embodiment 201, wherein a heat exchanger is arranged in parallel fluid communication with the first reformer.

Embodiment 230. The method of Embodiment 229, further comprising providing the NH₃ stream to the heat exchanger, wherein the NH₃ stream bypasses the first reformer.

Embodiment 231. The method of Embodiment 230, wherein the NH₃ stream bypasses the first reformer after (c) or before (d).

Embodiment 232. The method of Embodiment 201, wherein the NH₃ stream is directed to the first reformer after exiting a heat exchanger, wherein the heat exchanger is configured to exchange heat between (1) the NH₃ stream and at least one of (2) the first reformate stream or the second reformate stream.

Embodiment 233. The method of Embodiment 201, further comprising directing the first reformate stream to a combustion heater in thermal communication with the second reformer.

Embodiment 234. The method of Embodiment 233, further comprising directing the first reformate stream to the second reformer before providing the first reformate stream to the combustion heater.

Embodiment 235. The method of Embodiment 233, further comprising directing the first reformate stream to the combustion heater, wherein the first reformate stream bypasses the second reformer.

Embodiment 236. The method of Embodiment 235, further comprising directing the first reformate stream to a heat exchanger before providing the first reformate stream to the combustion heater, wherein the heat exchanger is configured to exchange heat between the first reformate stream and the NH₃ stream.

Embodiment 237. The method of Embodiment 233, further comprising directing the first reformate stream to an NH₃ filter configured to remove residual NH₃ before providing the first reformate stream to the combustion heater.

Embodiment 238. The method of Embodiment 201, further comprising filtering at least one of the first reformate stream or the second reformate stream to remove residual NH₃.

Embodiment 239. The method of Embodiment 201, further comprising providing at least one of the first reformate stream or the second reformate stream to a combustion heater in thermal communication with the second reformer, wherein the at least one of the first reformate stream or the second reformate stream bypasses an NH₃ filter configured to remove residual NH₃.

Embodiment 240. The method of Embodiment 201, further comprising providing a second portion of the second reformate stream to an H₂ processing module.

Embodiment 241. The method of Embodiment 240, wherein the H₂ processing module comprises a fuel cell configured to generate electricity.

Embodiment 242. The method of Embodiment 240, wherein the H₂ processing module comprises a combustion engine configured to generate mechanical work.

Embodiment 243. The method of Embodiment 240, further comprising providing an off-gas comprising hydrogen from the H₂ processing module to a combustion heater in thermal communication with the second reformer.

Embodiment 244. The method of Embodiment 243, wherein the first portion of the second reformate stream is provided to the combustion heater upstream of the H₂ processing module.

Embodiment 245. The method of Embodiment 243, wherein (1) the first portion of the second reformate stream and (2) at least part of the off-gas are provided to the combustion heater simultaneously.

Embodiment 246. The method of Embodiment 243, wherein at least one of (1) the first portion of the second reformate stream or (2) at least part of the off-gas is not provided to the combustion heater.

Embodiment 247. The method of Embodiment 243, wherein (1) at least part of the off-gas is not provided to the combustion heater and (2) a remaining part of the off-gas is provided to the combustion heater.

Embodiment 248. The method of Embodiment 243, wherein an H₂ utilization rate of the H₂ processing module is greater than about 10% and less than about 90% of the H₂ in the second portion of the reformate stream.

Embodiment 249. The method of Embodiment 243, wherein an H₂ consumption rate of the H₂ processing module is constant within a tolerance, and the first portion of the second reformate stream is modulated to control a temperature in the second reformer.

Embodiment 250. The method of Embodiment 243, wherein an H₂ utilization rate of the H₂ processing module is constant within a tolerance, and the first portion of the second reformate stream is modulated to control a temperature in the second reformer.

Embodiment 251. The method of Embodiment 201, further comprising processing at least a portion of the first reformate stream in a secondary H₂ processing module.

Embodiment 252. The method of Embodiment 251, wherein the secondary H₂ processing module comprises a fuel cell configured to generate electricity.

Embodiment 253. The method of Embodiment 251, further comprising providing the first reformate stream to an NH₃ filter before providing at least the portion of the first reformate stream to the secondary H₂ processing module.

Embodiment 254. The method of Embodiment 251, further comprising providing an off-gas comprising hydrogen from the secondary H₂ processing module to a combustion heater in thermal communication with the second reformer.

Embodiment 255. The method of Embodiment 201, further comprising providing the first reformate stream, the second reformate stream, or a combination thereof to an ammonia oxidation catalyst to reduce residual ammonia.

Embodiment 256. The method of Embodiment 255, further comprising providing the first reformate stream, the second reformate stream, or the combination thereof to an NH₃ filter after providing the first reformate stream, the second reformate stream, or the combination thereof to the ammonia oxidation catalyst.

Embodiment 257. The method of Embodiment 201, further comprising transferring heat from (1) at least one of the first reformate stream or the second reformate stream to (2) the NH₃ stream.

Embodiment 258. The method of Embodiment 257, wherein the heat is transferred using a heat transfer fluid.

Embodiment 259. The method of Embodiment 201, further comprising transferring heat from (1) a H₂ processing module configured to process H₂ to (2) the NH₃ stream.

Embodiment 260. The method of Embodiment 259, wherein the heat is transferred using a heat transfer fluid.

Embodiment 261. The method of Embodiment 201, further comprising transferring heat from (1) a water or air source to (2) the NH₃ stream.

Embodiment 262. The method of Embodiment 261, wherein the heat is transferred using a heat transfer fluid.

Embodiment 263. The method of Embodiment 261, wherein the water or air source comprises seawater, freshwater, or air.

Embodiment 264. The method of Embodiment 201, further comprising transferring heat from (1) at least one of the first reformate stream or the second reformate stream to (2) a water or air source.

Embodiment 265. The method of Embodiment 264, wherein the heat is transferred using a heat transfer fluid.

Embodiment 266. The method of Embodiment 264, wherein the water or air source comprises seawater, freshwater, or air.

Embodiment 267. The method of Embodiment 201, further comprising transferring heat from (1) a H₂ processing module configured to process H₂ to (2) a water or air source.

Embodiment 268. The method of Embodiment 267, wherein the heat is transferred using a heat transfer fluid.

Embodiment 269. The method of Embodiment 267, wherein the water or air source comprises seawater, freshwater, or air.

Embodiment 270. The method of Embodiment 201, further comprising transferring heat from (1) a H₂ processing module configured to process H₂, the first reformate stream, the second reformate stream, or a combination thereof to (2) a water or air source.

Embodiment 271. The method of Embodiment 270, wherein the heat is transferred using a heat transfer fluid.

Embodiment 272. The method of Embodiment 270, wherein the water or air source comprises seawater, freshwater, or air.

Embodiment 273. The method of Embodiment 201, wherein the first reformer and the second reformer are a single reformer.

Embodiment 274. The method of Embodiment 273, wherein the single reformer is in thermal communication with an electric heater, a combustion heater, or a combination thereof.

Embodiment 275. An ammonia (NH₃) reforming system, the system comprising:
a first reformer configured to reform an NH₃ stream at a first flowrate and at a first target temperature range to generate a first reformate stream comprising hydrogen (H₂) and nitrogen (N₂); and
a second reformer configured to reform the NH₃ stream at a second flowrate and at a second target temperature range to generate a second reformate stream comprising H₂ and N₂,
wherein the second reformer is configured to be heated to the second target temperature range by combusting the first reformate stream,
wherein the second flowrate is greater than the first flowrate, and
wherein the second reformer is configured to be heated by combusting a first portion of the second reformate stream.

Embodiment 276. An ammonia (NH₃) reforming method, the method comprising:
(j) reforming an NH₃ stream at a first flowrate using an NH₃ reforming catalyst to generate a first reformate stream comprising hydrogen (H₂) and nitrogen (N₂);
(k) combusting the first reformate stream to heat the NH₃ reforming catalyst;
(l) reforming the NH₃ stream at a second flowrate using the NH₃ reforming catalyst to generate a second reformate stream comprising H₂ and N₂, wherein the second flowrate is greater than the first flowrate; and
(m) combusting a first portion of the second reformate stream to heat the NH₃ reforming catalyst.

Embodiment 277. The method of Embodiment 276, wherein the NH₃ reforming catalyst is in a reformer.

Embodiment 278. The method of Embodiment 276, wherein a first region of the NH₃ reforming catalyst is in a first reformer, and a second region of the NH₃ reforming catalyst is in a second reformer.

Embodiment 279. The method of Embodiment 276, wherein the NH₃ reforming catalyst is in thermal communication with an electric heater, a combustion heater, or a combination thereof.

Embodiment 280. The method of Embodiment 276, wherein the NH₃ reforming catalyst is heated by an electrical heater before (a).

Embodiment 281. The method of Embodiment 276, wherein a first region of the NH₃ reforming catalyst is heated by an electrical heater, and a second region of the NH₃ reforming catalyst is heated by a combustion heater.

Embodiment 282. The method of Embodiment 279, wherein (b) and (d) are performed using the combustion heater.

Embodiment 283. The method of Embodiment 276, wherein the NH₃ reforming catalyst is heated to a target temperature range.

Embodiment 284. The method of Embodiment 276, wherein the NH₃ reforming catalyst is at a target temperature range.

Embodiment 285. The method of Embodiment 276, wherein a first region of the NH₃ reforming catalyst is heated to a first target temperature range, and a second region of the NH₃ reforming catalyst is heated to a second target temperature range.

Embodiment 286. The method of Embodiment 285, wherein the first target temperature range and the second target temperature range at least partially overlap.

Embodiment 287. The method of Embodiment 285, wherein the first target temperature range and the second target temperature range are different.

Embodiment 288. The method of Embodiment 285, wherein a midpoint temperature of the first target temperature range is greater than a midpoint temperature of the second target temperature range.

Embodiment 289. An ammonia decomposition system, the system comprising:
a reformer configured to reform ammonia to generate a reformate stream comprising hydrogen, nitrogen, and residual ammonia;
a hydrogen processing module configured to utilize a portion of the hydrogen in the reformate stream, and output an exhaust comprising water;
a water extraction device configured to extract the water from the exhaust; and
an ammonia filter configured to reduce a concentration of the residual ammonia in the reformate stream using scrubbing fluid, wherein the scrubbing fluid comprises at least part of the water extracted from the exhaust.

Embodiment 290. The system of Embodiment 289, wherein the hydrogen processing module comprises a fuel cell.

Embodiment 291. The system of Embodiment 290, wherein a portion of the extracted water is used to humidify at least one of an anode or a cathode of the fuel cell.

Embodiment 292. The system of Embodiment 290, wherein the exhaust comprises an anode exhaust of the fuel cell or a cathode exhaust of the fuel cell.

Embodiment 293. The system of Embodiment 289, wherein at least about 10% of the scrubbing fluid is the extracted water.

Embodiment 294. The system of Embodiment 289, wherein about 100% of the scrubbing fluid is the extracted water.

Embodiment 295. The system of Embodiment 289, wherein a portion of the extracted water is provided to a combustion heater.

Embodiment 296. The system of Embodiment 289, wherein the ammonia filter is configured to discharge the scrubbing fluid.

Embodiment 297. The system of Embodiment 296, wherein the discharged scrubbing fluid comprises at least about 5% ammonia by weight and at most about 60% ammonia by weight.

Embodiment 298. The system of Embodiment 289, wherein at most 10% of the water extracted from the exhaust is discharged externally.

Embodiment 299. The system of Embodiment 289, wherein the scrubbing fluid comprises an acid.

Embodiment 300. The system of Embodiment 299, wherein the acid comprises sulfuric acid or nitric acid.

Embodiment 301. An ammonia decomposition system, the system comprising:
a reformer configured to reform ammonia to generate a reformate stream comprising hydrogen, nitrogen, and residual ammonia; and
a first NH₃ filter configured to reduce a concentration of the ammonia using scrubbing fluid.

Embodiment 302. The system of Embodiment 301, wherein the ammonia is provided to the first NH₃ filter from a position between an NH₃ storage tank and the reformer.

Embodiment 303. The system of Embodiment 302, wherein the position is at one or more fluid lines that fluidically couple at least one of:
an ammonia storage tank and the reformer;
the ammonia storage tank and a flow control module; or
the flow control module and the reformer.

Embodiment 304. The system of Embodiment 301, wherein the ammonia is diluted with air before being provided to the first NH₃ filter.

Embodiment 305. The system of Embodiment 301, further comprising a second NH₃ filter configured to reduce a concentration of the residual ammonia in the reformate stream using a scrubbing fluid.

Embodiment 306. The system of Embodiment 305, wherein the reformate stream is provided to the second NH₃ filter from a position between the reformer and an H₂ processing module.

Embodiment 307. The system of Embodiment 306, wherein the position is at one or more fluid lines that fluidically couple at least one of: the reformer and an H₂ processing module; the reformer and an adsorbent; the adsorbent and the H₂ processing module; the reformer and a first flow control module; the first flow control module and the adsorbent; the adsorbent and a second flow control module; or the second flow control module and the H₂ processing module.

Embodiment 308. The system of Embodiment 305, wherein the reformate stream is diluted with an inert gas before being provided to the second NH₃ filter.

Embodiment 309. An ammonia decomposition system, the system comprising: a reformer configured to reform ammonia to generate a reformate stream comprising hydrogen and nitrogen; and a reactor adjacent to the reformer configured to transfer heat from an exothermic reaction to the reformer, wherein the exothermic reaction consumes at least a portion of the hydrogen.

Embodiment 310. The system of Embodiment 309, wherein the exothermic reaction comprises oil hydrogenation.

Embodiment 311. An ammonia decomposition system, the system comprising:
an electrical heater configured to heat a reformer to a target temperature range, wherein the reformer is configured to reform ammonia to generate a reformate stream comprising hydrogen and nitrogen; and
an H₂ processing module configured to utilize a portion of the hydrogen in the reformate stream to generate electrical power,
wherein the utilized portion comprises at least about 80% of the hydrogen in the reformate stream, and
wherein at least part of the electrical power generated by the H₂ processing module is provided to the electrical heater to heat the reformer.

Embodiment 312. The system of Embodiment 311, wherein the hydrogen processing module comprises a fuel cell.

Embodiment 313. The system of Embodiment 311, wherein the hydrogen processing module comprises a combustion engine.

Embodiment 314. The system of Embodiment 311, wherein the electrical heater is configured to receive low-carbon electrical power to heat the reformer.

Embodiment 315. The system of Embodiment 314, wherein the low-carbon electrical power is sourced from at least one of: a photovoltaic solar generator; a concentrated solar power (CSP) generator; a wind turbine generator; a hydropower generator; a geothermal generator; a biofuel-fired generator; an ocean-power generator; a nuclear generator; or stored electrical power.

Embodiment 316. The system of Embodiment 311, wherein a portion of the hydrogen in the reformate stream is not utilized in the H₂ processing module.

Embodiment 317. The system of Embodiment 316, wherein the nonutilized portion of the hydrogen comprises less than about 20% of the hydrogen.

Embodiment 318. The system of Embodiment 316, wherein the nonutilized portion of the hydrogen is provided to a filter configured to remove water, ammonia, or a combination thereof.

Embodiment 319. The system of Embodiment 316, wherein the nonutilized portion of the hydrogen is used to purge an ammonia filter.

Embodiment 320. The system of Embodiment 316, wherein the nonutilized portion of the hydrogen is combusted to heat at least one of: the reformer; an NH₃ filter to desorb ammonia from the NH₃ filter; a water filter to desorb water from the water filter; a water boiler; or a heat-transfer fluid.

Embodiment 321. The system of Embodiment 316, wherein the nonutilized portion of the hydrogen is not provided to the H₂ processing module.

Embodiment 322. An ammonia reforming method, the method comprising:
(a) reforming ammonia (NH₃) using a reformer to generate a reformate stream comprising hydrogen (H₂), nitrogen (N₂), and residual ammonia;
(b) reducing a concentration of the residual ammonia in the reformate stream using scrubbing fluid; and
(c) further reducing the concentration of the residual ammonia in the reformate stream using an adsorbent.

Embodiment 323. The method of Embodiment 322, further comprising using a water extraction device to extract water from the reformate stream.

Embodiment 324. The method of Embodiment 323, wherein the water extraction device extracts the water from the reformate stream after (b).

Embodiment 325. The method of Embodiment 323, wherein the water extraction device comprises a chiller or condenser.

Embodiment 326. The method of Embodiment 322, wherein the scrubbing fluid comprises a first scrubbing fluid and a second scrubbing fluid arranged in parallel fluid communication.

Embodiment 327. The method of Embodiment 326, wherein the first scrubbing fluid stops performing (b) and the second scrubbing fluid starts performing (b).

Embodiment 328. The method of Embodiment 322, further comprising utilizing at least a portion of the hydrogen in the reformate stream using a fuel cell to generate electricity.

Embodiment 329. The method of Embodiment 328, further comprising outputting an anode off-gas and a cathode off-gas from the fuel cell.

Embodiment 330. The method of Embodiment 329, further comprising extracting water from at least one of (i) the anode off-gas or (ii) the cathode off-gas using one or more water extraction devices and providing the extracted water to a drain tank.

Embodiment 331. The method of Embodiment 330, wherein the extracted water is provided to the drain tank using gravity.

Embodiment 332. The method of Embodiment 330, further comprising extracting water from a combustion exhaust output by a combustion heater configured to heat the reformer, and providing the water extracted from the combustion exhaust to the drain tank.

Embodiment 333. The method of Embodiment 330, further comprising providing the extracted water to the scrubbing fluid.

Embodiment 334. The method of Embodiment 330, further comprising using a perfluorinated and polyfluorinated substance (PFAS) filter to remove PFAS from the extracted water.

Embodiment 335. The method of Embodiment 334, further comprising discharging the extracted water after filtering to remove the PFAS.

Embodiment 336. The method of Embodiment 335, wherein the extracted water is discharged based on a concentration of the PFAS in the extracted water being less than a threshold concentration.

Embodiment 337. An ammonia reforming method, the method comprising:
(a) reforming ammonia (NH₃) using a reformer to generate a reformate stream comprising hydrogen (H₂) and nitrogen (N₂);
(b) utilizing at least a portion of the hydrogen in the reformate stream using a fuel cell to generate electricity;
(c) outputting an anode off-gas and a cathode off-gas from the fuel cell;
(d) extracting water from at least one of (i) the anode off-gas or (ii) the cathode off-gas using one or more water extraction devices; and
(e) using a perfluorinated and polyfluorinated substance (PFAS) filter to remove PFAS from the extracted water.

Embodiment 338. The method of Embodiment 337, further comprising reducing a concentration of residual ammonia in the reformate stream using scrubbing fluid.

Embodiment 339. The method of Embodiment 338, wherein the scrubbing fluid reduces the concentration of the residual ammonia in the reformate stream after (a).

Embodiment 340. The method of Embodiment 339, further comprising providing the extracted water to the scrubbing fluid.

Embodiment 341. The method of Embodiment 340, wherein the extracted water is provided to the scrubbing fluid after (d).

Embodiment 342. The method of Embodiment 337, further comprising discharging the extracted water after filtering to remove the PFAS.

Embodiment 343. The method of Embodiment 342, wherein the extracted water is discharged based on a concentration of the PFAS in the extracted water being less than a threshold concentration.

Embodiment 344. An ammonia reforming method, comprising: reforming ammonia (NH₃) in a reformer to generate a reformate stream comprising hydrogen (H₂), nitrogen (N₂), and residual ammonia; reducing a concentration of the residual ammonia in the reformate stream by passing the reformate stream through a scrubber comprising a scrubbing fluid, thereby generating an ammonia-containing solution comprising at least part of the residual ammonia and the scrubbing fluid, and generating a purified reformate stream; and reducing a concentration of the at least part of the residual ammonia in the ammonia-containing solution by passing a gas stream through a stripper comprising the ammonia-containing solution, thereby regenerating the scrubbing fluid, and generating an ammonia-containing gas stream including the at least part of the residual ammonia.

Embodiment 345. The method of Embodiment 344, wherein the gas stream comprises at least one of air or an inert gas.

Embodiment 346. The method of Embodiment 344, further comprising: heating the reformer using a combustion heater; and transferring heat from a combustion exhaust of the combustion heater to the gas stream before the gas stream passes through the stripper.

Embodiment 347. The method of Embodiment 344, further comprising transferring heat from the reformate stream to the gas stream before the gas stream passes through the stripper.

Embodiment 348. The method of Embodiment 344, further comprising: heating the reformer using a combustion heater; and transferring heat from the combustion exhaust to the ammonia-containing solution before providing the ammonia-containing solution from the scrubber to the stripper.

Embodiment 349. The method of Embodiment 344, further comprising transferring heat from the reformate stream to the ammonia-containing solution stream before providing the ammonia-containing solution from the scrubber to the stripper.

Embodiment 350. The method of Embodiment 344, further comprising oxidizing the at least part of the residual ammonia in the ammonia-containing gas stream, thereby generating a purified gas stream.

Embodiment 351. The method of Embodiment 350, wherein the at least part of the residual ammonia is oxidized using an ammonia oxidation catalyst.

Embodiment 352. The method of Embodiment 350, wherein the purified gas stream is provided to a combustion heater.

Embodiment 353. The method of Embodiment 352, wherein the combustion heater is configured to heat the reformer.

Embodiment 354. The method of Embodiment 344, wherein the regenerated scrubbing fluid is provided from the stripper to the scrubber.

Embodiment 355. The method of Embodiment 344, further comprising transferring heat from the scrubbing fluid to the ammonia.

Embodiment 356. The method of Embodiment 355, wherein the heat is transferred from the scrubbing fluid to the ammonia before at least one of: the reforming of the ammonia; or the reducing of the concentration of the residual ammonia in the reformate stream by passing the reformate stream through the scrubber.

Embodiment 357. The method of Embodiment 344, further comprising transferring heat from the scrubbing fluid regenerated by the stripper to the ammonia-containing solution.

Embodiment 358. The method of Embodiment 344, further comprising using an ammonia filter to reduce a concentration of a remaining part of the residual ammonia in the purified reformate stream.

Embodiment 359. The method of Embodiment 358, wherein the ammonia filter comprises an adsorbent.

Embodiment 360. The method of Embodiment 358, wherein the ammonia filter comprises an ion exchange filter.

Embodiment 361. The method of Embodiment 344, further comprising using a water extraction device to reduce a concentration of water in the purified reformate stream.

Embodiment 362. The method of Embodiment 361, wherein the water extraction device comprises a silica gel.

Embodiment 363. The method of Embodiment 361, wherein the water extraction device comprises a membrane humidifier.

Embodiment 364. The method of Embodiment 363, wherein the membrane humidifier is configured to humidify the purified reformate stream after an adsorbent reduces the concentration of a remaining part of the residual ammonia in the purified reformate stream.

Embodiment 365. The method of Embodiment 363, wherein the membrane humidifier is configured to humidify the purified reformate stream before an ion exchange filter reduces the concentration of a remaining part of the residual ammonia in the purified reformate stream.

Embodiment 366. A system, comprising: an ammonia reformer configured to reform ammonia (NH₃) to generate a reformate stream comprising hydrogen (H₂), nitrogen (N₂), and residual ammonia; a scrubber comprising a scrubbing fluid, wherein the scrubber is configured to reduce a concentration of the residual ammonia in the reformate stream by passing the reformate stream through the scrubber, thereby generating an ammonia-containing solution comprising at least part of the residual ammonia and the scrubbing fluid, and generating a purified reformate stream; and a stripper configured to reduce a concentration of the at least part of the residual ammonia in the ammonia-containing solution by passing a gas stream through the stripper comprising the ammonia-containing solution, thereby regenerating the scrubbing fluid, and generating an ammonia-containing gas stream including the at least part of the residual ammonia.

Embodiment 367. An ammonia reforming method, comprising reforming ammonia (NH₃) in a reformer to generate a reformate stream comprising hydrogen (H₂) and nitrogen (N₂); and using a fuel cell to process a second portion of the hydrogen in the reformate stream to generate electricity.

Embodiment 368. The method of Embodiment 367, wherein the fuel cell comprises at least one of: a proton exchange membrane fuel cell (PEMFC), a solid oxide fuel cell (SOFC), a phosphoric acid fuel cell (PAFC), or a molten carbonate fuel cell (MCFC).

Embodiment 369. The method of Embodiment 367, further comprising transferring heat from the fuel cell to the ammonia before the ammonia is reformed in the reformer.

Embodiment 370. The method of Embodiment 369, wherein the heat is transferred from the fuel cell to the ammonia by transferring the heat from at least one of (i) an anode off-gas of the fuel cell, (ii) a cathode off-gas of the fuel cell, or (iii) a heat transfer fluid configured to cool the fuel cell.

Embodiment 371. The method of Embodiment 370, further comprising driving a turbine using the heat transfer fluid before transferring the heat from the heat transfer fluid to the ammonia.

Embodiment 372. The method of Embodiment 369, further comprising driving a turbine using the heated ammonia before the ammonia is reformed.

Embodiment 373. The method of Embodiment 367, further comprising transferring heat from the fuel cell to a gas stream.

Embodiment 374. The method of Embodiment 373, wherein the heat is transferred from the fuel cell to the gas stream by transferring the heat from at least one of (i) an anode off-gas of the fuel cell, (ii) a cathode off-gas of the fuel cell, or (iii) a heat transfer fluid configured to cool the fuel cell.

Embodiment 375. The method of Embodiment 373, further comprising providing the heated gas stream to at least one of (i) the fuel cell, (ii) a combustion heater configured to heat the reformer, or (iii) a stripper configured to remove at least part of residual ammonia from an ammonia-containing solution.

Embodiment 376. The method of Embodiment 367, further comprising compressing an air stream, and providing the compressed air stream to the fuel cell and a combustion heater configured to heat the reformer.

Embodiment 377. The method of Embodiment 367, further comprising driving a turbine using the reformate stream.

Embodiment 378. The method of Embodiment 377, further comprising using the turbine to drive a compressor configured to compress an anode off-gas of the fuel cell.

Embodiment 379. The method of Embodiment 367, further comprising transferring heat from the fuel cell to an ammonia-containing solution.

Embodiment 380. The method of Embodiment 379, wherein the heat is transferred to the ammonia-containing solution from at least one of (i) an anode off-gas of the fuel cell, (ii) a cathode off-gas of the fuel cell, or (iii) a heat transfer fluid configured to cool the fuel cell.

Embodiment 381. The method of Embodiment 379, wherein the ammonia-containing solution is generated by passing the reformate stream through a scrubber to remove at least part of residual ammonia in the reformate stream.

Embodiment 382. The method of Embodiment 379, further comprising providing the heated ammonia-containing solution to a stripper configured to remove the at least part of the residual ammonia from the ammonia-containing solution.

Embodiment 383. The method of Embodiment 367, further comprising generating a mixture by mixing at least two of (i) an anode off-gas of the fuel cell, (ii) a gas stream, or (iii) a first portion of the hydrogen in the reformate stream.

Embodiment 384. The method of Embodiment 383, further comprising providing the mixture to a combustion heater configured to heat the reformer.

Embodiment 385. The method of Embodiment 383, wherein the mixture is generated using a vacuum ejector.

Embodiment 386. The method of Embodiment 367, further comprising providing the reformate stream to a membrane configured to separate the hydrogen from the nitrogen and residual ammonia in the reformate stream, wherein the membrane generates a permeate stream comprising the separated hydrogen, wherein the membrane generates a retentate stream comprising leftover hydrogen that is not separated by the membrane, the nitrogen, and the residual ammonia.

Embodiment 387. The method of Embodiment 386, further comprising providing the permeate stream to the fuel cell.

Embodiment 388. The method of Embodiment 387, further comprising providing an anode off-gas of the fuel cell to the permeate stream.

Embodiment 389. The method of Embodiment 386, further comprising providing the retentate stream to a combustion heater configured to heat the reformer.

Embodiment 390. The method of Embodiment 389, further comprising providing the retentate stream to an ammonia oxidation catalyst before providing the retentate stream to the combustion heater.

Embodiment 391. The method of Embodiment 367, further comprising providing at least part of an anode off-gas of the fuel cell to an ammonia oxidation catalyst.

Embodiment 392. The method of claim 391, further comprising providing a first part of a cathode off-gas of the fuel cell to the ammonia oxidation catalyst.

Embodiment 393. The method of Embodiment 391, further comprising providing a purified anode off-gas from the ammonia oxidation catalyst to a combustion heater in thermal communication with the reformer.

Embodiment 394. The method of Embodiment 393, further comprising providing a second part of a cathode off-gas of the fuel cell to the combustion heater.

Embodiment 395. The method of Embodiment 393, further comprising transferring heat from a combustion exhaust of the combustion heater to at least one of (i) an air stream provided to the fuel cell, or (ii) the ammonia provided to the reformer.\

Embodiment 396. The method of Embodiment 393, further comprising using a combustion exhaust of the combustion heater to drive a turbine.

Embodiment 397. The method of Embodiment 396, further comprising using the turbine to drive a compressor configured to compress at least one of (i) an air stream provided to the fuel cell, (ii) the reformate stream generated by the reformer, or (iii) the anode off-gas of the fuel cell.

Embodiment 398. A system, comprising: a reformer configured to reform ammonia (NH₃) to generate a reformate stream comprising hydrogen (H₂) and nitrogen (N₂); and a fuel cell configured to process a second portion of the hydrogen in the reformate stream to generate electricity.

Embodiment 399. A method, comprising oxidizing residual ammonia in a gas stream using an ammonia oxidation catalyst.

Embodiment 400. The method of Embodiment 399, further comprising, before oxidizing the residual ammonia in the gas stream, desorbing the residual ammonia from an adsorbent using the gas stream.

Embodiment 401. The method of Embodiment 400, wherein the adsorbent is configured to adsorb the residual ammonia from a reformate stream comprising hydrogen (H₂), nitrogen (N₂), and the residual ammonia.

Embodiment 402. The method of Embodiment 399, further comprising, before oxidizing the residual ammonia in the gas stream, removing the residual ammonia from an ammonia-contaminated scrubbing fluid using the gas stream, thereby regenerating the scrubbing fluid.

Embodiment 403. The method of Embodiment 399, further comprising, before oxidizing the residual ammonia in the gas stream, separating the residual ammonia from a reformate stream comprising hydrogen (H₂), nitrogen (N₂), and the residual ammonia, thereby generating the gas stream including the residual ammonia.

Embodiment 404. The method of Embodiment 399, further comprising absorbing heat from the oxidation by reforming leftover residual ammonia that is not oxidized using an ammonia reforming catalyst.

Embodiment 405. The method of Embodiment 404, wherein the ammonia reforming catalyst is in thermal communication with the ammonia oxidation catalyst.

Embodiment 406. The method of Embodiment 399, wherein the gas stream is at least one of (i) a reformate stream comprising hydrogen and nitrogen, (ii) an inert gas, or (iii) air.

Embodiment 407. The method of Embodiment 399, further comprising absorbing heat from the oxidation by boiling fluid in a boiler.

Embodiment 408. The method of Embodiment 407, wherein the boiler in thermal communication with the ammonia oxidation catalyst.

Embodiment 409. An ammonia oxidation catalyst configured to oxidize residual ammonia in a gas stream.

Embodiment 410. An ammonia reforming method, comprising: (a) heating a first reformer to a first target temperature range; (b) reforming an NH₃ stream at a first flowrate in the first reformer to generate a first reformate stream comprising hydrogen (H₂) and nitrogen (N₂); (c) combusting at least part of the first reformate stream to heat a second reformer to a second target temperature range; (d) reforming the NH₃ stream at a second flowrate in the second reformer to generate a second reformate stream comprising H₂ and N₂, wherein the second flowrate is greater than the first flowrate; and (e) combusting a first portion of the second reformate stream to heat the second reformer.

Embodiment 411. The method of Embodiment 410, wherein the first reformer comprises a first ammonia reforming catalyst and the second reformer comprises a second ammonia reforming catalyst.

Embodiment 412. The method of Embodiment 411, wherein the first ammonia reforming catalyst comprises at least one of: Ru, Pt, Pd, Ni, Co, Mo, Fe, or Cu.

Embodiment 413. The method of Embodiment 411, wherein the second ammonia reforming catalyst comprises at least one of: Ru, Pt, Pd, Ni, Co, Mo, Fe, or Cu.

Embodiment 414. The method of Embodiment 411, wherein the first ammonia reforming catalyst and the second ammonia reforming catalyst have a same chemical composition.

Embodiment 415. The method of Embodiment 411, wherein the first ammonia reforming catalyst and the second ammonia reforming catalyst have at least partially a same chemical composition.

Embodiment 416. The method of Embodiment 411, wherein the first ammonia reforming catalyst and the second ammonia reforming catalyst have different chemical compositions.

Embodiment 417. The method of Embodiment 410, wherein the first reformer and the second reformer have different housings or vessels.

Embodiment 418. The method of Embodiment 410, wherein the first reformer and the second reformer share a housing or vessel.

Embodiment 419. The method of Embodiment 418, wherein the first reformer is a first region of the housing or vessel, and the second reformer is a second region of the housing or vessel.

Embodiment 420. The method of Embodiment 410, wherein the first reformer and the second reformer are at least partially in thermal communication with each other.

Embodiment 421. The method of Embodiment 410, wherein the first reformer and the second reformer are in fluid communication.

Embodiment 422. The method of Embodiment 421, wherein the method further comprises passing at least one of the following through the first reformer, the second reformer, or a combination thereof: (i) the NH₃ stream at the first flowrate, (ii) the NH₃ stream at the second flowrate, (iii) the first reformate stream, or (iv) the second reformate stream.

Embodiment 423. The method of Embodiment 422, further comprising passing at least three of (i) to (iv) through the first reformer, the second reformer, or a combination thereof.

Embodiment 424. The method of Embodiment 422, further comprising passing all of (i) to (iv) through the first reformer, the second reformer, or a combination thereof.

Embodiment 425. The method of Embodiment 422, further comprising ceasing the passing of at least one of (i) to (iv) through the first reformer, the second reformer, or a combination thereof.

Embodiment 426. The method of Embodiment 422, further comprising reducing the passing of at least one of (i) to (iv) through the first reformer, the second reformer, or a combination thereof.

Embodiment 427. The method of Embodiment 422, wherein (i) or (ii) are at least partially reformed in the first reformer and subsequently reformed in the second reformer.

Embodiment 428. The method of Embodiment 422, wherein (i) or (ii) are at least partially reformed in the second reformer and subsequently reformed in the first reformer.

Embodiment 429. The method of Embodiment 410, further comprising ceasing or reducing the heating of the first reformer.

Embodiment 430. The method of Embodiment 410, further comprising using a combustion heater to combust at least one of (1) the first reformate stream or (2) the first portion of the second reformate stream, wherein the combustion heater is in thermal communication with the second reformer.

Embodiment 431. The method of Embodiment 430, wherein the combustion heater performs at least one of (c) or (e).

Embodiment 432. The method of Embodiment 430, wherein the combustion that heats the second reformer is fuel-rich.

Embodiment 433. The method of Embodiment 430, wherein the combustion that heats the second reformer is fuel-lean.

Embodiment 434. The method of Embodiment 410, further comprising using an electrical heater to heat the first reformer.

Embodiment 435. The method of Embodiment 410, further comprising using a combustion heater to combust a fuel to heat the first reformer, wherein the combustion heater is in thermal communication with the first reformer.

Embodiment 436. The method of Embodiment 435, wherein the fuel comprises at least one of hydrogen, ammonia, a hydrocarbon, or at least part of the first reformate stream.

Embodiment 437. The method of Embodiment 435, wherein the fuel is supplied from a fuel storage tank.

Embodiment 438. The method of Embodiment 435, wherein the combustion that heats the first reformer is fuel-rich.

Embodiment 439. The method of Embodiment 435, wherein the combustion that heats the first reformer is fuel-lean.

Embodiment 440. An ammonia (NH₃) reforming system, comprising: a first reformer configured to reform an NH₃ stream at a first flowrate and at a first target temperature range to generate a first reformate stream comprising hydrogen (H₂) and nitrogen (N₂); wherein the first reformer is configured to be heated to the first target temperature range; and a second reformer configured to reform the NH₃ stream at a second flowrate and at a second target temperature range to generate a second reformate stream comprising H₂ and N₂, wherein the second reformer is configured to be heated to the second target temperature range by combusting the first reformate stream, wherein the second flowrate is greater than the first flowrate, and wherein the second reformer is configured to be heated by combusting a first portion of the second reformate stream.

Embodiment 441. The system of Embodiment 440, wherein the first reformer comprises a first ammonia reforming catalyst and the second reformer comprises a second ammonia reforming catalyst.

Embodiment 442. The system of Embodiment 441, wherein the first ammonia reforming catalyst comprises at least one of: Ru, Pt, Pd, Ni, Co, Mo, Fe, or Cu.

Embodiment 443. The system of Embodiment 441, wherein the second ammonia reforming catalyst comprises at least one of: Ru, Pt, Pd, Ni, Co, Mo, Fe, or Cu.

Embodiment 444. The system of Embodiment 441, wherein the first ammonia reforming catalyst and the second ammonia reforming catalyst have a same chemical composition.

Embodiment 445. The system of Embodiment 441, wherein the first ammonia reforming catalyst and the second ammonia reforming catalyst have at least partially a same chemical composition.

Embodiment 446. The system of Embodiment 441, wherein the first ammonia reforming catalyst and the second ammonia reforming catalyst have different chemical compositions.

Embodiment 447. The system of Embodiment 440, wherein the first reformer and the second reformer have different housings or vessels.

Embodiment 448. The system of Embodiment 440, wherein the first reformer and the second reformer share a housing or vessel.

Embodiment 449. The system of Embodiment 448, wherein the first reformer is a first region of the housing or vessel, and the second reformer is a second region of the housing or vessel.

Embodiment 450. The system of Embodiment 440, wherein the first reformer and the second reformer are at least partially in thermal communication with each other.

Embodiment 451. The system of Embodiment 440, wherein the first reformer and the second reformer are in fluid communication.

Embodiment 452. The system of Embodiment 451, wherein the first reformer, the second reformer, or a combination thereof are configured to receive at least one of the following: (i) the NH₃ stream at the first flowrate, (ii) the NH₃ stream at the second flowrate, (iii) the first reformate stream, or (iv) the second reformate stream.

Embodiment 453. The system of Embodiment 452, wherein the first reformer, the second reformer, or a combination thereof are configured to receive at least three of (i) to (iv).

Embodiment 454. The system of Embodiment 452, wherein the first reformer, the second reformer, or a combination thereof are configured to receive all of (i) to (iv).

Embodiment 455. The system of Embodiment 452, wherein the first reformer, the second reformer, or a combination thereof are configured to cease receiving at least one of (i) to (iv).

Embodiment 456. The system of Embodiment 452, wherein the first reformer, the second reformer, or a combination thereof are configured to reduce receiving at least one of (i) to (iv).

Embodiment 457. The system of Embodiment 452, wherein the first reformer is configured to partially reform (i) or (ii), and the second reformer is configured to subsequently reform (i) or

(ii).

Embodiment 458. The system of Embodiment 452, wherein the second reformer is configured to partially reform (i) or (ii), and the first reformer is configured to subsequently reform (i) or (ii).

Embodiment 459. The system of Embodiment 452, wherein the first reformer is configured to cease or reduce heating.

Embodiment 460. The system of Embodiment 440, further comprising a combustion heater configured to combust at least one of (1) the first reformate stream or (2) the first portion of the second reformate stream to heat the second reformer, wherein the combustion heater is in thermal communication with the second reformer.

Embodiment 461. The system of Embodiment 460, wherein the combustion that heats the second reformer is fuel-rich.

Embodiment 462. The system of Embodiment 460, wherein the combustion that heats the second reformer is fuel-lean.

Embodiment 463. The system of Embodiment 440, further comprising an electrical heater configured to heat the first reformer.

Embodiment 464. The system of Embodiment 440, further comprising a combustion heater configured to combust a fuel to heat the first reformer, wherein the combustion heater is in thermal communication with the first reformer.

Embodiment 465. The system of Embodiment 464, wherein the fuel comprises at least one of hydrogen, ammonia, a hydrocarbon, or at least part of the first reformate stream.

Embodiment 466. The system of Embodiment 464, wherein the fuel is supplied from a fuel storage tank.

Embodiment 467. The system of Embodiment 464, wherein the combustion that heats the first reformer is fuel-rich.

Embodiment 468. The system of Embodiment 464, wherein the combustion that heats the first reformer is fuel-lean.

Embodiment 469. An ammonia (NH₃) reforming method, comprising: (a) reforming an NH₃ stream at a first flowrate using an NH₃ reforming catalyst to generate a first reformate stream comprising hydrogen (H₂) and nitrogen (N₂); (b) combusting the first reformate stream to heat the NH₃ reforming catalyst; (c) reforming the NH₃ stream at a second flowrate using the NH₃ reforming catalyst to generate a second reformate stream comprising H₂ and N₂, wherein the second flowrate is greater than the first flowrate; and (d) combusting a first portion of the second reformate stream to heat the NH₃ reforming catalyst.

Embodiment 470. The method of Embodiment 469, wherein the NH₃ reforming catalyst is in a reformer.

Embodiment 471. The method of Embodiment 469, wherein a first region of the NH₃ reforming catalyst is in a first reformer, and a second region of the NH₃ reforming catalyst is in a second reformer.

Embodiment 472. The method of Embodiment 469, wherein the NH₃ reforming catalyst is in thermal communication with an electric heater, a combustion heater, or a combination thereof.

Embodiment 473. The method of Embodiment 469, wherein the NH₃ reforming catalyst is heated by an electrical heater before (a).

Embodiment 474. The method of Embodiment 469, wherein a first region of the NH₃ reforming catalyst is heated by an electrical heater, and a second region of the NH₃ reforming catalyst is heated by a combustion heater.

Embodiment 475. The method of Embodiment 474, wherein (b) and (d) are performed using the combustion heater.

Embodiment 476. The method of Embodiment 469, wherein the NH₃ reforming catalyst is heated to a target temperature range.

Embodiment 477. The method of Embodiment 469, wherein the NH₃ reforming catalyst is at a target temperature range.

Embodiment 478. The method of Embodiment 469, wherein a first region of the NH₃ reforming catalyst is heated to a first target temperature range, and a second region of the NH₃ reforming catalyst is heated to a second target temperature range.

Embodiment 479. The method of Embodiment 478, wherein the first target temperature range and the second target temperature range at least partially overlap.

Embodiment 480. The method of Embodiment 478, wherein the first target temperature range and the second target temperature range are different.

Embodiment 481. The method of Embodiment 478, wherein a midpoint temperature of the first target temperature range is greater than a midpoint temperature of the second target temperature range.

Embodiment 482. The method of Embodiment 469, wherein a first region of the NH₃ reforming catalyst comprises a first NH₃ reforming catalyst and a second region of the NH₃ reforming catalyst comprises a second NH₃ reforming catalyst.

Embodiment 483. The method of Embodiment 482, wherein the first NH₃ reforming catalyst comprises at least one of: Ru, Pt, Pd, Ni, Co, Mo, Fe, or Cu.

Embodiment 484. The method of Embodiment 482, wherein the second NH₃ reforming catalyst comprises at least one of: Ru, Pt, Pd, Ni, Co, Mo, Fe, or Cu.

Embodiment 485. The method of Embodiment 482, wherein the first ammonia reforming catalyst and the second ammonia reforming catalyst have a same chemical composition.

Embodiment 486. The method of Embodiment 482, wherein the first ammonia reforming catalyst and the second ammonia reforming catalyst have at least partially a same chemical composition.

Embodiment 487. The method of Embodiment 482, wherein the first ammonia reforming catalyst and the second ammonia reforming catalyst have different chemical compositions.

Embodiment 488. An ammonia (NH₃) reforming system, comprising: (a) reforming an NH₃ stream at a first flowrate using an NH₃ reforming catalyst to generate a first reformate stream comprising hydrogen (H₂) and nitrogen (N₂); (b) combusting the first reformate stream to heat the NH₃ reforming catalyst; (c) reforming the NH₃ stream at a second flowrate using the NH₃ reforming catalyst to generate a second reformate stream comprising H₂ and N₂, wherein the second flowrate is greater than the first flowrate; and (d) combusting a first portion of the second reformate stream to heat the NH₃ reforming catalyst.

Embodiment 489. The system of Embodiment 488, further comprising a reformer comprising the NH₃ reforming catalyst.

Embodiment 490. The system of Embodiment 488, further comprising a first reformer comprising a first region of the NH₃ reforming catalyst, and a second reformer comprising a second region of the NH₃ reforming catalyst.

Embodiment 491. The system of Embodiment 488, wherein the NH₃ reforming catalyst is in thermal communication with an electric heater, a combustion heater, or a combination thereof.

Embodiment 492. The system of Embodiment 488, further comprising an electrical heater configured to heat the NH₃ reforming catalyst before (a).

Embodiment 493. The system of Embodiment 488, further comprising an electrical heater configured to heat a first region of the NH₃ reforming catalyst, and a combustion heater configured to heat a second region of the NH₃ reforming catalyst.

Embodiment 494. The system of Embodiment 491, wherein the combustion heater is configured to perform (b) and (d).

Embodiment 495. The system of Embodiment 488, wherein the NH₃ reforming catalyst is configured to be heated to a target temperature range.

Embodiment 496. The system of Embodiment 488, wherein the NH₃ reforming catalyst is configured to be at a target temperature range.

Embodiment 497. The system of Embodiment 488, wherein a first region of the NH₃ reforming catalyst is configured to be heated to a first target temperature range, and a second region of the NH₃ reforming catalyst is configured to be heated to a second target temperature range.

Embodiment 498. The system of Embodiment 497, wherein the first target temperature range and the second target temperature range at least partially overlap.

Embodiment 499. The system of Embodiment 497, wherein the first target temperature range and the second target temperature range are different.

Embodiment 500. The system of Embodiment 497, wherein a midpoint temperature of the first target temperature range is greater than a midpoint temperature of the second target temperature range.

Embodiment 501. The system of Embodiment 488, wherein a first region of the NH₃ reforming catalyst comprises a first NH₃ reforming catalyst, and a second region of the NH₃ reforming catalyst comprises a second NH₃ reforming catalyst.

Embodiment 502. The system of Embodiment 501, wherein the first NH₃ reforming catalyst comprises at least one of: Ru, Pt, Pd, Ni, Co, Mo, Fe, or Cu.

Embodiment 503. The system of Embodiment 501, wherein the second NH₃ reforming catalyst comprises at least one of: Ru, Pt, Pd, Ni, Co, Mo, Fe, or Cu.

Embodiment 504. The system of Embodiment 501, wherein the first ammonia reforming catalyst and the second ammonia reforming catalyst have a same chemical composition.

Embodiment 505. The system of Embodiment 501, wherein the first ammonia reforming catalyst and the second ammonia reforming catalyst have at least partially a same chemical composition.

Embodiment 506. The system of Embodiment 501, wherein the first ammonia reforming catalyst and the second ammonia reforming catalyst have different chemical compositions.

Embodiment 507. An ammonia decomposition method, comprising: (a) providing an inert gas to a first reformer; and (b) reforming ammonia using the first reformer to generate a first reformate stream comprising hydrogen and nitrogen.

Embodiment 508. The method of Embodiment 507, wherein (b) is performed after stopping (a).

Embodiment 509. The method of Embodiment 507, wherein (a) purges the first reformer thereby removing residual contaminants.

Embodiment 510. The method of Embodiment 509, wherein the residual contaminants comprise at least one of ammonia, oxygen, water, or hydrogen.

Embodiment 511. The method of Embodiment 507, wherein the first reformer is an electrically heated reformer, a combustion heated reformer, or a combination thereof.

Embodiment 512. The method of Embodiment 511, further comprising heating the first reformer during (a).

Embodiment 513. The method of Embodiment 507, further comprising, recirculating the inert gas to the first reformer after (a), so that the inert gas that leaves the first reformer is provided again to the first reformer.

Embodiment 514. The method of Embodiment 507, further comprising (c) providing the inert gas to a second reformer.

Embodiment 515. The method of Embodiment 514, further comprising, recirculating the inert gas to the second reformer after (c), so that the inert gas that leaves the second reformer is provided again to the second reformer.

Embodiment 516. The method of Embodiment 514, wherein (c) is performed before (b).

Embodiment 517. The method of Embodiment 514, wherein (c) purges the second reformer thereby removing residual contaminants.

Embodiment 518. The method of Embodiment 517, wherein the residual contaminants comprise at least one of ammonia, oxygen, water, or hydrogen.

Embodiment 519. The method of Embodiment 514, wherein the second reformer is an electrically heated reformer, a combustion heated reformer, or a combination thereof.

Embodiment 520. The method of Embodiment 514, further comprising heating the second reformer during (c).

Embodiment 521. The method of Embodiment 514, wherein the inert gas is provided to the second reformer from the first reformer, so that the inert gas that leaves the first reformer is provided to the second reformer.

Embodiment 522. The method of Embodiment 521, further comprising recirculating the inert gas to the second reformer after (c), so that the inert gas that leaves the first reformer and the second reformer is provided to the second reformer.

Embodiment 523. The method of Embodiment 507, further comprising (d) providing the inert gas to an ammonia filter.

Embodiment 524. The method of Embodiment 523, further comprising, recirculating the inert gas to the ammonia filter after (d), so that the inert gas that leaves the ammonia filter is provided again to the ammonia filter.

Embodiment 525. The method of Embodiment 523, wherein (d) is performed before (b).

Embodiment 526. The method of Embodiment 523, wherein the ammonia filter is at least one of an adsorbent, a scrubber, or an ion exchange filter.

Embodiment 527. The method of Embodiment 507, further comprising (e) providing the inert gas to a combustion heater in thermal communication with the second reformer.

Embodiment 528. The method of Embodiment 527, further comprising, recirculating the inert gas to the combustion heater after (e), so that the inert gas that leaves the combustion heater is provided again to the combustion heater.

Embodiment 529. The method of Embodiment 507, further comprising (f) providing the first reformate stream to a second reformer.

Embodiment 530. The method of Embodiment 507, further comprising (g) providing the first reformate stream to an adsorbent.

Embodiment 531. The method of Embodiment 507, further comprising (h) combusting the first reformate stream in a combustion heater in thermal communication with a second reformer.

Embodiment 532. The method of Embodiment 531, wherein providing the first reformate stream to the combustion heater bypasses the second reformer.

Embodiment 533. The method of Embodiment 531, wherein providing the first reformate stream to the combustion heater bypasses an ammonia filter.

Embodiment 534. The method of Embodiment 533, wherein the ammonia filter is at least one of an adsorbent, a scrubber, or an ion exchange filter.

Embodiment 535. The method of Embodiment 531, further comprising (i) providing the inert gas to the second reformer while (h) is performed.

Embodiment 536. The method of Embodiment 535, wherein the inert gas provided to the second reformer facilitates heat transfer from the combustion heater to an NH₃ reforming catalyst in the second reformer.

Embodiment 537. The method of Embodiment 531, further comprising (j) reforming the ammonia using the second reformer to generate a second reformate stream comprising hydrogen and nitrogen.

Embodiment 538. The method of Embodiment 537, wherein (j) is performed after stopping (b).

Embodiment 539. The method of Embodiment 537, wherein providing the ammonia to the second reformer bypasses the first reformer.

Embodiment 540. The method of Embodiment 539, further comprising providing the ammonia to a heat exchanger before providing the ammonia to the second reformer.

Embodiment 541. The method of Embodiment 540, wherein providing the ammonia to the heat exchanger bypasses the first reformer.

Embodiment 542. The method of Embodiment 507, further comprising using a gas stream to regenerate an ammonia filter and generate an ammonia-containing gas stream and providing the ammonia-containing gas stream to the first reformer.

Embodiment 543. The method of Embodiment 507, further comprising venting or flaring at least one of the inert gas or the first reformate stream.

Embodiment 544. An ammonia decomposition system, comprising: a first reformer configured to (a) receive an inert gas, and (b) reform ammonia to generate a first reformate stream comprising hydrogen and nitrogen.

Embodiment 545. A method for reforming ammonia, the method comprising:
(a) directing ammonia to a reformer at an ammonia flow rate to produce a reformate stream comprising hydrogen and nitrogen;
(b) combusting a first portion of the reformate stream with oxygen at an oxygen flow rate in a combustion heater to heat the reformer;
(c) processing a second portion of the reformate stream in a hydrogen processing module; and
(d) based at least in part on a stimulus, performing one or more of:
   (i) changing the ammonia flow rate,
   (ii) changing a percentage of the reformate stream that is the first portion of the reformate stream,
   (iii) changing a percentage of the reformate stream that is the second portion of the reformate stream, or
   (iv) changing an oxygen flow rate.

Embodiment 546. The method of Embodiment 545, wherein the stimulus is at least in part on a decreased amount of the hydrogen used by the hydrogen processing module.

Embodiment 547. The method of Embodiment 546, wherein the decreased amount of hydrogen is a projected decreased amount of hydrogen.

Embodiment 548. The method of Embodiment 545, wherein the ammonia flow rate is decreased in response to the stimulus.

Embodiment 549. The method of Embodiment 548, wherein the ammonia flow rate is decreased to about zero.

Embodiment 550. The method of Embodiment 548, further comprising reducing or stopping at least one of (a), (b), or (c) after the ammonia flowrate is decreased in response to the stimulus.

Embodiment 551. The method of Embodiment 548, further comprising (e) heating the reformer after the ammonia flow rate is decreased in response to the stimulus.

Embodiment 552. The method of Embodiment 551, wherein an electric heater is used to heat the reformer after the ammonia flow rate is decreased in response to the stimulus.

Embodiment 553. The method of Embodiment 552, wherein an insulated enclosure comprises the reformer enclosed therein, and the electric heater heats the reformer enclosed inside the insulated enclosure.

Embodiment 554. The method of Embodiment 553, wherein the electric heater is attached, affixed, or secured a wall of the insulated enclosure.

Embodiment 555. The method of Embodiment 552, wherein the electric heater is attached or part of the reformer.

Embodiment 556. The method of Embodiment 552, wherein the electric heater is attached, affixed, or secured a wall of the reformer.

Embodiment 557. The method of Embodiment 551, further comprising increasing the ammonia flow rate and reducing or stopping (e).

Embodiment 558. The method of Embodiment 557, further comprising increasing or starting at least one of (a), (b), or (c) after increasing the ammonia flow rate.

Embodiment 559. The method of Embodiment 557, further comprising increasing or starting all of (a), (b), or (c) after increasing the ammonia flow rate.

Embodiment 560. The method of Embodiment 545, wherein at least about 50% of mechanical work or electricity generated by the hydrogen processing module is not used for at least one of vehicle propulsion, battery charging, or hotel load.

Embodiment 561. The method of Embodiment 560, wherein the hotel load comprises at least one of climate control, communications, entertainment, lighting, refrigeration, or water distribution.

Embodiment 562. The method of Embodiment 545, wherein at least about 50% of mechanical work or electricity generated by the hydrogen processing module is used to power at least one of (1) an air supply unit configured to provide the oxygen to the combustion heater or (2) an air supply unit configured to provide oxygen to the hydrogen processing module. It is to be understood that while the present application has been described in conjunction with the detailed description thereof, the foregoing description is intended to illustrate and not limit the scope of the present application, which is defined by the scope of the appended claims. Other aspects, advantages, and modifications are within the scope of the following claims.

What is claimed is:

1. An ammonia (NH₃) reforming method, the method comprising:
(a) heating a first reformer to a first temperature within a first target temperature range;
(b) reforming an NH₃ stream at a first flowrate in the first reformer to generate a first reformate stream comprising hydrogen (H₂) and nitrogen (N₂);
(c) combusting the first reformate stream in a combustion heater to heat a second reformer to a second temperature within a second target temperature range;
(d) reforming the NH₃ stream at a second flowrate in the second reformer to generate a second reformate stream comprising H₂ and N₂, wherein the second flowrate is greater than the first flowrate;
(e) combusting at least a first portion of the second reformate stream in the combustion heater to heat the second reformer; and
(f) increasing the second flowrate to an operating flowrate, wherein the first flowrate is greater than about 5% and less than about 20% of the operating flowrate.

2. The method of claim 1, wherein before step (f), the second flowrate is greater than about 5% and less than about 50% of the operating flowrate.

3. The method of claim 1, wherein the NH₃ stream bypasses the first reformer after (c) or before (d).

4. The method of claim 1, further comprising directing a second portion of the second reformate stream to an H₂ processing module.

5. The method of claim 4, wherein the H₂ processing module comprises a fuel cell or a combustion engine.

6. The method of claim 5, wherein the fuel cell is a proton exchange membrane fuel cell (PEMFC), a solid oxide fuel cell (SOFC), a phosphoric acid fuel cell (PAFC), or a molten carbonate fuel cell (MCFC).

7. The method of claim 5, wherein the combustion engine is a reciprocating piston engine or a gas turbine.

8. The method of claim 1, further comprising transferring heat from the first reformate stream or the second reformate stream to the NH₃ stream.

9. The method of claim 1, further comprising transferring heat from the H₂ processing module to the NH₃ stream.

10. The method of claim 1, further comprising directing the first reformate stream to an NH₃ filter configured to remove residual NH₃ before step (c).

11. The method of claim 10, wherein the NH₃ filter comprises an adsorbent or an ammonia oxidation catalyst.

12. The method of claim 10, further comprising regenerating the NH₃ filter.

13. The method of claim 1, further comprising filtering at least one of the first reformate stream or the second reformate stream to remove residual NH₃.

14. The method of claim 1, further comprising vaporizing the NH₃ stream using an electric heater.

15. The method of claim 1, further comprising vaporizing the NH₃ stream using a heat exchanger.

16. The method of claim 1, further comprising reducing nitrogen oxides (NOₓ) generated by the combustion heater.

17. The method of claim 16, wherein reducing the NOₓ uses a selective catalytic reduction (SCR) catalyst.

18. The method of claim 17, wherein the SCR catalyst comprises platinum or palladium.

19. The method of claim 1, wherein the first reformer is heated by an electrical heater.

20. The method of claim 1, wherein the first reformer or the second reformer contains an ammonia reforming catalyst comprising at least one metal selected from the group consisting of Ru, Pt, Pd, Ni, Co, Mo, Fe, and Cu.
